(19) United States
(12) Patent Application Publication
(10) Pub. No.: US 2026/0288080 A1
(43) Pub. Date: Sep. 24, 2026

(54) SYSTEMS AND METHODS FOR PROVIDING, MODIFYING, AND/OR INTERACTING WITH USER INTERFACES

(71) Applicant: Apple Inc., Cupertino, CA (US)

(72) Inventors: Andrew P. CLYMER, San Jose, CA (US); Yeobeen CHUNG, Sunnyvale, CA (US); Louis R. MIKOLAY, San Francisco, CA (US)

(21) Appl. No.: 19/455,595

(22) Filed: Jan. 21, 2026

Related U.S. Application Data
(60) Provisional application No. 63/775,941, filed on Mar. 21, 2025.
(60) Provisional application No. 63/798,498, filed on May 1, 2025.

(51) Int. Cl. G04G 9/02; G04G 21/00; G06F 3/0481

(52) U.S. Cl. CPC G04G 9/02; G04G 21/00; G06F 3/0481

(57) ABSTRACT

The present disclosure generally relates to providing, modifying, and/or interacting with user interfaces.

### CROSS-REFERENCE TO RELATED APPLICATIONS

This application claims priority to U.S. Provisional Application No. 63/798,498, filed on May 1, 2025, entitled “SYSTEMS AND METHODS FOR PROVIDING, MODIFYING, AND/OR INTERACTING WITH USER INTERFACES,” and claims priority to U.S. Provisional Application No. 63/775,941, filed on Mar. 21, 2025, entitled “SYSTEMS AND METHODS FOR PROVIDING, MODIFYING, AND/OR INTERACTING WITH USER INTERFACES,” the contents of which are hereby incorporated by reference for all purposes, as if fully set forth herein.

### FIELD

The present disclosure relates generally to computer user interfaces, and more specifically to techniques for providing, modifying, and/or interacting with user interfaces.

### BACKGROUND

Computer systems use input devices to detect user inputs. Based on the detected user inputs, computer systems perform operations and provide the user with feedback. For example, in response to user inputs, certain computer systems display visual feedback by displaying content on one or more displays. By providing different user inputs, users can cause computer systems to perform various operations.

### BRIEF SUMMARY

Some techniques for providing, modifying, and/or interacting with user interfaces using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for providing, modifying, and/or interacting with user interfaces. Such methods and interfaces optionally complement or replace other methods for providing, modifying, and/or interacting with user interfaces. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method is performed at a computer system that is in communication with one or more display generation components. The method comprises: displaying, via the one or more display generation components, a time user interface, wherein: the time user interface includes an indication of a respective time; the time user interface includes a first dial that is used to indicate the respective time; and displaying the time user interface includes displaying the first dial moving from a first position of the time user interface to a second position of the time user interface different from the first position as the respective time changes.

In accordance with some embodiments, a non-transitory computer-readable storage medium is described. The non-transitory computer-readable storage medium stores one or more programs configured to be executed by one or more processors of a computer system that is in communication with one or more display generation components. The one or more programs include instructions for: displaying, via the one or more display generation components, a time user interface, wherein: the time user interface includes an indication of a respective time; the time user interface includes a first dial that is used to indicate the respective time; and displaying the time user interface includes displaying the first dial moving from a first position of the time user interface to a second position of the time user interface different from the first position as the respective time changes.

In accordance with some embodiments, a transitory computer-readable storage medium is described. The transitory computer-readable storage medium stores one or more programs configured to be executed by one or more processors of a computer system that is in communication with one or more display generation components. The one or more programs include instructions for: displaying, via the one or more display generation components, a time user interface, wherein: the time user interface includes an indication of a respective time; the time user interface includes a first dial that is used to indicate the respective time; and displaying the time user interface includes displaying the first dial moving from a first position of the time user interface to a second position of the time user interface different from the first position as the respective time changes.

In accordance with some embodiments, a computer system is described. The computer system is configured to communicate with one or more display generation components, and comprises: one or more processors; and memory storing one or more programs configured to be executed by the one or more processors, the one or more programs including instructions for: displaying, via the one or more display generation components, a time user interface, wherein: the time user interface includes an indication of a respective time; the time user interface includes a first dial that is used to indicate the respective time; and displaying the time user interface includes displaying the first dial moving from a first position of the time user interface to a second position of the time user interface different from the first position as the respective time changes.

In accordance with some embodiments, a computer system is described. The computer system is configured to communicate with one or more display generation components, and comprises: means for displaying, via the one or more display generation components, a time user interface, wherein: the time user interface includes an indication of a respective time; the time user interface includes a first dial that is used to indicate the respective time; and displaying the time user interface includes displaying the first dial moving from a first position of the time user interface to a second position of the time user interface different from the first position as the respective time changes.

In accordance with some embodiments, a computer program product is described. The computer program product comprises one or more programs configured to be executed by one or more processors of a computer system that is in communication with one or more display generation components. The one or more programs include instructions for: displaying, via the one or more display generation components, a time user interface, wherein: the time user interface includes an indication of a respective time; the time user interface includes a first dial that is used to indicate the respective time; and displaying the time user interface includes displaying the first dial moving from a first position of the time user interface to a second position of the time user interface different from the first position as the respective time changes.

In accordance with some embodiments, a method is described. The method is performed at a computer system that is in communication with one or more display generation components and one or more input devices. The method comprises: detecting, via the one or more input devices, a first set of one or more user inputs corresponding to a user request to display a wake screen user interface; and in response to detecting the first set of one or more user inputs corresponding to a user request to display a wake screen user interface, displaying, via the one or more display generation components, the wake screen user interface, wherein: the wake screen user interface includes one or more visual media items; and displaying the wake screen user interface includes: in accordance with a determination that the computer system has a first context, displaying, via the one or more display generation components, the wake screen user interface with a first set of one or more visual media items; and in accordance with a determination that the computer system has a second context that is different from the first context, displaying, via the one or more display generation components, the wake screen user interface with a second set of one or more visual media items that is different from the first set of one or more visual media items.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices. The one or more programs include instructions for: detecting, via the one or more input devices, a first set of one or more user inputs corresponding to a user request to display a wake screen user interface; and in response to detecting the first set of one or more user inputs corresponding to a user request to display a wake screen user interface, displaying, via the one or more display generation components, the wake screen user interface, wherein: the wake screen user interface includes one or more visual media items; and displaying the wake screen user interface includes: in accordance with a determination that the computer system has a first context, displaying, via the one or more display generation components, the wake screen user interface with a first set of one or more visual media items; and in accordance with a determination that the computer system has a second context that is different from the first context, displaying, via the one or more display generation components, the wake screen user interface with a second set of one or more visual media items that is different from the first set of one or more visual media items.

In accordance with some embodiments, a transitory computer-readable storage medium is described. The transitory computer-readable storage medium stores one or more programs configured to be executed by one or more processors of a computer system that is in communication with one or more display generation components and one or more input devices. The one or more programs include instructions for: detecting, via the one or more input devices, a first set of one or more user inputs corresponding to a user request to display a wake screen user interface; and in response to detecting the first set of one or more user inputs corresponding to a user request to display a wake screen user interface, displaying, via the one or more display generation components, the wake screen user interface, wherein: the wake screen user interface includes one or more visual media items; and displaying the wake screen user interface includes: in accordance with a determination that the computer system has a first context, displaying, via the one or more display generation components, the wake screen user interface with a first set of one or more visual media items; and in accordance with a determination that the computer system has a second context that is different from the first context, displaying, via the one or more display generation components, the wake screen user interface with a second set of one or more visual media items that is different from the first set of one or more visual media items.

In accordance with some embodiments, a computer system is described. The computer system is configured to communicate with one or more display generation components and one or more input devices, and comprises: one or more processors; and memory storing one or more programs configured to be executed by the one or more processors, the one or more programs including instructions for: detecting, via the one or more input devices, a first set of one or more user inputs corresponding to a user request to display a wake screen user interface; and in response to detecting the first set of one or more user inputs corresponding to a user request to display a wake screen user interface, displaying, via the one or more display generation components, the wake screen user interface, wherein: the wake screen user interface includes one or more visual media items; and displaying the wake screen user interface includes: in accordance with a determination that the computer system has a first context, displaying, via the one or more display generation components, the wake screen user interface with a first set of one or more visual media items; and in accordance with a determination that the computer system has a second context that is different from the first context, displaying, via the one or more display generation components, the wake screen user interface with a second set of one or more visual media items that is different from the first set of one or more visual media items.

In accordance with some embodiments, a computer system is described. The computer system is configured to communicate with one or more display generation components and one or more input devices, and comprises: means for detecting, via the one or more input devices, a first set of one or more user inputs corresponding to a user request to display a wake screen user interface; and means for, in response to detecting the first set of one or more user inputs corresponding to a user request to display a wake screen user interface, displaying, via the one or more display generation components, the wake screen user interface, wherein: the wake screen user interface includes one or more visual media items; and displaying the wake screen user interface includes: in accordance with a determination that the computer system has a first context, displaying, via the one or more display generation components, the wake screen user interface with a first set of one or more visual media items; and in accordance with a determination that the computer system has a second context that is different from the first context, displaying, via the one or more display generation components, the wake screen user interface with a second set of one or more visual media items that is different from the first set of one or more visual media items.

In accordance with some embodiments, a computer program product is described. The computer program product comprises one or more programs configured to be executed by one or more processors of a computer system that is in communication with one or more display generation components and one or more input devices. The one or more programs include instructions for: detecting, via the one or more input devices, a first set of one or more user inputs corresponding to a user request to display a wake screen user interface; and in response to detecting the first set of one or more user inputs corresponding to a user request to display a wake screen user interface, displaying, via the one or more display generation components, the wake screen user interface, wherein: the wake screen user interface includes one or more visual media items; and displaying the wake screen user interface includes: in accordance with a determination that the computer system has a first context, displaying, via the one or more display generation components, the wake screen user interface with a first set of one or more visual media items; and in accordance with a determination that the computer system has a second context that is different from the first context, displaying, via the one or more display generation components, the wake screen user interface with a second set of one or more visual media items that is different from the first set of one or more visual media items.

In accordance with some embodiments, a method is described. The method is performed at a computer system that is in communication with one or more display generation components and one or more input devices. The method comprises: detecting, via the one or more input devices, a first language input that includes one or more words specified by a user of the computer system; and in response to detecting the first language input: in accordance with a determination that the one or more words of the first language input correspond to a request to change a first user interface, initiating a process to change the first user interface in a manner that will persist after the first language input has ended.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices. The one or more programs include instructions for: detecting, via the one or more input devices, a first language input that includes one or more words specified by a user of the computer system; and in response to detecting the first language input: in accordance with a determination that the one or more words of the first language input correspond to a request to change a first user interface, initiating a process to change the first user interface in a manner that will persist after the first language input has ended.

In accordance with some embodiments, a transitory computer-readable storage medium is described. The transitory computer-readable storage medium stores one or more programs configured to be executed by one or more processors of a computer system that is in communication with one or more display generation components and one or more input devices. The one or more programs include instructions for: detecting, via the one or more input devices, a first language input that includes one or more words specified by a user of the computer system; and in response to detecting the first language input: in accordance with a determination that the one or more words of the first language input correspond to a request to change a first user interface, initiating a process to change the first user interface in a manner that will persist after the first language input has ended.

In accordance with some embodiments, a computer system is described. The computer system is configured to communicate with one or more display generation components and one or more input devices, and comprises: one or more processors; and memory storing one or more programs configured to be executed by the one or more processors, the one or more programs including instructions for: detecting, via the one or more input devices, a first language input that includes one or more words specified by a user of the computer system; and in response to detecting the first language input: in accordance with a determination that the one or more words of the first language input correspond to a request to change a first user interface, initiating a process to change the first user interface in a manner that will persist after the first language input has ended.

In accordance with some embodiments, a computer system is described. The computer system is configured to communicate with one or more display generation components and one or more input devices, and comprises: means for detecting, via the one or more input devices, a first language input that includes one or more words specified by a user of the computer system; and in response to detecting the first language input: in accordance with a determination that the one or more words of the first language input correspond to a request to change a first user interface, initiating a process to change the first user interface in a manner that will persist after the first language input has ended.

In accordance with some embodiments, a computer program product is described. The computer program product comprises one or more programs configured to be executed by one or more processors of a computer system that is in communication with one or more display generation components and one or more input devices. The one or more programs include instructions for: detecting, via the one or more input devices, a first language input that includes one or more words specified by a user of the computer system; and in response to detecting the first language input: in accordance with a determination that the one or more words of the first language input correspond to a request to change a first user interface, initiating a process to change the first user interface in a manner that will persist after the first language input has ended.

In accordance with some embodiments, a method is described. The method is performed at a computer system that is in communication with one or more display generation components and one or more input devices. The method comprises: detecting, via the one or more input devices, a request to display a time user interface; and in response to detecting the request to display the time user interface, displaying, via the one or more display generation components, the time user interface, wherein displaying the time user interface includes: in accordance with a determination that the time user interface includes a user interface object of a first type at a first position of the time user interface, displaying a first element of the time user interface with a bend at a first location corresponding to the first position to accommodate the user interface object of the first type at the first position of the time user interface.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices. The one or more programs include instructions for: detecting, via the one or more input devices, a request to display a time user interface; and in response to detecting the request to display the time user interface, displaying, via the one or more display generation components, the time user interface, wherein displaying the time user interface includes: in accordance with a determination that the time user interface includes a user interface object of a first type at a first position of the time user interface, displaying a first element of the time user interface with a bend at a first location corresponding to the first position to accommodate the user interface object of the first type at the first position of the time user interface.

In accordance with some embodiments, a transitory computer-readable storage medium is described. The transitory computer-readable storage medium stores one or more programs configured to be executed by one or more processors of a computer system that is in communication with one or more display generation components and one or more input devices. The one or more programs include instructions for: detecting, via the one or more input devices, a request to display a time user interface; and in response to detecting the request to display the time user interface, displaying, via the one or more display generation components, the time user interface, wherein displaying the time user interface includes: in accordance with a determination that the time user interface includes a user interface object of a first type at a first position of the time user interface, displaying a first element of the time user interface with a bend at a first location corresponding to the first position to accommodate the user interface object of the first type at the first position of the time user interface.

In accordance with some embodiments, a computer system is described. The computer system is configured to communicate with one or more display generation components and one or more input devices, and comprises: one or more processors; and memory storing one or more programs configured to be executed by the one or more processors, the one or more programs including instructions for: detecting, via the one or more input devices, a request to display a time user interface; and in response to detecting the request to display the time user interface, displaying, via the one or more display generation components, the time user interface, wherein displaying the time user interface includes: in accordance with a determination that the time user interface includes a user interface object of a first type at a first position of the time user interface, displaying a first element of the time user interface with a bend at a first location corresponding to the first position to accommodate the user interface object of the first type at the first position of the time user interface.

In accordance with some embodiments, a computer system is described. The computer system is configured to communicate with one or more display generation components and one or more input devices, and comprises: means for detecting, via the one or more input devices, a request to display a time user interface; and means for, in response to detecting the request to display the time user interface, displaying, via the one or more display generation components, the time user interface, wherein displaying the time user interface includes: in accordance with a determination that the time user interface includes a user interface object of a first type at a first position of the time user interface, displaying a first element of the time user interface with a bend at a first location corresponding to the first position to accommodate the user interface object of the first type at the first position of the time user interface.

In accordance with some embodiments, a computer program product is described. The computer program product comprises one or more programs configured to be executed by one or more processors of a computer system that is in communication with one or more display generation components and one or more input devices. The one or more programs include instructions for: detecting, via the one or more input devices, a request to display a time user interface; and in response to detecting the request to display the time user interface, displaying, via the one or more display generation components, the time user interface, wherein displaying the time user interface includes: in accordance with a determination that the time user interface includes a user interface object of a first type at a first position of the time user interface, displaying a first element of the time user interface with a bend at a first location corresponding to the first position to accommodate the user interface object of the first type at the first position of the time user interface.

In accordance with some embodiments, a method is described. The method is performed at a computer system that is in communication with one or more display generation components and one or more input devices. The method comprises: displaying, via the one or more display generation components, a first set of one or more complications including a first complication; while displaying the first set of one or more complications, detecting, via the one or more input devices, one or more inputs directed to the first complication; and in response to detecting the one or more inputs directed to the first complication: in accordance with a determination that the first complication is in a first state, displaying, via the one or more display generation components, a first user interface; and in accordance with a determination that the first complication is in a second state different from the first state, displaying, via the one or more display generation components, a second user interface different from the first user interface.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices. The one or more programs include instructions for: displaying, via the one or more display generation components, a first set of one or more complications including a first complication; while displaying the first set of one or more complications, detecting, via the one or more input devices, one or more inputs directed to the first complication; and in response to detecting the one or more inputs directed to the first complication: in accordance with a determination that the first complication is in a first state, displaying, via the one or more display generation components, a first user interface; and in accordance with a determination that the first complication is in a second state different from the first state, displaying, via the one or more display generation components, a second user interface different from the first user interface.

In accordance with some embodiments, a transitory computer-readable storage medium is described. The transitory computer-readable storage medium stores one or more programs configured to be executed by one or more processors of a computer system that is in communication with one or more display generation components and one or more input devices. The one or more programs include instructions for: displaying, via the one or more display generation components, a first set of one or more complications including a first complication; while displaying the first set of one or more complications, detecting, via the one or more input devices, one or more inputs directed to the first complication; and in response to detecting the one or more inputs directed to the first complication: in accordance with a determination that the first complication is in a first state, displaying, via the one or more display generation components, a first user interface; and in accordance with a determination that the first complication is in a second state different from the first state, displaying, via the one or more display generation components, a second user interface different from the first user interface.

In accordance with some embodiments, a computer system is described. The computer system is configured to communicate with one or more display generation components and one or more input devices, and comprises: one or more processors; and memory storing one or more programs configured to be executed by the one or more processors, the one or more programs including instructions for: displaying, via the one or more display generation components, a first set of one or more complications including a first complication; while displaying the first set of one or more complications, detecting, via the one or more input devices, one or more inputs directed to the first complication; and in response to detecting the one or more inputs directed to the first complication: in accordance with a determination that the first complication is in a first state, displaying, via the one or more display generation components, a first user interface; and in accordance with a determination that the first complication is in a second state different from the first state, displaying, via the one or more display generation components, a second user interface different from the first user interface.

In accordance with some embodiments, a computer system is described. The computer system is configured to communicate with one or more display generation components and one or more input devices, and comprises: means for displaying, via the one or more display generation components, a first set of one or more complications including a first complication; means for, while displaying the first set of one or more complications, detecting, via the one or more input devices, one or more inputs directed to the first complication; and means for, in response to detecting the one or more inputs directed to the first complication: in accordance with a determination that the first complication is in a first state, displaying, via the one or more display generation components, a first user interface; and in accordance with a determination that the first complication is in a second state different from the first state, displaying, via the one or more display generation components, a second user interface different from the first user interface.

In accordance with some embodiments, a computer program product is described. The computer program product comprises one or more programs configured to be executed by one or more processors of a computer system that is in communication with one or more display generation components and one or more input devices. The one or more programs include instructions for: displaying, via the one or more display generation components, a first set of one or more complications including a first complication; while displaying the first set of one or more complications, detecting, via the one or more input devices, one or more inputs directed to the first complication; and in response to detecting the one or more inputs directed to the first complication: in accordance with a determination that the first complication is in a first state, displaying, via the one or more display generation components, a first user interface; and in accordance with a determination that the first complication is in a second state different from the first state, displaying, via the one or more display generation components, a second user interface different from the first user interface.

In accordance with some embodiments, a method is described. The method is performed at a computer system that is in communication with one or more display generation components and one or more input devices. The method comprises: displaying, via the one or more display generation components, a time user interface with a first appearance, wherein displaying the time user interface with the first appearance includes concurrently displaying: an indication of a respective time; a first sequence of colors that includes a first plurality of colors; and a second sequence of colors that is different from the first sequence of colors and includes a second plurality of colors different from the first plurality of colors; while displaying the time user interface with the first appearance, detecting the occurrence of an event; and in response to detecting the event, displaying, via the one or more display generation components, the time user interface with a second appearance different from the first appearance, including: displaying the first sequence of colors shifted in a first direction; and displaying the second sequence of colors shifted in a second direction different from the first direction.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices. The one or more programs include instructions for: displaying, via the one or more display generation components, a time user interface with a first appearance, wherein displaying the time user interface with the first appearance includes concurrently displaying: an indication of a respective time; a first sequence of colors that includes a first plurality of colors; and a second sequence of colors that is different from the first sequence of colors and includes a second plurality of colors different from the first plurality of colors; while displaying the time user interface with the first appearance, detecting the occurrence of an event; and in response to detecting the event, displaying, via the one or more display generation components, the time user interface with a second appearance different from the first appearance, including: displaying the first sequence of colors shifted in a first direction; and displaying the second sequence of colors shifted in a second direction different from the first direction.

In accordance with some embodiments, a transitory computer-readable storage medium is described. The transitory computer-readable storage medium stores one or more programs configured to be executed by one or more processors of a computer system that is in communication with one or more display generation components and one or more input devices. The one or more programs include instructions for: displaying, via the one or more display generation components, a time user interface with a first appearance, wherein displaying the time user interface with the first appearance includes concurrently displaying: an indication of a respective time; a first sequence of colors that includes a first plurality of colors; and a second sequence of colors that is different from the first sequence of colors and includes a second plurality of colors different from the first plurality of colors; while displaying the time user interface with the first appearance, detecting the occurrence of an event; and in response to detecting the event, displaying, via the one or more display generation components, the time user interface with a second appearance different from the first appearance, including: displaying the first sequence of colors shifted in a first direction; and displaying the second sequence of colors shifted in a second direction different from the first direction.

In accordance with some embodiments, a computer system is described. The computer system is configured to communicate with one or more display generation components and one or more input devices, and comprises: one or more processors; and memory storing one or more programs configured to be executed by the one or more processors, the one or more programs including instructions for: displaying, via the one or more display generation components, a time user interface with a first appearance, wherein displaying the time user interface with the first appearance includes concurrently displaying: an indication of a respective time; a first sequence of colors that includes a first plurality of colors; and a second sequence of colors that is different from the first sequence of colors and includes a second plurality of colors different from the first plurality of colors; while displaying the time user interface with the first appearance, detecting the occurrence of an event; and in response to detecting the event, displaying, via the one or more display generation components, the time user interface with a second appearance different from the first appearance, including: displaying the first sequence of colors shifted in a first direction; and displaying the second sequence of colors shifted in a second direction different from the first direction.

In accordance with some embodiments, a computer system is described. The computer system is configured to communicate with one or more display generation components and one or more input devices, and comprises: means for displaying, via the one or more display generation components, a time user interface with a first appearance, wherein displaying the time user interface with the first appearance includes concurrently displaying: an indication of a respective time; a first sequence of colors that includes a first plurality of colors; and a second sequence of colors that is different from the first sequence of colors and includes a second plurality of colors different from the first plurality of colors; means for, while displaying the time user interface with the first appearance, detecting the occurrence of an event; and means for, in response to detecting the event, displaying, via the one or more display generation components, the time user interface with a second appearance different from the first appearance, including: displaying the first sequence of colors shifted in a first direction; and displaying the second sequence of colors shifted in a second direction different from the first direction.

In accordance with some embodiments, a computer program product is described. The computer program product comprises one or more programs configured to be executed by one or more processors of a computer system that is in communication with one or more display generation components and one or more input devices. The one or more programs include instructions for: displaying, via the one or more display generation components, a time user interface with a first appearance, wherein displaying the time user interface with the first appearance includes concurrently displaying: an indication of a respective time; a first sequence of colors that includes a first plurality of colors; and a second sequence of colors that is different from the first sequence of colors and includes a second plurality of colors different from the first plurality of colors; while displaying the time user interface with the first appearance, detecting the occurrence of an event; and in response to detecting the event, displaying, via the one or more display generation components, the time user interface with a second appearance different from the first appearance, including: displaying the first sequence of colors shifted in a first direction; and displaying the second sequence of colors shifted in a second direction different from the first direction.

In accordance with some embodiments, a method is described. The method is performed at a computer system that is in communication with one or more display generation components and one or more input devices. The method comprises: displaying, via the one or more display generation components, a time user interface with a first visual appearance, wherein displaying the time user interface with the first visual appearance includes concurrently displaying: an indication of a respective time; a point of interest (POI) region that at least partially surrounds the indication of the respective time; a first POI representation representative of a first point of interest, wherein the first POI representation is displayed at a first display position within the POI region indicative of the first point of interest being located at a first direction relative to the computer system; and a second POI representation, wherein the second POI representation is representative of a second point of interest different from the first point of interest, and the second POI representation is displayed at a second display position within the POI region different from the first display position, wherein the second display position is indicative of the second point of interest being located at a second direction relative to the computer system; detecting, via the one or more input devices, a first movement of the computer system; and in response to detecting the first movement of the computer system, displaying, via the one or more display generation components: movement of the first POI representation within the POI region from the first display position within the POI region to a third display position within the POI region that is different from the first display position and is indicative of the first point of interest being located at a third direction relative to the computer system; and movement of the second POI representation within the POI region from the second display position within the POI region to a fourth display position within the POI region that is different from the second display position and is indicative of the second point of interest being located at a fourth direction relative to the computer system.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices. The one or more programs include instructions for: displaying, via the one or more display generation components, a time user interface with a first visual appearance, wherein displaying the time user interface with the first visual appearance includes concurrently displaying: an indication of a respective time; a point of interest (POI) region that at least partially surrounds the indication of the respective time; a first POI representation representative of a first point of interest, wherein the first POI representation is displayed at a first display position within the POI region indicative of the first point of interest being located at a first direction relative to the computer system; and a second POI representation, wherein the second POI representation is representative of a second point of interest different from the first point of interest, and the second POI representation is displayed at a second display position within the POI region different from the first display position, wherein the second display position is indicative of the second point of interest being located at a second direction relative to the computer system; detecting, via the one or more input devices, a first movement of the computer system; and in response to detecting the first movement of the computer system, displaying, via the one or more display generation components: movement of the first POI representation within the POI region from the first display position within the POI region to a third display position within the POI region that is different from the first display position and is indicative of the first point of interest being located at a third direction relative to the computer system; and movement of the second POI representation within the POI region from the second display position within the POI region to a fourth display position within the POI region that is different from the second display position and is indicative of the second point of interest being located at a fourth direction relative to the computer system.

In accordance with some embodiments, a transitory computer-readable storage medium is described. The transitory computer-readable storage medium stores one or more programs configured to be executed by one or more processors of a computer system that is in communication with one or more display generation components and one or more input devices. The one or more programs include instructions for: displaying, via the one or more display generation components, a time user interface with a first visual appearance, wherein displaying the time user interface with the first visual appearance includes concurrently displaying: an indication of a respective time; a point of interest (POI) region that at least partially surrounds the indication of the respective time; a first POI representation representative of a first point of interest, wherein the first POI representation is displayed at a first display position within the POI region indicative of the first point of interest being located at a first direction relative to the computer system; and a second POI representation, wherein the second POI representation is representative of a second point of interest different from the first point of interest, and the second POI representation is displayed at a second display position within the POI region different from the first display position, wherein the second display position is indicative of the second point of interest being located at a second direction relative to the computer system; detecting, via the one or more input devices, a first movement of the computer system; and in response to detecting the first movement of the computer system, displaying, via the one or more display generation components: movement of the first POI representation within the POI region from the first display position within the POI region to a third display position within the POI region that is different from the first display position and is indicative of the first point of interest being located at a third direction relative to the computer system; and movement of the second POI representation within the POI region from the second display position within the POI region to a fourth display position within the POI region that is different from the second display position and is indicative of the second point of interest being located at a fourth direction relative to the computer system.

In accordance with some embodiments, a computer system is described. The computer system is configured to communicate with one or more display generation components and one or more input devices, and comprises: one or more processors; and memory storing one or more programs configured to be executed by the one or more processors, the one or more programs including instructions for: displaying, via the one or more display generation components, a time user interface with a first visual appearance, wherein displaying the time user interface with the first visual appearance includes concurrently displaying: an indication of a respective time; a point of interest (POI) region that at least partially surrounds the indication of the respective time; a first POI representation representative of a first point of interest, wherein the first POI representation is displayed at a first display position within the POI region indicative of the first point of interest being located at a first direction relative to the computer system; and a second POI representation, wherein the second POI representation is representative of a second point of interest different from the first point of interest, and the second POI representation is displayed at a second display position within the POI region different from the first display position, wherein the second display position is indicative of the second point of interest being located at a second direction relative to the computer system; detecting, via the one or more input devices, a first movement of the computer system; and in response to detecting the first movement of the computer system, displaying, via the one or more display generation components: movement of the first POI representation within the POI region from the first display position within the POI region to a third display position within the POI region that is different from the first display position and is indicative of the first point of interest being located at a third direction relative to the computer system; and movement of the second POI representation within the POI region from the second display position within the POI region to a fourth display position within the POI region that is different from the second display position and is indicative of the second point of interest being located at a fourth direction relative to the computer system.

In accordance with some embodiments, a computer system is described. The computer system is configured to communicate with one or more display generation components and one or more input devices, and comprises: means for displaying, via the one or more display generation components, a time user interface with a first visual appearance, wherein displaying the time user interface with the first visual appearance includes concurrently displaying: an indication of a respective time; a point of interest (POI) region that at least partially surrounds the indication of the respective time; a first POI representation representative of a first point of interest, wherein the first POI representation is displayed at a first display position within the POI region indicative of the first point of interest being located at a first direction relative to the computer system; and a second POI representation, wherein the second POI representation is representative of a second point of interest different from the first point of interest, and the second POI representation is displayed at a second display position within the POI region different from the first display position, wherein the second display position is indicative of the second point of interest being located at a second direction relative to the computer system; means for detecting, via the one or more input devices, a first movement of the computer system; and means for, in response to detecting the first movement of the computer system, displaying, via the one or more display generation components: movement of the first POI representation within the POI region from the first display position within the POI region to a third display position within the POI region that is different from the first display position and is indicative of the first point of interest being located at a third direction relative to the computer system; and movement of the second POI representation within the POI region from the second display position within the POI region to a fourth display position within the POI region that is different from the second display position and is indicative of the second point of interest being located at a fourth direction relative to the computer system.

In accordance with some embodiments, a computer program product is described. The computer program product comprises one or more programs configured to be executed by one or more processors of a computer system that is in communication with one or more display generation components and one or more input devices. The one or more programs include instructions for: displaying, via the one or more display generation components, a time user interface with a first visual appearance, wherein displaying the time user interface with the first visual appearance includes concurrently displaying: an indication of a respective time; a point of interest (POI) region that at least partially surrounds the indication of the respective time; a first POI representation representative of a first point of interest, wherein the first POI representation is displayed at a first display position within the POI region indicative of the first point of interest being located at a first direction relative to the computer system; and a second POI representation, wherein the second POI representation is representative of a second point of interest different from the first point of interest, and the second POI representation is displayed at a second display position within the POI region different from the first display position, wherein the second display position is indicative of the second point of interest being located at a second direction relative to the computer system; detecting, via the one or more input devices, a first movement of the computer system; and in response to detecting the first movement of the computer system, displaying, via the one or more display generation components: movement of the first POI representation within the POI region from the first display position within the POI region to a third display position within the POI region that is different from the first display position and is indicative of the first point of interest being located at a third direction relative to the computer system; and movement of the second POI representation within the POI region from the second display position within the POI region to a fourth display position within the POI region that is different from the second display position and is indicative of the second point of interest being located at a fourth direction relative to the computer system.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for providing, modifying, and/or interacting with user interfaces, thereby increasing the effectiveness, efficiency, and user satisfaction with such devices. Such methods and interfaces may complement or replace other methods for providing, modifying, and/or interacting with user interfaces.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6S illustrate exemplary devices and user interfaces for providing time user interfaces, in accordance with some embodiments.

FIG. 7 is a flow diagram illustrating methods of providing time user interfaces, in accordance with some embodiments.

FIGS. 8A-8I illustrate exemplary devices and user interfaces for providing wake screen user interfaces, in accordance with some embodiments.

FIG. 9 is a flow diagram illustrating methods of providing wake screen user interfaces, in accordance with some embodiments.

FIGS. 10A-10X illustrate exemplary devices and user interfaces for modifying user interfaces, in accordance with some embodiments.

FIG. 11 is a flow diagram illustrating methods of modifying user interfaces, in accordance with some embodiments.

FIGS. 12A-12Y illustrate exemplary devices and user interfaces for providing time user interfaces, in accordance with some embodiments.

FIG. 13A is a flow diagram illustrating methods of providing time user interfaces, in accordance with some embodiments.

FIG. 13B flow diagram illustrating methods of providing time user interfaces, in accordance with some embodiments.

FIGS. 14A-14J illustrate exemplary devices and user interfaces for providing interactive complications, in accordance with some embodiments.

FIG. 15 is a flow diagram illustrating methods of providing interactive complications, in accordance with some embodiments.

FIGS. 16A-16X illustrate exemplary devices and user interfaces for providing time user interfaces, in accordance with some embodiments.

FIG. 17 is a flow diagram illustrating methods of providing time user interfaces, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and systems for providing, modifying, and/or interacting with user interfaces. Such techniques can reduce the cognitive burden on a user who interacts with user interfaces, thereby enhancing productivity. Further, such techniques can reduce processor and battery power otherwise wasted on redundant user inputs.

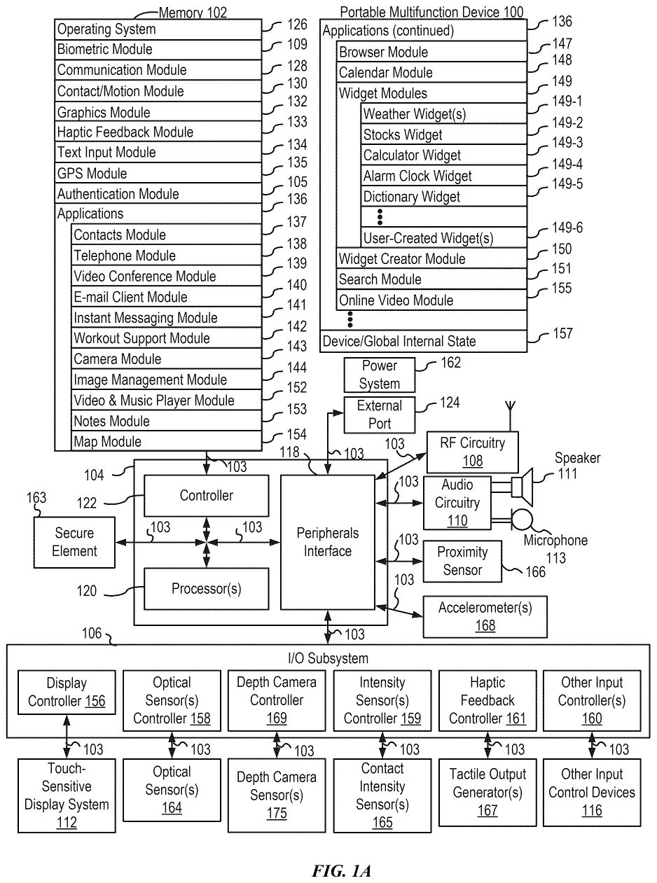

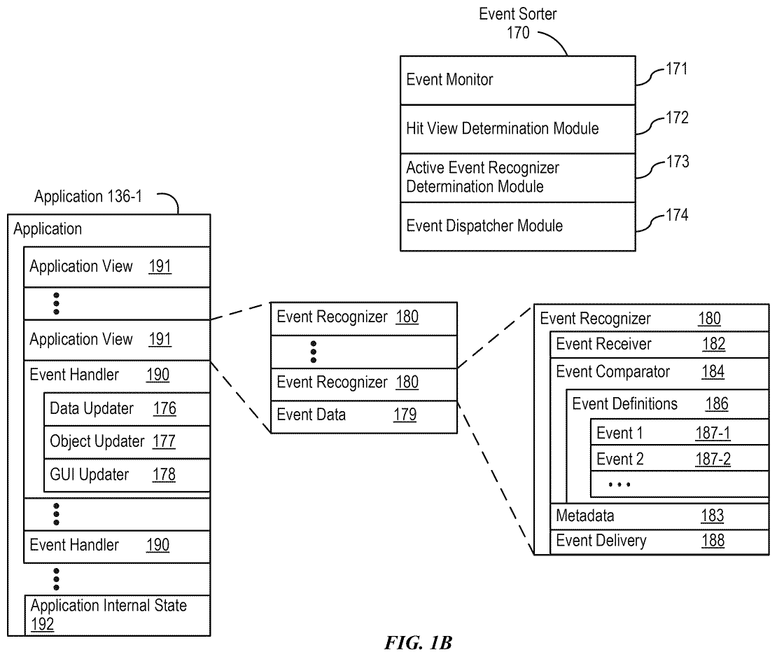

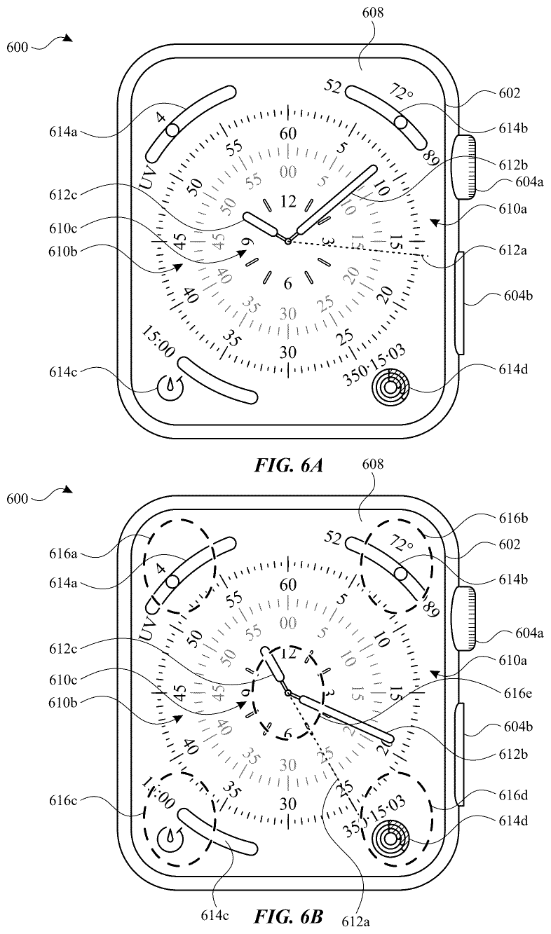

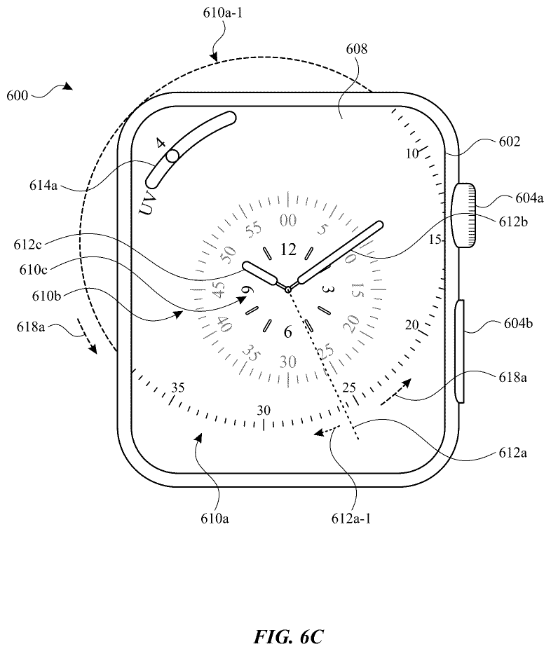

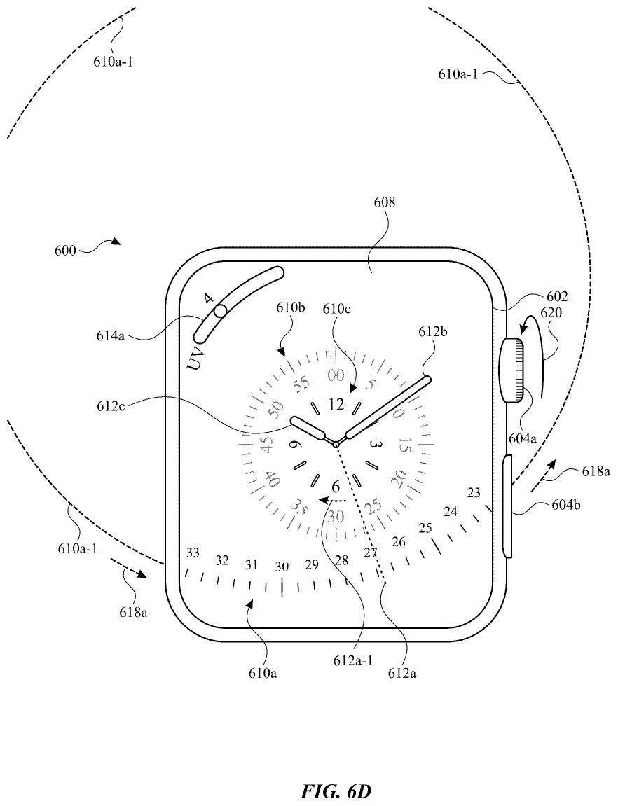

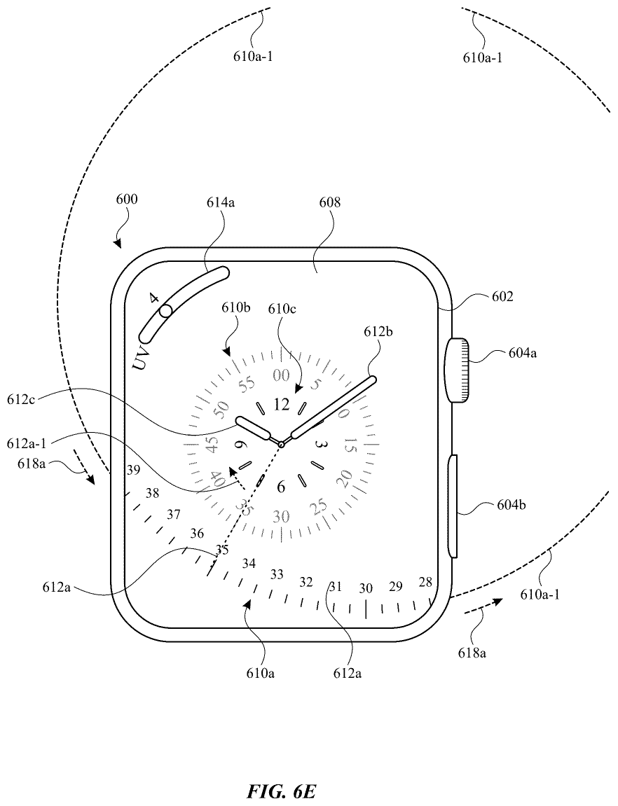

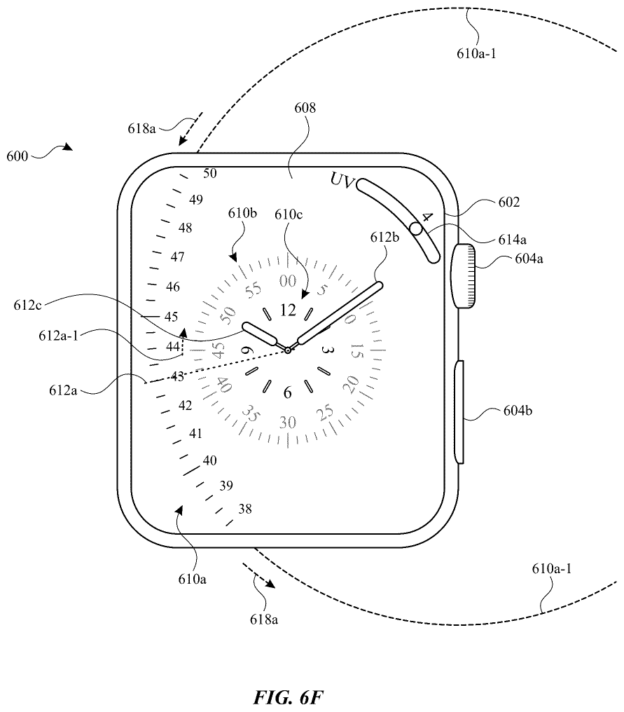

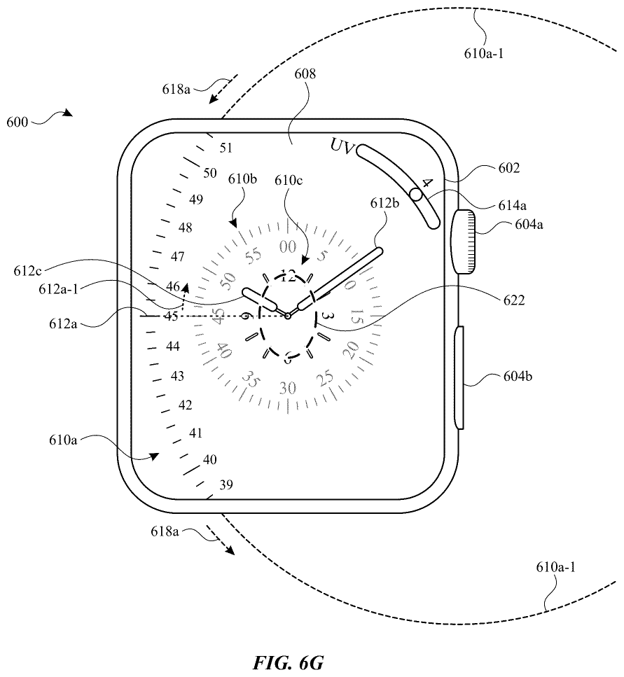

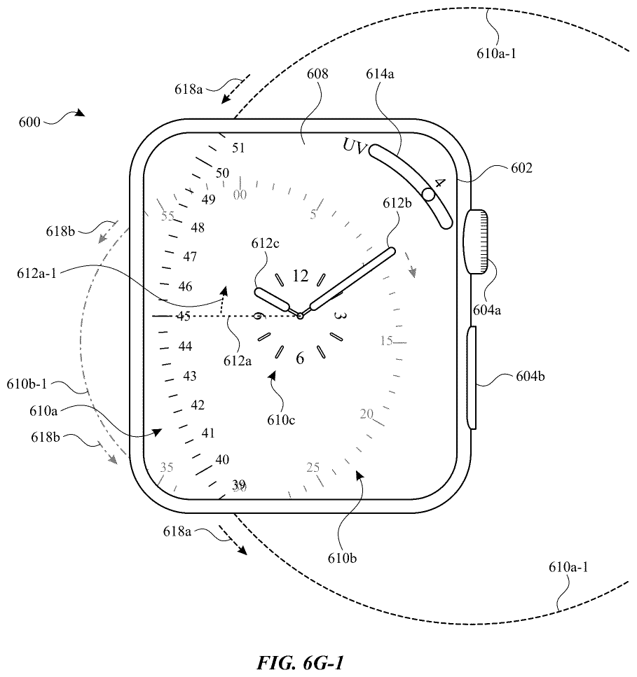

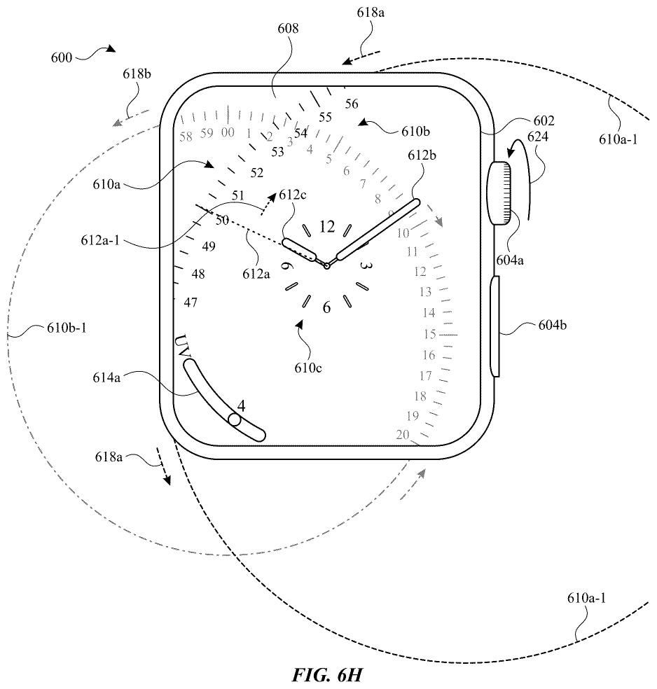

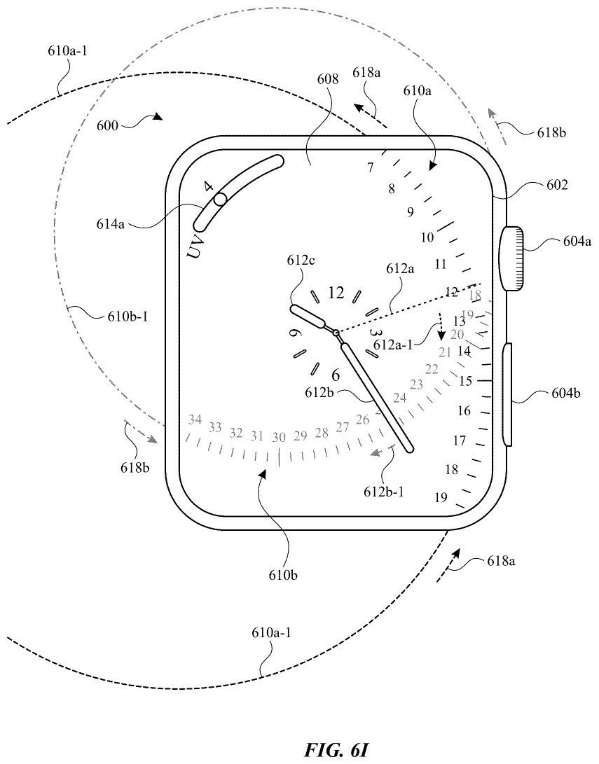

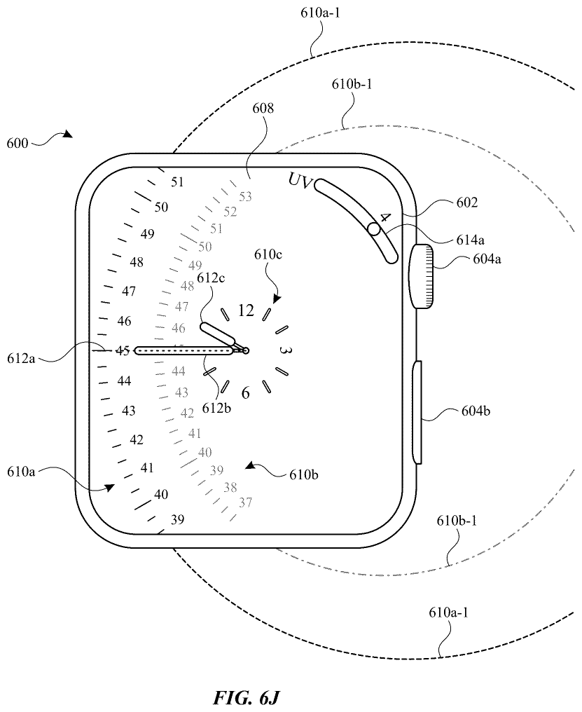

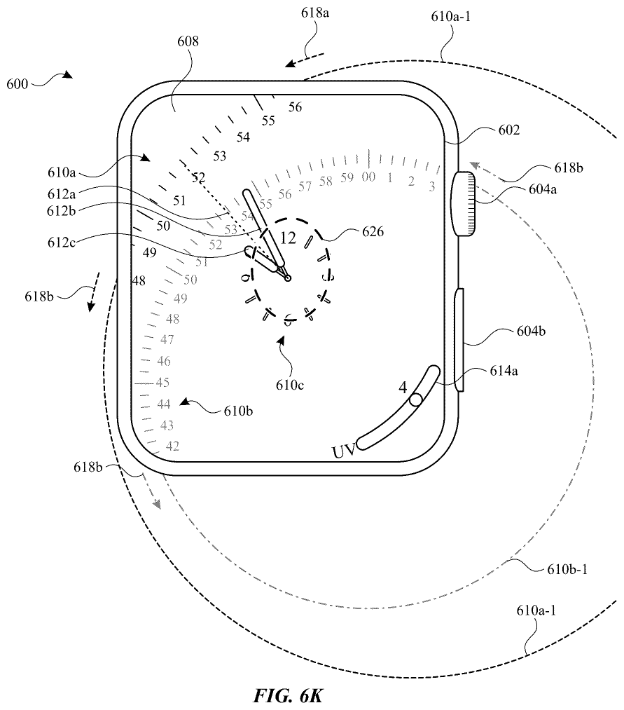

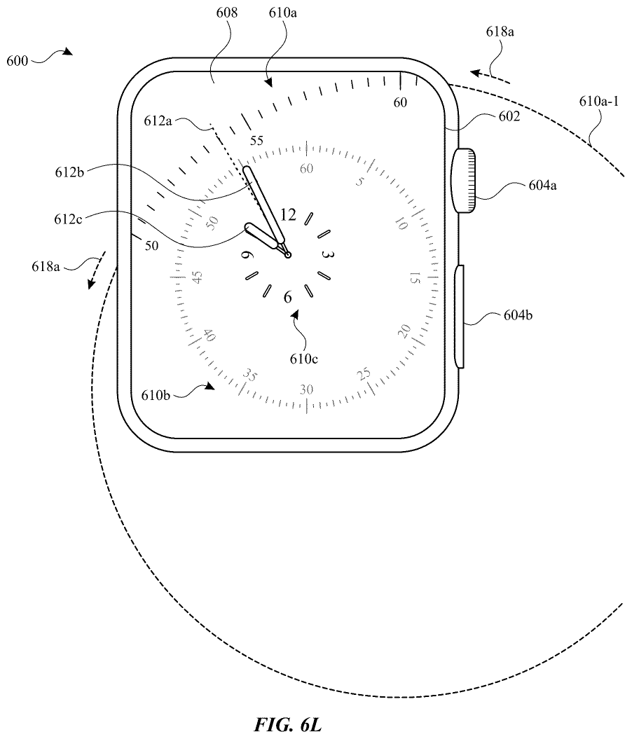

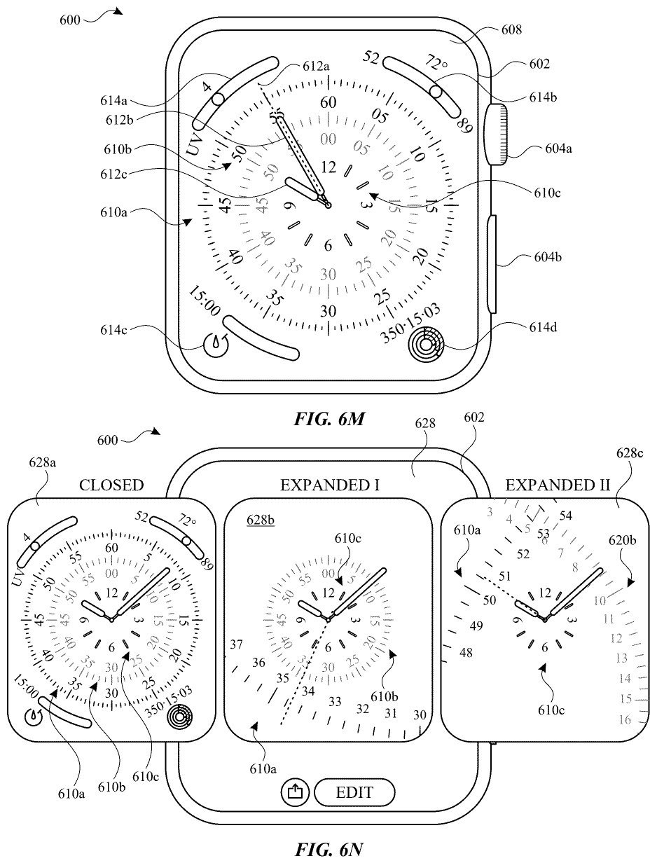

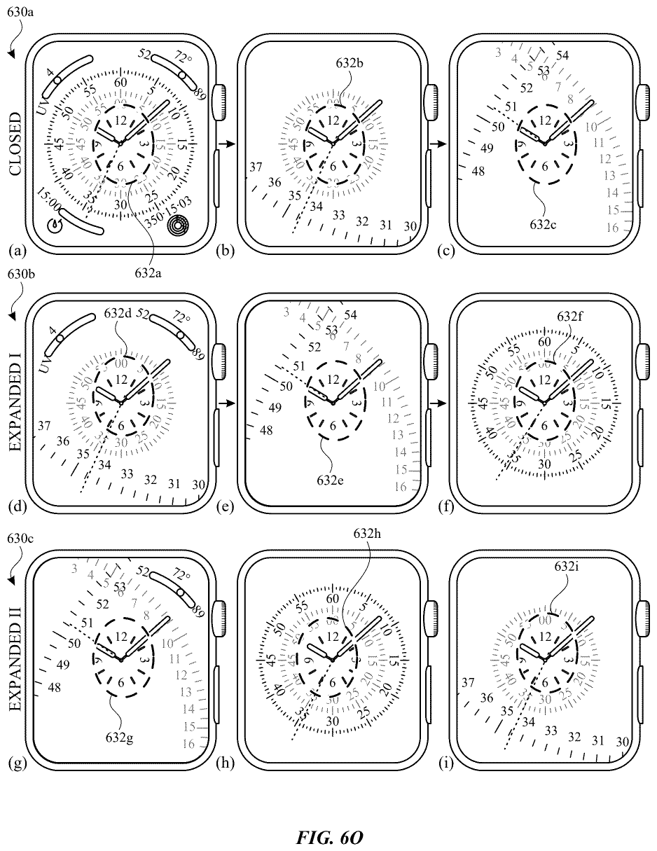

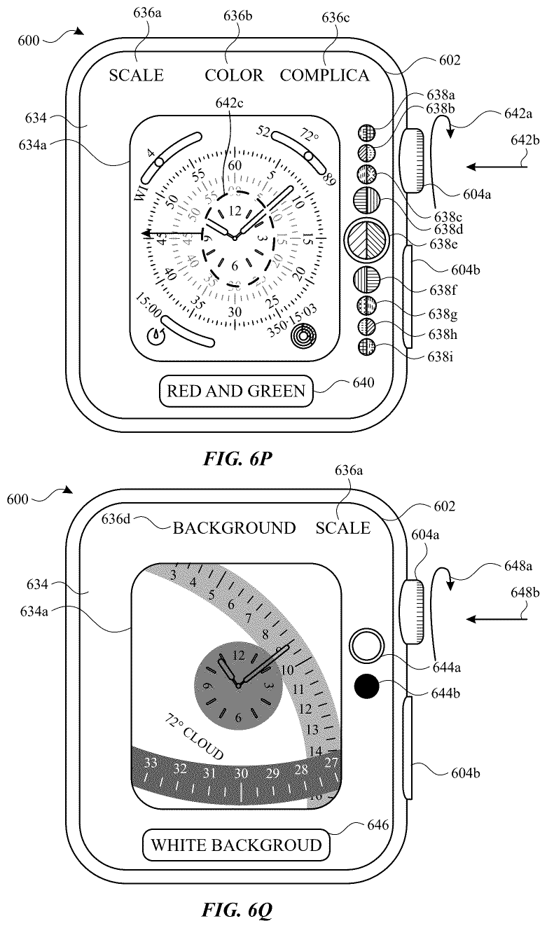

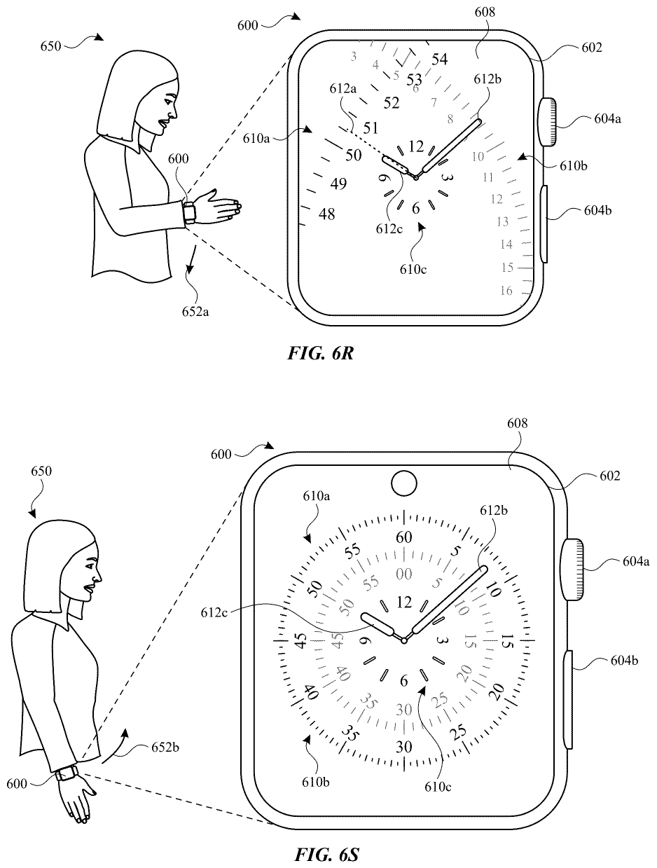

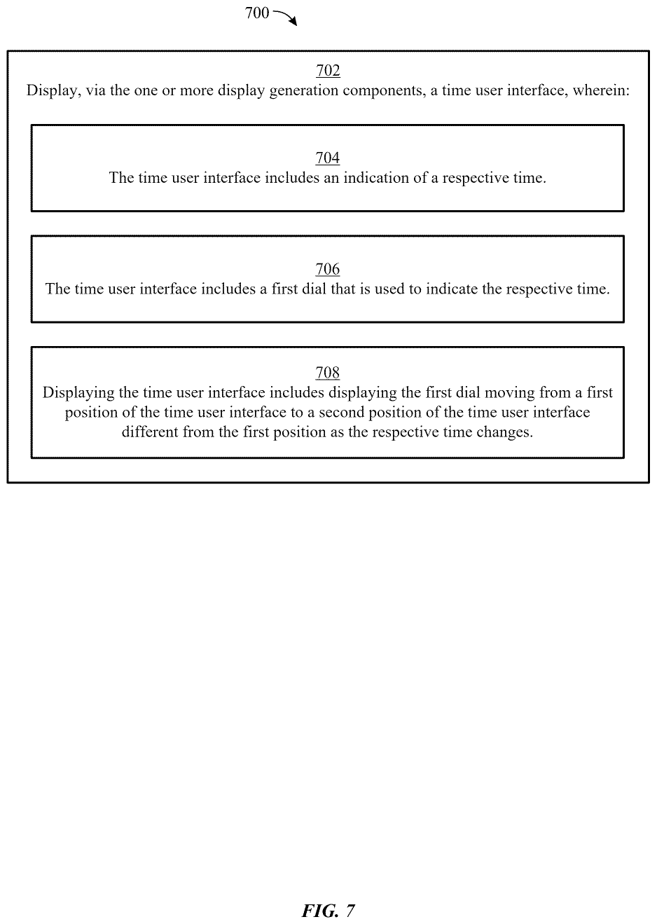

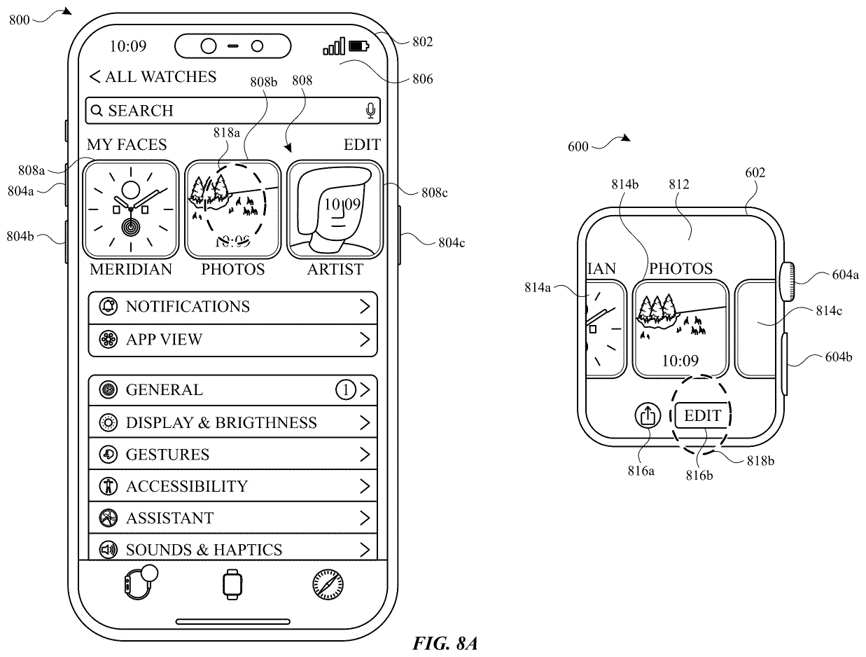

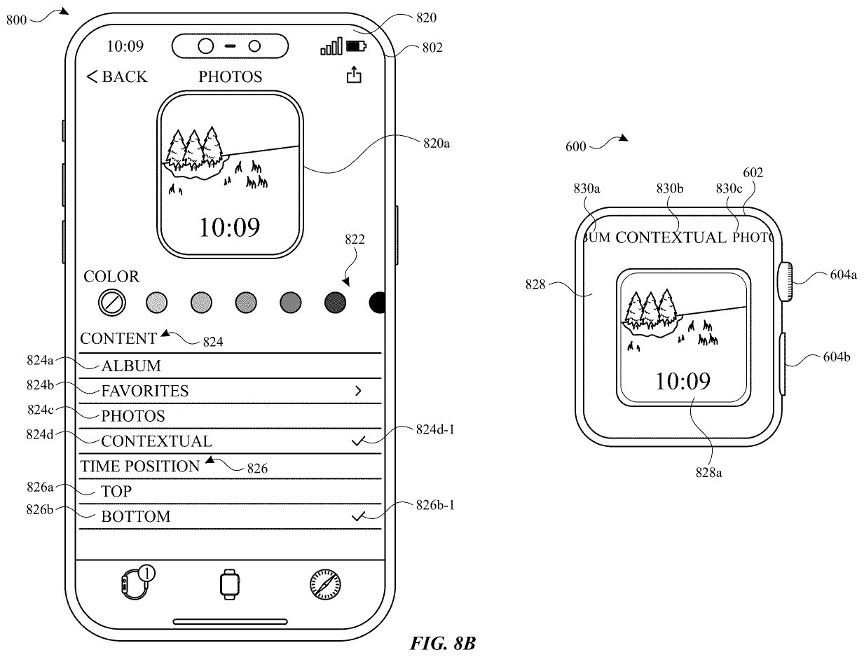

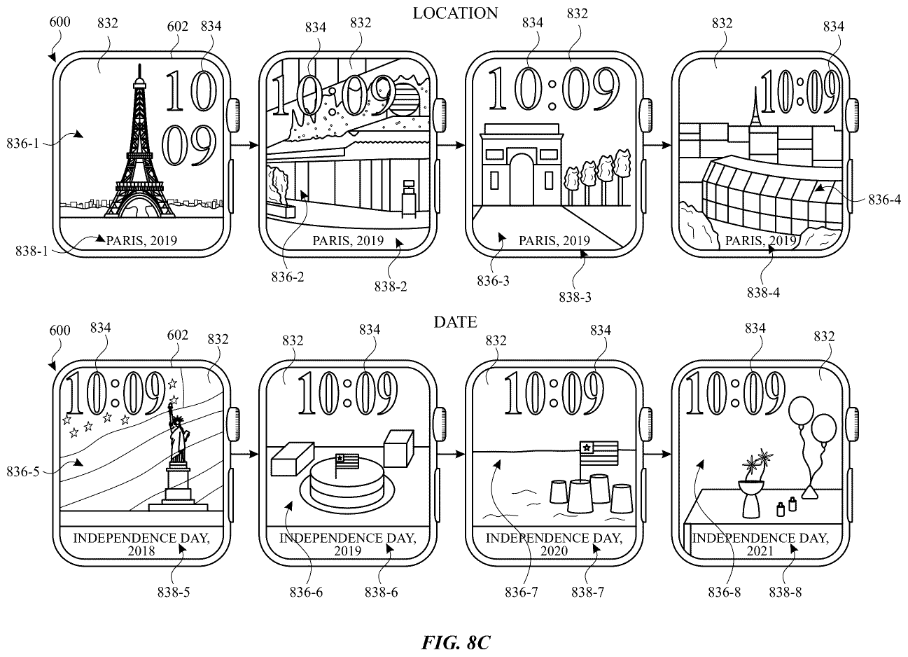

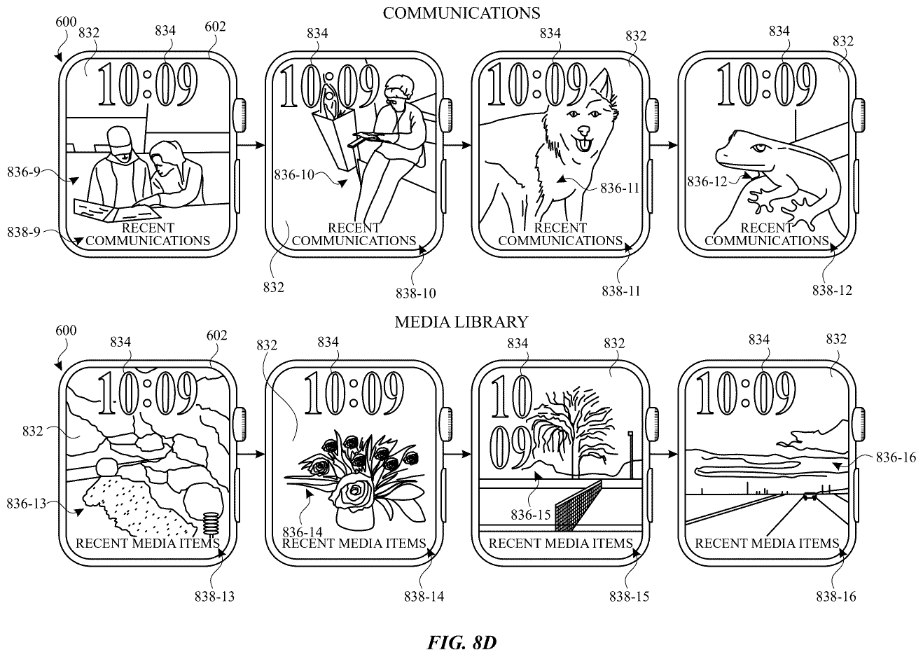

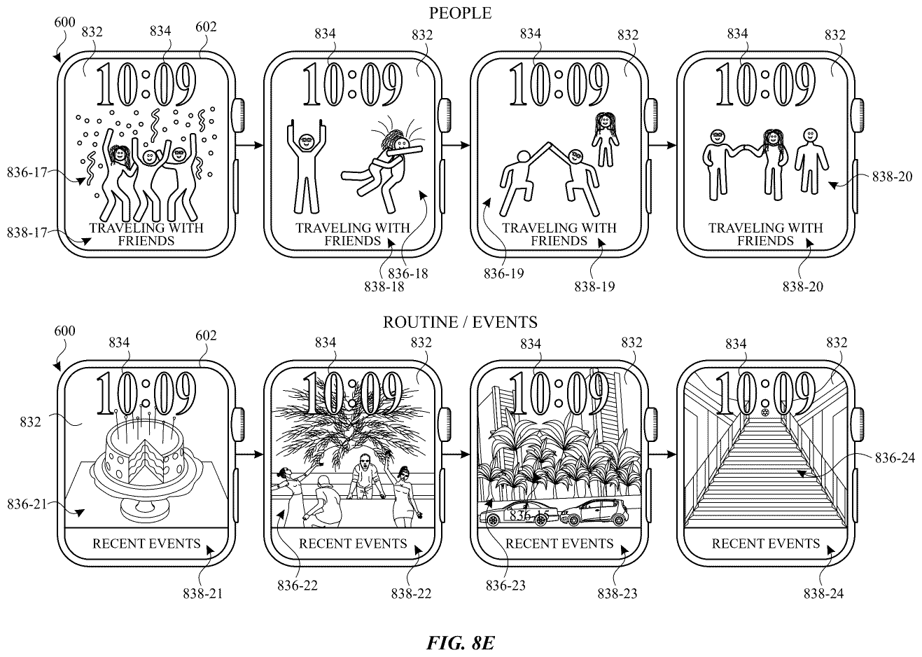

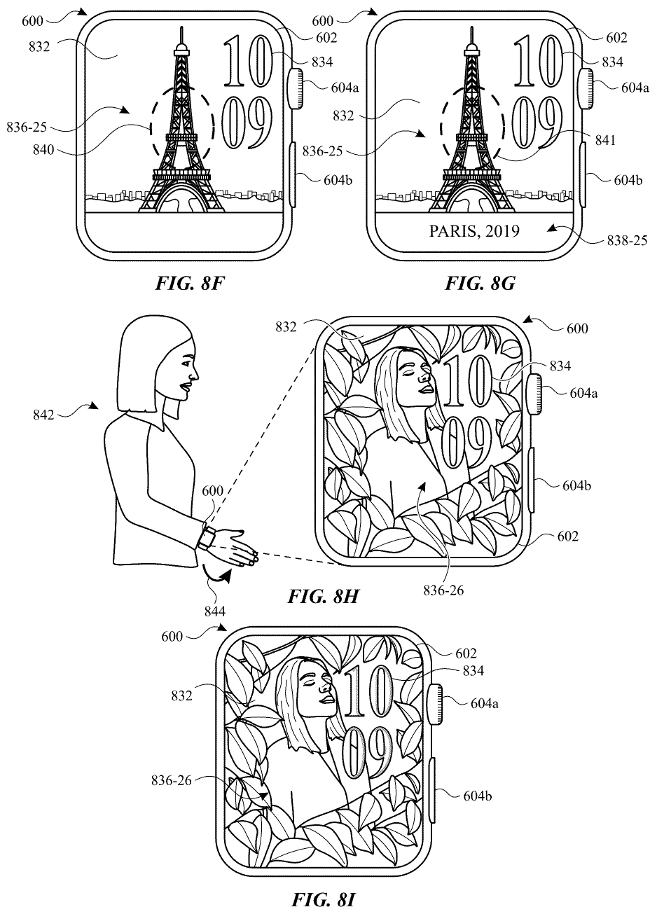

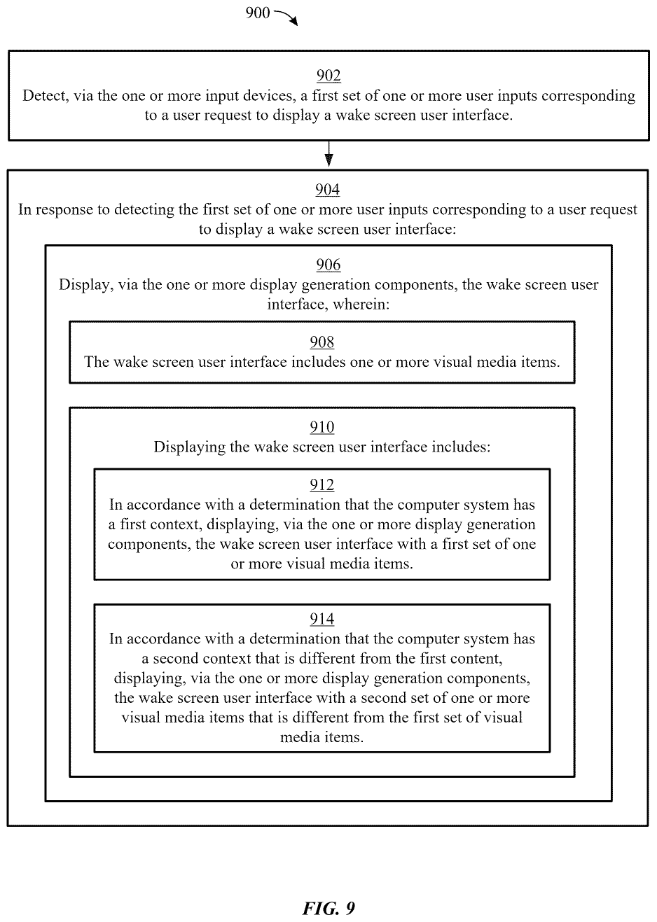

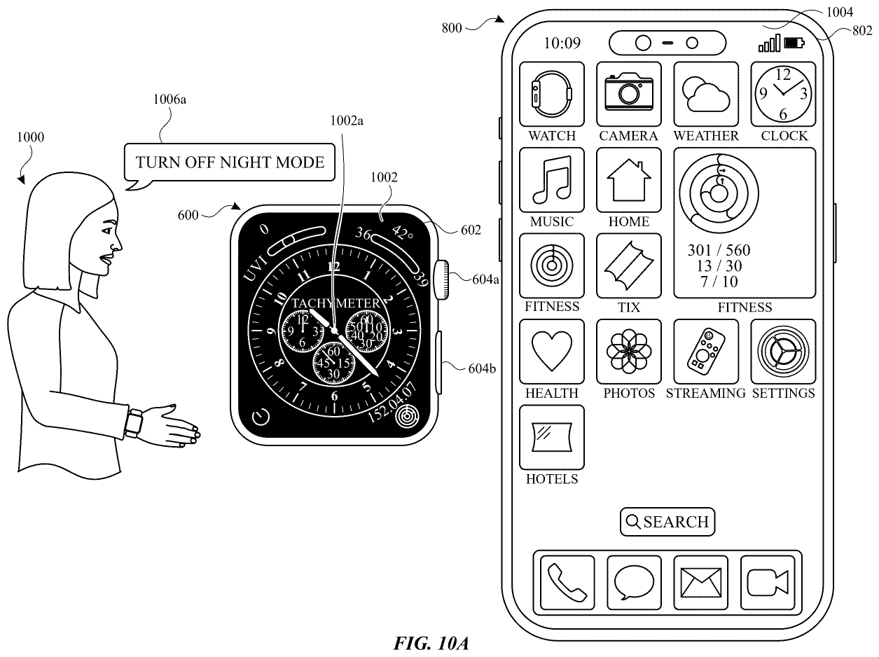

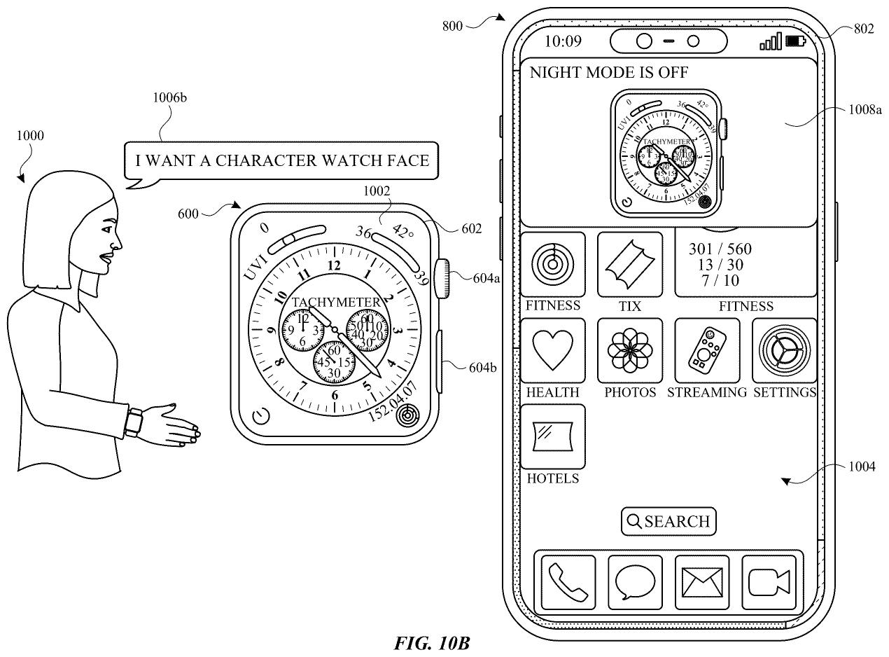

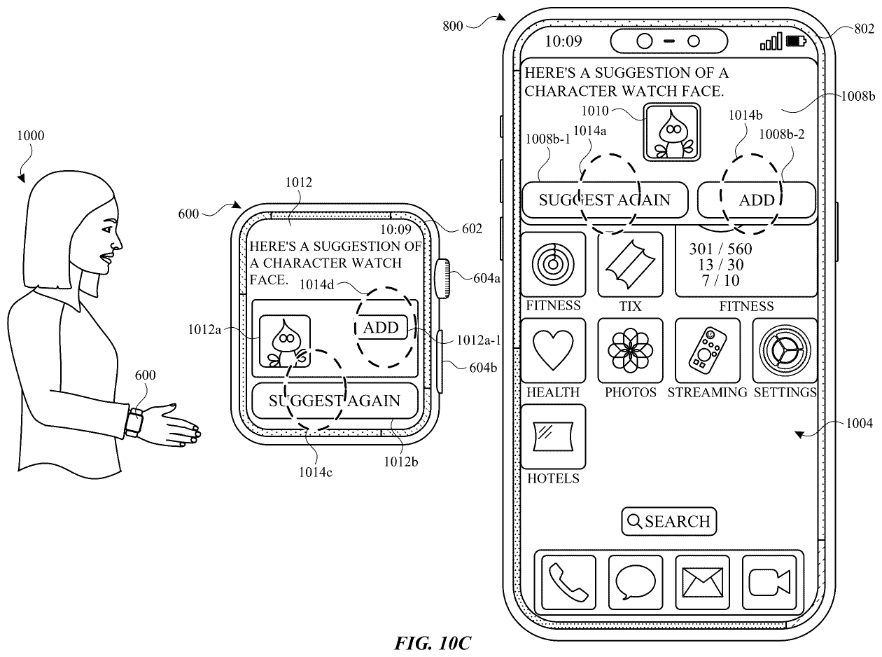

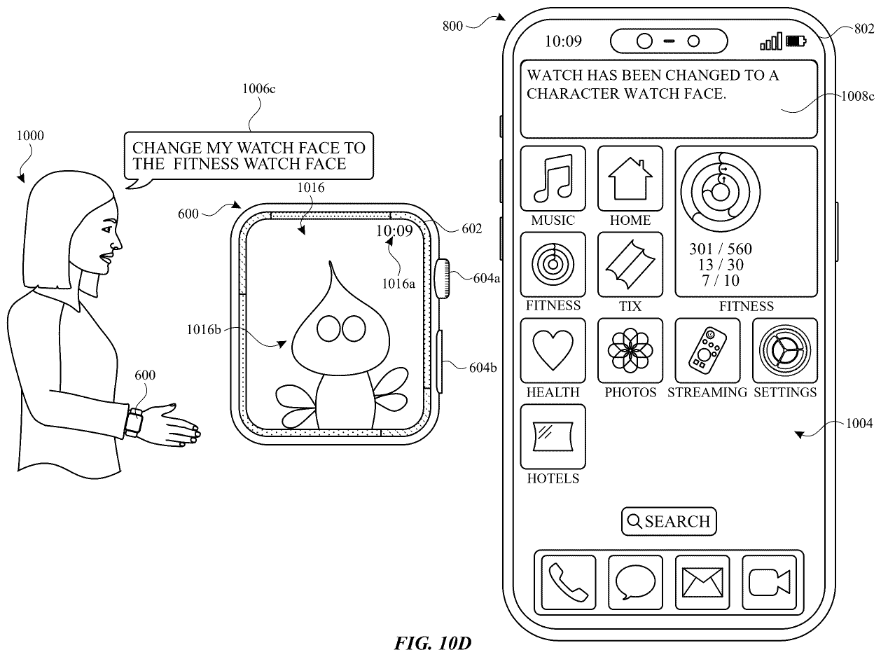

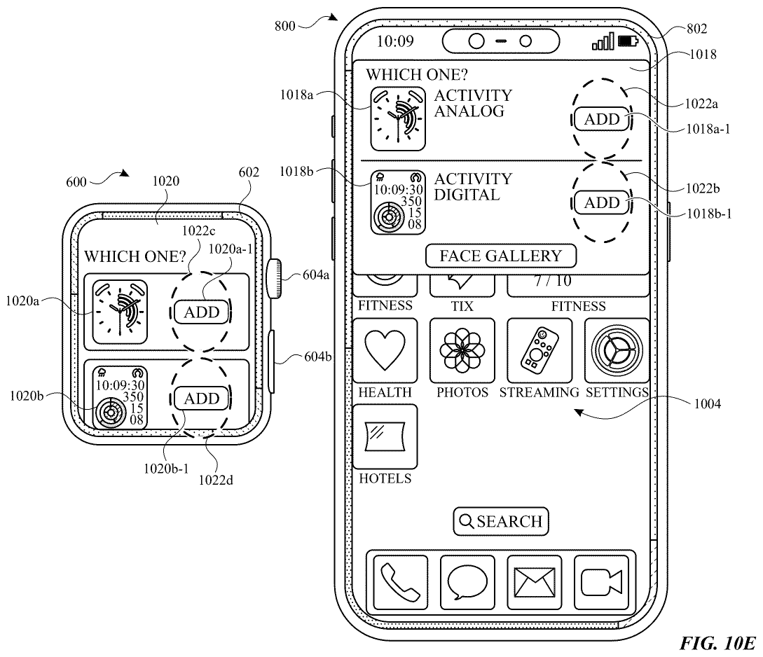

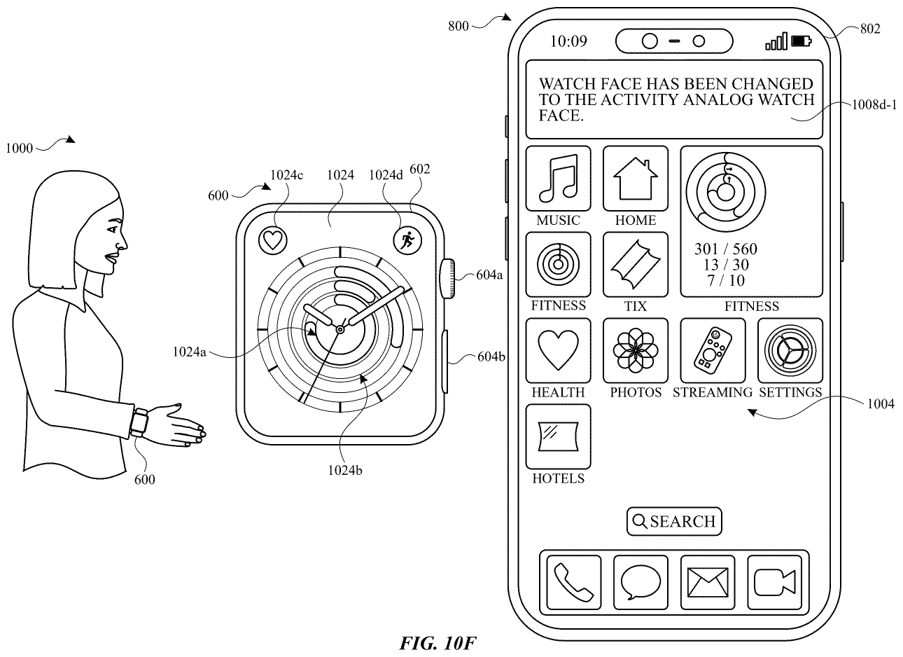

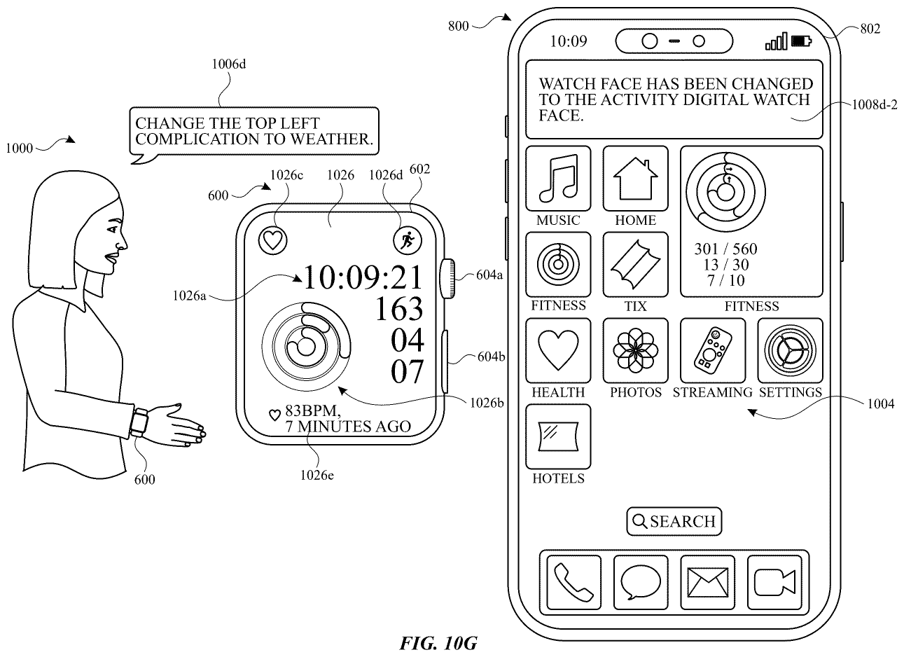

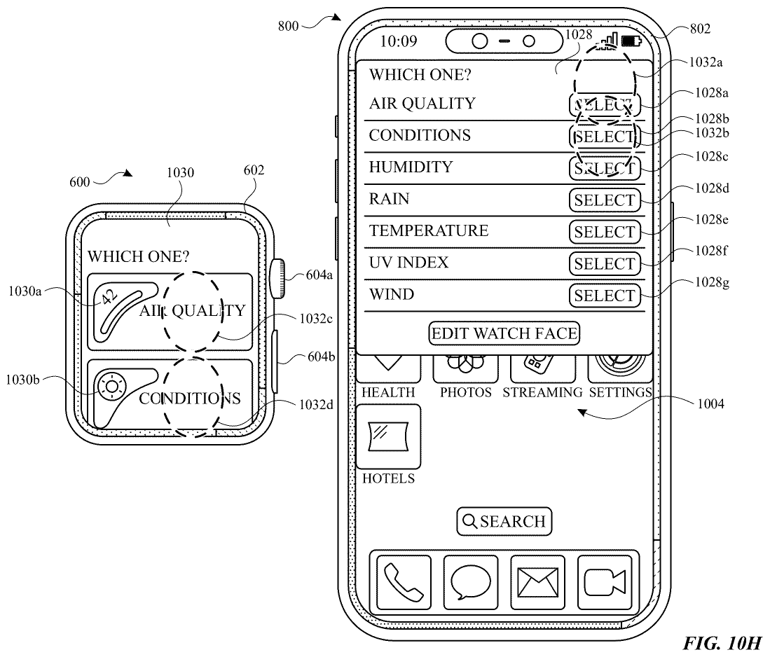

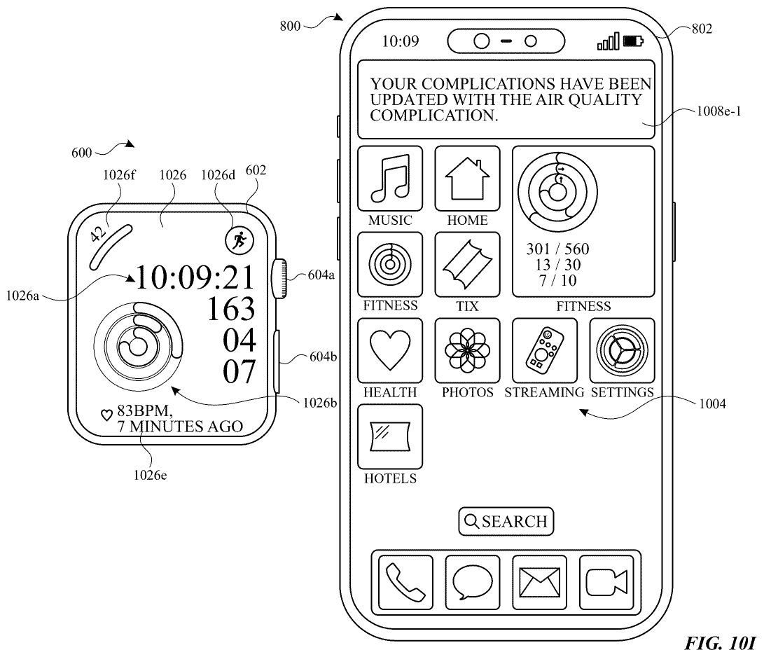

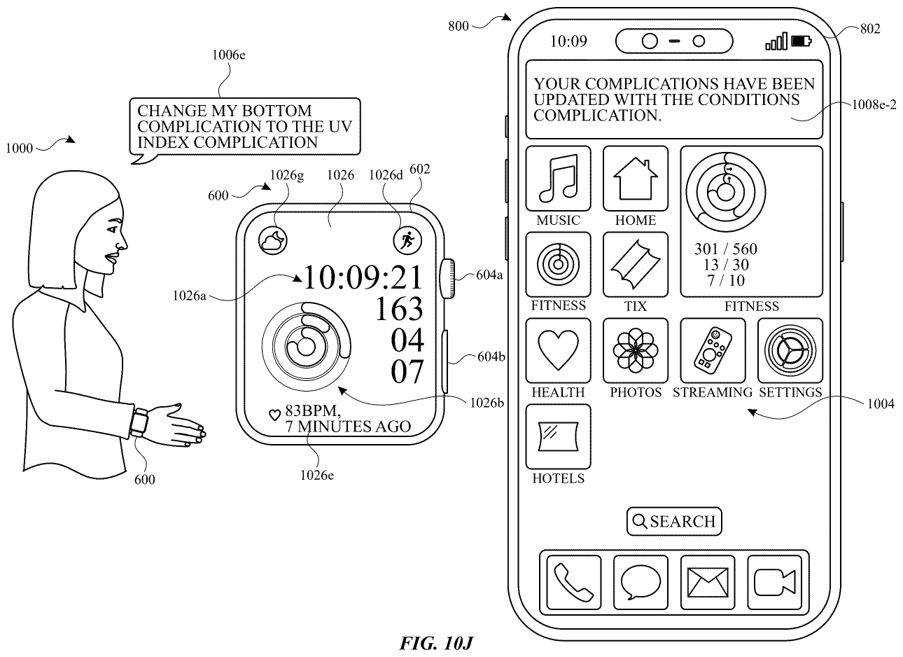

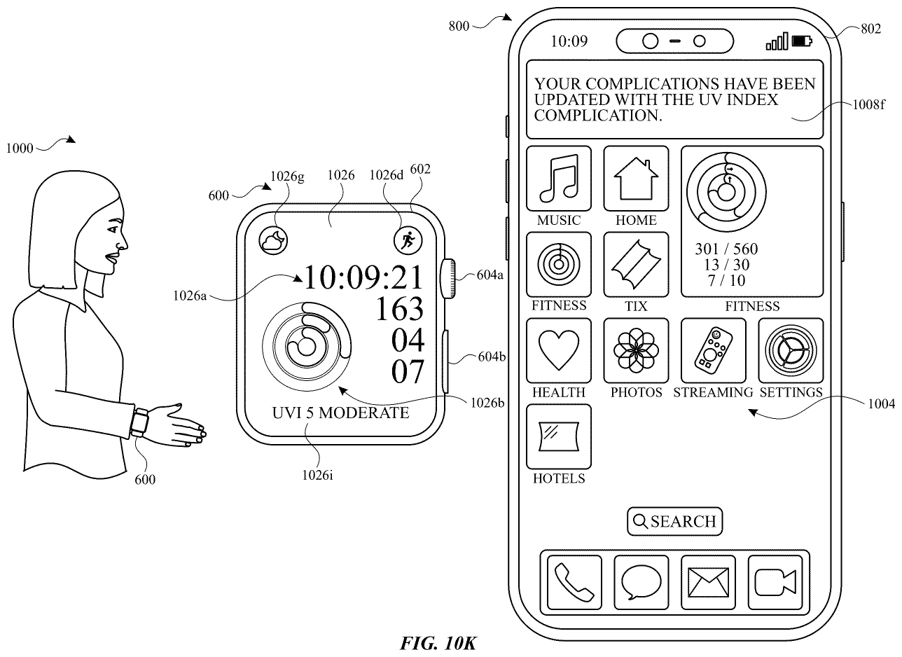

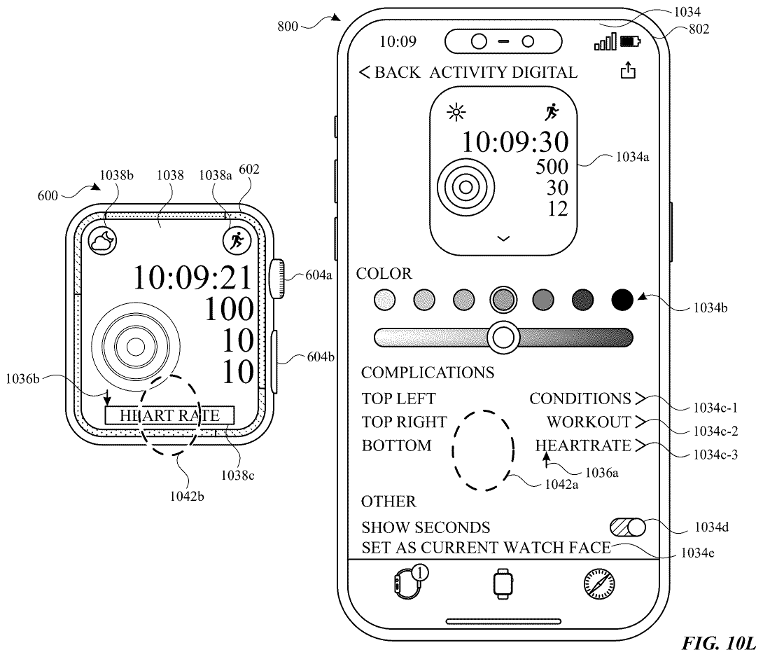

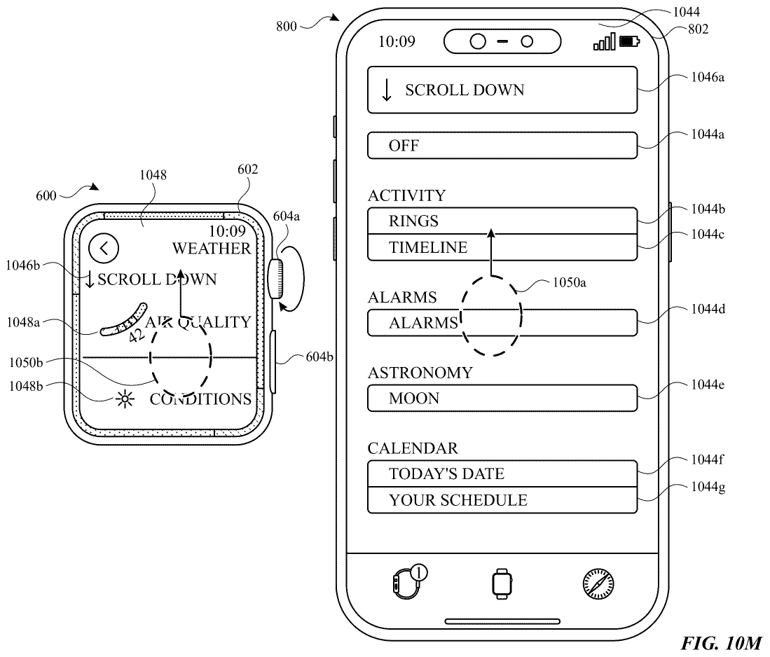

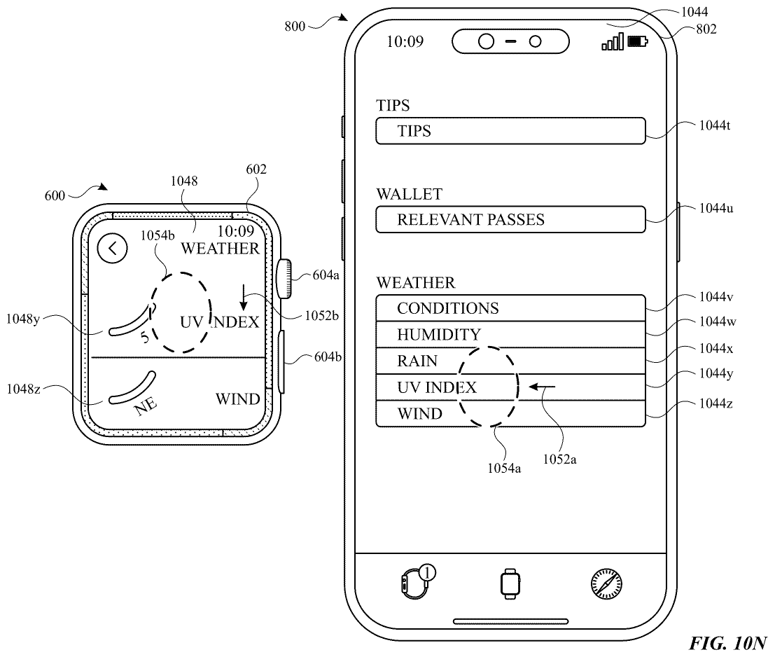

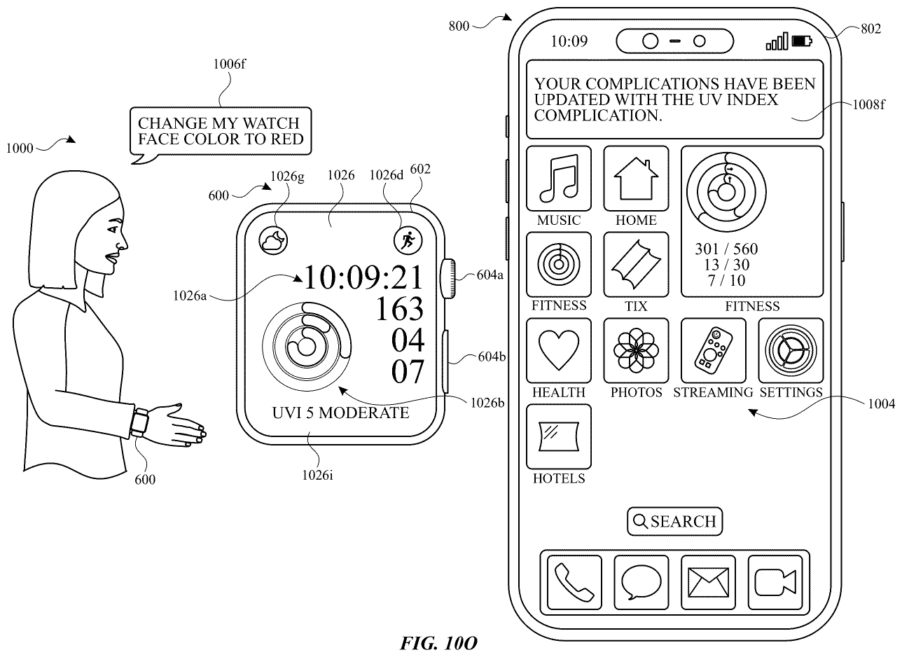

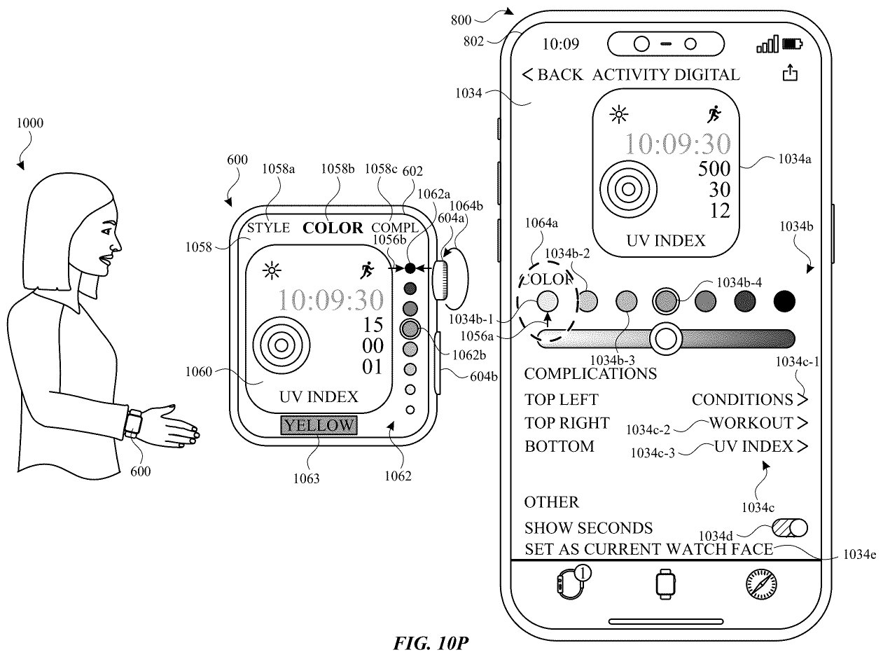

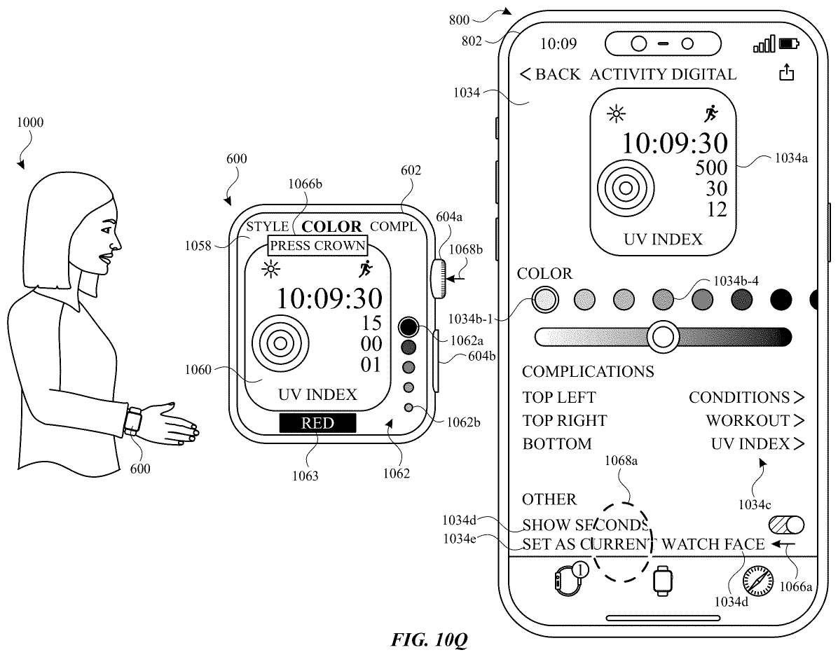

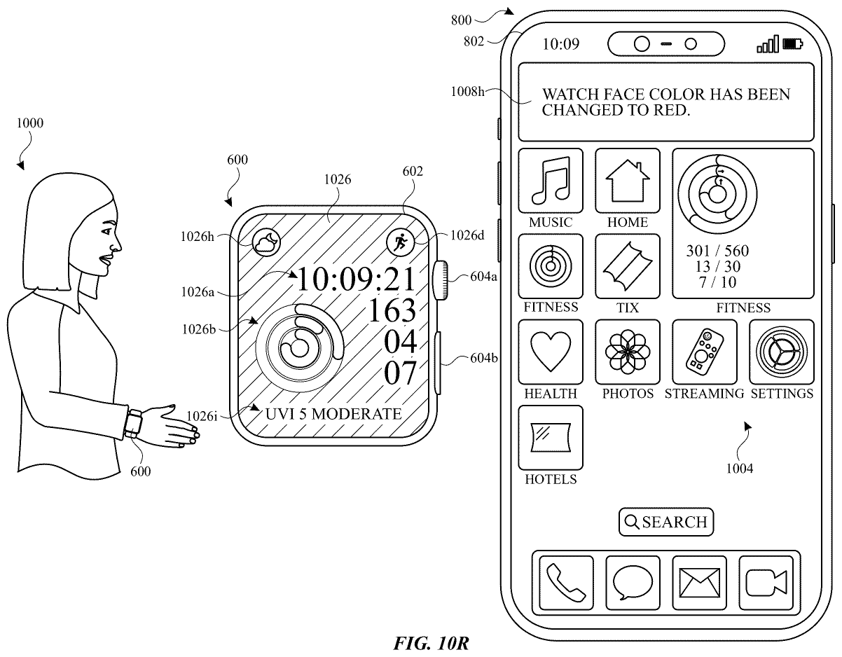

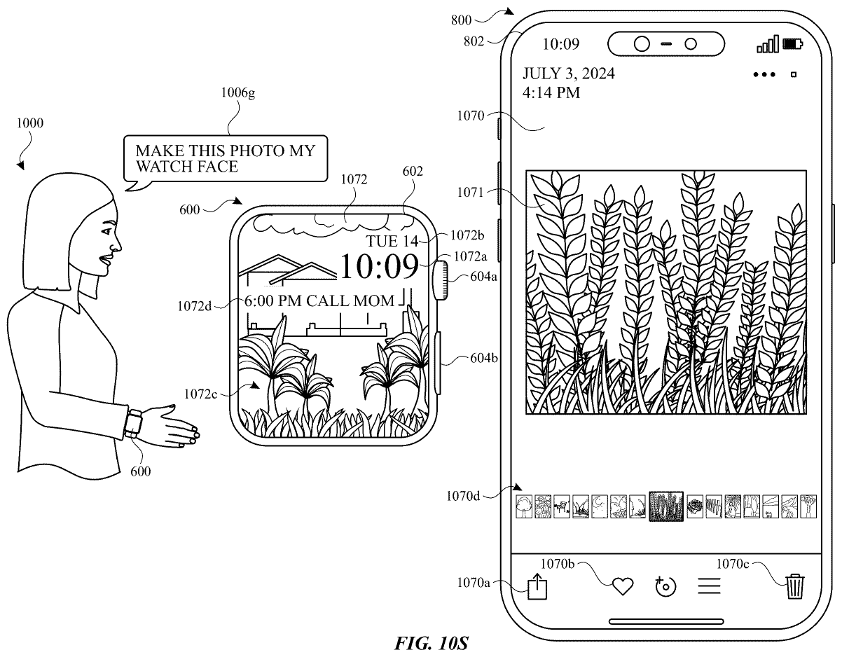

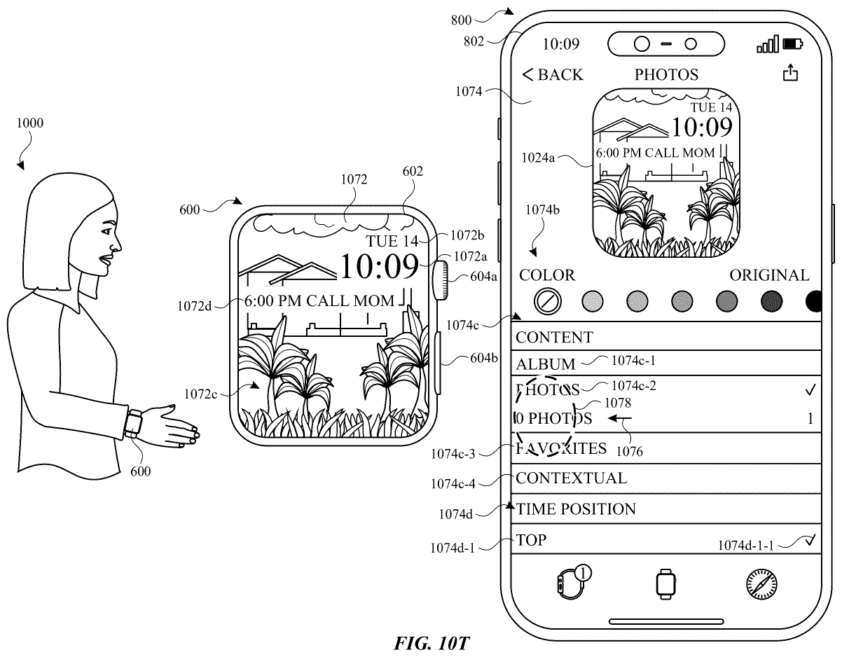

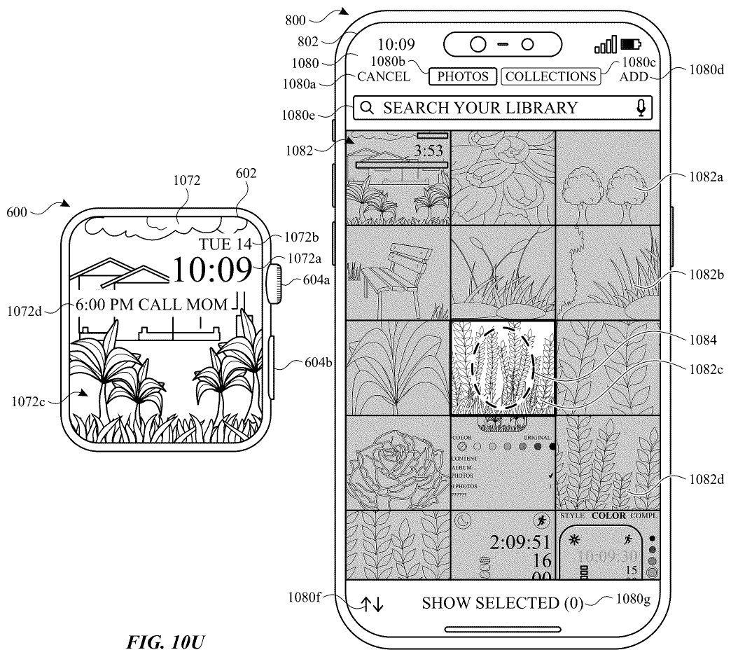

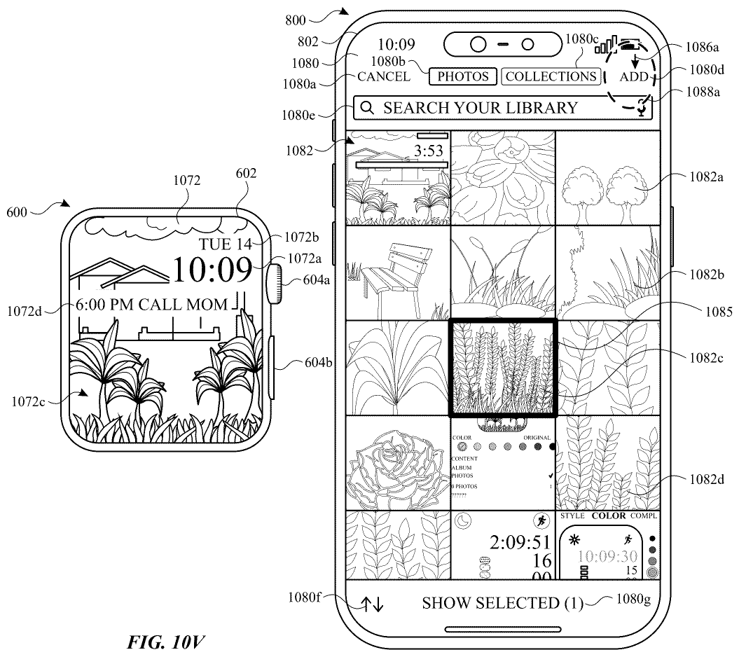

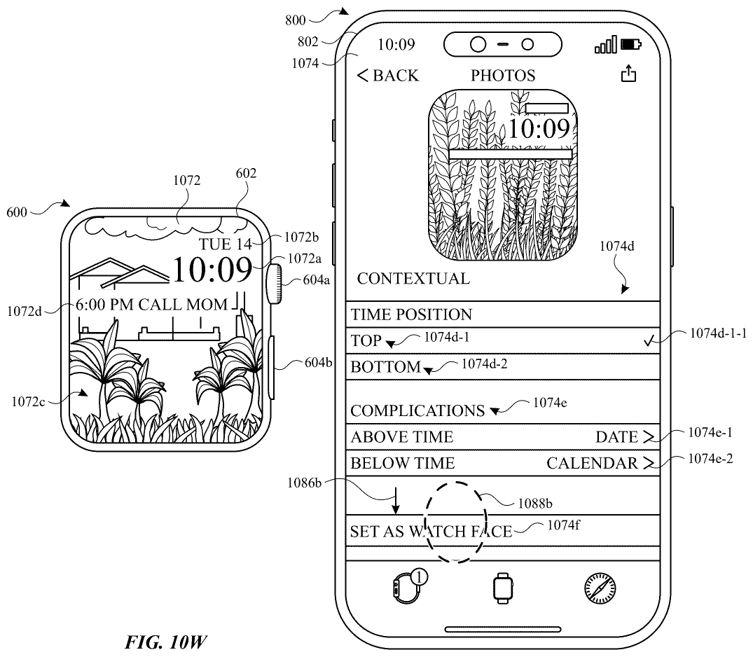

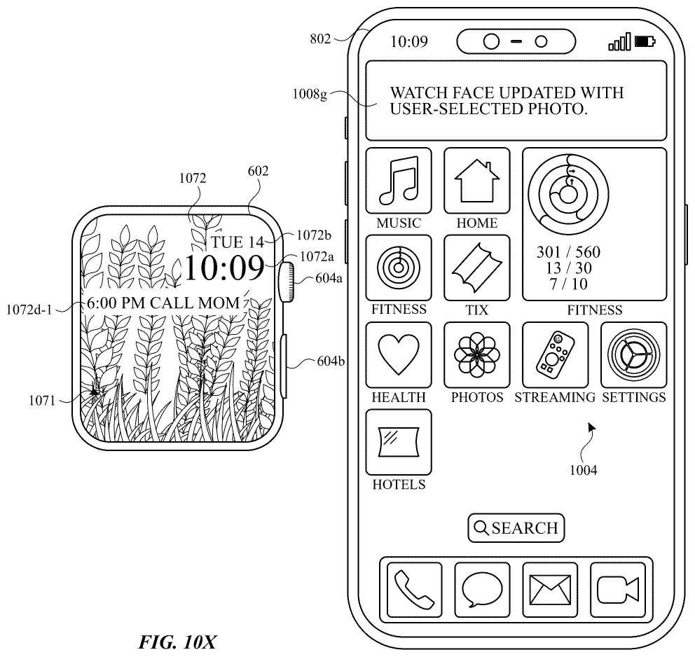

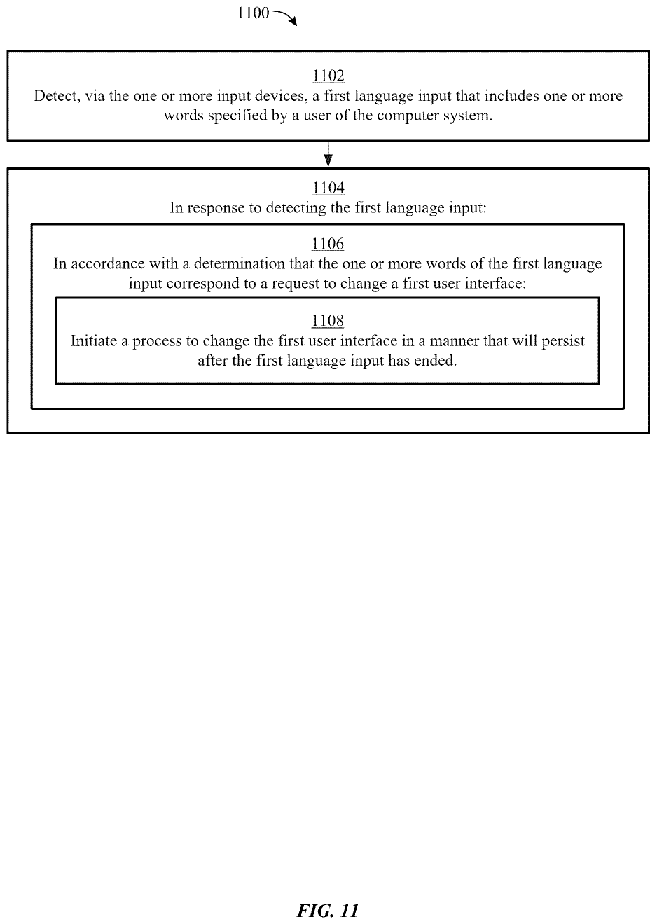

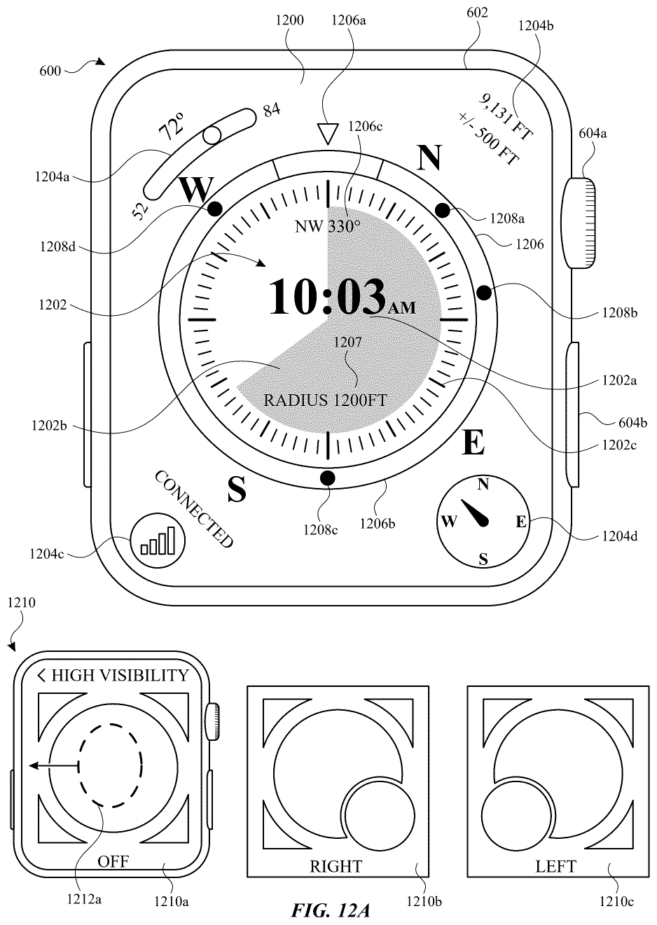

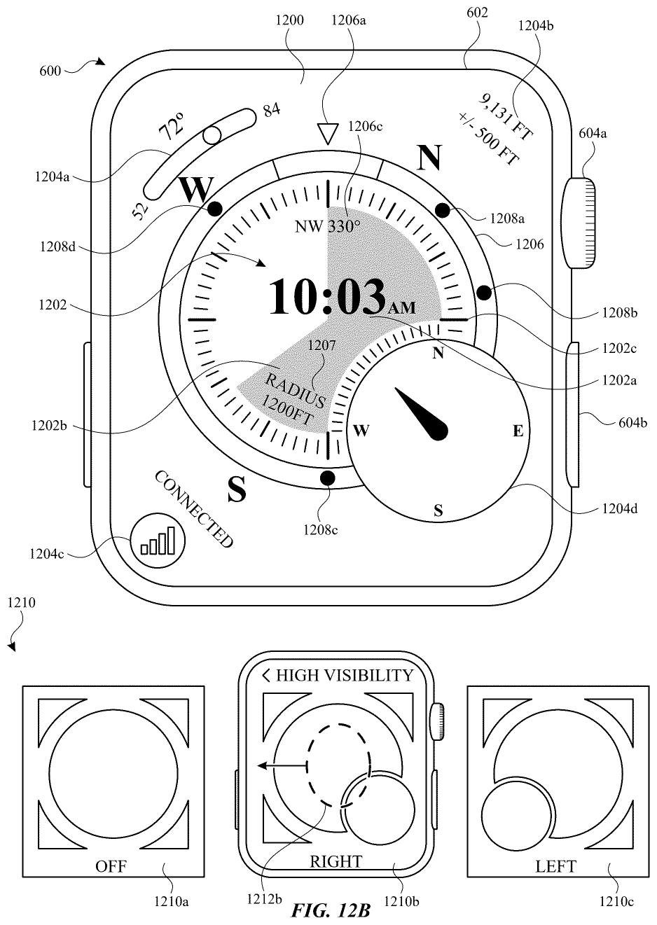

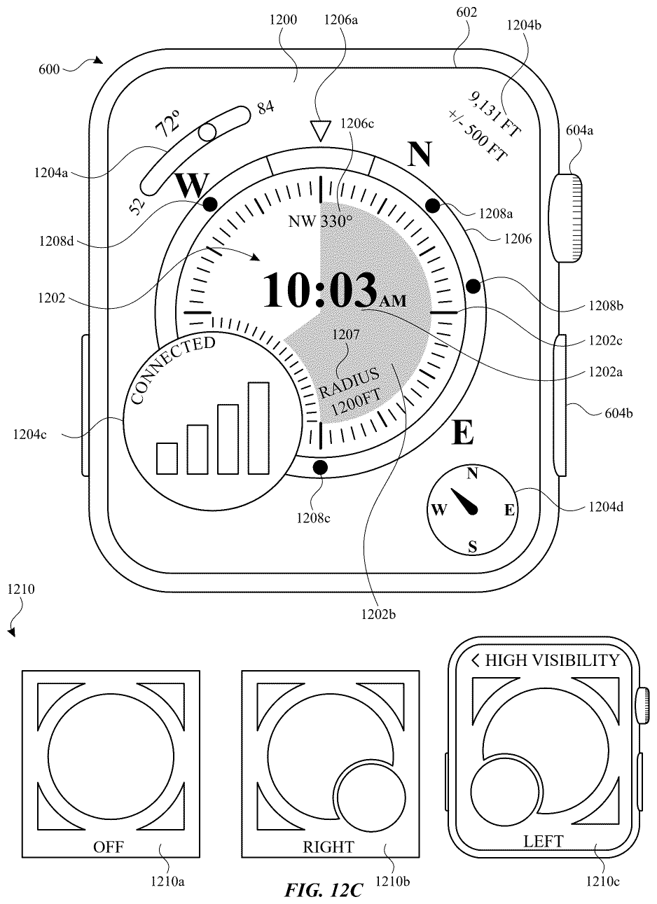

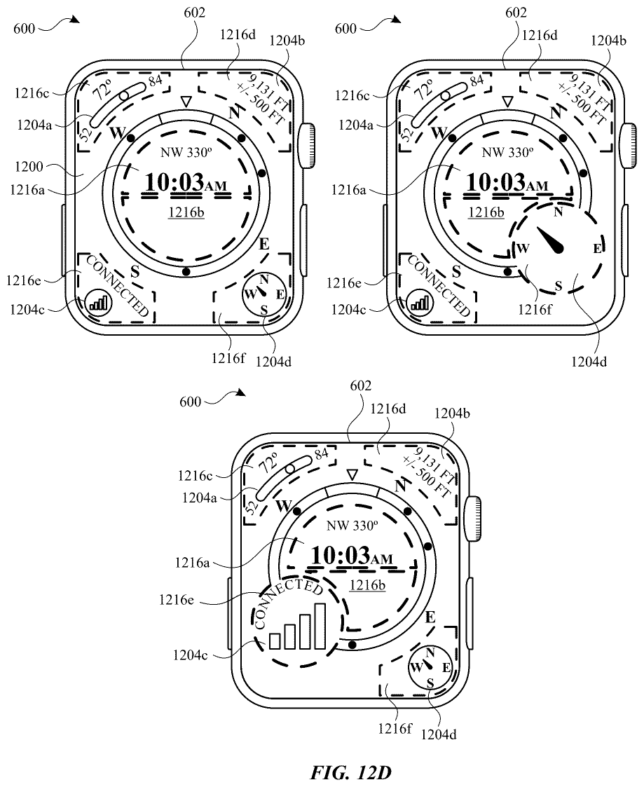

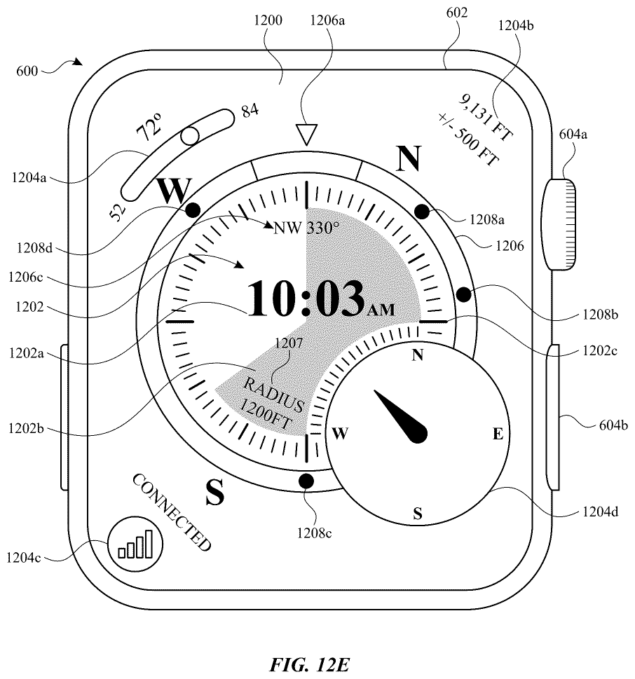

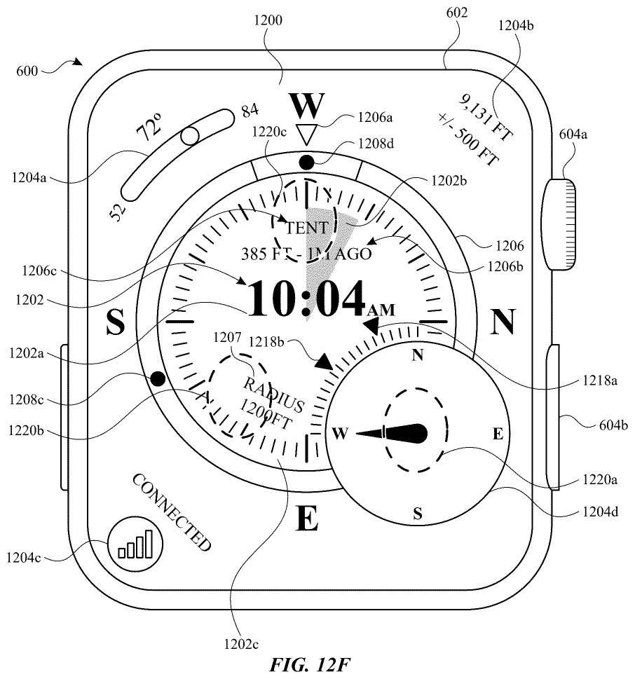

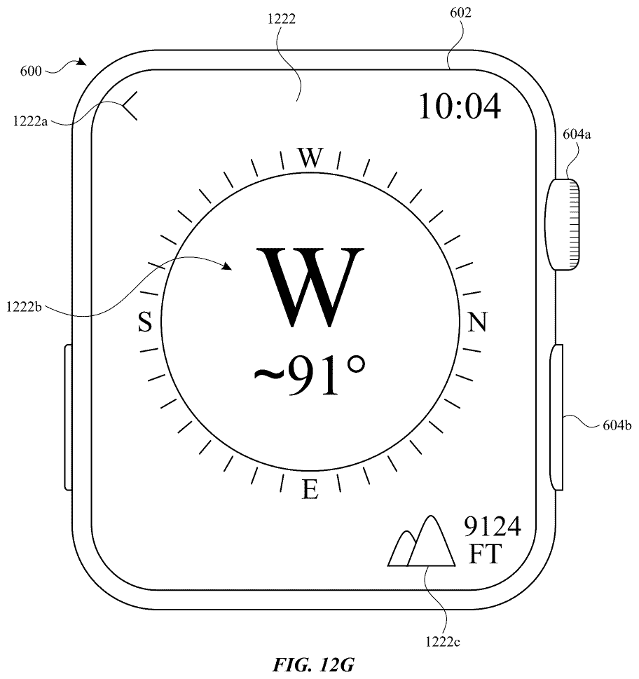

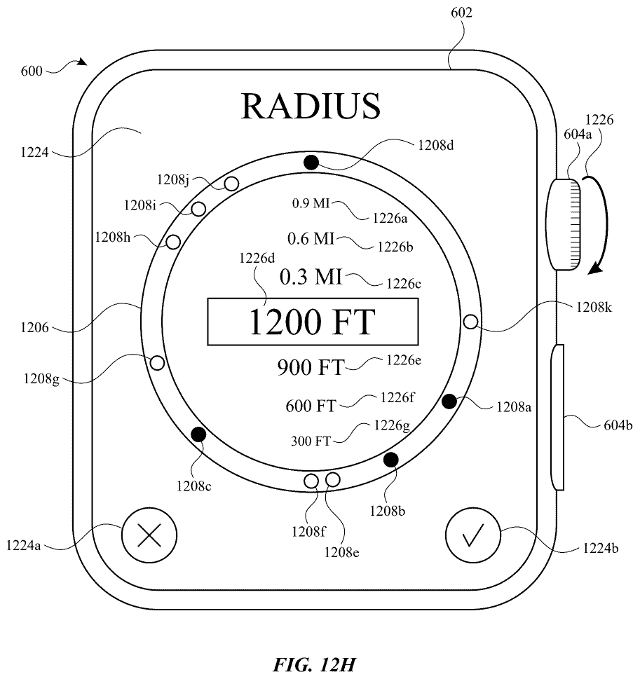

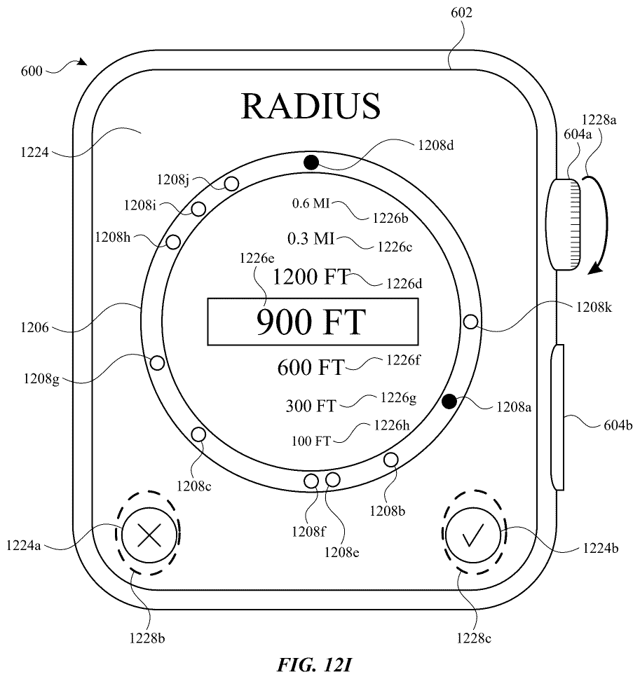

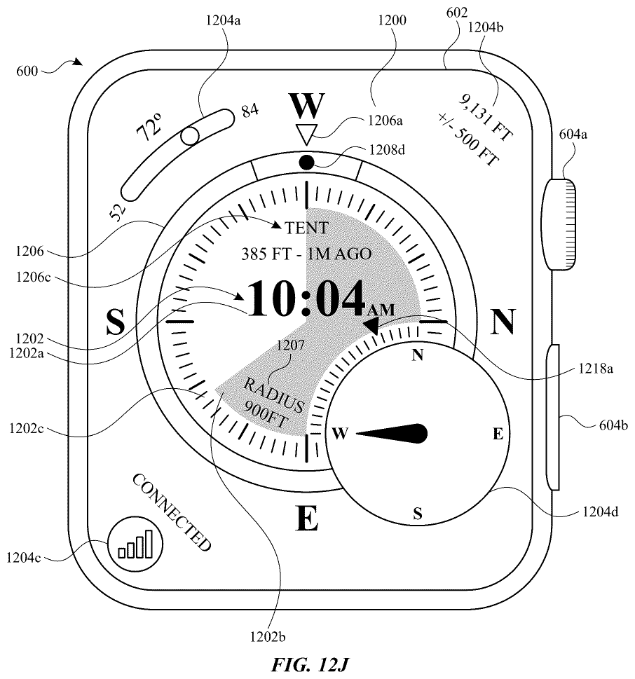

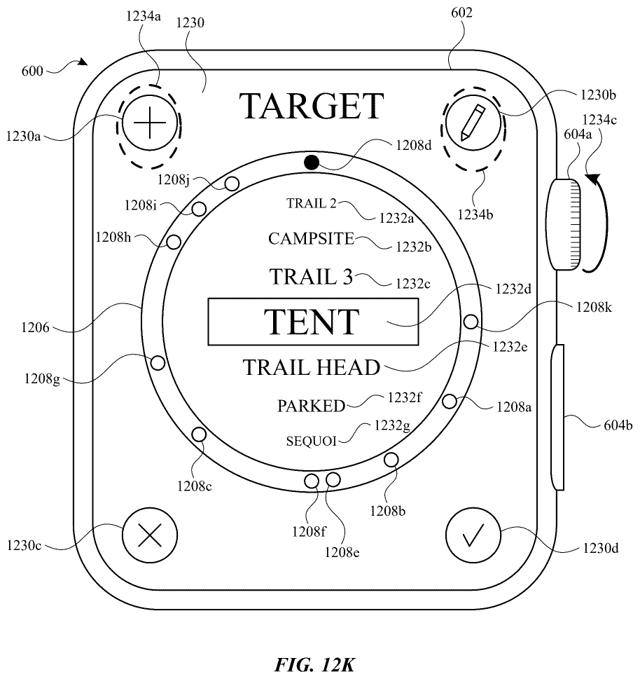

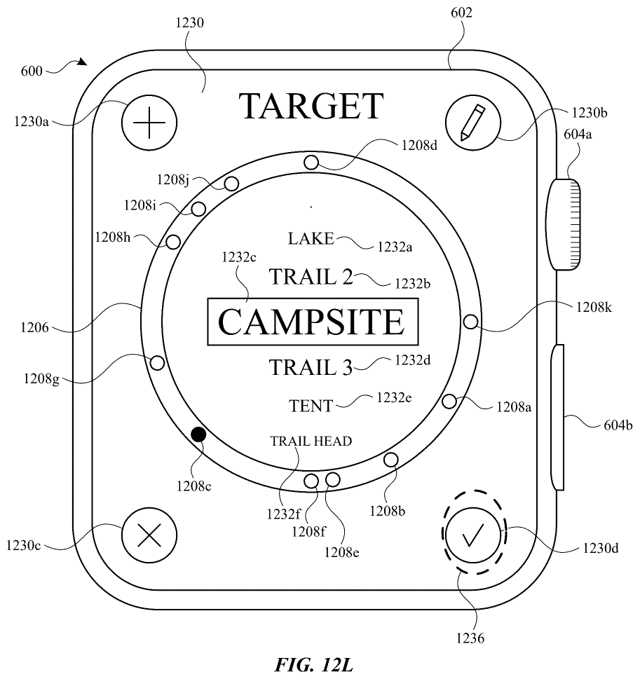

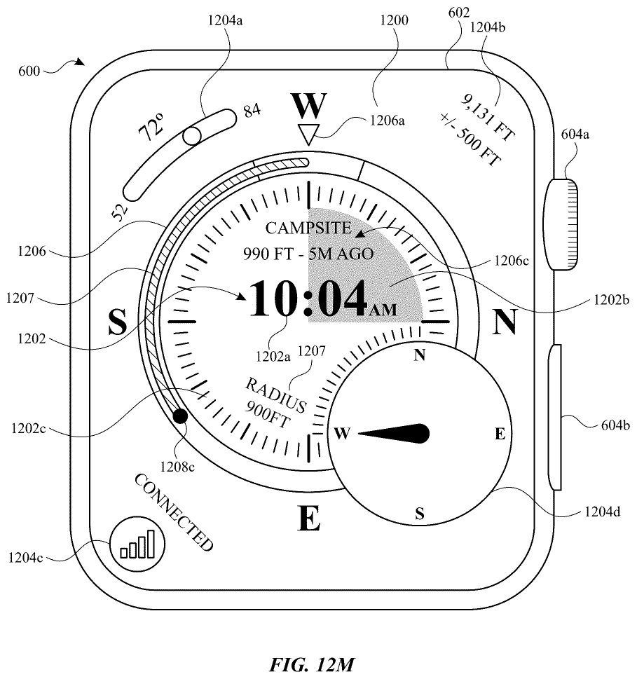

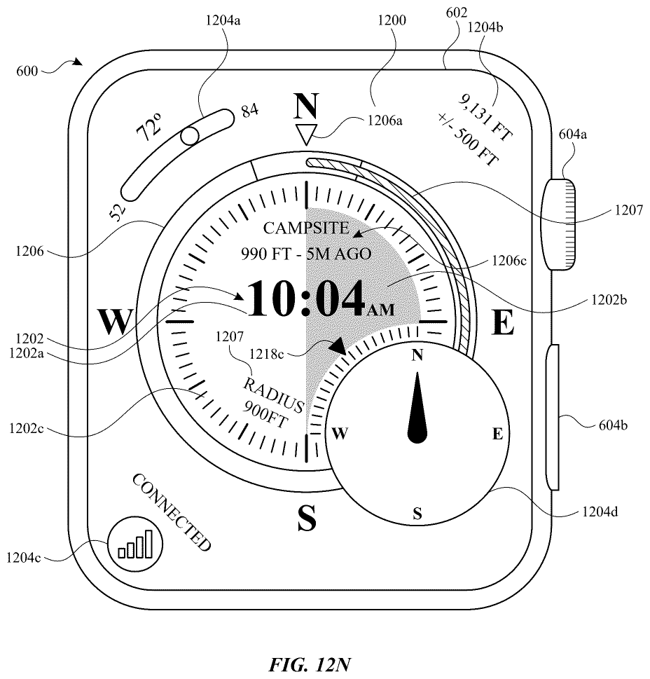

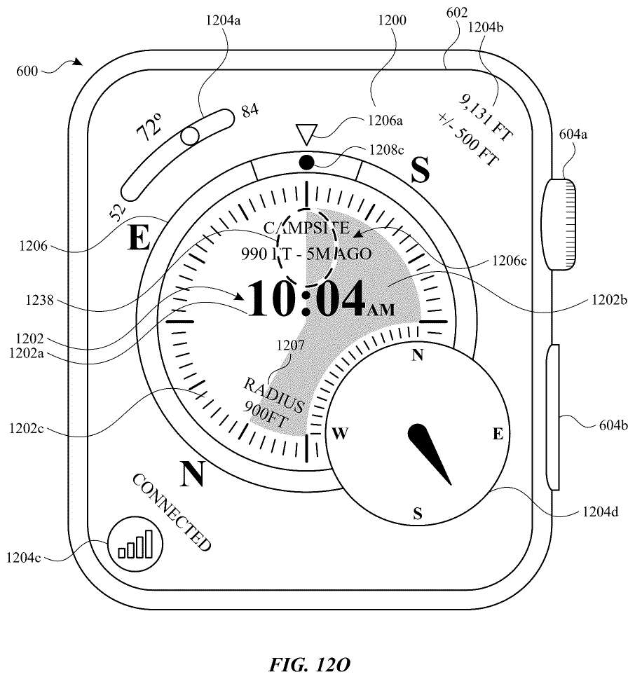

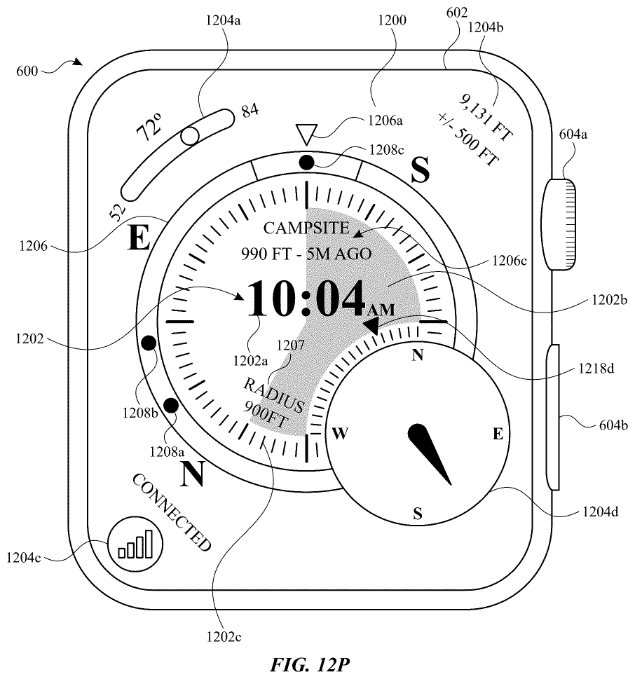

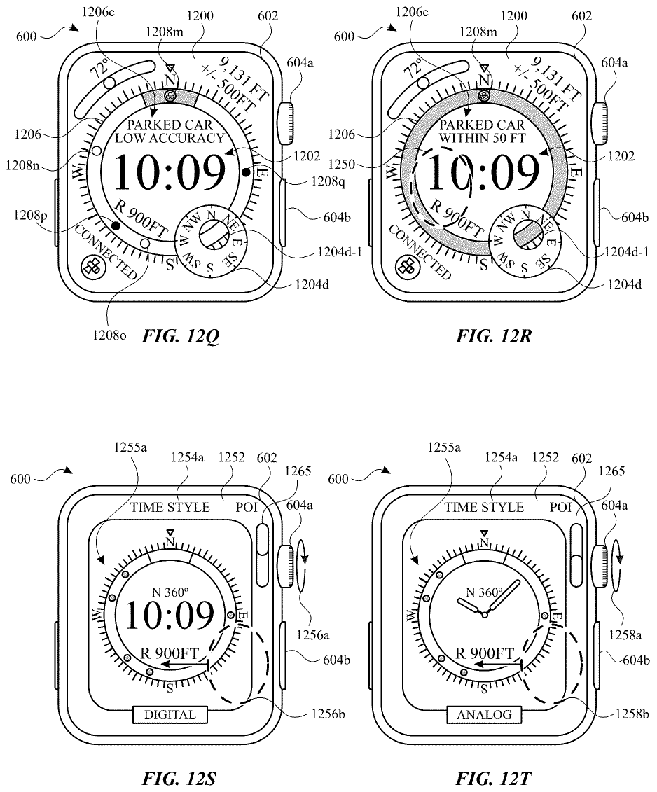

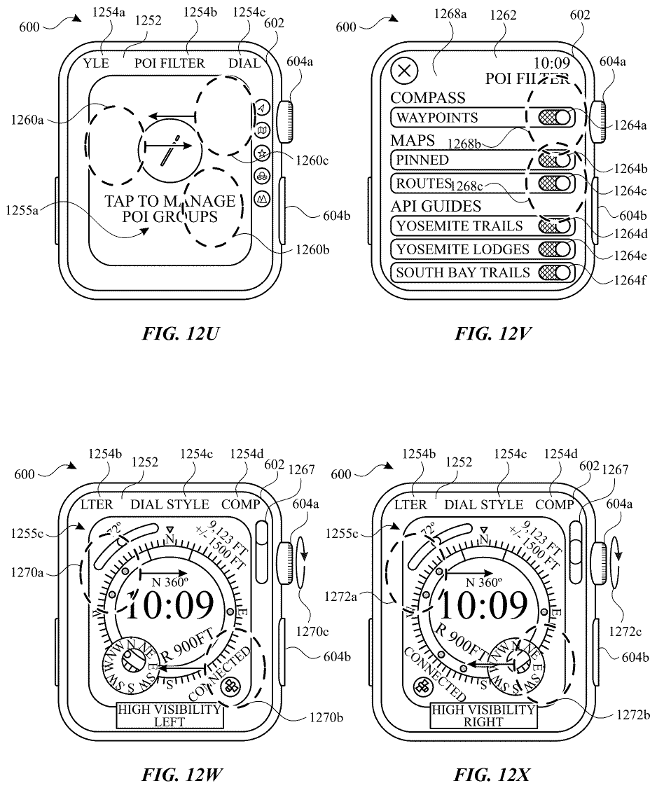

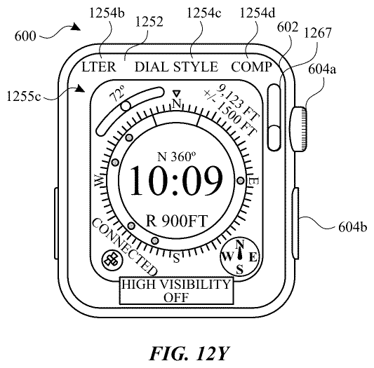

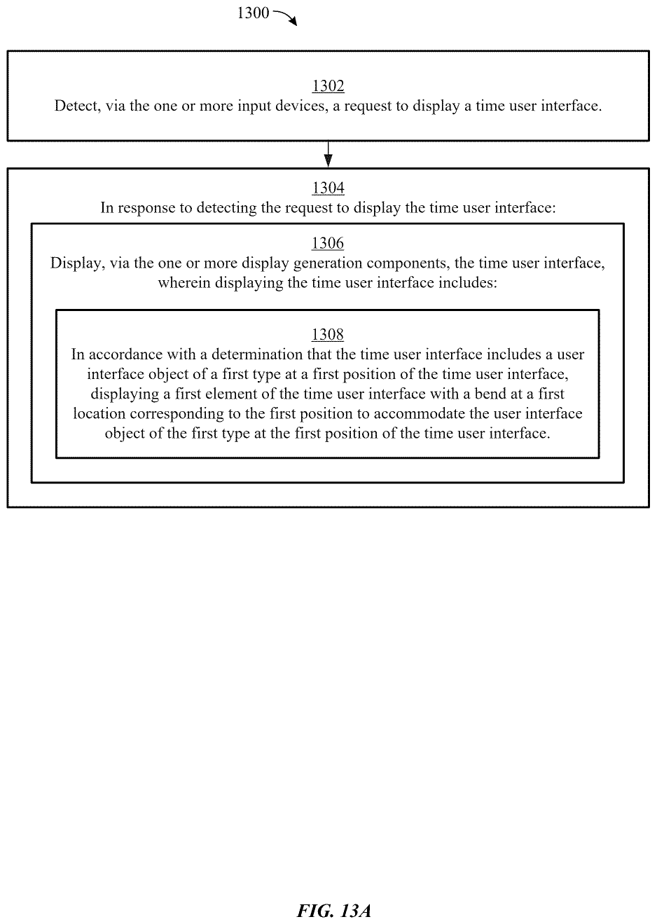

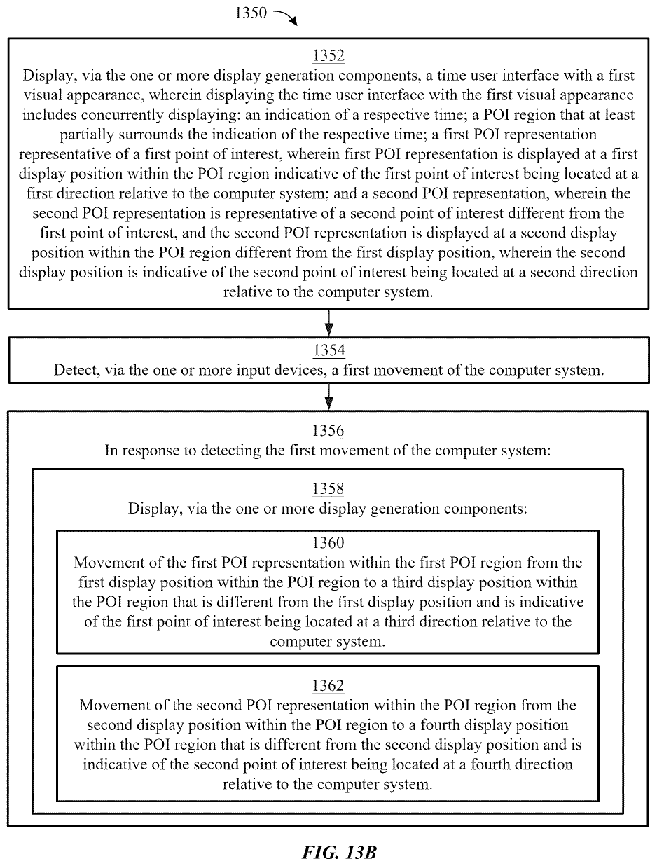

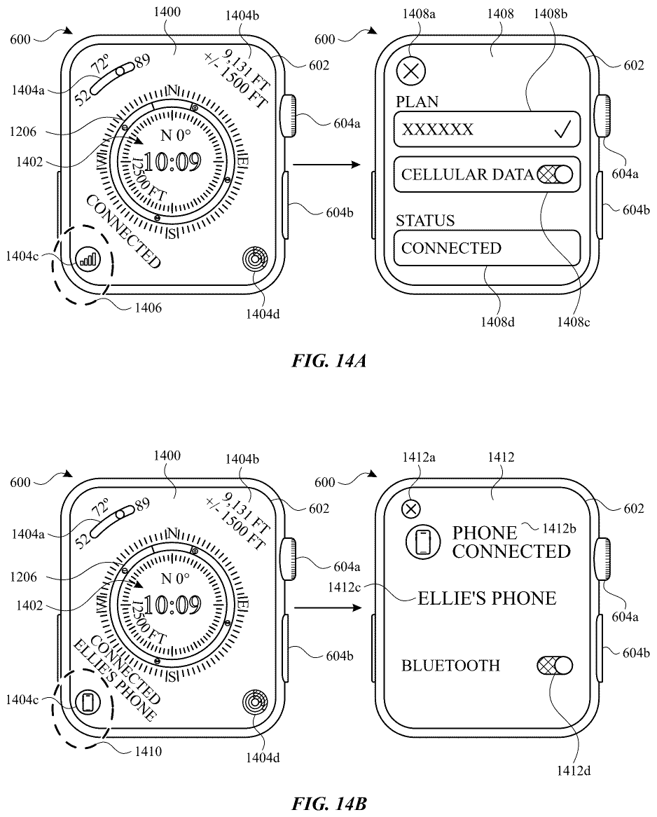

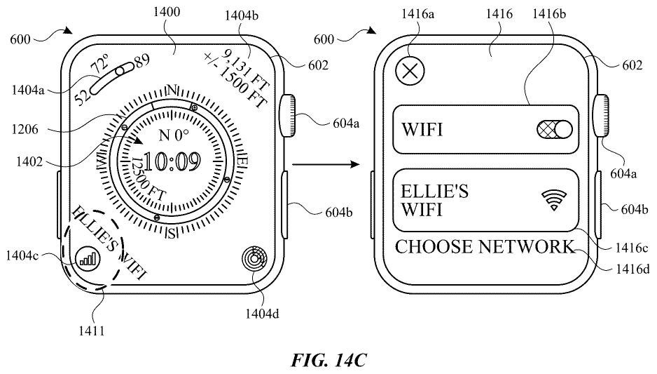

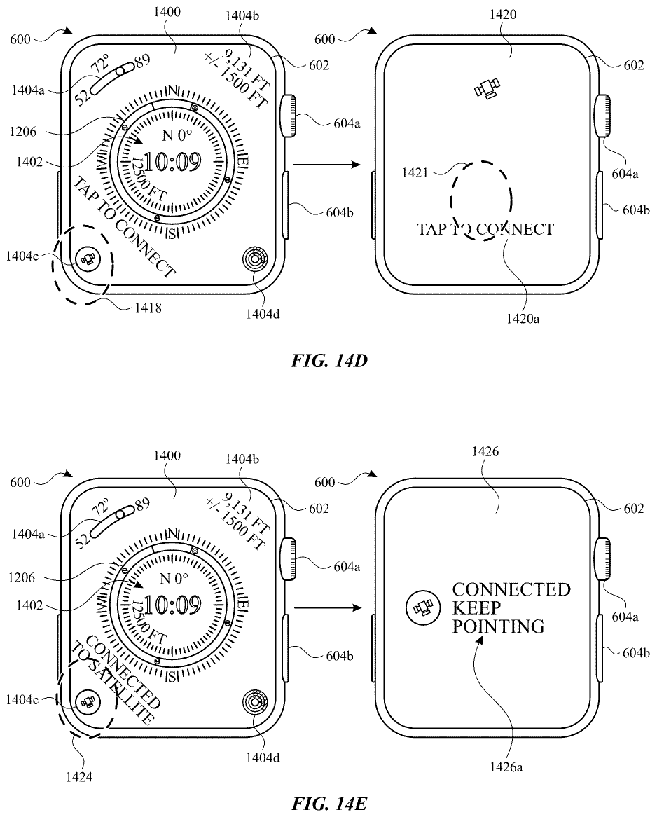

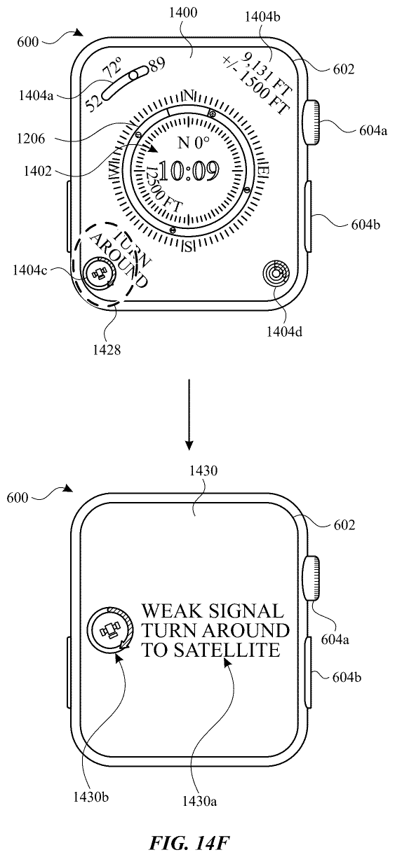

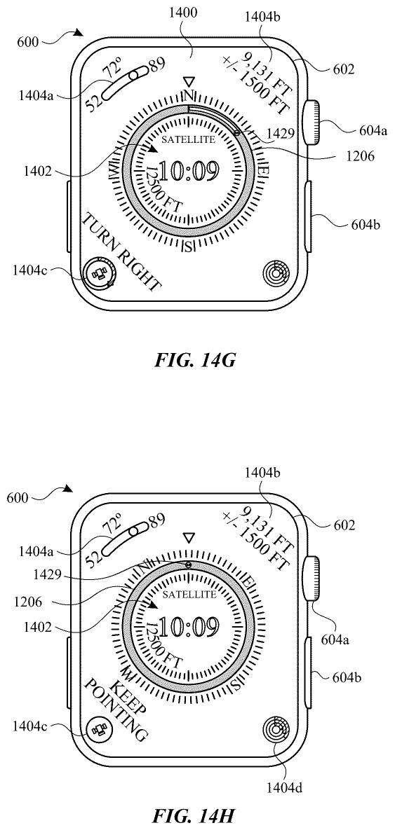

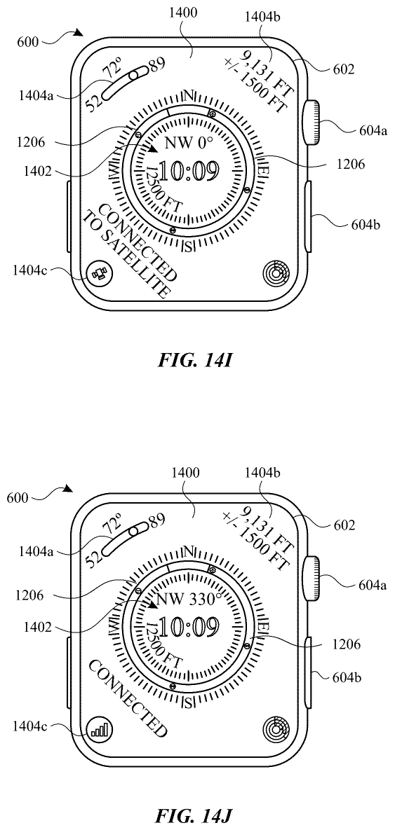

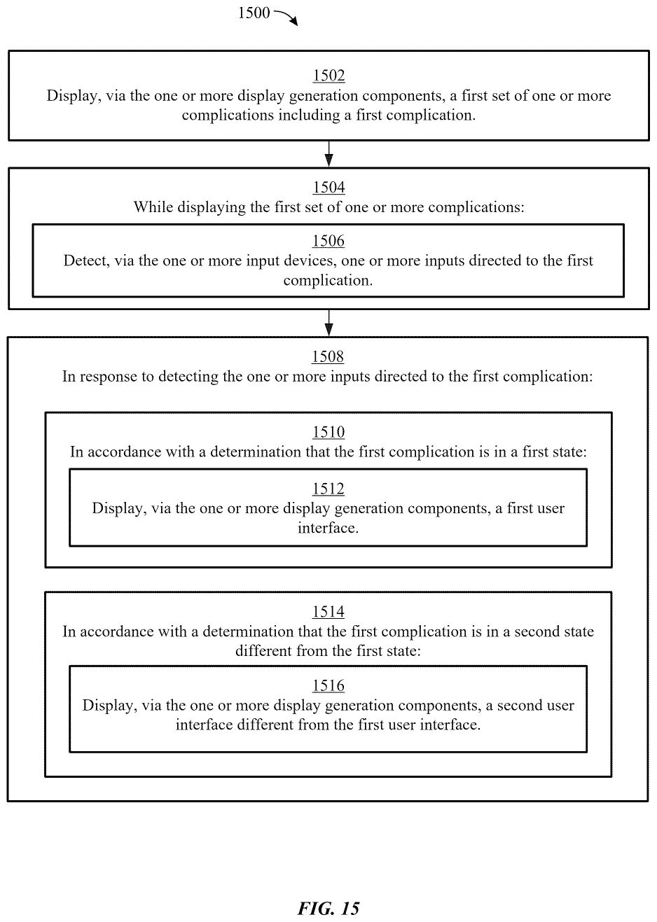

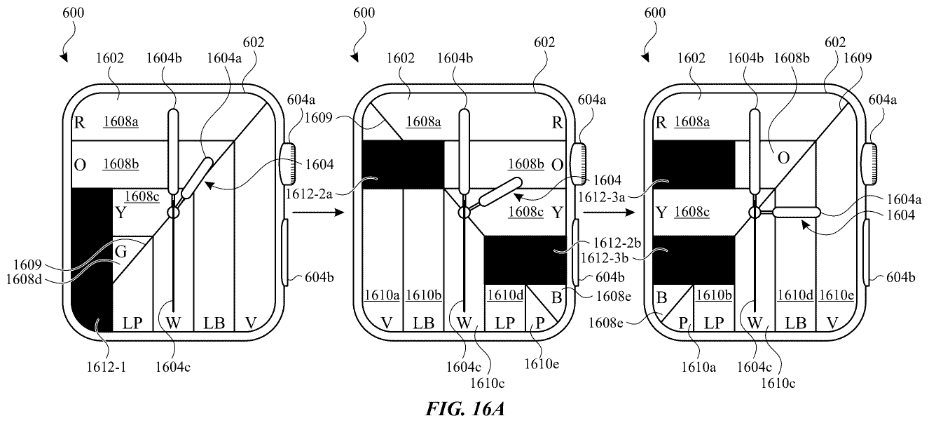

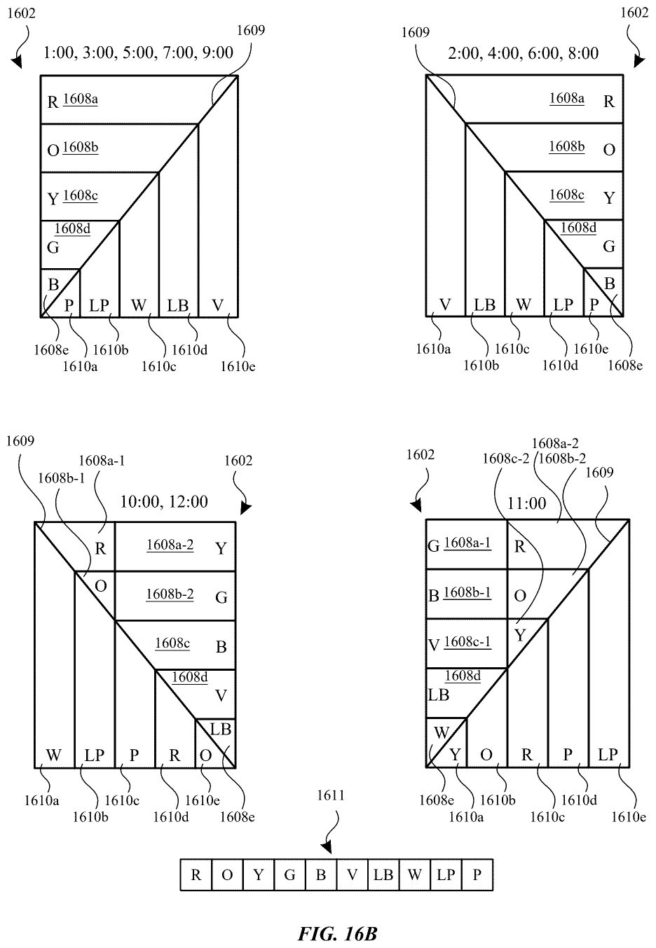

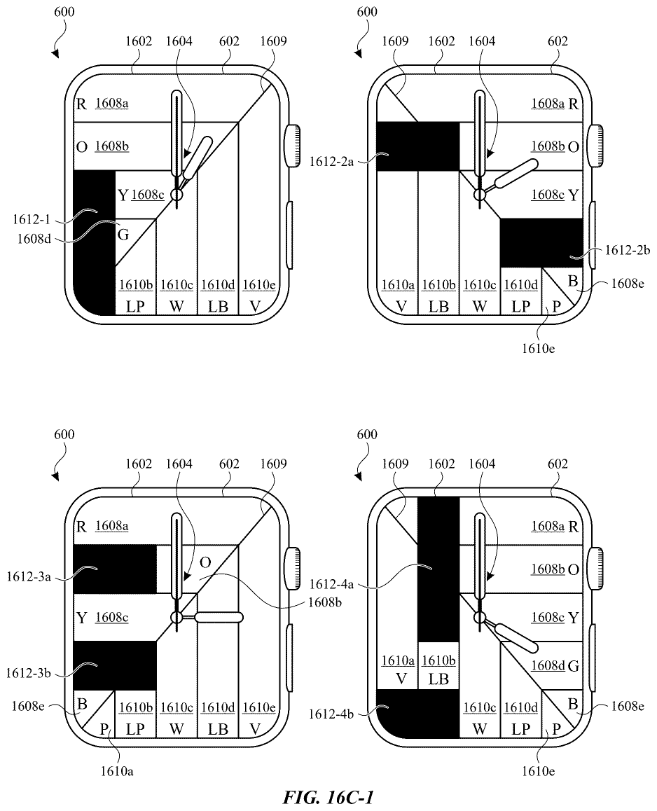

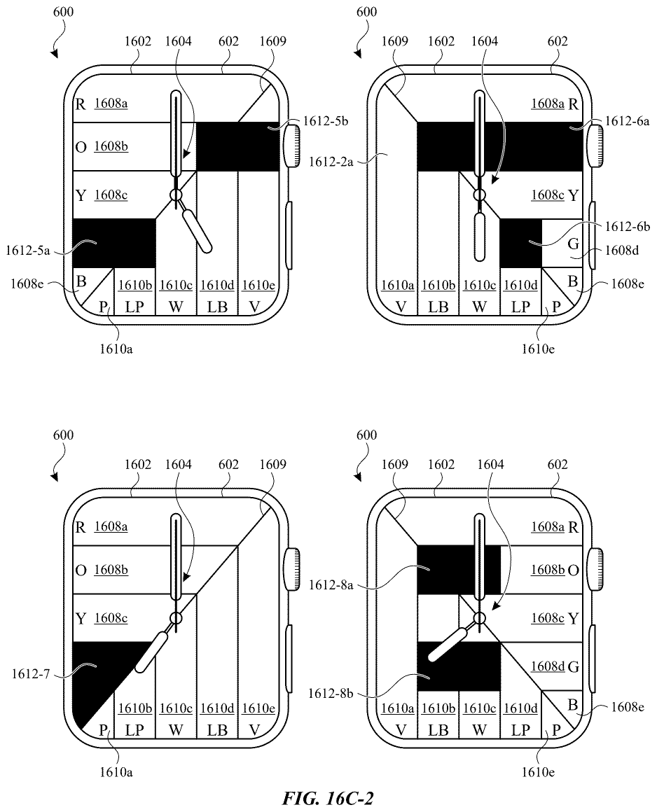

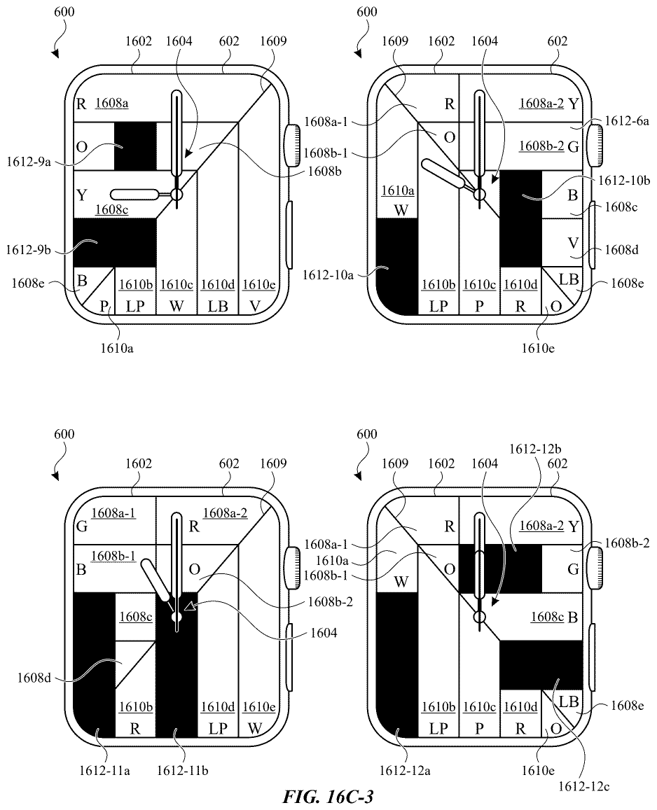

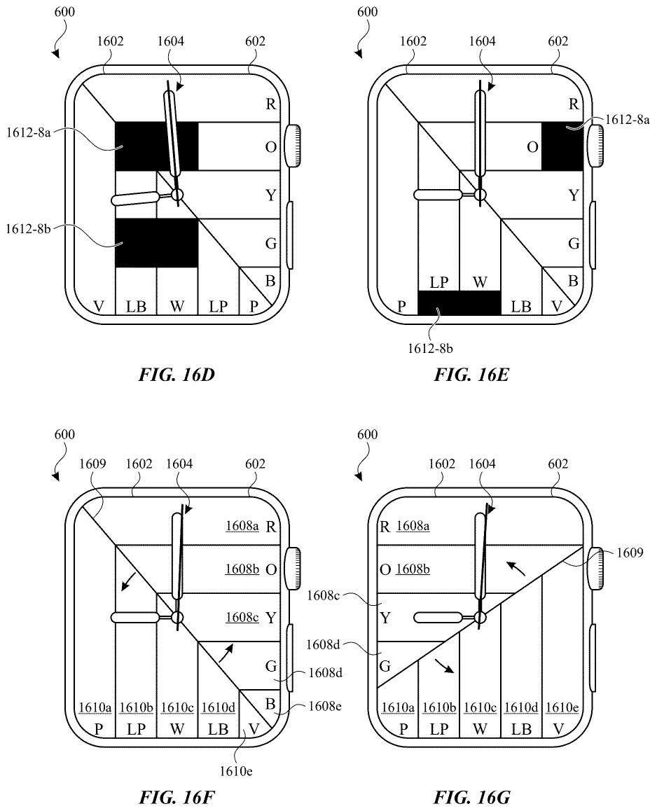

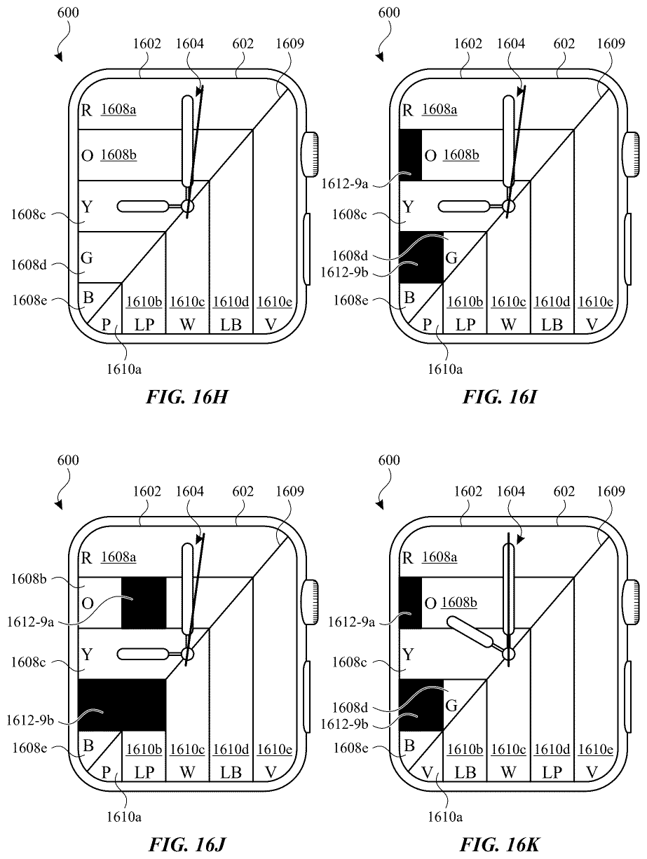

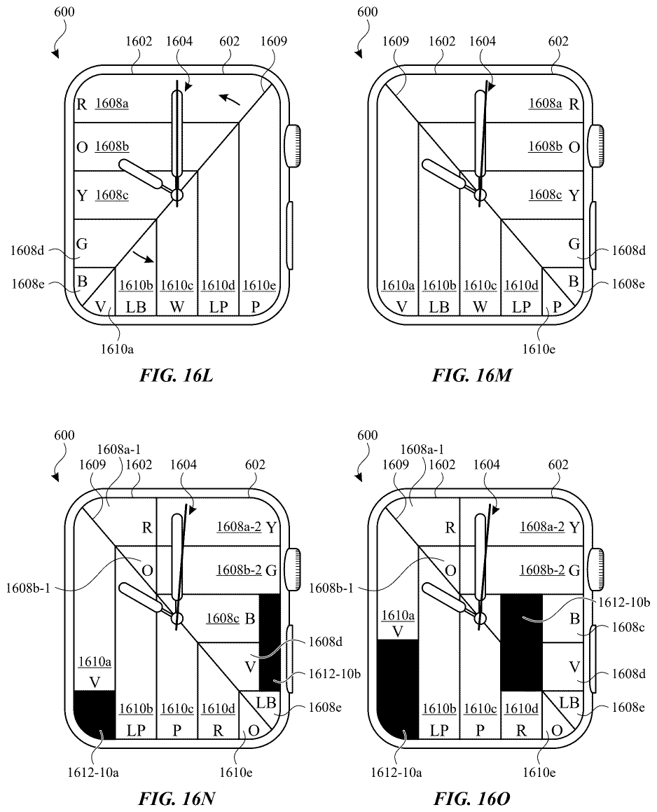

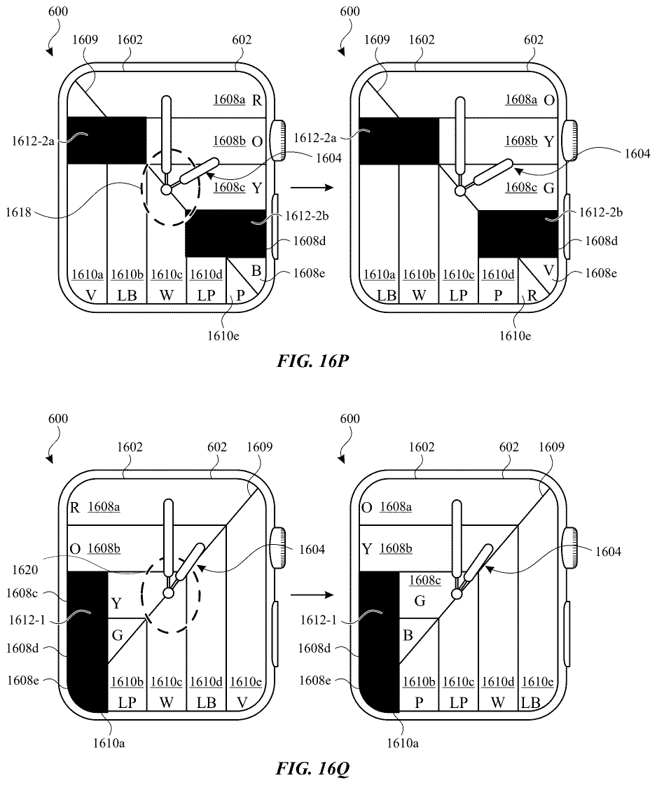

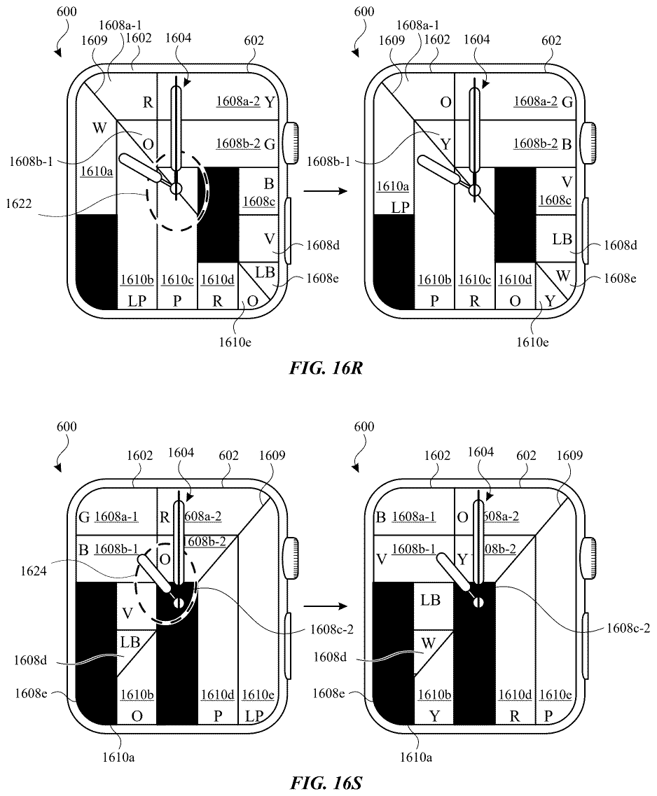

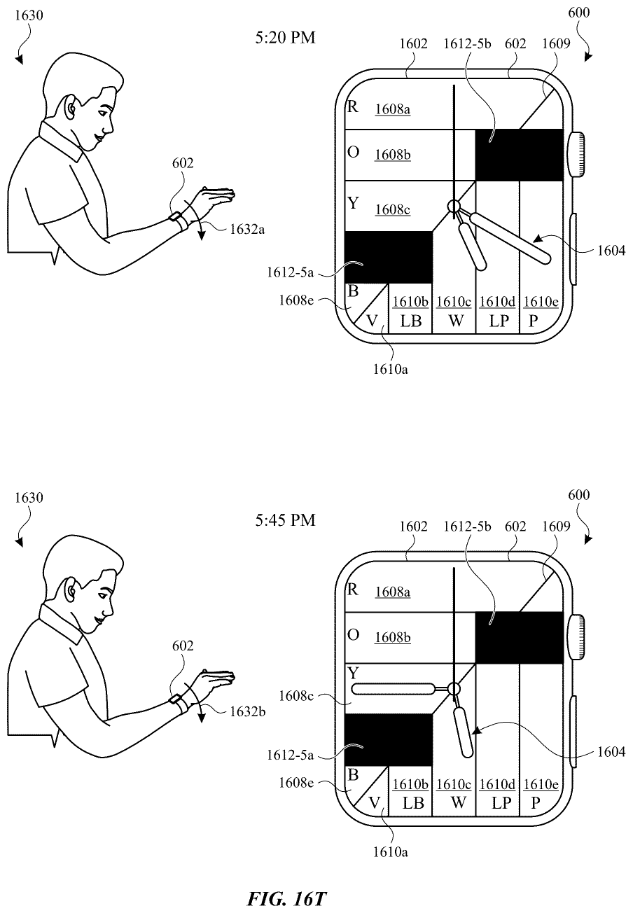

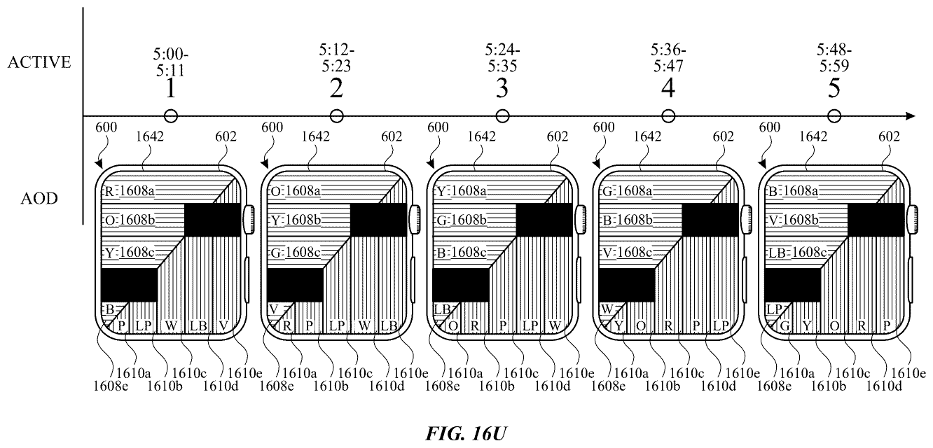

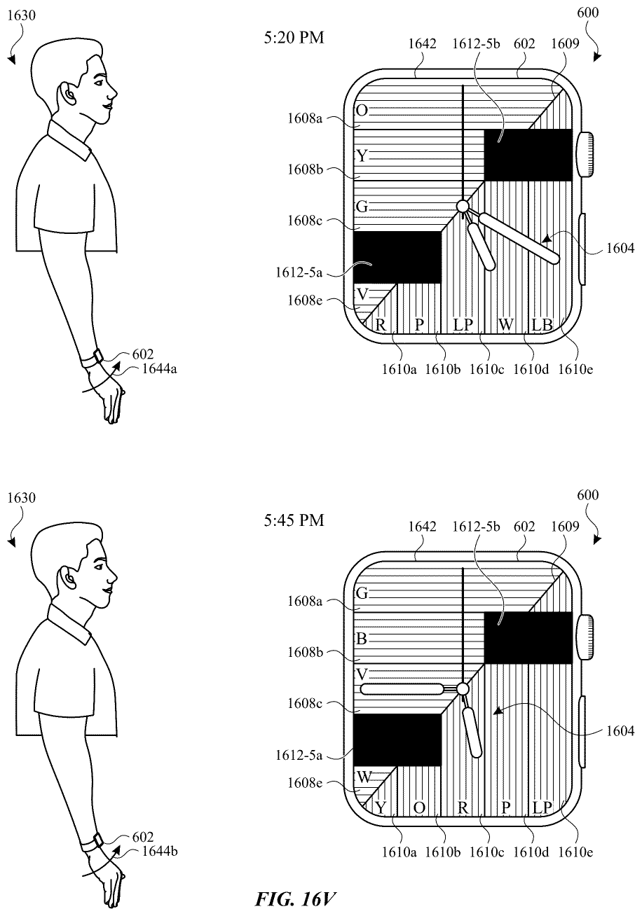

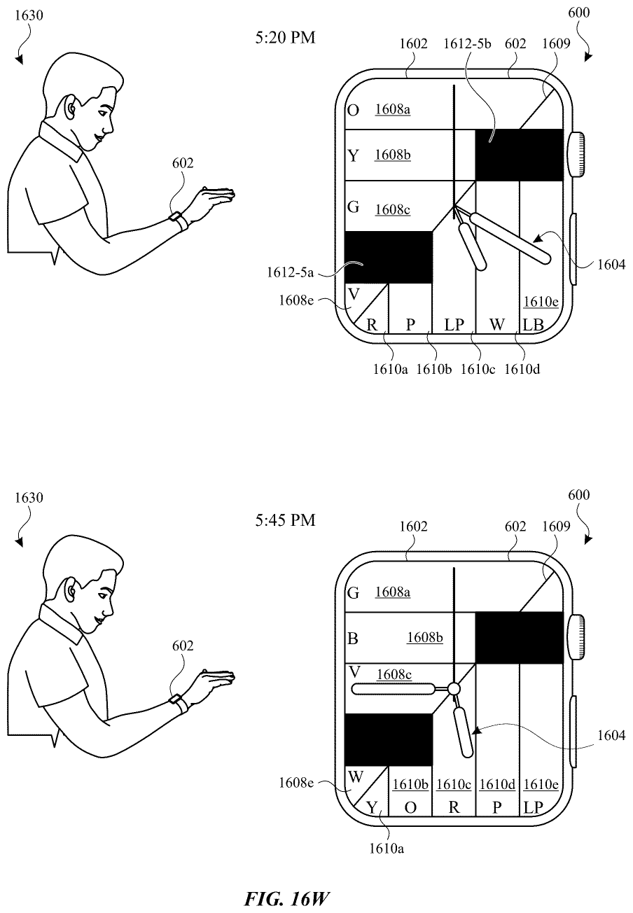

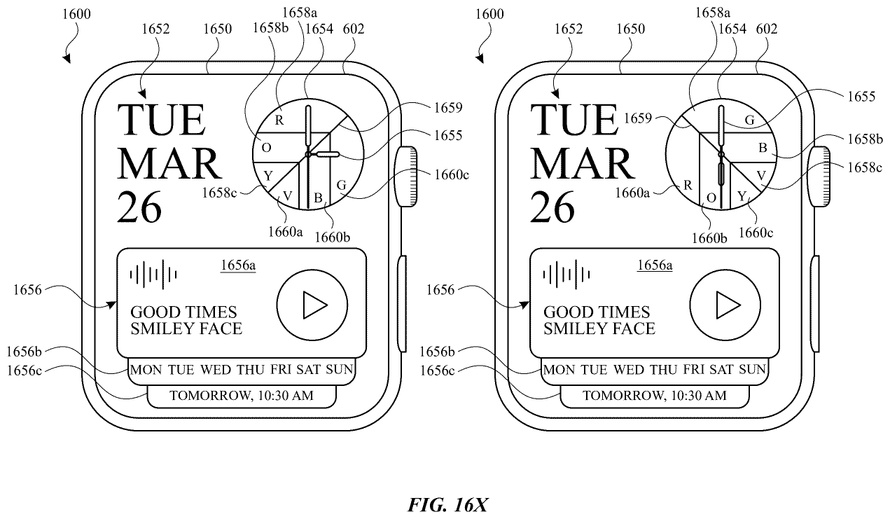

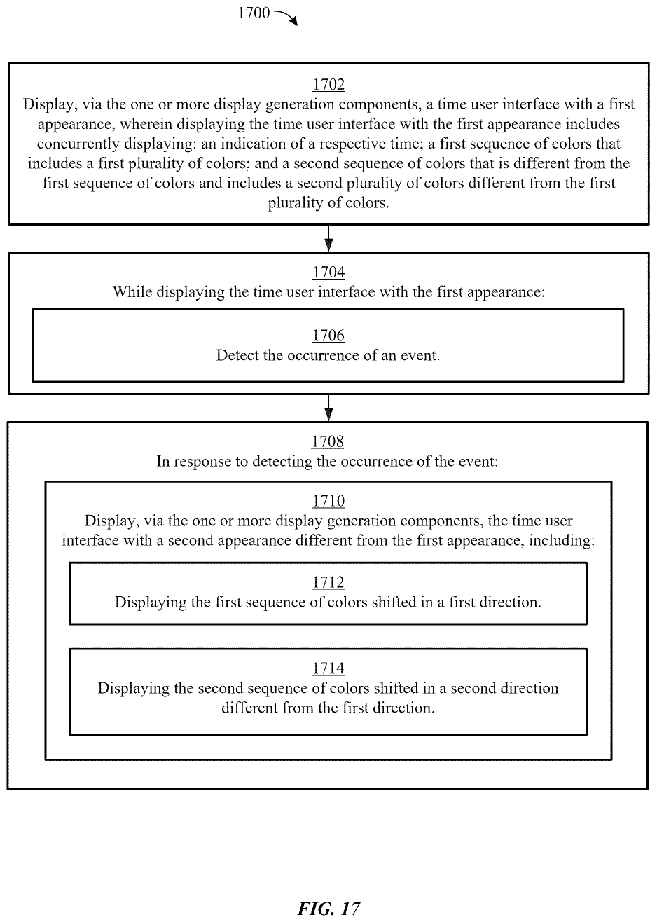

Below, FIGS. 1A-1B, 2, 3A-3G, 4A-4B, and 5A-5B provide a description of exemplary devices for performing the techniques for managing event notifications. FIGS. 6A-6S illustrate exemplary devices and user interfaces for providing time user interfaces, in accordance with some embodiments. FIG. 7 is a flow diagram illustrating methods of providing time user interfaces in accordance with some embodiments. The user interfaces in FIGS. 6A-6S are used to illustrate the processes described below, including the processes in FIG. 7. FIGS. 8A-8I illustrate exemplary devices and user interfaces for providing wake screen user interfaces, in accordance with some embodiments. FIG. 9 is a flow diagram illustrating methods of providing wake screen user interfaces, in accordance with some embodiments. The user interfaces in FIGS. 8A-8I are used to illustrate the processes described below, including the processes in FIG. 9. FIGS. 10A-10X illustrate exemplary devices and user interfaces for modifying user interfaces, in accordance with some embodiments. FIG. 11 is a flow diagram illustrating methods of modifying user interfaces, in accordance with some embodiments. The user interfaces in FIGS. 10A-10X are used to illustrate the processes described below, including the processes in FIG. 11. FIGS. 12A-12Y illustrate exemplary devices and user interfaces for providing time user interfaces, in accordance with some embodiments. FIG. 13A is a flow diagram illustrating methods of providing time user interfaces in accordance with some embodiments. FIG. 13B is a flow diagram illustrating methods of providing time user interfaces in accordance with some embodiments. The user interfaces in FIGS. 12A-12Y are used to illustrate the processes described below, including the processes in FIG. 13A and FIG. 13B. FIGS. 14A-14J illustrate exemplary devices and user interfaces for providing interactive complications, in accordance with some embodiments. FIG. 15 is a flow diagram illustrating methods of providing interactive complications in accordance with some embodiments. The user interfaces in FIGS. 14A-14J are used to illustrate the processes described below, including the processes in FIG. 15. FIGS. 16A-16X illustrate exemplary devices and user interfaces for providing time user interfaces, in accordance with some embodiments. FIG. 17 is a flow diagram illustrating methods of providing time user interfaces in accordance with some embodiments. The user interfaces in FIGS. 16A-16X are used to illustrate the processes described below, including the processes in FIG. 17.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

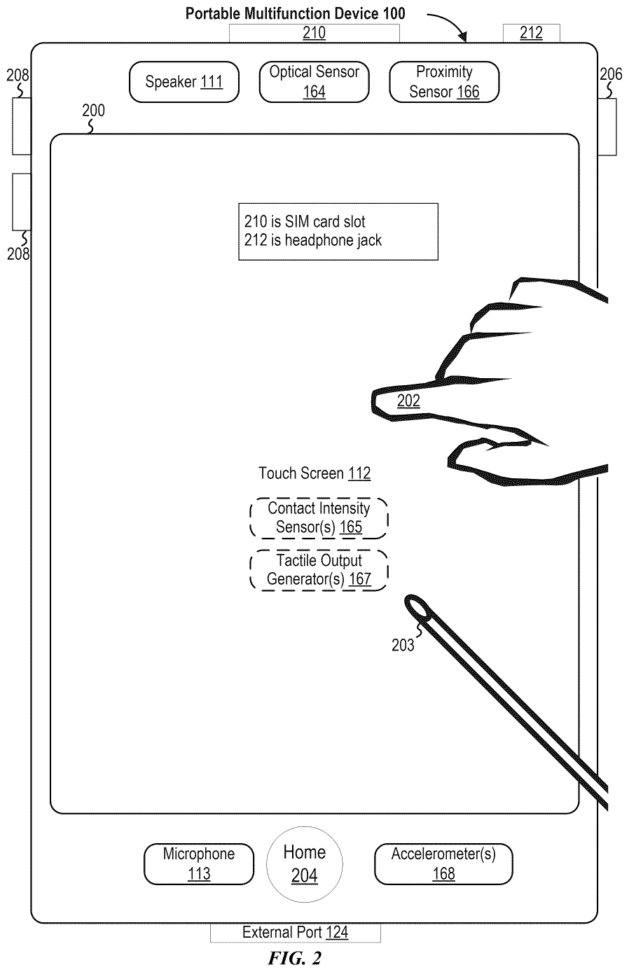

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

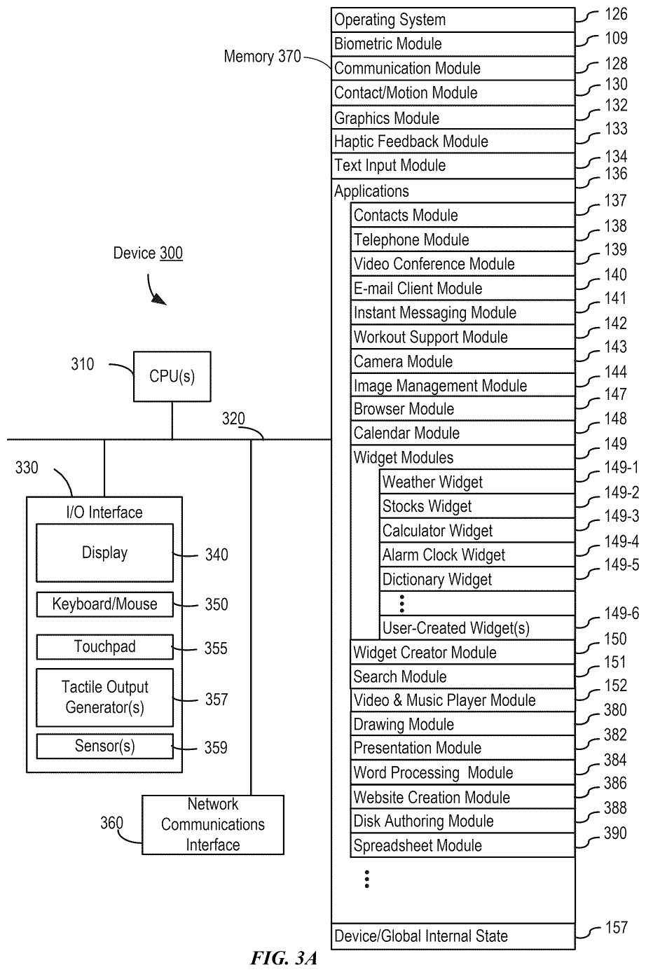

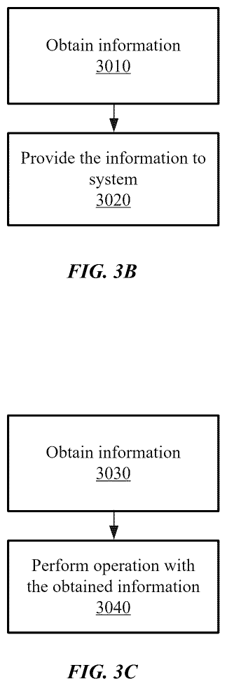

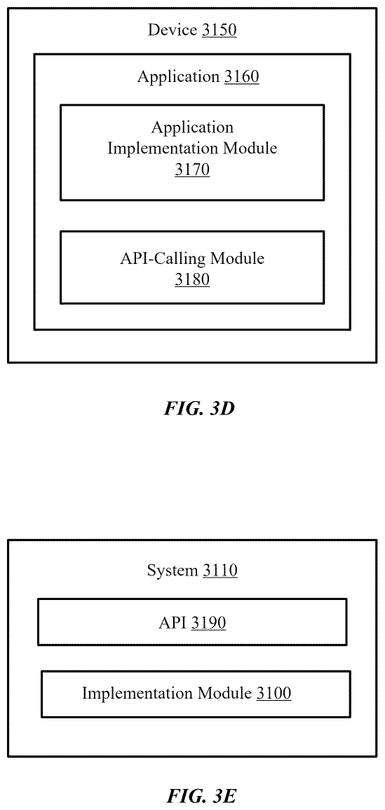

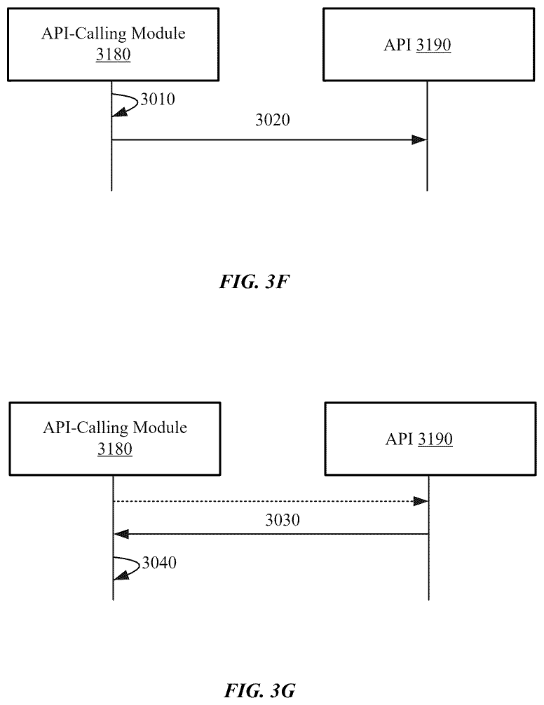

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 Optionally Include the Following Modules (or Sets of Instructions), or a Subset or Superset Thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7), method 900 (FIG. 9), method 1100 (FIG. 11), method 1300 (FIG. 13A), method 1350 (FIG. 13B), method 1500 (FIG. 15), and/or method 1700 (FIG. 17) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

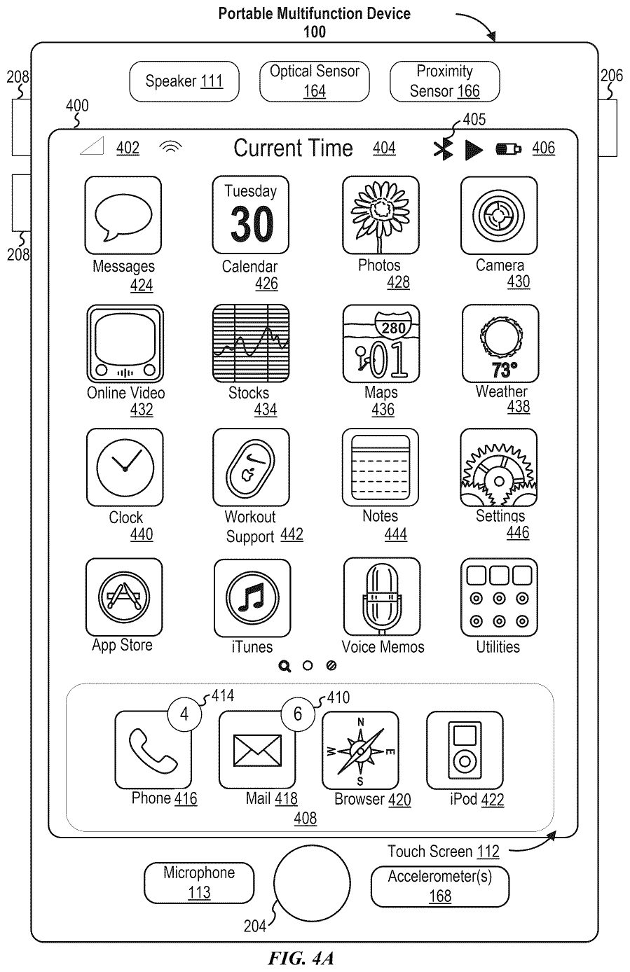

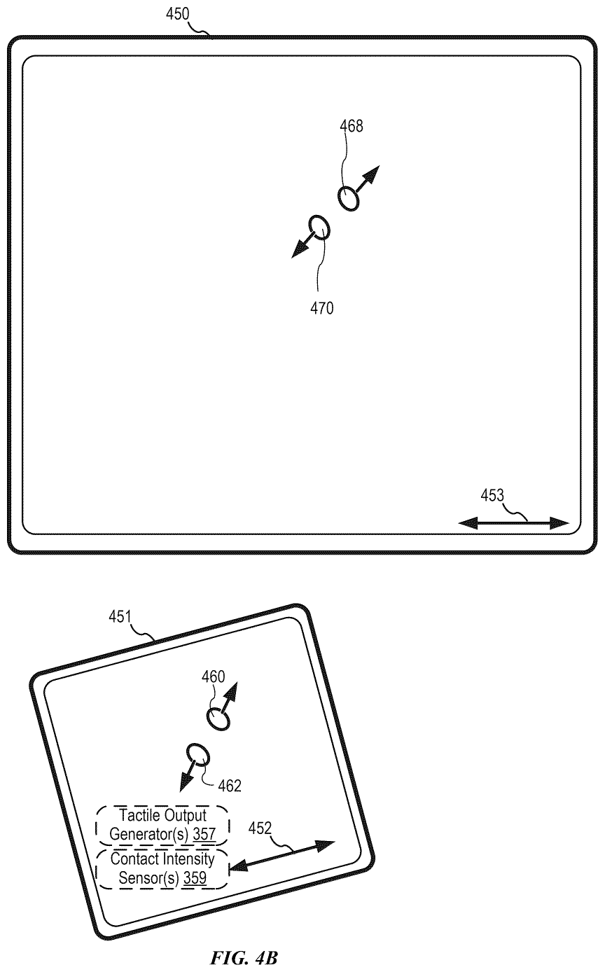

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

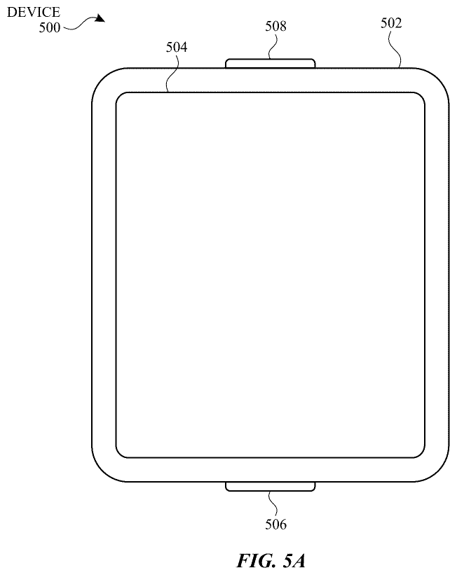

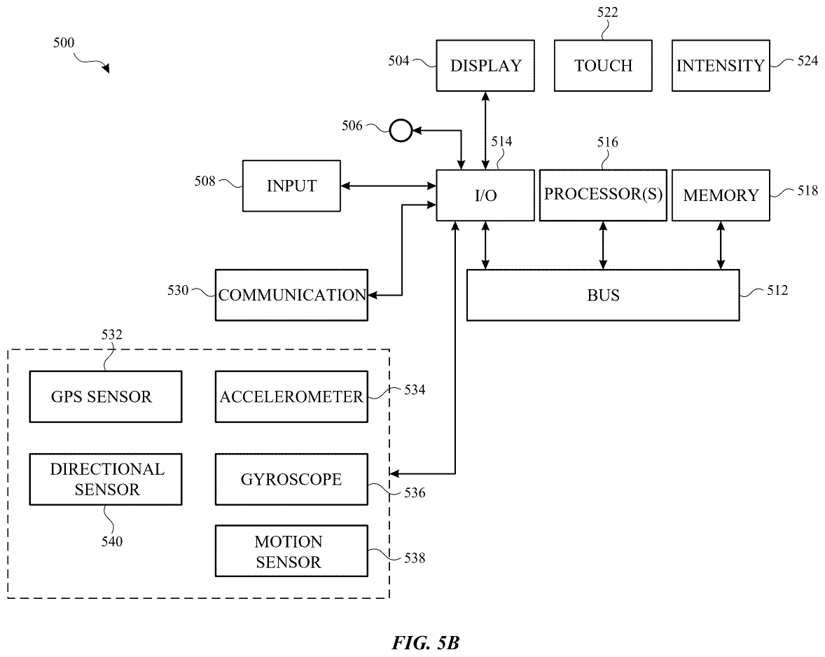

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including processes 700, 900, 1100, 1300, 1350, 1500, and/or 1700 (FIGS. 7, 9, 11, 13A, 13B, 15, and/or 17). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Attention is now directed towards embodiments of user interfaces (“UI”) and associated processes that are implemented on an electronic device, such as portable multifunction device 100, device 300, or device 500.

FIGS. 6A-6S illustrate exemplary user interfaces for providing time user interfaces, in accordance with some embodiments. The user interfaces in these figures are used to illustrate the processes described below, including the processes in FIG. 7.

FIG. 6A depicts computer system 600, which is a smart watch that includes touch-sensitive display 602, crown 604a, and button 604b. In the depicted embodiments, crown 604a is rotatable (e.g., in a clockwise direction and a counter-clockwise direction) and depressible, such that a user is able to use crown 604a to provide rotational input and depression (e.g., press) inputs. At FIG. 6A, computer system 600 displays, via touch-sensitive display 602, time user interface 608. Time user interface 608 includes time indication 610a, which includes seconds dial 610a, minutes dial 610b, hours dial 610c, seconds hand 612a, minutes hand 612b, and hours hand 612c. Time user interface 608 also includes complications 614a-614d. Complication 614a is a UV Index complication that displays the current UV Index in a particular location (e.g., the current location at which computer system 600 is located and/or a user-specified location). In some embodiments, complication 614a corresponds to and/or is generated by a weather application. Complication 614b is a temperature complication that displays the current day's forecasted low temperature (52 degrees), the current day's forecasted high temperature (89 degrees), and the current temperature (72 degrees) for a particular location (e.g., the current location at which computer system 600 is located and/or a user-specified location). In some embodiments, complication 614b corresponds to and/or is generated by a weather application. Complication 614c is a timer complication that displays the time remaining on a countdown timer. In some embodiments, complication 614c corresponds to and/or is generated by a timer application. Complication 614d is a physical activity complication that displays the user's progress in the current day towards three different daily physical activity goals (e.g., calories burned, which is currently 350 calories; minutes of movement, which is currently 15 minutes; and/or standing hours, which is currently three hours). In some embodiments, complication 614d corresponds to and/or is generated by a physical activity application and/or a fitness application.

At FIG. 6A, time indication 610a indicates that the time is currently 10:08:16. At FIG. 6B, time has progressed, and time indication 610a now indicates that the time is currently 11:19:25. FIG. 6B depicts various example scenarios in which computer system 600 detects various user inputs, including: user input 616a (e.g., a tap input) corresponding to selection of complication 614a; user input 616b (e.g., a tap input) corresponding to selection of complication 614b; user input 616c (e.g., a tap input) corresponding to selection of complication 614c; user input 616d (e.g., a tap input) corresponding to selection of complication 614d; and user input 616e (e.g., a tap input) on time indication 610a.

In some embodiments, in response to detecting user input 616a, computer system 610 displays, via touch-sensitive display 602, a UV index user interface and/or a user interface generated by a weather application that corresponds to complication 614a (and, optionally, ceases display of time user interface 608). In some embodiments, in response to detecting user input 616b, computer system 610 displays, via touch-sensitive display 602, a temperature user interface, a weather forecast user interface, and/or a user interface generated by a weather application that corresponds to complication 614b (and, optionally, ceases display of time user interface 608). In some embodiments, in response to detecting user input 616c, computer system 600 displays, via touch-sensitive display 602, a countdown timer user interface and/or a user interface generated by a timer application that corresponds to complication 614c (and, optionally, ceases display of time user interface 608). In some embodiments, in response to detecting user input 616d, computer system 600 displays, via touch-sensitive display 602, a fitness user interface and/or a user interface generated by a fitness application that corresponds to complication 614d (and, optionally, ceases display of time user interface 608). In some embodiments, in response to detecting user input 616e, computer system 600 transitions time user interface 608 from a collapsed state, as shown in FIGS. 6A and 6B, to a first expanded state, as will be described in greater detail below.

In some embodiments, in the collapsed state of time user interface 608 shown in FIG. 6A and FIG. 6B, hours dial 610c, minutes dial 610b, and seconds dial 610a are displayed at respective sizes that, for example, fit entirely within time user interface 608 and/or touch-sensitive display 602. In some embodiments, time user interface 608 includes one or more expanded states in which seconds dial 610a and/or minutes dial 610b are expanded to larger respective sizes than their respective collapsed sizes. In some embodiments, in the one or more expanded states, seconds dial 610a and/or minutes dial 610b is expanded to a larger size such that at least a portion of seconds dial 610a and/or minutes dial 610b extends beyond touch-sensitive display 602. Various examples of these expanded states will be described below and depicted in later figures.

At FIG. 6C, in response to detecting user input 616e in FIG. 6B, computer system 600 displays an animation in which time user interface 608 is transitioned from a collapsed state to a first expanded state. In the expanded state, seconds dial 610a is expanded from a first collapsed size to a first expanded size that is larger than the first collapsed size. In FIG. 6C, in response to detecting user input 616e, computer system 600 displays an animation in which seconds dial 610a is shown gradually expanding from the first collapsed size to the first expanded size, such that in FIG. 6C, seconds dial 610a is shown at an intermediate size that is between the first collapsed size and the first expanded size. In FIG. 6D, the animation completes such that in FIG. 6D, seconds dial 610a is shown at the first expanded size. In some embodiments, the animation depicted in FIG. 6B to FIG. 6C to FIG. 6D shows seconds dial 610a increasing in size more gradually than shown in these three figures (e.g., with additional intermediate sizes of seconds dial 610a between FIG. 6B, FIG. 6C, and FIG. 6D). In FIG. 6D, it can be seen that as seconds dial 610a is expanded to its first expanded size, additional number indications are added to seconds dial 610a. For example, in FIG. 6B and FIG. 6C, seconds dial 610a was shown with numbers every five seconds (e.g., 00, 5, 10, 15, 20, and so forth), but in FIG. 6D, in the first expanded state, seconds dial 610a is now shown with numbers indicating every second (e.g., 23, 24, 25, 26, 27, 28, 29, 30, 31, 32, and 33 in FIG. 6D). Furthermore, in FIGS. 6C and 6D, it can be seen that when time user interface 608 is expanded from the collapsed state (e.g., FIG. 6B) to the first expanded state (e.g., FIG. 6D), complications 614b-614d are no longer displayed, while complication 614a continues to be displayed. In some embodiments, this is done so that the additional complications do not overlap with the now-expanded seconds dial 610a. In some embodiments, in the first expanded state, complication 614a is moved to different positions around time user interface 608 so that it does not intersect seconds dial 610a as seconds dial 610a moves around time user interface 608, as will be described in greater detail below. FIG. 6D depicts computer system 600 detecting user input 620, which is a rotational input of crown 604a. In some embodiments, while time user interface 608 is displayed in the first expanded state, a user is able to modify the size of seconds dial 610a by rotating crown 604a. For example, in some embodiments, computer system 600 gradually expands seconds dial 610a in response to rotation of crown 604a in a first direction (e.g., gradually expanding seconds dial 610a in response to further rotation in the first direction until a maximum size is reached), and computer system 600 gradually shrinks or collapses seconds dial 610a in response to rotation of crown 604a in a second direction (e.g., gradually shrinking seconds dial 610a in response to further rotation in the second direction until a minimum size is reached).

Returning to FIG. 6C, portion 610a-1 of seconds dial 610a extends beyond touch-sensitive display 602 and is not displayed and/or is not visible to a user. Additionally, during the expansion animation, seconds dial 610a is displayed expanding away from the position on seconds dial 610a that corresponds to the current time in seconds. For example, in FIG. 6C, seconds hand 612a is displayed at a position and/or angle that indicates that the current time in seconds is 26 seconds (e.g., the time is 10:09:26). In FIG. 6C, computer system 600 displays seconds dial 610a at a position in time user interface 608 such that the position on seconds dial 610a corresponding to the current time in seconds (e.g., the 26-second position on seconds dial 610a) intersects seconds hand 612a and is perpendicular to seconds hand 612a. As seconds hand 612a continues moving in a clockwise direction (e.g., as represented by arrow 612a-1), seconds dial 610a is moved in a generally counter-clockwise direction (e.g., as indicated by arrow 618a) so that the correct position of seconds dial 610a intersects seconds hand 612a and is perpendicular to seconds hand 612a to correctly indicate the current time in seconds. Although movement of seconds dial 610a is described as including movement in a counter-clockwise direction, in various embodiments, and in the depicted embodiments, seconds dial 610a is translated and/or shifted around time user interface 608 without rotation and without zooming of seconds dial 610a. In FIG. 6D, approximately one second has passed from FIG. 6C, and computer system 600 has moved seconds hand 612a in a clockwise direction to indicate the passage of one second, and has also slightly shifted seconds dial 610a so that the 27-second position of seconds dial 610a intersects and is perpendicular to seconds hand 612. At FIG. 6E, approximately eight seconds have passed from FIG. 6D, such that the time is now 10:09:35, and computer system 600 displays seconds hand 612a at a position and/or angle that corresponds to 35 seconds, and has also moved seconds dial 610a in a generally counter-clockwise direction so that the position on seconds dial 610a that corresponds to 35 seconds (e.g., the 35-second position of seconds dial 610a) is now displayed, and intersects and is perpendicular to seconds hand 612a.

At FIG. 6F, approximately eight seconds have passed from FIG. 6E, such that the time is now 10:09:43, and computer system 600 displays seconds hand 612a at a position and/or angle that corresponds to 43 seconds, and has also moved seconds dial 610a in a generally counter-clockwise direction so that the position on seconds dial 610a that corresponds to 43 seconds (e.g., the 43-second position of seconds dial 610a) is now displayed, and intersects and is perpendicular to seconds hand 612a. Additionally, at FIG. 6F, computer system 600 moves complication 614a from the top left corner of time user interface 608 to the top right corner of time user interface 608 so that complication 614a will not intersect and/or overlap with seconds dial 610a. In some embodiments, complication 610a is moved to a few discrete locations in time user interface 608 to avoid overlap with seconds dial 610a and/or minutes dial 610b. For example, in some embodiments, complication 610a is only displayed at the corners of time user interface 608 and is displayed jumping from corner to corner over time. In some embodiments, time user interface 608 is gradually moved around time user interface 608 (e.g., every second, every half second, every quarter second, or every tenth second) in smaller increments so that time user interface 608 gradually traverses a circular path, a square path, or other path around time user interface 608 as seconds dial 610a (and/or, in some embodiments, minutes dial 610b) moves around time user interface 608.

At FIG. 6G, approximately two seconds have passed from FIG. 6F, such that the time is now 10:09:45, and computer system 600 displays seconds hand 612a at a position and/or angle that corresponds to 45 seconds, and computer system 600 has also moved seconds dial 610a in a generally counter-clockwise direction so that the position on seconds dial 610a that corresponds to 45 seconds (e.g., the 45-second position of seconds dial 610a) now intersects and is perpendicular to seconds hand 612a. At FIG. 6G, computer system 600 detects user input 622 (e.g., a tap input) on time indication 610.

At FIG. 6G-1, in response to detecting user input 622, computer system 600 displays an animation in which time user interface 608 is transitioned from the first expanded state to a second expanded state. In the second expanded state, minutes dial 610b is expanded from a second collapsed size to a second expanded size that is larger than the second collapsed size, while seconds dial 610a is maintained at the first expanded size. In FIG. 6G-1, in response to detecting user input 622, computer system 600 displays an animation in which minutes dial 610b is shown gradually expanding from the second collapsed size to the second expanded size, such that in FIG. 6G-1, minutes dial 610b is shown at an intermediate size that is between the second collapsed size and the second expanded size. In FIG. 6H, the animation completes such that in FIG. 6H, minutes dial 610b is shown at the second expanded size. In some embodiments, the animation depicted in FIG. 6G to FIG. 6G-1 to FIG. 6H shows minutes dial 610b increasing in size more gradually than shown in these three figures (e.g., with additional intermediate sizes of minutes dial 610b between FIG. 6G, FIG. 6G-1, and FIG. 6H). In FIG. 6H, it can be seen that as minutes dial 610b is expanded to the second expanded size, additional number indications are added to minutes dial 610B. For example, in FIG. 6G and FIG. 6G-1, minutes dial 610b was shown with numbers every five seconds (e.g., 00, 5, 10, 15, 20, and so forth), but in FIG. 6H, in the second expanded state of time user interface 608, minutes dial 610b is now shown with numbers indicating every minutes (e.g., 58, 59, 00, 1, 2, 3, 4, 5, 6, 7, 8, and so forth in FIG. 6H). In FIG. 6G-1 and FIG. 6H, complication 614a continues to be displayed within time user interface 608. In some embodiments, in the second expanded state, like the first expanded state, complication 614a is moved to different positions around time user interface 608 so that it does not intersect seconds dial 610a and/or minutes dial 610b as seconds dial 610a and minutes dial 610b move around time user interface 608.

FIG. 6H depicts computer system 600 detecting user input 624, which is a rotational input of crown 604a. In some embodiments, while time user interface 608 is displayed in the second expanded state, a user is able to modify the size of seconds dial 610a and/or minutes dial 610b by rotating crown 604a. For example, in some embodiments, computer system 600 gradually expands seconds dial 610a and/or minutes dial 610b in response to rotation of crown 604a in a first direction (e.g., gradually expanding seconds dial 610a and/or minutes dial 610b in response to further rotation in the first direction until a maximum size is reached), and computer system 600 gradually shrinks or collapses seconds dial 610a and/or minutes dial 610b in response to rotation of crown 604a in a second direction (e.g., gradually shrinking seconds dial 610a and/or minutes dial 610b in response to further rotation in the second direction until a minimum size is reached). In some embodiments, while time user interface 608 is displayed in the second expanded state, rotation of crown 604a changes the size of only minutes dial 610b and does not change the size of seconds dial 610a. In some embodiments, while time user interface 608 is displayed in the second expanded state, rotation of crown 604a changes the size of only seconds dial 610a and does not change the size of minutes dial 610b. In some embodiments, while time user interface 608 is displayed in the second expanded state, rotation of crown 604a changes the sizes of both seconds dial 610a and minutes dial 610b.

Returning to FIG. 6G-1, portion 610b-1 of minutes dial 610b extends beyond touch-sensitive display 602 and is not displayed and/or is not visible to a user. Additionally, during the expansion animation of minutes dial 610b, similar to the expansion animation of seconds dial 610a discussed above, minutes dial 610b is displayed expanding away from the position on minutes dial 610b that corresponds to the current time in minutes. For example, in FIG. 6G-1, minutes hand 612b is displayed at a position and/or angle that indicates that the current time in minutes is 10 minutes (e.g., the time is 10:10:45). In FIG. 6G-1, computer system 600 displays minutes dial 610b at a position in time user interface 608 such that the position on minutes dial 610b corresponding to the current time in minutes (e.g., the 10-minute position on minutes dial 610b) intersects minutes hand 612b and is perpendicular to minutes hand 612b. As minutes hand 612b continues moving in a clockwise direction (e.g., as represented by arrow 612b-1), minutes dial 610b is moved in a generally counter-clockwise direction (e.g., as indicated by arrow 618b) so that the correct position of minutes dial 610b intersects minutes hand 612b and is perpendicular to minutes hand 612b to correctly indicate the current time in minutes. While movement of minutes dial 610b is described as being in a generally counter-clockwise direction, in various embodiments, and in the depicted embodiments, minutes dial 610b is shifted, translated, and/or moved without rotation and without zooming of minutes dial 610b. It will be appreciated that, in various embodiments, minutes dial 610b is moved at a rate that is slower than the speed of movement of seconds dial 610a due, at least in part, to minutes hand 612b moving at a rate that is slower than seconds hand 612a.

At FIG. 6H, animation of time user interface 608 to the second expanded state and minutes dial 610b to the second expanded size is complete. In some embodiments, the second expanded size is smaller than the first expanded size, such that minutes dial 610b at the second expanded size is smaller than seconds dial 610a at the first expanded size. At FIG. 6H, the current time is 10:09:50. Accordingly, computer system 600 displays minutes dial 610b at a position in time user interface 608 such that minutes hand 612b intersects minutes dial 610b at the 9-minute position of minutes dial 610b; and computer system 600 displays seconds dial 610a at a position in time user interface 608 such that seconds hand 612a intersects seconds dial 610a at the 50-second position of seconds dial 610a. Additionally, at FIG. 6H, computer system 600 displays complication 614a in the bottom left corner of time user interface 608 based on the current time and/or based on a determination that the bottom left corner of time user interface 608 does not intersect and/or overlap seconds dial 610a and/or minutes dial 610b.

At FIG. 6I, the time is now 10:25:12. Accordingly, computer system 600 displays minutes dial 610b at a position in time user interface 608 such that minutes hand 612b intersects minutes dial 610b at the 25-minute position of minutes dial 610b; and computer system 600 displays seconds dial 610a at a position in time user interface 608 such that seconds hand 612a intersects seconds dial 610a at the 12-second position of seconds dial 610a. Additionally, at FIG. 6I, computer system 600 displays complication 614a in the top left corner of time user interface 608 based on the current time and/or based on a determination that the top left corner of time user interface 608 does not intersect and/or overlap seconds dial 610a and/or minutes dial 610b.

At FIG. 6J, the time is now 10:45:45. Accordingly, computer system 600 displays minutes dial 610b at a position in time user interface 608 such that minutes hand 612b intersects minutes dial 610b at the 45-minute position of minutes dial 610b; and computer system 600 displays seconds dial 610a at a position in time user interface 608 such that seconds hand 612a intersects seconds dial 610a at the 45-second position of seconds dial 610a. Additionally, at FIG. 6J, computer system 600 displays complication 614a in the top right corner of time user interface 608 based on the current time and/or based on a determination that the top right corner of time user interface 608 does not intersect and/or overlap seconds dial 610a and/or minutes dial 610b.

At FIG. 6K, the time is now 10:53:52. Accordingly, computer system 600 displays minutes dial 610b at a position in time user interface 608 such that minutes hand 612b intersects minutes dial 610b at the 53-minute position of minutes dial 610b; and computer system 600 displays seconds dial 610a at a position in time user interface 608 such that seconds hand 612a intersects seconds dial 610a at the 52-second position of seconds dial 610a. Additionally, at FIG. 6K, computer system 600 displays complication 614a in the bottom right corner of time user interface 608 based on the current time and/or based on a determination that the bottom right corner of time user interface 608 does not intersect and/or overlap seconds dial 610a and/or minutes dial 610b. At FIG. 6K, computer system 600 detects user input 626 (e.g., a tap input) on time indication 610.

At FIG. 6L, in response to detecting user input 626, computer system 600 displays an animation in which time user interface 608 transitions from the second expanded state to the collapsed state of time user interface 608. In FIG. 6L, computer system 600 displays minutes dial 610b gradually decreasing in size from the second expanded size to the second collapsed size, and seconds dial 610a gradually decreasing in size from the first expanded size to the first collapsed size. In some embodiments, during the animation, the position of minutes dial 610b relative to minutes hand 612b is maintained in order to continue displaying the correct time in minutes (e.g., minutes hand 612b continues to intersect the correction position of minutes dial 610b to indicate the correct time in minutes throughout the animation). In some embodiments, during the animation, the position of seconds dial 610a relative to seconds hand 612a is maintained in order to continue displaying the correct time in seconds (e.g., seconds hand 612a continues to intersect the correction position of seconds dial 610a to indicate the correct time in seconds throughout the animation). Additionally, in some embodiments, during the animation, no complications are displayed within time user interface 608.

At FIG. 6M, the animation has completed such that time user interface 608 is now displayed in the contracted state described above with reference to FIG. 6A. At FIG. 6M, while time user interface 608 is displayed in the contracted state, computer system 600 displays complications 614a-614b.

In some embodiments, a user is able to choose and/or define a default state for time user interface 608 (e.g., the collapsed state, the first expanded state, or the second expanded state). In FIG. 6N, computer system 600 displays, via touch-sensitive display 602, user interface 628. User interface 628 includes option 628a which, when selected, defines the collapsed state of time user interface 608 (labeled “CLOSED” in FIG. 6N) as the default state for time user interface 608; option 628b which, when selected, defines the first expanded state of time user interface 608 (labeled “EXPANDED I” in FIG. 6N) as the default state for time user interface 608; and option 628c which, when selected, defines the second expanded state of time user interface 608 (labeled “EXPANDED II” in FIG. 6N) as the default state for time user interface 608. In some embodiments, computer system 600 automatically returns time user interface 608 to its default state when certain criteria are met. For example, in some embodiments, computer system 600 automatically returns time user interface 608 to its default state when user input has not been received for a threshold duration of time.

FIG. 60 depicts three example scenarios. In the top row of FIG. 60, the collapsed state of time user interface 608 (labeled “CLOSED” in FIG. 6O) has been selected as the default state for time user interface 608. In some embodiments, computer system 600 transitions from the collapsed state (labeled (a) in FIG. 6O) to the first expanded state (labeled (b) in FIG. 6O) in response to detecting a tap input (e.g., user input 632a) directed to time indication 610. In some embodiments, computer system 600 transitions from the first expanded state (labeled (b) in FIG. 6O) to the second expanded state (labeled (c) in FIG. 6O) in response to detecting a tap input (e.g., user input 632b) directed to time indication 610. In some embodiments, computer system 600 transitions from the second expanded state (labeled (c) in FIG. 6O) to the collapsed state (labeled (a) in FIG. 6O) in response to detecting a tap input (e.g., user input 632c) directed to time indication 610. In some embodiments, computer system 600 automatically transitions computer system 600 to the default state which, in the top row of FIG. 6O, is the collapsed state labeled (a), when certain criteria are met (e.g., user input has not been detected for a threshold duration of time and/or computer system enters a locked state). In some embodiments, complications are only displayed when the default state of time user interface 608 is displayed, such that in the top row of FIG. 6O, complications are not displayed when time user interface 608 is in the first expanded state (b) or when time user interface 608 is in the second expanded state (c).

In the middle row of FIG. 60, the first expanded state of time user interface 608 (labeled “EXPANDED I” in FIG. 6O) has been selected as the default state for time user interface 608. In some embodiments, computer system 600 transitions from the first expanded state (labeled (d) in FIG. 6O) to the second expanded state (labeled (e) in FIG. 6O) in response to detecting a tap input (e.g., user input 632d) directed to time indication 610. In some embodiments, computer system 600 transitions from the second expanded state (labeled (e) in FIG. 6O) to the collapsed state (labeled (f) in FIG. 6O) in response to detecting a tap input (e.g., user input 632e) directed to time indication 610. In some embodiments, computer system 600 transitions from the collapsed state (labeled (f) in FIG. 6O) to the first expanded state (labeled (d) in FIG. 6O) in response to detecting a tap input (e.g., user input 632f) directed to time indication 610. In some embodiments, computer system 600 automatically transitions computer system 600 to the default state which, in the middle row of FIG. 6O, is the first expanded state labeled (d), when certain criteria are met (e.g., user input has not been detected for a threshold duration of time and/or computer system enters a locked state). In some embodiments, complications are only displayed when the default state of time user interface 608 is displayed, such that in the middle row of FIG. 6O, complications are not displayed when time user interface 608 is in the second expanded state (e) or when time user interface 608 is in the collapsed state (f).

In the bottom row of FIG. 60, the second expanded state of time user interface 608 (labeled “EXPANDED II” in FIG. 6O) has been selected as the default state for time user interface 608. In some embodiments, computer system 600 transitions from the second expanded state (labeled (g) in FIG. 6O) to the collapsed state (labeled (h) in FIG. 6O) in response to detecting a tap input (e.g., user input 632g) directed to time indication 610. In some embodiments, computer system 600 transitions from the collapsed state (labeled (h) in FIG. 6O) to the first expanded state (labeled (i) in FIG. 6O) in response to detecting a tap input (e.g., user input 632h) directed to time indication 610. In some embodiments, computer system 600 transitions from the first expanded state (labeled (i) in FIG. 6O) to the second expanded state (labeled (g) in FIG. 6O) in response to detecting a tap input (e.g., user input 632i) directed to time indication 610. In some embodiments, computer system 600 automatically transitions computer system 600 to the default state which, in the bottom row of FIG. 6O, is the second expanded state labeled (g), when certain criteria are met (e.g., user input has not been detected for a threshold duration of time and/or computer system enters a locked state). In some embodiments, complications are only displayed when the default state of time user interface 608 is displayed, such that in the bottom row of FIG. 6O, complications are not displayed when time user interface 608 is in the collapsed state (h) or when time user interface 608 is in the first expanded state (i).

In some embodiments, computer system 600 provides various color options for time user interface 608 that are selectable by a user. At FIG. 6P, computer system 600 displays user interface 634, which includes various options for modifying time user interface 608. User interface 608 includes preview 634a which allows the user to see a preview of time user interface 608 with the currently selected options. User interface 634 includes section options 636a, 636b, 636c, which allow a user to go to different sections of user interface 634. In FIG. 6P, color section 636b is selected and, accordingly, user interface 634 includes a plurality of color options 638a-638i for time user interface 608. In some embodiments, seconds hand 612a and seconds dial 610a are displayed in a first color (e.g., are displayed in the same color as each other) and minutes hand 612b and minutes dial 612b are displayed in a second color different from the first color. User interface 634 and options 638a-638i allow a user to select the first color (e.g., for the seconds hand and seconds dial) and the second color (e.g., for the minutes hand and the minutes dial). In some embodiments, hours hand 612c and hours dial 610c are displayed in a third color different from the first color and the second color, and user interface 634 also includes options for selecting the third color. In some embodiments, a user is able to scroll through the different color options 638a-638i via rotation of crown 604a (e.g., user input 642a), and is able to select a particular color option 638a-638i via a press of crown 604a (e.g., user input 642b). In some embodiments, as a user scrolls through different color options 638a-638i (e.g., via rotational input 642a), preview 634a is updated to display a preview of the different color options applied to time user interface 608. At FIG. 6P, computer system 600 detects user input 642c, which is a swipe left input via touch-sensitive display 602.

At FIG. 6Q, in response to detecting user input 642c, computer system 600 displays a “background” section of user interface 634. In some embodiments, computer system 600 provides various background color options for time user interface 608 that are selectable by a user. At FIG. 6Q, user interface 634 includes white background option 644a which, when selected, applies a white background to time user interface 608; and black background option 644b which, when selected, applies a black background to time user interface 608. In some embodiments, a user is able to scroll through the different background color options 644a-644b via rotation of crown 604a (e.g., user input 648a), and is able to select a particular background color option 644a-644b via a press of crown 604a (e.g., user input 648b). In some embodiments, as a user scrolls through different background color options 644a-644b (e.g., via rotational input 648a), preview 634a is updated to display a preview of the background color options applied to time user interface 608.

At FIG. 6R, computer system 600 displays time user interface 608 in the second expanded state in which seconds dial 610a and minutes dial 610b are both shown at larger, expanded sizes. At FIG. 6R, user 650 is wearing computer system 600 on her wrist. At FIG. 6R, user 650 lowers her wrist and computer system 600 detects wrist lowering gesture 652a. In some embodiments, when computer system 600 detects a wrist lowering gesture, computer system 600 enters a low power mode. In some embodiments, in the low power mode, computer system 600 consumes less power than in a higher power (or lower latency) mode. In some embodiments, when computer system 600 is operating in the low power mode, computer system 600 decreases the frequency at which touch-sensitive display 602 is updated (e.g., compared to the higher power mode) and/or decreases a brightness of touch-sensitive display 602 (e.g., compared to the higher power mode). In some embodiments, when computer system 600 transitions from the higher power mode to the low power mode, computer system 600 automatically transitions time user interface from the second expanded state and/or the first expanded state to the collapsed state.

At FIG. 6S, in response to detecting wrist lowering gesture 652a, computer system 600 transitions from the higher power mode to the low power mode and transitions time user interface 608 from the second expanded state to the collapsed state. At FIG. 6S, computer system 600 detects wrist raising gesture 652b. In some embodiments, in response to detecting wrist raising gesture 652b, computer system 600 transitions from the low power mode to the higher power mode, and transitions time user interface 608 from the collapsed state to the second expanded state (e.g., returning to the state shown in FIG. 6R). In some embodiments, in response to detecting wrist raising gesture 652b and/or when transitioning from the low power mode to the higher power mode, computer system 600 transitions time user interface 608 from the collapsed state to a default state (which, in various embodiments, can be the collapsed state, the first expanded state, or the second expanded state) and/or transitions time user interface 608 to the state of time user interface 608 immediately prior to wrist lower gesture 652a and/or immediately prior to transitioning to the low power mode.

FIG. 7 is a flow diagram illustrating a method for providing time user interfaces using a computer system in accordance with some embodiments. Method 700 is performed at a computer system (e.g., 100, 300, 500, and/or 600) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 602) (e.g., a display controller, a display, a touch-sensitive display system, a touchscreen, a monitor, and/or a head mounted display system) (and, optionally, with one or more input devices (e.g., a touch-sensitive surface, a physical button, a rotatable input mechanism, a rotatable and depressible input mechanism, a motion sensor, an accelerometer, a gyroscope, a keyboard, a controller, and/or a mouse)). Some operations in method 700 are, optionally, combined, the orders of some operations are, optionally, changed, and some operations are, optionally, omitted.

As described below, method 700 provides an intuitive way for providing time user interfaces. The method reduces the cognitive burden on a user for accessing time information and/or time user interfaces, thereby creating a more efficient human-machine interface. For battery-operated computing devices, enabling a user to access time user interfaces and/or time information faster and more efficiently conserves power and increases the time between battery charges.

The computer system (e.g., 600) displays (702), via the one or more display generation components (e.g., 602), a time user interface (e.g., 608) (e.g., a user interface that includes an analog and/or digital indication of time, a clock face user interface, a watch face user interface, a reduced-power screen, a wake screen, and/or a lock screen), wherein: the time user interface includes an indication of a respective time (e.g., 610, 610a, 610b, 610c, 612a, 612b, and/or 612c) (e.g., an analog and/or digital indication of a current time, past time, or future time) (704); the time user interface includes a first dial (e.g., 610a, 610b, and/or 610c) that is used to indicate the respective time (e.g., a first dial that is part of the indication of time; a seconds dial; a minutes dial; and/or an hours dial that, in combination with a position indicator such as a clock hand or other object, indicates the respective time) (706); and displaying the time user interface includes displaying the first dial moving from a first position of the time user interface to a second position of the time user interface different from the first position as the respective time changes (708) (e.g., as the current time, past time, or future time changes over a period of time from a first time to a second time) (e.g., in FIGS. 6D-6G, seconds dial 610a is seen moving to different areas of time user interface 108; and in FIGS. 6H-6K, seconds dial 610a and minutes dial 610b are seen moving to different areas of time user interface 108). In some embodiments, the first dial moves continuously as time progresses. In some embodiments, the one or more display generation components are updated and/or refreshed at a first refresh rate, and the first dial is moved and/or the position of the first dial is changed and/or updated at the first refresh rate (e.g., the first dial moves each time the one or more display generation components are updated and/or refreshed). In some embodiments, the first dial extends outside of a display region of the one or more display generation components. In some embodiments, displaying the time user interface includes displaying, at a first time, a first portion of the first dial at the first position of the time user interface (e.g., without displaying a second portion of the first dial) and displaying, at a second time subsequent to the first time, a second portion of the first dial different from the first portion at the second position of the time user interface (e.g., without displaying the first portion of the first dial). Displaying a time user interface that includes a first dial that moves and/or changes position over time as the respective time changes provides the user with an indication of time without the need for user input. Furthermore, in various embodiments, moving the first dial from the first position to the second position as the respective time changes allows for more detailed time information to be displayed within limited display space, thereby providing the user with more useful information within a limited amount of display space and improving the efficiency of utilization of limited display space.

In some embodiments, the time user interface (e.g., 608) includes a first clock hand (e.g., 612a, 612b, and/or 612c) corresponding to the first dial (e.g., 610a, 610b, and/or 610c) (e.g., a first clock hand that, in combination with the first dial, indicates the respective time and/or at least a portion of the respective time; a seconds hand; a minutes hand; and/or an hour hand). In some embodiments, displaying the time user interface further includes: displaying, via the one or more display generation components (e.g., 602), the first clock hand (e.g., 612a, 612b, and/or 612c) moving from a first clock hand position to a second clock hand position different from the first clock hand position as the first dial (e.g., 610a, 610b, and/or 610c) moves from the first position of the time user interface to the second position of the time user interface (e.g., in some embodiments, displaying the first clock hand moving from the first clock hand position to the second clock hand position concurrently with the first dial moving from the first position of the time user interface to the second position of the time user interface) (e.g., in FIGS. 6D-6G, seconds hand 612a moves to different positions as seconds dial 610a also moves to different positions). In some embodiments, the position of the first dial changes as a position of a corresponding clock hand changes. Displaying a time user interface that includes a first dial and a first clock hand that move and/or change positions over time as the respective time changes provides the user with an indication of time without the need for user input. Furthermore, in various embodiments, moving the first dial from the first position to the second position and/or moving the first clock hand from the first clock hand position to the second clock hand position as the respective time changes allows for more detailed time information to be displayed within limited display space, thereby providing the user with more useful information within a limited amount of display space and improving the efficiency of utilization of limited display space.

In some embodiments, the first dial (e.g., 610a, 610b, and/or 610c) has a first curve (e.g., a first curve having a first degree of curvature; and/or a first curve having a first curve radius). In some embodiments, the first dial is a circle that has a first degree of curvature and/or a first curve radius. In some embodiments, the first clock hand (e.g., 612a, 612b, and/or 612c) is perpendicular to at least a portion of the first curve (e.g., a portion of the first curve that the first clock hand intersects and/or that the first clock hand would intersect if extended) (e.g., seconds hand 612a is perpendicular to seconds dial 610a at a point of intersection; and/or minutes hand 612b is perpendicular to minutes dial 610b at a point of intersection). In some embodiments, the first clock hand remains perpendicular to at least a portion of the first dial and/or the first curve as it moves from the first clock hand position to the second clock hand position. In some embodiments, the first clock hand does not intersect the first dial and/or the first curve, but is oriented in a direction that is perpendicular to at least a portion of the first dial and/or the first curve (e.g., if the first clock hand was extended). Displaying a time user interface that includes a first dial and a first clock hand that move and/or change positions over time as the respective time changes provides the user with an indication of time without the need for user input. Furthermore, in various embodiments, moving the first dial from the first position to the second position and/or moving the first clock hand from the first clock hand position to the second clock hand position as the respective time changes allows for more detailed time information to be displayed within limited display space, thereby providing the user with more useful information within a limited amount of display space and improving the efficiency of utilization of limited display space. Furthermore, maintaining a consistent orientation between the first clock hand and the first dial as both the first clock hand and the first dial move allows for a user to view relevant information (e.g., about the respective time) more quickly and efficiently. This enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, displaying the first dial (e.g., 610a, 610b, and/or 610c) moving from the first position of the time user interface (e.g., 608) to the second position of the time user interface as the respective time changes comprises displaying movement of the first dial from the first position of the time user interface to the second position of the time user interface without displaying rotation of the first dial and without displaying zooming of the first dial (e.g., without rotating the first dial and without changing the zoom of the first dial) (e.g., in FIGS. 6D-6G, seconds dial 610a is moved without rotation and without zooming). In some embodiments, displaying the first clock hand (e.g., 612a, 612b, and/or 612c) moving from the first clock hand position to the second clock hand position comprises displaying the first clock hand moving from the first clock hand position to the second clock hand position while maintaining an orientation of the first clock hand relative to the first dial (e.g., while maintaining a consistent angle between the first clock hand and the first dial and/or keeping the first clock hand perpendicular to the first dial) (e.g., from FIGS. 6D-6G, seconds hand 612a remains perpendicular relative to a point of intersection of seconds dial 610a as seconds hand 612a and seconds dial 610a move around time user interface 608 such that seconds hand 612a and seconds dial 610a continue to correctly indicate the current time in seconds even as they move around time user interface 608). Displaying a time user interface that includes a first dial and a first clock hand that move and/or change positions over time as the respective time changes provides the user with an indication of time without the need for user input. Furthermore, in various embodiments, moving the first dial from the first position to the second position and/or moving the first clock hand from the first clock hand position to the second clock hand position as the respective time changes allows for more detailed time information to be displayed within limited display space, thereby providing the user with more useful information within a limited amount of display space and improving the efficiency of utilization of limited display space. Furthermore, maintaining a consistent orientation between the first clock hand and the first dial as both the first clock hand and the first dial move allows for a user to view relevant information (e.g., about the respective time) more quickly and efficiently. This enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, the first clock hand (e.g., 612a, 612b, and/or 612c) and the first dial (e.g., 610a, 610b, and/or 610c) both include a first color. In some embodiments, the first clock hand and the first dial are displayed in the same color. In some embodiments, the time user interface includes a second dial separate from the first dial, wherein the second dial is used to indicate the respective time (e.g., a second dial that is part of the indication of time, a seconds dial, a minutes dial, and/or an hours dial that, in combination with a position indicator such as a clock hand or other object, indicates the respective time). In some embodiments, the time user interface includes a second clock hand that corresponds to the second dial and is separate from the first clock hand (e.g., a second clock hand that, in combination with the second dial, indicates the respective time and/or at least a portion of the respective time). In some embodiments, the second clock hand and the second dial are displayed in and/or include a second color different from the first color. For example, in some embodiments, the seconds hand and the seconds dial are displayed in the same color, and the minutes hand and the minutes dial are displayed in the same color, but a color that is different from the seconds hand and the seconds dial. Displaying a time user interface that includes a first dial and a first clock hand that move and/or change positions over time as the respective time changes provides the user with an indication of time without the need for user input. Furthermore, in various embodiments, moving the first dial from the first position to the second position and/or moving the first clock hand from the first clock hand position to the second clock hand position as the respective time changes allows for more detailed time information to be displayed within limited display space, thereby providing the user with more useful information within a limited amount of display space and improving the efficiency of utilization of limited display space. Furthermore, displaying the first clock hand and the first dial in the same color allows for a user to view relevant information (e.g., about the respective time) more quickly and efficiently. This enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, the first dial (e.g., 610a, 610b, and/or 610c) includes a plurality of time division indicators (e.g., a plurality of tick marks representing units of time and/or a plurality of tick marks that represent different times); the first clock hand (e.g., 612a, 612b, and/or 612c) overlaps the first dial (e.g., the first clock hand extends to the first dial; the first clock hand extends over the first dial; and/or the first clock hand extends beyond the first dial); and the first clock hand is at least partially translucent such that one or more time division indicators of the plurality of time division indicators is visible through the first clock hand. Displaying a time user interface that includes a first dial and a first clock hand that move and/or change positions over time as the respective time changes provides the user with an indication of time without the need for user input. Furthermore, in various embodiments, moving the first dial from the first position to the second position and/or moving the first clock hand from the first clock hand position to the second clock hand position as the respective time changes allows for more detailed time information to be displayed within limited display space, thereby providing the user with more useful information within a limited amount of display space and improving the efficiency of utilization of limited display space.

In some embodiments, the time user interface (e.g., 608) includes a second dial (e.g., 610a, 610b, and/or 610c) that is different from the first dial and that is used to indicate the respective time (e.g., a second dial that is part of the indication of time; a seconds dial; a minutes dial; and/or an hours dial that, in combination with the first dial and/or one or more position indicators such as a clock hand or other object, indicates the respective time); and displaying the time user interface further includes displaying the second dial moving from a third position of the time user interface to a fourth position of the time user interface different from the third position as the respective time changes (e.g., as the current time, past time, or future time changes over a period of time from a first time to a second time) (e.g., in FIGS. 6H-6K, both seconds dial 610a and minutes dial 610b move to different regions of time user interface 608 as time progresses). In some embodiments, the computer system (e.g., 600) displays the second dial moving from the third position of the time user interface to the fourth position of the time user interface while also displaying the first dial moving from the first position of the time user interface to the second position of the time user interface. Displaying a time user interface that includes a first dial and a second dial that move and/or change positions over time as the respective time changes provides the user with an indication of time without the need for user input. Furthermore, in various embodiments, moving the first dial from the first position to the second position and moving the second dial from the third position to the fourth position as the respective time changes allows for more detailed time information to be displayed within limited display space, thereby providing the user with more useful information within a limited amount of display space and improving the efficiency of utilization of limited display space.

In some embodiments, the computer system (e.g., 600) displays, via the one or more display generation components (e.g., 602), and at a first time, the first dial overlapping the second dial (e.g., FIG. 6I, seconds dial 610a overlapping minutes dial 610b). Displaying a time user interface that includes a first dial and a second dial that move and/or change positions over time as the respective time changes provides the user with an indication of time without the need for user input. Furthermore, in various embodiments, moving the first dial from the first position to the second position and moving the second dial from the third position to the fourth position as the respective time changes allows for more detailed time information to be displayed within limited display space, thereby providing the user with more useful information within a limited amount of display space and improving the efficiency of utilization of limited display space.

In some embodiments, at a second time subsequent to the first time, the computer system concurrently displays, via the one or more display generation components (e.g., 602), the first dial and the second dial without the first dial overlapping the second dial (e.g., in FIG. 6J, seconds dial 610a does not overlap minutes dial 610b). Displaying a time user interface that includes a first dial and a second dial that move and/or change positions over time as the respective time changes provides the user with an indication of time without the need for user input. Furthermore, in various embodiments, moving the first dial from the first position to the second position and moving the second dial from the third position to the fourth position as the respective time changes allows for more detailed time information to be displayed within limited display space, thereby providing the user with more useful information within a limited amount of display space and improving the efficiency of utilization of limited display space.

In some embodiments, the time user interface (e.g., 608) includes a second dial (e.g., 610a, 610b, and/or 610c) that is different from the first dial (e.g., 610a, 610b, and/or 610c) and that is used to indicate the respective time (e.g., a second dial that is part of the indication of time; a seconds dial; a minutes dial; and/or an hours dial that, in combination with the first dial and/or one or more position indicators such as a clock hand or other object, indicates the respective time). In some embodiments, the computer system (e.g., 600) detects, via one or more input devices (e.g., 602, 604a, and/or 604b) (e.g., one or more input devices that are in communication with the computer system, a touch-sensitive surface, a physical button, a rotatable input mechanism, a rotatable and depressible input mechanism, a motion sensor, an accelerometer, a gyroscope, a keyboard, a controller, and/or a mouse), a first set of one or more user inputs (e.g., one or more touch inputs, one or more gesture inputs, one or more air gesture inputs, one or more spoken inputs, and/or one or more hardware control inputs) (e.g., 616e, 632a, 632f, and/or 632h) corresponding to a user request to display the time user interface in a first mode, wherein in the first mode, displaying the time user interface includes displaying the first dial changing positions (e.g., displaying the first dial moving) as the respective time changes without displaying the second dial changing positions as the respective time changes (e.g., in some embodiments, displaying the time user interface in the first mode includes concurrently displaying the first dial and the second dial, wherein the first dial changes positions as the respective time changes and the second dial is stationary and does not change positions as the respective time changes) (e.g., FIGS. 6D-6G; “EXPANDED I” in FIG. 6N; and/or scenarios (b), (d), and/or (i) in FIG. 60). In response to detecting the first set of one or more user inputs, the computer system (e.g., 600) displays, via the one or more display generation components (e.g., 602), the time user interface (e.g., 608) in the first mode (e.g., FIGS. 6D-6G; “EXPANDED I” in FIG. 6N; and/or scenarios (b), (d), and/or (i) in FIG. 6O). Subsequent to detecting the first set of one or more user inputs, the computer system detects, via the one or more input devices, a second set of one or more user inputs (e.g., 622, 632b, 632d, and/or 632i) (e.g., one or more touch inputs, one or more gesture inputs, one or more air gesture inputs, one or more spoken inputs, and/or one or more hardware control inputs) corresponding to a user request to display the time user interface in a second mode different from the first mode, wherein in the second mode, displaying the time user interface includes concurrently displaying the first dial changing positions (e.g., displaying the first dial moving) and displaying the second dial changing positions (e.g., displaying the second dial moving) as the respective time changes (e.g., FIGS. 6H-6K; “EXPANDED II” in FIG. 6N; and/or scenarios (c), (e), and/or (g) in FIG. 60). In response to detecting the second set of one or more user inputs, the computer system displays, via the one or more display generation components (e.g., 602), the time user interface in the second mode (e.g., FIGS. 6H-6K; “EXPANDED II” in FIG. 6N; and/or scenarios (c), (e), and/or (g) in FIG. 60). In some embodiments, the time user interface includes a third dial that is different from the first dial and the second dial, and that is used to indicate the respective time (e.g., a third dial that is part of the indication of time; a seconds dial; a minutes dial; and/or an hours dial that, in combination with the first dial, the second dial, and/or one or more position indicates such as a clock hand or other object, indicates the respective time). Displaying a time user interface that includes a first dial and a second dial that move and/or change positions over time as the respective time changes provides the user with an indication of time without the need for user input. Furthermore, in various embodiments, moving the first dial from the first position to the second position and moving the second dial from the third position to the fourth position as the respective time changes allows for more detailed time information to be displayed within limited display space, thereby providing the user with more useful information within a limited amount of display space and improving the efficiency of utilization of limited display space. Allowing the user to provide user input to switch between the first mode of the time user interface and the second mode of the time user interface enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, the first set of one or more user inputs includes at least a first subset of one or more user inputs that correspond to selection of a first mode option (e.g., “EXPANDED I” in FIG. 6N) that is displayed within a first user interface (e.g., 628) (e.g., a mode selection user interface and/or a time user interface editing user interface) that is different from the time user interface (e.g., 608). In some embodiments, the first mode option corresponds to the first mode of the time user interface (and, in some embodiments, does not correspond to the second mode of the time user interface). In some embodiments, the second set of one or more user inputs includes at least a second subset of one or more user inputs that correspond to selection of a second mode option (e.g., “EXPANDED II” in FIG. 6N) that is different from the first mode option and is displayed within the first user interface (e.g., 628). In some embodiments, the second mode option corresponds to the second mode of the time user interface (and, in some embodiments, does not correspond to the first mode of the time user interface). In some embodiments, the first user interface is a time user interface editing user interface that includes one or more options for editing one or more visual characteristics of the time user interface. Allowing the user to provide user input to switch between the first mode of the time user interface and the second mode of the time user interface enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, the first set of one or more user inputs is detected while displaying the time user interface (e.g., 608) and is directed to the time user interface (e.g., user inputs 616e, 632a, 632f, and/or 632h); and the second set of one or more user inputs is detected while displaying the time user interface and is directed to the time user interface (e.g., user inputs 622, 632b, 632d, and/or 632i). In some embodiments, the first set of one or more user inputs includes and/or is a tap input and/or a touch input directed to the time user interface. In some embodiments, the second set of one or more user inputs includes and/or is a tap input and/or a touch input directed to the time user interface. Allowing the user to provide user input to switch between the first mode of the time user interface and the second mode of the time user interface enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, prior to detecting the first set of one or more user inputs (e.g., user inputs 616e, 632a, 632f, and/or 632h), the computer system (e.g., 600) displays, via the one or more display generation components, the time user interface (e.g., 608) in a third mode different from the first mode and the second mode (e.g., FIG. 6A and/or 6B), wherein: in the third mode of the time user interface, the first dial is displayed outside of the second dial (e.g., the first dial surrounds the second dial, the first dial is larger than the second dial, and/or the second dial is contained within the first dial). In some embodiments, in the third mode, the first dial does not move as the respective time changes and the second dial does not move as the respective time changes. In some embodiments, in the third mode of the time user interface (e.g., 608), the first dial is displayed at a first size (e.g., 610a in FIG. 6A) and the second dial is displayed at a second size (e.g., 610b in FIG. 6A). In some embodiments, in the first mode of the time user interface, the first dial is displayed at a first expanded size that is larger than the first size (e.g., 610a in FIG. 6D) and the second dial is displayed at the second size (e.g., 610b in FIG. 6D). In some embodiments, in the second mode of the time user interface, the first dial is displayed at the first expanded size (e.g., 610a in FIG. 6H) and the second dial is displayed at a second expanded size that is larger than the second size (e.g., 610b in FIG. 6H). In some embodiments, while displaying the time user interface, the computer system detects, via the one or more input devices, a third set of one or more user inputs (e.g., one or more user inputs directed to the time user interface). In response to detecting the third set of one or more user inputs: in accordance with a determination that the time user interface was displayed in the third mode when the third set of one or more user inputs was detected (e.g., user input 616e detected while time user interface 608 is displayed in a collapsed state), the computer system displays, via the one or more display generation components, the first dial at the first expanded size (e.g., 610a in FIG. 6D) while maintaining display of the second dial at the second size (e.g., 610b in FIG. 6D) (e.g., displaying an animation of at least a portion of the first dial expanding from the first size to the first expanded size while maintaining display of the second dial at the second size); and in accordance with a determination that the time user interface was displayed in the first mode when the third set of one or more user inputs was detected (e.g., user input 622 detected while time user interface 608 is displayed in the first expanded state), the computer system displays, via the one or more display generation components, the second dial at the second expanded size (e.g., 610b in FIG. 6H) (e.g., in some embodiments, while maintaining display of the first dial at the first expanded size (e.g., 610b in FIG. 6H); and/or, in some embodiments, displaying an animation of at least a portion of the second dial expanding from the second size to the second expanded size). In some embodiments, an outer dial (e.g., the first dial) (e.g., 610a) is expanded before an inner dial (e.g., the second dial) (e.g., 610b) is expanded. In some embodiments, in response to detecting the third set of one or more user inputs: in accordance with a determination that the time user interface was displayed in the second mode when the third set of one or more user inputs was detected, the computer system displays the time user interface in the third mode (e.g., FIGS. 6K-6M). In some embodiments, in response to detecting the third set of one or more user inputs: in accordance with a determination that the time user interface was displayed in the second mode when the third set of one or more user inputs was detected, the computer system displays contraction of the first dial from the first expanded size to the first size and contraction of the second dial from the second expanded size to the second size (e.g., FIGS. 6K-6M). Allowing the user to provide user input to switch between the first mode of the time user interface and the second mode of the time user interface enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, in response to detecting the second set of one or more user inputs (e.g., 622, 632b, and/or 632d), the computer system displays, via the one or more display generation components, the second dial (e.g., 610b) expanding from a second respective size to a second respective expanded size that is larger than the second respective size (e.g., FIGS. 6G-6H; scenario (b) to scenario (c) in FIG. 6O; and/or scenario (d) to scenario (e) in FIG. 6O). Subsequent to detecting the second set of one or more user inputs: in accordance with a determination that first criteria are satisfied (e.g., in accordance with a determination that a threshold amount of time has elapsed after detecting the second set of one or more user inputs), the computer system automatically displays (e.g., without user input, without additional user input, and/or not in response to any user input), via the one or more display generation components, the second dial (e.g., 610b) at the second respective size (e.g., displaying an animation of at least a portion of the second dial shrinking from the second respective expanded size to the second respective size) (e.g., in some embodiments, computer system automatically goes from scenario (c) to scenario (a) and/or scenario (e) to scenario (d) in FIG. 60). In some embodiments, subsequent to detecting the second set of one or more user inputs: in accordance with a determination that the first criteria are not satisfied (e.g., a threshold amount of time has not elapsed after detecting the second set of one or more user inputs), the computer system maintains display of the second dial at the second respective expanded size. Automatically contracting a dial when first criteria are met (e.g., after a threshold duration of time) allows for such operations to be performed without user input. Doing so also enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, the first set of one or more user inputs (e.g., 616e) is detected while displaying the first dial (e.g., 610a) at a first size (and, optionally, concurrently displaying and/or also displaying the second dial at a second size) (e.g., FIG. 6B); the second set of one or more user inputs (e.g., 622) is detected while displaying the second dial (e.g., 610b) at a second size (e.g., FIG. 6G). In some embodiments, in response to detecting the first set of one or more user inputs (e.g., 616e), the computer system displays, via the one or more display generation components, the first dial at a first expanded size that is larger than the first size (e.g., in some embodiments, displaying an animation of at least a portion of the first dial expanding from the first size to the first expanded size, and, optionally, without displaying expansion of the second dial and/or without displaying the second dial changing in size) (e.g., 610a in FIG. 6D). In response to detecting the second set of one or more user inputs (e.g., 622), the computer system displays, via the one or more display generation components, the second dial (e.g., 610b) at a second expanded size that is larger than the second size (e.g., 610b in FIG. 6H) (e.g., in some embodiments, the computer system displays an animation of at least a portion of the second dial expanding from the second size to the second expanded size, and, optionally, while maintaining display of the first dial at the first expanded size and/or without displaying the first dial changing in size (e.g., FIGS. 6G-6H)). Allowing the user to provide user input to expand different dials of the time user interface enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, while displaying the time user interface (e.g., 608), including displaying the first dial (e.g., 610a and/or 610b) at a first expanded size, the computer system detects, via the one or more input devices, a third set of one or more user inputs 626) (e.g., one or more touch inputs, one or more gesture inputs, one or more air gesture inputs, one or more spoken inputs, and/or one or more hardware control inputs). In response to detecting the third set of one or more user inputs, the computer system displays, via the one or more display generation components, the first dial at a first size that is smaller than the first expanded size (e.g., 610a and/or 610b in FIGS. 6N) (e.g., in some embodiments, displaying an animation of at least a portion of the first dial contracting from the first expanded size to the first size). In some embodiments, displaying the time user interface (e.g., 608) includes displaying the second dial (e.g., 610a and/or 610b) at a second expanded size (e.g., FIG. 6K); and in response to detecting the third set of one or more user inputs (e.g., 626), the computer system displays, via the one or more display generation components, the second dial at a second size that is smaller than the second expanded size (e.g., 610a and/or 610b in FIG. 6N) (e.g., in some embodiments, displays an animation of at least a portion of the second dial contracting from the second expanded size to the second size (e.g., FIGS. 6K-6N)). Allowing the user to provide user input to collapse one or more dials of the time user interface enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, the time user interface (e.g., 608) includes a first clock hand (e.g., 612a, 612b, and/or 612c) corresponding to the first dial (e.g., 610a, 610b, and/or 610c) (e.g., a first clock hand that, in combination with the first dial, indicates the respective time and/or at least a portion of the respective time; a seconds hand; a minutes hand; and/or an hour hand). In some embodiments, in response to detecting the first set of one or more user inputs (e.g., 616e and/or 622), the computer system (e.g., 600) displays, via the one or more display generation components (e.g., 602), expansion of the first dial from a first size to a first expanded size that is larger than the first size (e.g., in some embodiments, without displaying expansion of the second dial and/or without displaying the second dial changing in size), including: in accordance with a determination that the first clock hand (e.g., 612a, 612b, and/or 612c) is pointed in a first respective direction when the first set of one or more user inputs is detected, expanding the first dial in a first expansion direction that corresponds to the first respective direction (e.g., from FIGS. 6B-6D, seconds dial 610a expands in a direction opposite the direction that seconds hand 612a is pointing and/or that moves away from the position at which seconds hand 612a intersects seconds dial 610a) (e.g., the first expansion direction is determined based on the first respective direction; the first expansion direction is parallel to the first respective direction; and/or the first dial expands in a direction toward or away from the first respective direction); and in accordance with a determination that the first clock hand is pointed in a second respective direction different from the first respective direction when the first set of one or more user inputs is detected, expanding the first dial in a second expansion direction that is different from the first expansion direction and that corresponds to the second respective direction (e.g., from FIGS. 6G-6H, minutes dial 610b expands in a direction opposite the direction that minutes hand 612b is pointing and/or that moves away from the position at which minutes hand 612a intersects minutes dial 610a) (e.g., the second expansion direction is determined based on the second respective direction; the second expansion direction is parallel to the second respective direction; and/or the first dial expands in a direction toward or away from the second respective direction). In some embodiments, the first dial expands in an expansion direction that corresponds to the direction that the first clock hand is pointed (e.g., at the time of expansion) (e.g., the expansion direction is determined based on the direction of the first clock hand; the expansion direction is parallel to the direction of the first clock hand; and/or the first dial expands in a direction toward or away from the direction the first clock hand is pointed). In some embodiments, the time user interface includes a second clock hand that corresponds to the second dial (e.g., a second clock hand that, in combination with the second dial, indicates the respective time and/or at least a portion of the respective time; a seconds hand; a minutes hand; and/or an hour hand). In some embodiments, the first set of one or more user inputs is detected while the second clock hand is pointing in a second direction different from the first direction. In some embodiments, the first dial expands in an expansion direction that does not take into account the direction of the second clock hand and/or that is not determined based on the direction of the second clock hand. Allowing the user to provide user input to expand different dials of the time user interface enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, the computer system (e.g., 600) displays, via the one or more display generation components and within the time user interface (e.g., 608), the first dial (e.g., 610a, 610b, and/or 610c) at a first dial size. While displaying the first dial at the first dial size, the computer system detects, via one or more input devices (e.g., one or more input devices that are in communication with the computer system, a touch-sensitive surface, a physical button, a rotatable input mechanism, a rotatable and depressible input mechanism, a motion sensor, an accelerometer, a gyroscope, a keyboard, a controller, and/or a mouse), a first user input (e.g., a touch input, a gesture input, an air gesture input, a spoken input, and/or a hardware control input) (e.g., 620 and/or 624). In response to detecting the first user input, the computer system displays, via the one or more display generation components and within the time user interface, the first dial (e.g., 610a, 610b, and/or 610c) changing in size from the first dial size to a second dial size that is different from the first dial size (e.g., in FIG. 6D, in response to user input 620, computer system 600 expands seconds dial 610a (e.g., based on rotation in a first direction) and/or shrinks seconds dial 610b (e.g., based on rotation in a second direction)). Allowing the user to provide user input to change the size of the first dial enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, while displaying the first dial having the first dial size, the computer system (e.g., 600) displays, via the one or more display generation components, the first dial moving at a first speed of movement (e.g., a first linear speed and/or a first velocity) (e.g., if seconds dial 610a was maintained at the size shown in FIG. 6C, seconds dial 610a would move at a first speed of movement (e.g., to keep up with seconds dial 612a)). While displaying the first dial having the second dial size (e.g., 610a in FIG. 6D), the computer system (e.g., 600) displays, via the one or more display generation components, the first dial moving at a second speed of movement (e.g., a second linear speed and/or a second velocity) that is different from the first speed of movement (e.g., if seconds dial 610a was maintained at the size shown in FIG. 6D, seconds dial 610a would move at a second speed of movement that is faster than the speed of movement had seconds dial 610a been displayed at the smaller size shown in FIG. 6C (e.g., to keep up with movement of seconds dial 612a)). In some embodiments, the first speed of movement is determined based on the first dial size, and the second speed of movement is determined based on the second dial size. For example, in some embodiments, the speed of movement of the first dial increases as the size of the first dial increases, and the speed of movement of the first dial decreases as the size of the first dial decreases. In some embodiments, a linear speed and/or velocity of the first dial increases as the size of the first increases, and the linear speed and/or velocity of the first dial decreases as the size of the first dial decreases, in order to maintain a constant angular speed of the first dial as the size of the first dial changes. Allowing the user to provide user input to change the size of the first dial enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently. Furthermore, automatically changing the speed of movement of the first dial as the size of the first dial changes allows for such operations to be performed without user input.

In some embodiments, displaying the time user interface (e.g., 608) further includes: while displaying the first dial at the first position of the time user interface, displaying, via the one or more display generation components, within the time user interface, a first complication (e.g., 614a) (e.g., a first complication that, when selected, causes the computer system to perform a first action corresponding to the first complication and/or causes the computer system to display a first application corresponding to the first complication) at a first complication position within the time user interface, wherein the first complication at the first complication position does not overlap the first dial when the first dial is in the first position of the time user interface (e.g., 614a in FIG. 6D); and while displaying the first dial at the second position of the time user interface, displaying, via the one or more display generation components, within the time user interface, the first complication (e.g., 614a) at a second complication position within the time user interface that is different from the first complication position (e.g., 614a in FIG. 6F), wherein the first complication at the second complication position does not overlap the first dial when the first dial is in the second position of the time user interface. In some embodiments, the first complication (e.g., 614a) moves around the time user interface (e.g., 608) as the first dial (e.g., 610a and/or 610b) moves around the time user interface to stay in a negative space that does not intersect the first dial. In some embodiments, displaying the time user interface comprises displaying the first complication moving from the first complication position to the second complication position while displaying the first dial moving from the first position to the second position (e.g., FIG. 6D to FIG. 6F). In some embodiments, the first complication at the second complication position would overlap the first dial when the first dial is at the first position of the time user interface. In some embodiments, the first complication at the first complication position would overlap the first dial when the first dial is at the second position of the time user interface. Automatically moving the first complication so that the first complication does not overlap the first dial allows for this operation to be performed without user input. Furthermore, doing so also enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, displaying the time user interface (e.g., 608) further includes: while displaying the first dial (e.g., 610a and/or 610b) moving from the first position of the time user interface to the second position of the time user interface (e.g., 610a in FIG. 6D to 610a in FIG. 6F), displaying, via the one or more display generation components, the first complication (e.g., 614a) moving gradually from the first complication position to the second complication position as the first dial moves from the first position of the time user interface to the second position of the time user interface (e.g., in some embodiments, from FIG. 6D to FIG. 6F, complication 614a moves gradually from the top left corner to the top right corner (e.g., with two or more, three or more, four or more, five or more, or 10 or more intermediate positions between the top left corner and the top right corner)). In some embodiments, displaying the first complication (e.g., 614a) moving gradually from the first complication position to the second complication position (e.g., FIG. 6D to FIG. 6F) comprises displaying the first complication at a plurality of complication positions (e.g., three or more, four or more, five or more, six or more, seven or more, eight or more, nine or more, or ten or more complication positions) along a path of movement between the first complication and the second complication position.

Automatically moving the first complication so that the first complication does not overlap the first dial allows for this operation to be performed without user input. Furthermore, doing so also enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, the first complication position (e.g., position of complication 614a in FIG. 6D) does not overlap the second complication position (e.g., position of complication 614a in FIG. 6F) (e.g., the first complication at the first complication position would not overlap the first complication at the second complication position; and/or the first complication position is spaced apart from the second complication position). In some embodiments, displaying the time user interface further includes: while displaying the first dial (e.g., 610a and/or 610b) moving from the first position of the time user interface to a third position of the time user interface that is between the first position and the second position of the time user interface, maintaining display of the first complication at the first complication position (e.g., from FIG. 6D to FIG. 6E, seconds dial 610a moves, but complication 614a is maintained in the top left corner); and in accordance with a determination that the first dial (e.g., 610a and/or 610b) has moved to the second position of the time user interface (e.g., 610a in FIG. 6F), ceasing display of the first complication at the first complication position (e.g., in FIG. 6F, complication 614a is no longer displayed in the top left corner); and displaying, via the one or more display generation components, the first complication at the second complication position (e.g., in FIG. 6F, complication 614a is moved to the top right corner). In some embodiments, the first complication is maintained at a static position in the time user interface while the first dial moves, and then jumps and/or moves to a different position in the time user interface when criteria are met (e.g., when the first dial moves to a particular position within the time user interface and/or when the first dial is within a threshold distance of overlapping and/or intersecting the first complication). Automatically moving the first complication so that the first complication does not overlap the first dial allows for this operation to be performed without user input. Furthermore, doing so also enhances the operability of the system and makes the user-system interface more efficient (e.g., by helping the user to provide proper inputs and/or access information more quickly) which, additionally, reduces power usage and improves battery life of the device by enabling the user to use the system more quickly and efficiently.

In some embodiments, the time user interface (e.g., 608) includes: a first display mode setting, wherein when the first display mode setting is enabled (and, for example, a second display mode setting is not enabled), a default display state of the time user interface includes displaying, via the one or more display generation components, the first dial at a first size and displaying movement of the first dial around the time user interface (e.g., “EXPANDED I” or “EXPANDED II” in FIG. 6N); and a second display mode setting different from the first display mode setting, wherein when the second display mode setting is enabled (and, for example, the first display mode setting is not enabled), the default display state of the time user interface includes displaying, via the one or more display generation components, the first dial at a second size that is smaller than the first size, and displaying, via the one or more display generation components, the first dial as a stationary object that does not move around the time user interface (e.g., CLOSED in FIG. 6N). In some embodiments, displaying the time user interface further includes: in accordance with a determination that the first display mode setting is enabled (and, optionally, that the time user interface is displayed in the default display state of the first display mode setting), displaying, via the one or more display generation components, a first complication in a first region of the time user interface while displaying the first dial moving from the first position of the time user interface to the second position of the time user interface (e.g., in scenario (d) and/or scenario (g) in FIG. 6O, one or more complications are displayed in time user interface 608 even when seconds dial 610a and/or minutes dial 610b are expanded because in scenario (d) the first expanded state EXPANDED I is set as the default state and in scenario (g) the second expanded state EXPANDED II is set as the default state); and in accordance with a determination that the second display mode setting is enabled (and, optionally, that the time user interface is not displayed in the default display state of the second display mode setting), forgoing display of the first complication in the first region of the time user interface while displaying the first dial moving from the first position of the time user interface to the second position of the time user interface (e.g., in some embodiments, forgoing display of the first complication (e.g., anywhere in the time user interface) while displaying the first dial moving from the first position to the second position of the time user interface) (e.g., in scenario (b) and scenario (c) in FIG. 6O, complications are not displayed while seconds dial 610a and/or minutes dial 610b are expanded because the first and second expanded states are not set as the default state in these scenarios). Displaying a time user interface that includes a first dial that moves and/or changes position over time as the respective time changes provides the user with an indication of time without the need for user input. Furthermore, in various embodiments, moving the first dial from the first position to the second position as the respective time changes allows for more detailed time information to be displayed within limited display space, thereby providing the user with more useful information within a limited amount of display space and improving the efficiency of utilization of limited display space. Additionally, displaying the first complication in the first region when the first display mode setting is enabled and forgoing display of the first complication in the first region when the first display mode setting is not enabled (e.g., the second display mode setting is enabled) provides the user with visual feedback about a state of the system (e.g., whether the first display mode setting is enabled or the second display mode setting is enabled), thereby providing improved visual feedback to the user.

In some embodiments, displaying the time user interface (e.g., 608) further includes: in accordance with a determination that the first display mode setting is enabled (and, optionally, that the time user interface is displayed in the default display state of the first display mode setting), displaying, via the one or more display generation components, a second complication different from the first complication in a second region of the time user interface different from the first region of the time user interface while displaying the first dial moving from the first position of the time user interface to the second position of the time user interface (e.g., in scenario (d) in FIG. 6O, two complications are displayed in time user interface 608 even when seconds dial 610a is expanded because in scenario (d) the first expanded state EXPANDED I is set as the default state); and in accordance with a determination that the second display mode setting is enabled (and, optionally, that the time user interface is not displayed in the default display state of the second display mode setting), forgoing display of the second complication in the second region of the time user interface while displaying the first dial moving from the first position of the time user interface to the second position of the time user interface (e.g., in some embodiments, forgoing display of the second complication (e.g., anywhere in the time user interface) while displaying the first dial moving from the first position to the second position of the time user interface) (e.g., in scenario (b) and scenario (c) in FIG. 6O, complications are not displayed while seconds dial 610a and/or minutes dial 610b are expanded because the collapsed state is set as the defaulted state, and the first and second expanded states are not set as the default state in these scenarios). Displaying a time user interface that includes a first dial that moves and/or changes position over time as the respective time changes provides the user with an indication of time without the need for user input. Furthermore, in various embodiments, moving the first dial from the first position to the second position as the respective time changes allows for more detailed time information to be displayed within limited display space, thereby providing the user with more useful information within a limited amount of display space and improving the efficiency of utilization of limited display space. Additionally, displaying complications when the first display mode setting is enabled and forgoing display of the complications when the first display mode setting is not enabled (e.g., the second display mode setting is enabled) provides the user with visual feedback about a state of the system (e.g., whether the first display mode setting is enabled or the second display mode setting is enabled), thereby providing improved visual feedback to the user.

In some embodiments, the time user interface (e.g., 608) further comprises a second dial (e.g., 610a, 610b, and/or 610c) separate from the first dial (e.g., 610a, 610b, and/or 610c) that is used to indicate the respective time (e.g., a second dial that is part of the indication of time, a seconds dial, a minutes dial, and/or an hours dial that, in combination with the first dial and/or one or more position indicators such as a clock hand or other object, indicates the respective time). In some embodiments, displaying the time user interface further comprises: in accordance with a determination that a first color combination setting is enabled (e.g., option 638a, option 638b, option 638c, option 638d, option 638e, option 638f, option 638g, option 638h, and/or option 638i) (e.g., selected, active, and/or selected by a user), concurrently displaying the first dial in a first color corresponding to the first color combination setting and the second dial in a second color that is different from the first color and that corresponds to the first color combination setting; and in accordance with a determination that a second color combination setting (e.g., option 638a, option 638b, option 638c, option 638d, option 638e, option 638f, option 638g, option 638h, and/or option 638i) different from the first color combination setting is enabled (e.g., selected, active, and/or selected by a user), concurrently displaying the first dial in a third color that is different from the first color and that corresponds to the second color combination setting and the second dial in a fourth color that is different from the third color and the second color and that corresponds to the second color combination setting. In some embodiments, displaying the time user interface further comprises: in accordance with a determination that a third color combination setting (e.g., option 638a, option 638b, option 638c, option 638d, option 638e, option 638f, option 638g, option 638h, and/or option 638i) different from the first color combination setting and the second color combination setting is enabled (e.g., selected, active, and/or selected by a user), concurrently displaying the first dial in a fifth color that is different from the first color and the third color and that corresponds to the third color combination setting and the second dial in a sixth color that is different from the second color, the fourth color, and the fifth color, and that corresponds to the third color combination setting. In some embodiments, the time user interface (e.g., 608) further comprises a first clock hand (e.g., 612a) corresponding to the first dial (e.g., 610a) (e.g., a first clock hand that, in combination with the first dial, indicates the respective time and/or at least a portion of the respective time; a seconds hand; a minutes hand; and/or an hour hand) and a second clock hand (e.g., 612b) corresponding to the second dial (e.g., 610b) (e.g., a second clock hand that, in combination with the second dial, indicates the respective time and/or at least a portion of the respective time; a seconds hand; a minutes hand; and/or an hour hand). In some embodiments, displaying the time user interface comprises: in accordance with a determination that a first color combination setting is enabled (e.g., selected, active, and/or selected by a user), concurrently displaying: the first dial and the first clock hand in a first color corresponding to the first color combination setting; and the second dial and the second clock hand in a second color that is different from the first color and that corresponds to the first color combination setting; and in accordance with a determination that a second color combination setting different from the first color combination setting is enabled (e.g., selected, active, and/or selected by a user), concurrently displaying: the first dial and the first clock hand in a third color that is different from the first color and that corresponds to the second color combination setting; and the second dial and the second clock hand in a fourth color that is different from the third color and the second color and that corresponds to the second color combination setting. Displaying a time user interface that includes a first dial that moves and/or changes position over time as the respective time changes provides the user with an indication of time without the need for user input. Furthermore, in various embodiments, moving the first dial from the first position to the second position as the respective time changes allows for more detailed time information to be displayed within limited display space, thereby providing the user with more useful information within a limited amount of display space and improving the efficiency of utilization of limited display space.

In some embodiments, displaying the time user interface (e.g., 608) further comprises: in accordance with a determination that a first display mode (e.g., 644a and/or 644b) (e.g., a dark mode and/or a dark display option) of the time user interface is enabled (e.g., selected, active, and/or selected by a user), displaying, via the one or more display generation components, the first dial with a first degree of transparency and overlaid on a background having a first darkness level (e.g., a black background); and in accordance with a determination that a second display mode (e.g., 644a and/or 644b) (e.g., a bright mode and/or a bright display option) of the time user interface is enabled (e.g., selected, active, and/or selected by a user), displaying, via the one or more display generation components, the first dial with a second degree of transparency that is less transparent than the first degree of transparency (e.g., is more opaque than the first degree of transparency and/or is fully opaque) and overlaid on a background (e.g., a white background) having a second darkness level that is brighter than (e.g., is less dark than and/or has a higher lumen value than) the first darkness level. Displaying a time user interface that includes a first dial that moves and/or changes position over time as the respective time changes provides the user with an indication of time without the need for user input. Furthermore, in various embodiments, moving the first dial from the first position to the second position as the respective time changes allows for more detailed time information to be displayed within limited display space, thereby providing the user with more useful information within a limited amount of display space and improving the efficiency of utilization of limited display space.

In some embodiments, the computer system (e.g., 600) displays, via the one or more display generation components (e.g., 602), the time user interface (e.g., 608) in a first display state, wherein in the first display state: the first dial (e.g., 610a) is displayed at a first size and is displayed as a stationary object that does not move within the time user interface (e.g., 610a in FIG. 6B); and the first dial is displayed with a first number of time indication marks (e.g., tick marks, second marks, 5-second marks, 10-second marks, 15-second marks, minute marks, 5-minute marks, 10-minute marks, 15-minute marks, and/or hour marks) that are indicative of at least a portion of the respective time (e.g., 610a in FIG. 6B). While displaying the time user interface in the first display state, the computer system detects, via one or more input devices (e.g., 602) (e.g., one or more input devices that are in communication with the computer system, a touch-sensitive surface, a physical button, a rotatable input mechanism, a rotatable and depressible input mechanism, a motion sensor, an accelerometer, a gyroscope, a keyboard, a controller, and/or a mouse), a first set of one or more user inputs (e.g., 616e) (e.g., one or more touch inputs, one or more gesture inputs, one or more air gesture inputs, one or more spoken inputs, and/or one or more hardware control inputs) that correspond to a request to transition the time user interface from the first display state to a second display state different from the first display state. In response to detecting the first set of one or more user inputs that correspond to the request to transition the time user interface from the first display state to the second display state, the computer system displays, via the one or more display generation components, the time user interface (e.g., 608) in the second display state (e.g., FIG. 6D), wherein the second display state: the first dial (e.g., 610a) is displayed at a second size that is larger than the first size and is displayed as a moving object that changes positions in the time user interfaces as the respective time changes (e.g., 610a in FIG. 6D); and the first dial is displayed with a second number of time indication marks (e.g., tick marks, quarter-second marks, half-second marks, second marks, 5-second marks, 10-second marks, 15-second marks, minute marks, 5-minute marks, 10-minute marks, 15-minute marks, and/or hour marks) that are indicative of at least a portion of the respective time, wherein the second number is greater than the first number (e.g., in FIG. 6D, seconds dial 610a is displayed with tick marks for every half second, whereas in FIG. 6B, seconds dial 610a is displayed with tick marks for every full second). Increasing the size of the first dial in the second display state, and displaying additional tick marks on the second dial when in the second display state, allows for more detailed time information to be displayed within limited display space, thereby providing the user with more useful information within a limited amount of display space and improving the efficiency of utilization of limited display space.

In some embodiments, while the computer system (e.g., 600) is in a first power state (e.g., a normal power state and/or a high-power state) (e.g., FIG. 6R), the computer system displays, via the one or more display generation components (e.g., 602), the time user interface (e.g., 608) in a first expanded display state, wherein in the first expanded display state, the first dial (e.g., 610a and/or 610b) is displayed at a first expanded size (e.g., 608 in FIG. 6R). While displaying the time user interface in the first expanded display state, the computer system (e.g., 600) detects that low power state criteria are met (e.g., wrist down movement 652a) (e.g., detecting that the user has moved a body part in a prescribed manner; detecting that the user has lowered his or her wrist while wearing the computer system on his or her wrist; detecting one or more user inputs corresponding to a user request to transition to a lower power state; and/or detecting that the user has not provided user input on the computer system for a threshold duration of time). In response to detecting that the low power state criteria are met, the computer system transitions the computer system from the first power state to a low power state in which the computer system consumes less power than in the first power state (e.g., a low power state in which the one or more display generation components are darkened to a lower brightness; and/or a lower power state in which the one or more display generation components and/or the time user interface is refreshed at a lower frequency than in the first power state); and displays the time user interface (e.g., 608) in a first collapsed display state different from the first expanded display state (e.g., 608 in FIG. 6S), wherein, in the first collapsed display state, the first dial (e.g., 610a and/or 610b) is displayed at a first collapsed size that is smaller than the first expanded size (e.g., 610a and/or 610b in FIG. 6S). In some embodiments, while the computer system is in the first power state (e.g., 600 in FIG. 6R) (e.g., a normal power state and/or a high-power state), the computer system displays, via the one or more display generation components, the time user interface (e.g., 608) in a first expanded display state (e.g., 608 in FIG. 6R), wherein in the first expanded display state, the first dial is displayed at a first expanded size (e.g., 610a in FIG. 6R) and a second dial of the time user interface separate from the first dial is displayed (e.g., concurrently with the first dial) at a second expanded size (e.g., 610b in FIG. 6R) (e.g., a second expanded size different from the first expanded size). While displaying the time user interface in the first expanded display state, the computer system detects that low power state criteria are met (e.g., wrist lowering gesture 652a) (e.g., detects that the user has moved a body part in a prescribed manner; detects that the user has lowered his or her wrist while wearing the computer system on his or her wrist; detects one or more user inputs corresponding to a user request to transition to a lower power state; and/or detects that the user has not provided user input on the computer system for a threshold duration of time). In response to detecting that the low power state criteria are met, the computer system: transitions the computer system from the first power state to a low power state in which the computer system consumes less power than in the first power state (e.g., computer system 600 in FIG. 6S) (e.g., a low power state in which the one or more display generation components are darkened to a lower brightness; and/or a lower power state in which the one or more display generation components and/or the time user interface is refreshed at a lower frequency than in the first power state); and displays the time user interface in a first collapsed display state (e.g., 608 in FIG. 6S) different from the first expanded display state, wherein, in the first collapsed display state, the first dial is displayed at a first collapsed size that is smaller than the first expanded size (e.g., 610a in FIG. 6S) and the second dial is displayed (e.g., concurrently with the first dial) at a second collapse size that is smaller than the second expanded size (and, in some embodiments, is smaller than the first collapsed size) (e.g., 610b in FIG. 6S). Automatically collapsing one or more dials of the time user interface when the computer system transitions to a low power state allows for such operations to be performed without additional user input. Furthermore, in some embodiments, transitioning the time user interface to the first collapsed display state when the computer system is in a low power state allows the computer system to further conserve additional power by transitioning to a state in which the first dial is smaller, and there is less (e.g., in some embodiments, no) movement of the first dial.

In some embodiments, while the computer system is in the low power state (e.g., 600 in FIG. 6S) and the time user interface (e.g., 608) is displayed in the first collapsed display state (e.g., 608 in FIG. 6S), the computer system detects that higher power state criteria are met (e.g., wrist raise gesture 652b) (e.g., detecting that the user has moved a body part in a prescribed manner; detecting that the user has raised his or her wrist while wearing the computer system on his or her wrist; detecting one or more user inputs corresponding to a user request to transition to the first power state; and/or detecting that the user has provided a user input to the computer system). In response to detecting that the higher power state criteria are met, the computer system: transitions the computer system from the low power state to the first power state in which the computer system consumes more power than in the low power state (e.g., 600 in FIG. 6R) (e.g., a first power state in which the one or more display generation components are brightened compared to the low power state; and/or a first power state in which the one or more display generation components and/or the time user interface is refreshed at a higher frequency than in the low power state); and displays the time user interface (e.g., 608) in the first expanded display state (e.g., 608 in FIG. 6R), including displaying, via the one or more display generation components, the first dial (e.g., 610a) at the first expanded size that is larger than the first collapsed size (e.g., 610 in FIG. 6R). In some embodiments, while the computer system is in the low power state and the time user interface is displayed in the first collapsed display state, the computer system displays the time user interface with the first dial having a first collapsed size (e.g., 610a in FIG. 6S) and a second dial of the time user interface having a second collapsed size (e.g., 610b in FIG. 6S). In some embodiments, in response to detecting that the higher power state criteria are met (e.g., wrist raise gesture 652b), the computer system: transitions the computer system from the low power state to the first power state in which the computer system consumes more power than in the low power state (e.g., 600 in FIG. 6R) (e.g., a first power state in which the one or more display generation components are brightened compared to the low power state; and/or a first power state in which the one or more display generation components and/or the time user interface is refreshed at a higher frequency than in the low power state); and displays the time user interface in the first expanded display state (e.g., 608 in FIG. 6R), including displaying the first dial at the first expanded size that is larger than the first collapsed size (e.g., 610a in FIG. 6R) and displaying the second dial at a second expanded size that is larger than the second collapsed size (e.g., 610b in FIG. 6R). Automatically expanding one or more dials of the time user interface when the computer system transitions to from the low power state to a higher power consumption state allows for such operations to be performed without additional user input.

Note that details of the processes described above with respect to method 700 (e.g., FIG. 7) are also applicable in an analogous manner to the methods described below. For example, methods 900, 1100, 1300, 1350, 1500, and/or 1700 optionally include one or more of the characteristics of the various methods described above with reference to method 700. For example, in various embodiments, the user interface object of the first type recited in method 1300 and/or the first complication recited in method 1500 can be displayed within the time user interface recited in method 700, the wake screen user interface recited in method 900, the time user interface recited in method 1350, and/or the time user interface recited in method 1700. In another example, in various embodiments, the first user interface recited in method 1100 can include the time user interface recited in method 700, the wake screen user interface recited in method 900, the user interface object of the first type recited in method 1300, the time user interface recited in method 1350, the first complication recited in method 1500, and/or the time user interface recited in method 1700. For brevity, these details are not repeated below.

FIGS. 8A-8I illustrate exemplary user interfaces for providing wake screen user interfaces, in accordance with some embodiments. The user interfaces in these figures are used to illustrate the processes described below, including the processes in FIG. 9.

FIG. 8A depicts computer system 600, which is a smart watch that includes touch-sensitive display 602, crown 604a, and button 604b. In the depicted embodiments, crown 604a is rotatable (e.g., in a clockwise direction and a counter-clockwise direction) and depressible, such that a user is able to use crown 604a to provide rotational input and depression (e.g., press) inputs. FIG. 8A also depicts computer system 800, which is a smart phone that includes touch-sensitive display 802 and buttons 804a-804c. In some embodiments, computer system 800 is associated with computer system 600. For example, in some embodiments, computer system 800 and computer system 600 are associated with the same user and/or same owner, and/or computer system 800 and computer system 600 are logged into the same user account. At FIG. 8A, computer system 800 displays, via touch-sensitive display 802, watch editing user interface 806. Watch editing user interface 806 includes one or more options for modifying settings of computer system 600. For example, in FIG. 8A, watch editing user interface 806 includes watch face section 808, which provides various watch face options for selecting different watch faces to be displayed on computer system 600, including meridian watch face option 808a, photos watch face option 808b, and artist watch face option 808c. At FIG. 8A, computer system 600 displays watch faces user interface 812, which also provides options for selecting between different watch faces to be displayed on computer system 600, including meridian watch face option 814a, photos watch face option 814b, and artist watch face option 814c. In FIG. 8A, photos watch face option 814b is currently in focus, and the user can switch between different watch face options by, for example, providing a swipe left or swipe right user inputs (e.g., swipe right to bring meridian watch face option 814a into focus and swipe left to bring artist watch face option 814c into focus). Watch faces user interface 812 includes options 816a, 816b. Option 816a, when selected, causes computer system 600 to initiate a process for sharing a currently selected watch face (e.g., photos watch face option 814b in FIG. 8A). Option 816b, when selected, causes computer system 600 to initiate a process for editing a currently selected watch face (e.g., photos watch face option 814b in FIG. 8A). At FIG. 8A, computer system 800 detects user input 818a (e.g., a tap input) corresponding to selection of photos watch face option 808b, and computer system 600 detects user input 808b (e.g., a tap input) corresponding to selection of option 816b while photos watch face option 814b is selected and/or in focus.

At FIG. 8B, in response to detecting user input 818a, computer system 800 displays, via touch-sensitive display 802, user interface 820; and in response to detecting user input 818b, computer system 600 displays, via touch-sensitive display 602, user interface 828. User interface 820 includes various options for modifying one or more aspects of a photos watch face that can be used as a watch face for computer system 600. In some embodiments, the photos watch face displays one or more photographs and/or media items as a background for a watch face, and also displays an indication of time overlaid on the one or more media items. In some embodiments, the one or more photographs and/or media items are selected from a media library (e.g., a photo library) that is stored on and/or otherwise associated with computer system 600 and/or computer system 800 (e.g., associated with a user account that is logged into computer system 600 and/or computer system 800).

User interface 820 includes preview 820a, which provides a preview of what the photos watch face will look like on computer system 600. In FIG. 8B, preview 820a displays an indication of time (e.g., 10:09) overlaid on a photograph of a field. User interface 820 includes color options 822, which displays various color options for, for example, the indication of time in the photos watch face. User interface also includes content section 824 and time position section 826. Content section 824 includes content options 824a-824d that allow a user to select which media items (e.g., which media items from a media library) to use in the photos watch face. Content option 824a, when selected, causes computer system 800 to initiate a process for user selection of one or more albums (e.g., collections of media items) to be used in the photos watch face. Content option 824b, when selected, causes computer system 800 to initiate a process for using a set of media items that have been marked as “favorites” as the media items in the photos watch face. Content option 824c, when selected, causes computer system 800 to initiate a process for user selection of one or more individual media items to be used as media items in the photos watch face. Content option 824d, when selected, causes computer system 800 and/or computer system 600 to automatically select media items for use in the photos watch face based on a context of computer system 600 and/or a user of computer system 600, as will be described in greater detail below. In FIG. 8B, content option 824d is currently selected, as indicated by indication 824d-1. Time position section 826 includes options 826a, 826b for defining where the indication of time will be displayed in the photos watch face-on top (e.g., option 826a) or on bottom (e.g., option 826b). In FIG. 8B, option 826b is currently selected, as indicated by indication 826b-1.

At FIG. 8B, computer system 600 displays user interface 828, which includes content options 830a-830c that are similar to content options 824a-824d discussed above, and allow a user to select which media items will be used in the photos watch face. In FIG. 8B, contextual option 830b is currently selected, such that computer system 600 and/or another computer system will automatically select which media items to use in the photos watch face based on a context of computer system 600 and/or a user of computer system 600. In some embodiments, when contextual option 830b and/or context option 824d is selected for the photos watch face, the media items used in the photos watch face will automatically change as the context of computer system 600 and/or a user of computer system 600 changes.

FIGS. 8C-8E illustrate various example scenarios in which media items for use in the photos watch face are automatically selected (e.g., by computer system 600 and/or a different computer system) based on a context of computer system 600 and/or a user of computer system 600. The top row of FIG. 8C displays an example scenario in which media items are selected for a photos watch face based on location-based context information for computer system 600 and/or a user of computer system 600. In the top row of FIG. 8C, computer system 600 displays photos watch face 832, which includes indication of time 834 overlaid on a media item. In the top row of FIG. 8C, computer system 600 detects that computer system 600 is currently located in Paris. Based on a determination that computer system 600 is currently located in Paris, computer system 600 and/or a remote computer system (e.g., a remote server and/or a separate computer system) automatically selects one or more media items for use in photos watch face 832. In the top row of FIG. 8C, media items 836-1, 836-2, 836-3, 836-4 have been automatically selected for use in photos watch face 832 based on a determination that computer system 600 is currently located in Paris. For example, media items 836-1, 836-2, 836-3, 836-4 are selected for inclusion in photos watch face 832 based on a determination that media items 836-1, 836-2, 836-3, 836-4 were previously captured in Paris and/or depict concepts associated with Paris. Media item 836-1 is displayed with caption 838-1, which, in some embodiments, provides an indication as to why media item 836-1 was selected for inclusion in photos watch face 832 (e.g., “Paris 2019” indicating that media item 836-1 was previously captured in Paris in 2019). Similarly, media item 836-2 is displayed with caption 838-2 which provides an indication as to why media item 836-2 was selected for inclusion in photos watch face 832; media item 836-3 is displayed with caption 838-3 which provides an indication as to why media item 836-3 was selected for inclusion in photos watch face 832; and media item 836-4 is displayed with caption 838-4 which provides an indication as to why media item 836-4 was selected for inclusion in photos watch face 832.

In some embodiments, computer system 600 transitions between a plurality of media items selected for photos watch face 832 (e.g., in the top row of FIG. 8C, computer system 600 switches between media items 836-1, 836-2, 836-3, and/or 836-4 for display in photos watch face 832). In some embodiments, computer system 600 switches from a first media item to a next media item in response to user input (e.g., a tap on touch-sensitive display 602 and/or rotation of crown 604a). In some embodiments, computer system 600 switches from a first media item to a next media item automatically and/or without user input based on satisfaction of one or more criteria (e.g., a threshold duration of time passing since the current media item was displayed).

The bottom row of FIG. 8C displays an example scenario in which media items are selected for photos watch face 832 based on date-based context information for computer system 600 and/or a user of computer system 600. In the bottom row of FIG. 8C, computer system 600 determines that the current day is Independence Day and/or that the current day is within a threshold number of days of Independence Day. Based on a determination that it is Independence Day, computer system 600 and/or a remote computer system (e.g., a remote server and/or a separate computer system) automatically selects one or more media items for use in photos watch face 832. In the bottom row of FIG. 8C, media items 836-5, 836-6, 836-7, 836-8 have been automatically selected for use in photos watch face 832 based on a determination that the current day is Independence Day. For example, media items 836-5, 836-6, 836-7, 836-8 are selected for inclusion in photos watch face 832 based on a determination that media items 836-5, 836-6, 836-7, 836-8 were previously captured on Independence Day and/or depict concepts associated with Independence Day. Media item 836-5 is displayed with caption 838-5, which, in some embodiments, provides an indication as to why media item 836-5 was selected for inclusion in photos watch face 832 (e.g., “Independence Day, 2018” indicating that media item 836-5 was previously captured on Independence Day in 2018). Similarly, media item 836-6 is displayed with caption 838-6 which provides an indication as to why media item 836-6 was selected for inclusion in photos watch face 832; media item 836-7 is displayed with caption 838-7 which provides an indication as to why media item 836-7 was selected for inclusion in photos watch face 832; and media item 836-8 is displayed with caption 838-8 which provides an indication as to why media item 836-8 was selected for inclusion in photos watch face 832.

The top row of FIG. 8D displays an example scenario in which media items are selected for photos watch face 832 based on communications-based context information for computer system 600 and/or a user of computer system 600. In the top row of FIG. 8D, computer system 600 detects that computer system 600 has recently received one or more media items within communications sessions with other users and/or other computer systems. Based on a determination that computer system 600 has recently received one or more media items within communications sessions with other users and/or other computer systems, computer system 600 and/or a remote computer system (e.g., a remote server and/or a separate computer system) automatically selects one or more media items for use in photos watch face 832 from those communications sessions. In the top row of FIG. 8D, media items 836-9, 836-10, 836-11, 836-12 have been automatically selected for use in photos watch face 832 based on a determination that computer system 600 has currently received these media items within communications sessions with other users. Media item 836-9 is displayed with caption 838-9, which, in some embodiments, provides an indication as to why media item 836-9 was selected for inclusion in photos watch face 832 (e.g., “Recent Communications” indicating that photos watch face 832 is currently displaying media items received in recent communications). Similarly, media item 836-10 is displayed with caption 838-10 which provides an indication as to why media item 836-10 was selected for inclusion in photos watch face 832; media item 836-11 is displayed with caption 838-11 which provides an indication as to why media item 836-11 was selected for inclusion in photos watch face 832; and media item 836-12 is displayed with caption 838-12 which provides an indication as to why media item 836-12 was selected for inclusion in photos watch face 832.

The bottom row of FIG. 8D displays an example scenario in which media items are selected for photos watch face 832 based on media library-based context information for computer system 600 and/or a user of computer system 600. In the bottom row of FIG. 8D, computer system 600 and/or a remote computer system (e.g., a remote server and/or a separate computer system) automatically selects one or more media items for use in photos watch face 832 from media items that have recently been added to a media library associated with computer system 600 and/or a user of computer system 600 (e.g., media items that have recently been captured and added to the media library). In the bottom row of FIG. 8D, media items 836-13, 836-14, 836-15, 836-16 have been automatically selected for use in photos watch face 832 based on a determination that these media items were recently added to the media library (e.g., within the last week, within the last two weeks, or within the last month). Media item 836-13 is displayed with caption 838-13, which, in some embodiments, provides an indication as to why media item 836-13 was selected for inclusion in photos watch face 832 (e.g., “Recent Media Items” indicating that photos watch face 832 is currently displaying media items that were recently added to the media library). Similarly, media item 836-14 is displayed with caption 838-14 which provides an indication as to why media item 836-14 was selected for inclusion in photos watch face 832; media item 836-15 is displayed with caption 838-15 which provides an indication as to why media item 836-15 was selected for inclusion in photos watch face 832; and media item 836-16 is displayed with caption 838-16 which provides an indication as to why media item 836-16 was selected for inclusion in photos watch face 832.

The top row of FIG. 8E displays an example scenario in which media items are selected for photos watch face 832 based on people-based context information for computer system 600 and/or a user of computer system 600. In the top row of FIG. 8E, computer system 600 detects, for example, that a user of computer system 600 has recently traveled with a group of people, is currently traveling with a group of people, and/or is scheduled to travel with a group of people soon (e.g., in the next day, in the next week, in the next two weeks, or in the next month). Based on this determination, computer system 600 and/or a remote computer system (e.g., a remote server and/or a separate computer system) automatically selects one or more media items for use in photos watch face 832 that, for example, depict previous trips with friends and/or that depict the specific individuals in the group of people (e.g., that will be traveling with the user, that are traveling with the user, and/or that recently traveled with the user). In the top row of FIG. 8E, media items 836-17, 836-18, 836-19, 836-20 have been automatically selected for use in photos watch face 832 based on a determination that a user of computer system 600 has future travel plans with a group of people, is currently traveling with a group of people, or recently completed travel with a group of people. Media item 836-17 is displayed with caption 838-17, which, in some embodiments, provides an indication as to why media item 836-17 was selected for inclusion in photos watch face 832 (e.g., “Traveling with Friends” indicating that photos watch face 832 is currently displaying media items pertaining to travel with friends). Similarly, media item 836-18 is displayed with caption 838-18 which provides an indication as to why media item 836-18 was selected for inclusion in photos watch face 832; media item 836-19 is displayed with caption 838-19 which provides an indication as to why media item 836-19 was selected for inclusion in photos watch face 832; and media item 836-20 is displayed with caption 838-20 which provides an indication as to why media item 836-20 was selected for inclusion in photos watch face 832.

The bottom row of FIG. 8E displays an example scenario in which media items are selected for photos watch face 832 based on routine-based and/or event-based context information for computer system 600 and/or a user of computer system 600. In the bottom row of FIG. 8E, computer system 600 and/or a remote computer system (e.g., a remote server and/or a separate computer system) automatically selects one or more media items for use in photos watch face 832 based on identification of one or more recent events that the user of computer system 600 recently attended and/or participated in. In the bottom row of FIG. 8E, media items 836-21, 836-22, 836-23, 836-24 have been automatically selected for use in photos watch face 832 based on a determination that these media items pertain to recent events that the user of computer system 600 recently attended and/or participated in (e.g., within the last week, within the last two weeks, or within the last month). Media item 836-21 is displayed with caption 838-21, which, in some embodiments, provides an indication as to why media item 836-21 was selected for inclusion in photos watch face 832 (e.g., “Recent Events” indicating that photos watch face 832 is currently displaying media items that pertain to recent events for the user). Similarly, media item 836-22 is displayed with caption 838-22 which provides an indication as to why media item 836-22 was selected for inclusion in photos watch face 832; media item 836-23 is displayed with caption 838-23 which provides an indication as to why media item 836-23 was selected for inclusion in photos watch face 832; and media item 836-24 is displayed with caption 838-24 which provides an indication as to why media item 836-24 was selected for inclusion in photos watch face 832.

As can be seen in the various examples described above, the contextual content option for photos watch face 832 allows for automatic selection of various media items to be displayed in photos watch face 832 based on a changing context of computer system 600 and/or a user of computer system 600. In this way, the user of computer system 600 is presented with a variety of media items that are selected to be of particular relevance and/or interest to the user because the media items will pertain to a current, recent, and/or upcoming context of the user.

In the various examples described above, media items were displayed with a corresponding caption that, in some embodiments, provides an indication as to why each media item was selected for inclusion in photos watch face 832. In some embodiments, a user can selectively display or not display the caption with user input. At FIG. 8F, computer system 600 displays photos watch face 832 with media item 836-25. In FIG. 8F, media item 836-25 is displayed without a corresponding caption. At FIG. 8F, computer system 600 detects user input 840 (e.g., a tap input) on photos watch face 832. At FIG. 8G, in response to detecting user input 840, computer system 600 displays caption 838-25, which provides an indication of why media item 836-25 was selected for display within photos watch face 832. At FIG. 8G, computer system 600 detects user input 841 (e.g., a tap input) on photos watch face 832. In some embodiments, in response to user input 841, computer system 600 ceases display of media item 836-25 within photos watch face 832, and replaces display of media item 836-25 with display of a different media item that has been selected for display within photos watch face 832. In some embodiments, the different media item is displayed within photos watch face 832 without a corresponding caption (e.g., like media item 836-25 in FIG. 8F), and a user can provide another input (e.g., another tap input) to cause computer system 600 to display the corresponding caption.

In some embodiments, indication of time 834 is displayed with a reflective visual effect in which indication of time 834 appears to reflect light differently as computer system 600 moves (e.g., similar to how a reflective material would reflect light as it is moved around in a light source). In FIG. 8H, computer system 600 displays photos watch face 832 with indication of time 834 overlaid on media item 836-26. In FIG. 8H, indication of time 834 is displayed with a first set of reflective properties. At FIG. 8H, computer system 600 detects wrist movement 844 by user 842 that is wearing computer system 600 and/or detects that computer system 600 is being moved while computer system 600 is being worn by a user. At FIG. 8I, in response to detecting wrist movement 844, computer system 600 displays indication of time 844 with a second set of reflective properties different from the first set of reflective properties to give the appearance that indication of time 844 is reflecting light as computer system 600 is moved.

Although the example scenarios and embodiments described above used the example of photos watch face 832, the various features described above can also be applied to other user interfaces that, for example, include media items that are displayed with an indication of time. For example, in various embodiments, one or more of the features described above can also be applied to a wake screen user interface that is displayed when computer system 600 and/or computer system 800 transitions from a sleep state to a wake state and/or a lock screen user interface that is indicative of computer system 600 and/or computer system 800 being in a locked state. In some embodiments, photos watch face 832 is a wake screen user interface and/or a lock screen user interface.

FIG. 9 is a flow diagram illustrating a method for providing wake screen user interfaces using a computer system in accordance with some embodiments. Method 900 is performed at a computer system (e.g., 100, 300, 500, 600, and/or 800) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 602 and/or 802) (e.g., a display controller, a display, a touch-sensitive display system, a touchscreen, a monitor, and/or a head mounted display system) and one or more input devices (e.g., 602, 604a, 604b, 802, 804a, 804b, and/or 804c) (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 900 are, optionally, combined, the orders of some operations are, optionally, changed, and some operations are, optionally, omitted.

As described below, method 900 provides an intuitive way for providing a wake screen user interface. The method reduces the cognitive burden on a user for accessing visual media items within a wake screen user interface, thereby creating a more efficient human-machine interface. For battery-operated computing devices, enabling a user to access visual media items faster and more efficiently conserves power and increases the time between battery charges.

The computer system (e.g., 600) detects (902), via the one or more input devices (e.g., 602, 604a, and/or 604b), a first set of one or more user inputs (e.g., one or more touch inputs, one or more hardware control inputs, one or more button presses, one or more gesture inputs, and/or one or more spoken inputs) corresponding to a user request to display a wake screen user interface (e.g., 832) (e.g., a user interface that is indicative of the computer system having transitioned to an awakened state (e.g., from a sleep state) and/or having transitioned out of a sleep state). In some embodiments, the wake screen user interface is a time user interface (e.g., a user interface that includes an analog and/or digital indication of time, a clock face user interface, a watch face user interface, a reduced-power screen, a wake screen, and/or a lock screen). In some embodiments, the wake screen user interface is a lock screen user interface that is indicative of the computer system being awakened but in a locked state. In some embodiments, the wake screen user interface is a user interface that is indicative of the computer system having transitioned from a locked state to an unlocked state. In some embodiments, the wake screen user interface includes two or more photographs selected from the media library; and the wake screen user interface transitions between two or more photographs over time. In response to detecting the first set of one or more user inputs corresponding to a user request to display a wake screen user interface (904), the computer system (e.g., 600) displays (906), via the one or more display generation components (e.g., 602), the wake screen user interface (e.g., 832), wherein: the wake screen user interface includes one or more visual media items (e.g., photographs and/or videos) (e.g., one or more of 836-1 through 836-26) (908); and displaying the wake screen user interface includes (910): in accordance with a determination that the computer system has a first context (e.g., top row of FIG. 8C, bottom row of FIG. 8C, top row of FIG. 8D, bottom row of FIG. 8D, top row of FIG. 8E, and/or bottom row of FIG. 8E), displaying (912), via the one or more display generation components, the wake screen user interface (e.g., 832) with a first set of one or more visual media items (e.g., 836-1 through 836-4 in the top row of FIG. 8C; 836-5 through 836-8 in the bottom row of FIG. 8C; 836-9 through 836-12 in the top row of FIG. 8D; 836-13 through 836-16 in the bottom row of FIG. 8E; 836-17 through 836-20 in the top row of FIG. 8F; and/or 836-21 through 836-24 in the bottom row of FIG. 8F); and in accordance with a determination that the computer system has a second context (e.g., top row of FIG. 8C, bottom row of FIG. 8C, top row of FIG. 8D, bottom row of FIG. 8D, top row of FIG. 8E, and/or bottom row of FIG. 8E) that is different from the first context, displaying (914), via the one or more display generation components, the wake screen user interface with a second set of one or more visual media items (e.g., 836-1 through 836-4 in the top row of FIG. 8C; 836-5 through 836-8 in the bottom row of FIG. 8C; 836-9 through 836-12 in the top row of FIG. 8D; 836-13 through 836-16 in the bottom row of FIG. 8E; 836-17 through 836-20 in the top row of FIG. 8F; and/or 836-21 through 836-24 in the bottom row of FIG. 8F) that is different from the first set of one or more visual media items.

In some embodiments, displaying the wake screen user interface (e.g., 832) with the first set of one or more visual media items comprises concurrently displaying two or more visual media items of the first set of one or more visual media items (e.g., in some embodiments, rather than displaying a single media item at a time, computer system 600 displays multiple media items concurrently within photos watch face 832). In some embodiments, displaying the wake screen user interface (e.g., 832) with the first set of one or more visual media items comprises displaying two or more media items of the first set of one or more visual media items sequentially (e.g., changing automatically over time, in response to user inputs, and/or in response to repeated wake inputs) (e.g., 836-1 through 836-4 in the top row of FIG. 8C; 836-5 through 836-8 in the bottom row of FIG. 8C; 836-9 through 836-12 in the top row of FIG. 8D; 836-13 through 836-16 in the bottom row of FIG. 8E; 836-17 through 836-20 in the top row of FIG. 8F; and/or 836-21 through 836-24 in the bottom row of FIG. 8F). In some embodiments, displaying the wake screen user interface (e.g., 832) with the second set of one or more visual media items comprises concurrently displaying two or more visual media items of the second set of one or more visual media items. In some embodiments, displaying the wake screen user interface (e.g., 832) with the second set of one or more visual media items comprises displaying two or more media items of the second set of one or more visual media items sequentially (e.g., changing automatically over time, in response to user inputs, and/or in response to repeated wake inputs).

In some embodiments, the one or more visual media items are selected from a media library associated with a user of the computer system (e.g., 600) (e.g., a media library that is associated with a user account that is logged into the computer system) based on a context of the computer system (e.g., a context of the computer system at the time of detecting the first set of one or more user inputs). In some embodiments, the context of the computer system includes one or more of the following: a current location of the computer system; a current date in the computer system's current location; a current time in the computer system's current location; current weather conditions in the computer system's current location (e.g., temperature, heat index, humidity, UV index, dew point, sunny, cloudy, rainy, and/or windy); one or more detected users, detected contacts, and/or detected devices within a threshold distance of the computer system (e.g., within wireless communication range of the computer system); data received and/or transmitted by the computer system (e.g., messages transmitted and/or received by the computer system; media items captured by the computer system; media items transmitted by the computer system; and/or media items received by the computer system) within a threshold duration of time (e.g., within the last five minutes, within the last hour, within the last day, within the last week, within the last month, and/or within the last year); and/or events and/or appointments stored in a calendar that is accessible to the computer system.

In some embodiments, the context of the computer system includes an element of time, such as date, time, time of day, day of the week, and/or season (e.g., at the location of the computer system or a different location). In some embodiments, the context of the computer system is based on the current time (e.g., at the location of the computer system). In some embodiments, the context of the computer system is based on a time other than the current time, such as a period of time (e.g., five minutes, an hour, a day, a week, and/or a year), a previous time, and/or a future time. In some embodiments, the context of the computer system is a device context that relates to the current time but is not the current time (e.g., contexts pertaining to events that occurred within a threshold time of the current time, and/or information about the current time such as the current weather and/or devices and/or users detected near the computer system at the current time). In some embodiments, the context of the computer system is a non-time related context. In some embodiments, the context of the computer system includes location information, such as current location and/or proximity to (e.g., within a threshold range of) the computer system, a person, an object, an external device, and/or a respective location. In some embodiments, the context of the computer system is a device context that relates to the current location of the computer system but is not the current location of the computer system (e.g., points of interest within a threshold distance of the current location of the computer system; weather conditions at the current location of the computer system; events that occurred in the past at the current location and/or proximate the current location of the computer system; and/or devices and/or other users detected proximate the current location of the computer system). In some embodiments, the context of the computer system is a non-location related context. In some embodiments, the context of the computer system includes environmental conditions (e.g. at a location of the computer system or a different location), such as weather (e.g., temperature, heat index, humidity, UV index, dew point, and/or conditions, such as sunny, rainy, and/or windy) and/or lighting conditions (e.g., low light or bright light). In some embodiments, the context of the computer system is a non-environmental-condition related context. In some embodiments, the context of the computer system is based on occurrence of an event, such as receipt and/or transmission of data (e.g., a message, email, media item, and/or notification) from an external device, user input at the computer system, user input at a companion device, and/or activity (e.g., movement and/or motion). In some embodiments, the context of the computer system is a context other than receipt of incoming data from an external device. In some embodiments, the context of the computer system is based on application data that is accessible to the computer system, such as information stored in a calendar application (e.g., scheduled events and/or appointments), messaging application, email application, and/or notes application on the computer system. In some embodiments, the context of the computer system is based on historical information, such as patterns of usage (e.g., user input and/or activity) and/or location (e.g., repeatedly going to a location on a particular day and/or at a particular time). Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the first context of the computer system (e.g., 600) pertains to a first location (e.g., a first geographic location, a first country, a first city, and/or a first address) (e.g., top row of FIG. 8C); and the first set of one or more visual media items is selected for display within the wake screen user interface based on the first location (e.g., 836-1 through 836-4 in the top row of FIG. 8C selected based on those media items being associated with Paris) (e.g., the first set of one or more visual media items were captured in the first location, and/or the first set of one or more visual media items are determined to depict the first location). In some embodiments, the determination that the computer system (e.g., 600) has the first context comprises a determination that the computer system is currently located in the first location. In some embodiments, the determination that the computer system (e.g., 600) has the first context comprises a determination that the computer system was previously located in the first location (e.g., within a threshold period of time (e.g., within the last week, within the last two weeks, or within the last month)). In some embodiments, the determination that the computer system (e.g., 600) has the first context comprises a determination that a user of the computer system has a scheduled trip to the first location (e.g., within a threshold period of time (e.g., in the next week, in the next two weeks, or in the next month)). In some embodiments, the second context pertains to a second location (e.g., a second geographic location, a second country, a second city, and/or a second address) different from the first location; and the second set of one or more visual media items is selected for display within the wake screen user interface based on the second location (e.g., the second set of one or more visual media items were captured in the second location, and/or the first set of one or more visual media items are determined to depict the second location) (e.g., in the top row of FIG. 8C, different media items would be selected if the user and/or computer system 600 was located in a different city). In some embodiments, the determination that the computer system has the second context comprises a determination that the computer system is currently located in the second location. In some embodiments, the determination that the computer system has the second context comprises a determination that the computer system was previously located in the second location (e.g., within a threshold period of time (e.g., within the last week, within the last two weeks, or within the last month)). In some embodiments, the determination that the computer system has the second context comprises a determination that a user of the computer system has a scheduled trip to the second location (e.g., within a threshold period of time (e.g., in the next week, in the next two weeks, or in the next month)). Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the first context pertains to a first respective day of the year (e.g., a first respective birthday, a first respective anniversary, a first respective holiday, the beginning of a first season, and/or other date) (e.g., bottom row of FIG. 8C). In some embodiments, the first set of one or more visual media items is selected for display within the wake screen user interface based on the first respective day of the year (e.g., media items 836-5 through 836-8 in the bottom row of FIG. 8C are selected based on the current day being Independence day) (e.g., the first set of one or more visual media items were captured in the current year and/or in a previous year on the first respective day of the year (e.g., on the first respective holiday, the first respective birthday, and/or the first respective anniversary in the current year and/or in a previous year); and/or the first set of one or more visual media items are determined to depict content, objects, and/or concepts that are associated with the first respective day of the year (e.g., are associated with the first respective holiday, the first respective birthday, the first respective anniversary, and/or the first respective season)).

In some embodiments, the determination that the computer system (e.g., 600) has the first context comprises a determination that a current date (e.g., the current date at a location in which the computer system is located and/or the current date as determined by the computer system) is the first respective day of the year. In some embodiments, the determination that the computer system has the first context comprises a determination that the first respective day of the year is within a threshold duration of time from the current date (e.g., is coming up in the next day, the next week, the next two weeks, or the next month). In some embodiments, the second context pertains to a second respective day of the year (e.g., a second respective birthday, a second respective anniversary, a second respective holiday, the beginning of a second season, and/or other date) different from the first respective day of the year; and the second set of one or more visual media items is selected for display within the wake screen user interface based on the second respective day of the year (e.g., the second set of one or more visual media items were captured in the current year and/or in a previous year on the second respective day of the year (e.g., on the second respective holiday, the second respective birthday, and/or the second respective anniversary in the current year and/or in a previous year); and/or the second set of one or more visual media items are determined to depict content, objects, and/or concepts that are associated with the second respective day of the year (e.g., are associated with the second respective holiday, the second respective birthday, the second respective anniversary, and/or the second respective season)). In some embodiments, the determination that the computer system has the second context comprises a determination that a current date (e.g., the current date at a location in which the computer system is located and/or the current date as determined by the computer system) is the second respective day of the year. In some embodiments, the determination that the computer system has the second context comprises a determination that the second respective day of the year is within a threshold duration of time from the current date (e.g., is coming up in the next day, the next week, the next two weeks, or the next month). Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the first respective day of the year is a current day of the year (e.g., the current date at a location in which the computer system is located and/or the current date as determined by the computer system) (e.g., in some embodiments, media items 836-5 through 836-8 in the bottom row of FIG. 8C are selected based on the current day being Independence Day). In some embodiments, the first set of one or more visual media items is selected for display within the wake screen user interface based on the current day of the year. In some embodiments, the determination that the computer system has the first context comprises a determination that a current date (e.g., the current date at a location in which the computer system is located and/or the current date as determined by the computer system) is the first respective day of the year. In some embodiments, the determination that the computer system has the second context comprises a determination that the current date is the second respective day of the year. Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the first respective day of the year is an upcoming date (e.g., an upcoming date that has not yet passed; and/or an upcoming date that is within a threshold number of days and/or within a threshold duration of time of the current date (e.g., is coming up in the next day, the next week, the next two weeks, or the next month)). In some embodiments, the first set of one or more visual media items is selected for display within the wake screen user interface based on the upcoming date (e.g., in some embodiments, media items 836-5 through 836-8 in the bottom row of FIG. 8C are selected based on Independent Day coming up within a threshold number of days; and/or, in some embodiments, media items 836-17 through 836-20 in the top row of FIG. 8E are selected based on upcoming scheduled travel with friends). In some embodiments, the determination that the computer system has the first context comprises a determination that the first respective day of the year is within a threshold duration of time from the current date (e.g., is coming up in the next day, the next week, the next two weeks, or the next month). In some embodiments, the determination that the computer system has the second context comprises a determination that the second respective day of the year is within a threshold duration of time from the current date (e.g., is coming up in the next day, the next week, the next two weeks, or the next month). Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the first context of the computer system (e.g., 600) pertains to a first set of communications (e.g., top row of FIG. 8D) (e.g., a first set of messages and/or communications received by and/or at the computer system; a first set of messages and/or communications transmitted by a first sender and/or a first group of senders and received by and/or at the computer system; a first set of messages and/or communications transmitted by the computer system; and/or a first set of messages and/or communications transmitted by the computer system to a first set of recipients). In some embodiments, the first set of one or more visual media items is selected for display within the wake screen user interface based on the first set of communications (e.g., the first set of one or more visual media items were transmitted within the first set of communications and/or the first set of messages (e.g., received by the computer system in the first set of communications and/or transmitted by the computer system in the first set of communications)) (e.g., in the top row of FIG. 8D, media items 836-9 through 836-12 are selected based on those media items having been received in recent communications). In some embodiments, the determination that the computer system has the first context comprises a determination that the computer system has received and/or transmitted the first set of communications within a threshold duration of time (e.g., within the last day, within the last week, within the last two weeks, or within the last month). In some embodiments, the second context pertains to a second set of communications (e.g., a second set of messages and/or communications received by and/or at the computer system; a second set of messages and/or communications transmitted by a second sender and/or a second group of senders and received by and/or at the computer system; a second set of messages and/or communications transmitted by the computer system; and/or a second set of messages and/or communications transmitted by the computer system to a second set of recipients) different from the first set of communications; and the first set of one or more visual media items is selected for display within the wake screen user interface based on the second set of communications (e.g., the second set of one or more visual media items were transmitted within the second set of communications and/or the second set of messages (e.g., received by the computer system in the second set of communications and/or transmitted by the computer system in the second set of communications)). In some embodiments, the determination that the computer system has the second context comprises a determination that the computer system has received and/or transmitted the second set of communications within a threshold duration of time (e.g., within the last day, within the last week, within the last two weeks, or within the last month). Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the first context of the computer system (e.g., 600) pertains to a first plurality of media items that were added to a media library associated with the computer system (e.g., a media library that is at least partially stored on the computer system; a media library corresponding to and/or associated with a user account that is logged into the computer system; and/or a media library that is accessible by the computer system) within a threshold duration of time (e.g., within the last day, within the last week, within the last two weeks, or within the last month) (e.g., bottom row of FIG. 8D). In some embodiments, the first set of one or more visual media items is selected for display within the wake screen user interface (e.g., 832) from the first plurality of media items (e.g., based on a determination that the first plurality of media items was added to the media library associated with the computer system within the threshold duration of time) (e.g., media items 836-13 through 836-16 in the bottom row of FIG. 8D selected from recent media items). In some embodiments, the determination that the computer system has the first context comprises a determination that the first plurality of media items were added to the media library associated with the computer system within the threshold duration of time. In some embodiments, the second context pertains to a second plurality of media items that were added to a media library associated with the computer system (e.g., a media library that is at least partially stored on the computer system; a media library corresponding to and/or associated with a user account that is logged into the computer system; and/or a media library that is accessible by the computer system) within the threshold duration of time (e.g., within the last day, within the last week, within the last two weeks, or within the last month); and the second set of one or more visual media items is selected for display within the wake screen user interface from the second plurality of media items (e.g., based on a determination that the second plurality of media items was added to the media library associated with the computer system within the threshold duration of time). In some embodiments, the determination that the computer system has the second context comprises a determination that the second plurality of media items were added to the media library associated with the computer system within the threshold duration of time. Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the first context of the computer system (e.g., 600) pertains to a first group of one or more people (e.g., one or more people that are determined to be within a threshold distance of the computer system and/or one or more people that are determined to have been within a threshold distance of the computer system within a threshold duration of time (e.g., in the last day, in the last week, in the last two weeks, or in the last month)) (e.g., in the top row of FIG. 8E, media items 838-17 through 838-20 are selected for display based on upcoming travel and/or current travel with a specific group of people). In some embodiments, the first set of one or more visual media items is selected for display within the wake screen user interface (e.g., 832) based on the first group of one or more people (e.g., the first set of one or more visual media items are determined to depict at least a subset of the first group of one or more people and/or the first set of one or more visual media items were captured while the computer system was within a threshold distance of at least a subset of the first group of one or more people). In some embodiments, the determination that the computer system has the first context comprises a determination that the computer system is currently within a threshold distance (e.g., within 25 feet, within 50 feet, or within 100 feet) of the first group of one or more people and/or a determination that a user of the computer system is currently engaging with and/or nearby the first group of people. In some embodiments, the determination that the computer system has the first context comprises a determination that the computer system was previously within the threshold distance of the first group of people and/or that a user of the computer system was previously engaging with and/or nearby the first group of people (e.g., within a threshold period of time (e.g., within the last week, within the last two weeks, or within the last month)). In some embodiments, the determination that the computer system has the first context comprises a determination that a user of the computer system has a scheduled outing and/or activity with the first group of people (e.g., within a threshold period of time (e.g., in the next week, in the next two weeks, or in the next month)). In some embodiments, the second context of the computer system pertains to a second group of one or more people (e.g., one or more people that are determined to be within a threshold distance of the computer system and/or one or more people that are determined to have been within a threshold distance of the computer system within a threshold duration of time (e.g., in the last day, in the last week, in the last two weeks, or in the last month)) different from the first group of one or more people; and the second set of one or more visual media items is selected for display within the wake screen user interface based on the second group of one or more people (e.g., the second set of one or more visual media items are determined to depict at least a subset of the second group of one or more people and/or the second set of one or more visual media items were captured while the computer system was within a threshold distance of at least a subset of the second group of one or more people) (e.g., in some embodiments, in the top row of FIG. 8E, computer system 600 would select a different set of visual media items if the user of computer system 600 was traveling with a different group of people). In some embodiments, the determination that the computer system has the second context comprises a determination that the computer system is currently within a threshold distance (e.g., within 25 feet, within 50 feet, or within 100 feet) of the second group of one or more people and/or a determination that a user of the computer system is currently engaging with and/or nearby the second group of people. In some embodiments, the determination that the computer system has the second context comprises a determination that the computer system was previously within the threshold distance of the second group of people and/or that a user of the computer system was previously engaging with and/or nearby the second group of people (e.g., within a threshold period of time (e.g., within the last week, within the last two weeks, or within the last month)). In some embodiments, the determination that the computer system has the second context comprises a determination that a user of the computer system has a scheduled outing and/or activity with the second group of people (e.g., within a threshold period of time (e.g., in the next week, in the next two weeks, or in the next month)). Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the first context of the computer system pertains to a first detected routine of a user of the computer system (e.g., a first detected schedule, a first detected event, a first detected activity, a first detected change in schedule, and/or a first detected change in routing (e.g., the user waking up at a different time that they normally do and/or traveling to a different place than they normally do)) (e.g., bottom row of FIG. 8E). In some embodiments, the first set of one or more visual media items is selected for display within the wake screen user interface based on the first detected routine of the user of the computer system (e.g., the first set of one or more visual media items are determined to depict objects, content, and/or concepts that pertain to the first detected routine of the user of the computer system) (e.g., in the bottom row of FIG. 8E, media items 836-21 through 836-24 are selected based on detected recent events). In some embodiments, the determination that the computer system has the first context comprises a determination that the user is scheduled to attend a first event and/or a first activity and/or perform a first activity within a threshold duration of time (e.g., in the next hour, in the next twelve hours, in the next day, in the next three days, or in the next week). In some embodiments, the second context of the computer system pertains to a second detected routine of the user of the computer system (e.g., a second detected schedule, a second detected event, and/or a second detected activity); and the second set of one or more visual media items is selected for display within the wake screen user interface based on the second detected routine of the user of the computer system (e.g., the second set of one or more visual media items are determined to depict objects, content, and/or concepts that pertain to the second detected routine of the user of the computer system). In some embodiments, the determination that the computer system has the second context comprises a determination that the user is scheduled to attend a second event and/or a second activity and/or perform a second activity within a threshold duration of time (e.g., in the next hour, in the next twelve hours, in the next day, in the next three days, or in the next week). Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the first set of one or more visual media items comprises a first plurality of visual media items (e.g., 836-1 through 836-4 in the top row of FIG. 8C; 836-5 through 836-8 in the bottom row of FIG. 8C; 836-9 through 836-12 in the top row of FIG. 8D; 836-13 through 836-16 in the bottom row of FIG. 8E; 836-17 through 836-20 in the top row of FIG. 8F; and/or 836-21 through 836-24 in the bottom row of FIG. 8F). In some embodiments, the second set of one or more visual media items comprises a second plurality of visual media items different from the first plurality of visual media items. Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, displaying the wake screen user interface (e.g., 832) with the first set of one or more visual media items comprises: displaying, at a first respective time, a first respective visual media item of the first plurality of visual media items within the wake screen user interface (e.g., 836-1 in the top row of FIG. 8C); and displaying, at a second respective time subsequent to the first respective time, a second respective visual media item of the first plurality of visual media items within the wake screen user interface (e.g., in some embodiments, without displaying the first respective visual media item of the first plurality of visual media items within the wake screen user interface) (e.g., 836-2 in the top row of FIG. 8C). In some embodiments, visual media items displayed within the wake screen user interface (e.g., 832) change over time (e.g., automatically and/or without user input). In some embodiments, displaying the wake screen user interface with the second set of one or more visual media items comprises: displaying, at a third respective time, a third respective visual media item of the second set of one or more visual media items within the wake screen user interface (e.g., 836-5 in the bottom row of FIG. 8C); and displaying, at a fourth respective time subsequent to the third respective time, a fourth respective visual media item of the second set of one or more visual media items within the wake screen user interface (e.g., 836-6 in the bottom row of FIG. 8C) (e.g., in some embodiments, without displaying the third respective visual media item of the second set of one or more visual media items within the wake screen user interface). Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, while displaying a first visual media item (e.g., 836-1 in the top row of FIG. 8C) of the first set of one or more visual media items within the wake screen user interface, the computer system (e.g., 600) detects, via the one or more input devices, a wrist raise gesture (e.g., a gesture in which the wrist of the user is moved upwards and/or is moved towards a face of the user) (e.g., 652b). In response to detecting the wrist raise gesture: the computer system ceases display of the first visual media item (e.g., 836-1 in the top row of FIG. 8C); and displays, within the wake screen user interface (e.g., 832), a second visual media item (e.g., 836-2 in the top row of FIG. 8C) of the first set of one or more visual media items different from the first visual media item. In some embodiments, the computer system (e.g., 600) is worn on the wrist of the user. In some embodiments, media items displayed within the wake screen user interface change in response to a wrist raise gesture by a user (e.g., from media item 836-1 to 836-2 to 836-3 to 836-4; and/or from media item 836-5 to 836-6 to 836-7 to 836-8). Changing the visual media item that is presented in the wake screen user interface when a wrist raise gesture is detected presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the computer system (e.g., 600) identifies, at a first time, a first respective set of one or more visual media items (e.g., 836-1 through 836-4 in the top row of FIG. 8C; 836-5 through 836-8 in the bottom row of FIG. 8C; 836-9 through 836-12 in the top row of FIG. 8D; 836-13 through 836-16 in the bottom row of FIG. 8E; 836-17 through 836-20 in the top row of FIG. 8F; and/or 836-21 through 836-24 in the bottom row of FIG. 8F) (e.g., one or more visual media items) for display within the wake screen user interface (e.g., 832) (e.g., selecting the first set of visual media items for display within the wake screen user interface based on a first respective context of the computer system at the first time; receiving the first set of visual media items for display within the wake screen user interface; and/or receiving identification of the first set of visual media items for display within the wake screen user interface). Subsequent to identifying the first respective set of one or more visual media items for display within the wake screen user interface: in accordance with a determination that less than a first threshold time interval (e.g., one day, two days, three days, or a week) has passed since the first time, the computer system (e.g., 600) maintains the first respective set of one or more visual media items as the visual media items selected for display within the wake screen user interface (e.g., 832); and in accordance with a determination that the first threshold time interval has passed since the first time, the computer system ceases use of the first respective set of one or more visual media items as the visual media items selected for display within the wake screen user interface; and selects (e.g., or using) a second respective set of one or more visual media items (e.g., one or more visual media items) different from the first respective set of one or more visual media items for display within the wake screen user interface (e.g., switches from using visual media items 836-1 through 836-4 in the top row of FIG. 8C to using visual media items 836-5 through 836-8 in the bottom row of FIG. 8C). In some embodiments, the media items selected for display within the wake screen user interface (e.g., 832) change at a respective interval (e.g., daily, bi-daily, or weekly). In some embodiments, subsequent to selecting the second respective set of one or more visual media items for display within the wake screen user interface: in accordance with a determination that less than the first threshold time interval (e.g., one day, two days, three days, or a week) has passed since identifying the second respective set of one or more visual media items for display within the wake screen user interface, the computer system (e.g., 600) maintains the second respective set of one or more visual media items as the visual media items selected for display within the wake screen user interface (e.g., 832); and in accordance with a determination that the first threshold time interval has passed since identifying the second respective set of one or more visual media items for display within the wake screen user interface, the computer system: ceases use of the second respective set of one or more visual media items as the visual media items selected for display within the wake screen user interface; and identifies a third respective set of one or more visual media items (e.g., one or more visual media items) different from the second respective set of one or more visual media items for display within the wake screen user interface (e.g., switches from using visual media items 836-5 through 836-8 in the bottom row of FIG. 8C to media items 836-9 through 836-12 in the top row of FIG. 8D). Automatically changing the visual media items that are displayed within the wake screen user interface at a respective interval (and, in some embodiments, based on the context of the computer system) allows for performance of these operations without user input. Furthermore, automatically surfacing different visual media items for a user at different times presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the first set of one or more visual media items (e.g., 836-1 through 836-4 in the top row of FIG. 8C; 836-5 through 836-8 in the bottom row of FIG. 8C; 836-9 through 836-12 in the top row of FIG. 8D; 836-13 through 836-16 in the bottom row of FIG. 8E; 836-17 through 836-20 in the top row of FIG. 8F; and/or 836-21 through 836-24 in the bottom row of FIG. 8F) includes a first visual media item of a first type (e.g., a live photo and/or a multi-frame photo), wherein: the first visual media item of the first type comprises a plurality of frames; the first visual media item of the first type is represented by a static representation (e.g., a still and/or an unmoving representation) and an animated representation (e.g., a moving and/or changing representation) different from the static representation when a viewing setting of the first visual media item of the first type is in an enabled state; and the first visual media item of the first type is represented by the static representation and not the animated representation when the viewing setting of the first visual media item of the first type is in a disabled state. In some embodiments, when the viewing setting of the first visual media item of the first type is in the enabled state, the first visual media item of the first type transitions from the static representation to the animated representation when certain criteria are met (e.g., when the first visual media item of the first type is selected, when a user input on the first visual media item of the first type is detected, and/or when the first visual media item of the first type scrolls onto a display and/or a certain portion of a display). In some embodiments, one or more of media items 836-1 through 836-25 is a live photo and/or a visual media item of the first type that has a static representation and an animated representation. In some embodiments, when the viewing setting of the first visual media item of the first type is in the disabled state, the first visual media item of the first type is represented by the static representation, and not the animated representation, even when the criteria are met (e.g., the first visual media item of the first type stays in a static and/or unmoving state even when the criteria are met). In some embodiments, the second set of one or more visual media items includes a second visual media item of the first type. In some embodiments, visual media items of the first type comprise a plurality of frames; visual media items of the first type are represented by a respective static representation (e.g., a still and/or an unmoving representation) and a respective animated representation (e.g., a moving and/or changing representation) different from the respective static representation when a viewing setting is in an enabled state; and visual media items of the first type are represented by a respective static representation and not a respective animated representation when the viewing setting is in a disabled state. In some embodiments, when the viewing setting is in the enabled state, visual media items of the first type transition from a respective static representation to a respective animated representation when certain criteria are met (e.g., when the respective visual media item of the first type is selected, when a user input on the respective visual media item of the first type is detected, and/or when the respective visual media item of the first type scrolls onto a display and/or a certain portion of a display). In some embodiments, when the viewing setting is in the disabled state, visual media items of the first type are represented by their respective static representation, and not their respective animated representation, even when the criteria are met (e.g., visual media items of the first type stay in a static and/or unmoving state even when the criteria are met). Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the computer system (e.g., 600) displays, via the one or more display generation components (e.g., 602) and within the wake screen user interface (e.g., 832), the first visual media item of the first type, including displaying the animated representation of the first visual media item of the first type within the wake screen user interface (e.g., in some embodiments, visual media item 836-1 is a live photo and/or a media item of the first type, and the animated representation of visual media item 836-1 is displayed within photos watch face 832). In some embodiments, visual media items of the first type are displayed within the wake screen user interface by displaying the respective animated representation of the respective visual media item of the first type. Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Doing so also enhances the operability of the system and makes the user-system interface more efficient (e.g., by automatically surfacing content items to the user without the need for additional user input), which reduces power usage and improves battery life of the device by enabling the user to use the system more quickly and efficiently.

In some embodiments, the computer system (e.g., 600) detects, via the one or more input devices, a second set of one or more user inputs (e.g., one or more touch inputs, one or more hardware control inputs, one or more button presses, one or more gesture inputs, and/or one or more spoken inputs) corresponding to a user request to display the wake screen user interface (e.g., 832) (e.g., a touch input on display 602, a press input of crown 604a, and/or a wrist raise gesture). In response to detecting the second set of one or more user input corresponding to a user request to display the wake screen user interface, the computer system displays, via the one or more display generation components, the wake screen user interface (e.g., 832), including: in accordance with a determination that a first setting of the wake screen user interface is enabled (e.g., context option 824d and/or contextual option 830b is selected), displaying, via the one or more display generation components, the wake screen user interface with a first respective set of one or more visual media items that are automatically selected (e.g., without user input and/or without user input selecting and/or identifying specific visual media items) based on a first respective context of the computer system (e.g., FIGS. 8C-8F); and in accordance with a determination that a second setting (e.g., album option 824a, favorites option 824b, photos options 824c, album option 830a, and/or photos option 830c) of the wake screen user interface different from the first setting is enabled, displaying, via the one or more display generation components, the wake screen user interface with a first user-selected set of one or more visual media items, wherein the first user-selected set of one or more visual media items includes one or more visual media items that are manually selected by a user and are not automatically selected based on a detected context of the computer system. Automatically changing the visual media items that are displayed within the wake screen user interface based on the context of the computer system allows for performance of these operations without user input. Furthermore, automatically surfacing different visual media items for a user based on the context of the computer system presents the user with different sets of visual media items within media libraries that can often grow very large and difficult and/or intimidating to navigate. Additionally, allowing the user to select whether they would like visual media items in the wake screen user interface to be automatically selected or manually selected enhances the operability of the system and makes the user-system interface more efficient, which reduces power usage and improves battery life of the device by enabling the user to use the system more quickly and efficiently.

In some embodiments, the wake screen user interface (e.g., 832) includes a first indication of a respective time (e.g., 834) (e.g., an analog and/or digital indication of a current time, past time, or future time). In some embodiments, the computer system (e.g., 600) displays, via the one or more display generation components (e.g., 602), the first indication of the respective time (e.g., 834) within the wake screen user interface (e.g., 832) with a first set of visual characteristics (e.g., a first brightness, a first coloring, a first reflectivity, a first amount of simulated reflection, a first amount of simulated refraction, and/or a first opacity) (e.g., 834 in FIG. 8H). While displaying the first indication of the respective time (e.g., 834) within the wake screen user interface (e.g., 832) with the first set of visual characteristics, the computer system (e.g., 600) detects, via the one or more input devices, wrist movement (e.g., 844) by a user of the computer system. In some embodiments, the computer system (e.g., 600) is worn on a first wrist of the user of the computer system, and detecting the wrist movement by the user of the computer system comprises detecting movement of the first wrist of the user of the computer system and/or detecting movement of the computer system while it is worn on the first wrist of the user of the computer system. In response to detecting the wrist movement by the user of the computer system, the computer system displays, via the one or more display generation components (e.g., 602), the first indication of the respective time within the wake screen user interface with a second set of visual characteristics (e.g., a second brightness, a second coloring, a second reflectivity, a second amount of simulated reflection, a second amount of simulated refraction, and/or a second opacity) different from the first set of visual characteristics (e.g., 834 in FIG. 8I). In some embodiments, the first indication of the respective time changes visually in response to wrist movement. Displaying the first indication of the respective time changing visually in response to wrist movement provides the user with visual feedback about the state of the system (e.g., that the system has detected the wrist movement by the user), thereby providing improved visual feedback.

In some embodiments, displaying the first indication of the respective time (e.g., 834) within the wake screen user interface (e.g., 832) with the first set of visual characteristics comprises displaying the indication of the respective time with a first set of simulated lighting effects (e.g., a first amount of simulated reflection, a first number of simulated reflections, a first placement of simulated reflections, a first amount of simulated refraction, a first number of simulated refractions, and/or a first placement of simulated refractions) applied to the first indication of the respective time (e.g., 834 in FIG. 8H); and displaying the first indication of the respective time within the wake screen user interface with the second set of visual characteristics comprises displaying the indication of the respective time with a second set of simulated lighting effects (e.g., a second amount of simulated reflection, a second number of simulated reflections, a second placement of simulated reflections, a second amount of simulated refraction, a second number of simulated refractions, and/or a second placement of simulated refractions) applied to the first indication of the respective time (e.g., 834 in FIG. 8I). Displaying the first indication of the respective time changing visually in response to wrist movement provides the user with visual feedback about the state of the system (e.g., that the system has detected the wrist movement by the user), thereby providing improved visual feedback.

In some embodiments, the computer system (e.g., 600) displays, via the one or more display generation components, within the wake screen user interface (e.g., 832), a first visual media item (e.g., a first photo, a first video, and/or a first multi-frame image) (e.g., one or more of 836-1 through 836-25); and displays, via the one or more display generation components, concurrently with the first visual media item (e.g. 836-1) within the wake screen user interface (e.g., 832), a first caption (e.g., one or more of 838-1 through 838-25) corresponding to the first visual media item, wherein the first caption provides an indication of selection criteria that were used to select the first visual media item for display within the wake screen user interface. In some embodiments the first caption indicates that the first visual media item was selected based on a geographic location associated with the first visual media item (e.g., 838-1). In some embodiments the first caption indicates that the first visual media item was selected based on one or more people depicted within and/or associated with the first visual media item (e.g., in some embodiments, caption 838-17 identifies specific people depicted in visual media item 836-17). In some embodiments the first caption indicates that the first visual media item was selected based on a day of the year, a holiday, an anniversary, and/or an event associated with the first visual media item (e.g., 838-5 and/or, in some embodiments, caption 838-21 identifies a specific event). In some embodiments, the first caption indicates that the first visual media item was selected based on one or more detected schedules, events, and/or routines (e.g., of a user of the computer system). In some embodiments, the first caption indicates that the first visual media item was selected based on one or more communications and/or messages received at and/or transmitted by the computer system (e.g., 838-9). Displaying a first caption that provides an indication of selection criteria that were used to select the first visual media item for display within the wake screen user interface provides the user with visual feedback about a state of the system (e.g., visual feedback about the criteria being used to select media items for display within the wake screen user interface), thereby improving visual feedback. Furthermore, doing so also enhances the operability of the system and makes the user-system interface more efficient (e.g., by providing the user with information about how the system is operating), which reduces power usage and improves battery life of the device by enabling the user to use the system more quickly and efficiently.

In some embodiments, the computer system displays, via the one or more display generation components, the first visual media item (e.g., 836-25 in FIG. 8F) within the wake screen user interface (e.g., 832) without displaying the first caption (e.g., FIG. 8F). While displaying the first visual media item within the wake screen user interface without displaying the first caption, the computer system detects, via the one or more input devices, a first user input (e.g., 840) (e.g., a tap input, a touch input, a gesture input, a hardware control input, a button press, and/or a spoken input) directed to the wake screen user interface (e.g., a user input on the wake screen user interface and/or a user input directed to an element of the wake screen user interface). In response to detecting the first user input, the computer system displays, via the one or more display generation components, the first caption (e.g., 838-25) within the wake screen user interface (e.g., 832) while maintaining display of the first visual media item (e.g., 836-25) within the wake screen user interface (e.g., FIG. 8G). In some embodiments, the caption associated with a visual media item is displayed in response to a user input directed to the wake screen user interface. Displaying a first caption that provides an indication of selection criteria that were used to select the first visual media item for display within the wake screen user interface provides the user with visual feedback about a state of the system (e.g., visual feedback about the criteria being used to select media items for display within the wake screen user interface), thereby improving visual feedback. Furthermore, doing so also enhances the operability of the system and makes the user-system interface more efficient (e.g., by providing the user with information about how the system is operating), which reduces power usage and improves battery life of the device by enabling the user to use the system more quickly and efficiently.

In some embodiments, while displaying the first visual media item (e.g., 836-25) within the wake screen user interface (e.g., 832), the computer system (e.g., 600) detects, via the one or more input devices, a second user input (e.g., 840 and/or 841) (e.g., a tap input, a touch input, a gesture input, a hardware control input, a button press, and/or a spoken input) directed to the wake screen user interface (e.g., a user input on the wake screen user interface and/or a user input directed to an element of the wake screen user interface). In response to detecting the second user input: in accordance with a determination that the first visual media item (e.g., 836-25) was displayed within the wake screen user interface (e.g., 832) without the first caption (e.g., 838-25) when the second user input was detected (e.g., user input 840 in FIG. 8F), the computer system displays, via the one or more display generation components, the first caption (e.g., 838-25) within the wake screen user interface while maintaining display of the first visual media item within the wake screen user interface (e.g., FIG. 8G); and in accordance with a determination that the first visual media item (e.g., 836-25) was displayed with the first caption (e.g., 838-25) within the wake screen user interface when the second user input was detected (e.g., user input 841 in FIG. 8G), the computer system: ceases display of the first visual media item (e.g., 836-25) and the first caption (e.g., 838-25) within the wake screen user interface; and displays, via the one or more display generation components, within the wake screen user interface, a second visual media item (e.g., 836-2) different from the first visual media item (e.g., 836-25) (e.g., in some embodiments, without displaying a second caption (e.g., 838-2) associated with and/or corresponding to the second visual media item (e.g., 836-2)). Displaying a first caption that provides an indication of selection criteria that were used to select the first visual media item for display within the wake screen user interface provides the user with visual feedback about a state of the system (e.g., visual feedback about the criteria being used to select media items for display within the wake screen user interface), thereby improving visual feedback. Furthermore, doing so also enhances the operability of the system and makes the user-system interface more efficient (e.g., by providing the user with information about how the system is operating), which reduces power usage and improves battery life of the device by enabling the user to use the system more quickly and efficiently.

Note that details of the processes described above with respect to method 900 (e.g., FIG. 9) are also applicable in an analogous manner to the methods described above and/or below. For example, methods 700, 1100, 1300, 1350, 1500, and/or 1700 optionally include one or more of the characteristics of the various methods described above with reference to method 900. For example, in various embodiments, the user interface object of the first type recited in method 1300 and/or the first complication recited in method 1500 can be displayed within the time user interface recited in method 700, the wake screen user interface recited in method 900, the time user interface recited in method 1350, and/or the time user interface recited in method 1700. In another example, in various embodiments, the first user interface recited in method 1100 can include the time user interface recited in method 700, the wake screen user interface recited in method 900, the user interface object of the first type recited in method 1300, the time user interface recited in method 1350, the first complication recited in method 1500, and/or the time user interface recited in method 1700. For brevity, these details are not repeated below.

FIGS. 10A-10X illustrate exemplary user interfaces for modifying user interfaces, in accordance with some embodiments. The user interfaces in these figures are used to illustrate the processes described below, including the processes in FIG. 11.

FIG. 10A depicts computer system 600, which is a smart watch that includes touch-sensitive display 602, crown 604a, and button 604b. In the depicted embodiments, crown 604a is rotatable (e.g., in a clockwise direction and a counter-clockwise direction) and depressible, such that a user is able to use crown 604a to provide rotational input and depression (e.g., press) inputs. FIG. 8A also depicts computer system 800, which is a smart phone that includes touch-sensitive display 802 and buttons 804a-804c. In some embodiments, computer system 800 is associated with computer system 600. For example, in some embodiments, computer system 800 and computer system 600 are associated with the same user and/or same owner, and/or computer system 800 and computer system 600 are logged into the same user account.

At FIG. 10A, computer system 600 displays time user interface 1002, which includes indication of time 1002a and four corner complications. In FIG. 10A, computer system 600 is operating in a dark mode and/or a night mode of operation in which the background of time user interface 1002 is darkened. In FIG. 10A, computer system 800 displays, via touch-sensitive display 802, home screen user interface 1004, which includes a plurality of application icons that are selectable to cause computer system 800 to open a corresponding application. At FIG. 10A, user 1000 provides spoken input 1006a (e.g., “Turn off night mode.”). In various embodiments, computer system 600 detects spoken input 1006a (e.g., via one or more microphones of computer system 600) and/or computer system 800 detects spoken input 1006a (e.g., via one or more microphones of computer system 800).

In some embodiments, computer system 600 and/or computer system 800 use one or more machine learning models to interpret spoken input 1006a and determine one or more actions that are responsive to spoken input 1006a (e.g., turning off night mode of computer system 600). In some embodiments, in FIG. 10B, in response to detecting spoken input 1006a, computer system 600 turns off the night mode of operation (e.g., transitions from the night mode of operation to a day mode of operation) and displays time user interface 1002 with a brighter background. In some embodiments, in FIG. 10B, in response to detecting spoken input 1006a, computer system 800 communicates with computer system 600 and causes computer system 600 to turn off the night mode of operation (e.g., transition from the night mode of operation to a day mode of operation) and/or display time user interface 1002 with a brighter background. Additionally, in response to detecting spoken input 1006a, computer system 800 displays notification 1008a indicating that the night mode of computer system 600 has been turned off. Notification 1008a includes a representation of computer system 600 that shows computer system 600 with the night mode turned off. In some embodiments, computer system 600 also displays a notification indicating one or more changes that have been made to user interface 1002. At FIG. 10B, user 1000 provides spoken input 1006b (e.g., “I want a character watch face.”). In various embodiments, computer system 600 detects spoken input 1006b (e.g., via one or more microphones of computer system 600) and/or computer system 800 detects spoken input 1006b (e.g., via one or more microphones of computer system 800).

In some embodiments, computer system 600 and/or computer system 800 use one or more machine learning models to interpret spoken input 1006b and/or to determine one or more actions that are responsive to spoken input 1006b. In some embodiments, in FIG. 10C, in response to detecting spoken input 1006b, computer system 600 displays user interface 1012, which presents a suggestion of a character watch face 1012a. In some embodiments, character watch face 1012a is generated (e.g., by computer system 600, computer system 800, and/or one or more separate and/or remote computer systems) in response to spoken input 1006b using one or more generative AI processes. User interface 1012 also includes options 1012a-1, 1012b. Option 1012a-1, when selected, causes computer system 600 to use character watch face 1012a as the watch face for computer system 600. Option 1012b, when selected (e.g., user input 1014c), causes computer system 600 to display a new character watch face suggestion. In some embodiments, the new character watch face suggestion is generated in response to user input 1014c and spoken input 1006b using one or more generative AI processes.

In some embodiments, in FIG. 10C, in response to detecting spoken input 1006b, computer system 800 displays user interface 1008b, which presents a suggestion of a character watch face 1010. In some embodiments, character watch face 1010 is generated (e.g., by computer system 600, computer system 800, and/or one or more separate and/or remote computer systems) in response to spoken input 1006b using one or more generative AI processes. User interface 1008b also includes options 1008b-1, 1008b-2. Option 1008b-2, when selected, causes computer system 800 to communicate with computer system 600 to cause computer system 600 to use character watch face 1010 as the watch face for computer system 600. Option 1008b-1, when selected (e.g., user input 1014a), causes computer system 800 to display a new character watch face suggestion. In some embodiments, the new character watch face suggestion is generated in response to user input 1014a and spoken input 1006b using one or more generative AI processes.

At FIG. 10C, computer system 600 detects user input 1014d (e.g., a tap input) corresponding to selection of option 1012a-1. At FIG. 10C, computer system 800 detects user input 1014b (e.g., a tap input) corresponding to selection of option 1008b-2.

In some embodiments, in FIG. 10D, in response to detecting user input 1014d, computer system 600 replaces time user interface 1002 with character watch face 1016, which includes indication of time 1016a and media item 1016b. In some embodiments, in FIG. 10D in response to detecting user input 1014b, computer system 800 causes computer system 600 to replace time user interface 1002 with character watch face 1016, and computer system 800 displays notification 1008c, which indicates that the watch face for computer system 600 has been updated to character watch face 1016. In some embodiments, computer system 600 also displays a notification that the watch face for computer system 600 has been updated to character watch face 1016. At FIG. 10D, user 1000 provides spoken input 1006c (e.g., “Change my watch face to the fitness watch face”). In various embodiments, computer system 600 detects spoken input 1006c (e.g., via one or more microphones of computer system 600) and/or computer system 800 detects spoken input 1006c (e.g., via one or more microphones of computer system 800).

In some embodiments, computer system 600 and/or computer system 800 use one or more machine learning models to interpret spoken input 1006c and/or to determine one or more actions that are responsive to spoken input 1006c. In some embodiments, in FIG. 10E, in response to detecting spoken input 1006c, computer system 600 determines that there are multiple watch faces that fit the criteria “fitness watch face.” In accordance with the determination that there are multiple watch faces that are responsive to spoken input 1006c, computer system 600 displays user interface 1020. User interface 1020 asks the user to choose from multiple watch faces that are responsive to spoken input 1006c, including a first watch face represented by representation 1020a and a second watch face represented by representation 1020b. Representation 1020a is displayed with option 1020a-1 which, when selected (e.g., user input 1022c), causes computer system 600 to replace character watch face 1016 with a first fitness watch face that is represented by representation 1020a. Representation 1020b is displayed with option 1020b-1 which, when selected (e.g., user input 1022d), causes computer system 600 to replace character watch face 1016 with a second fitness watch face that is represented by representation 1020b.

In some embodiments, in FIG. 10E, in response to detecting spoken input 1006c, computer system 800 determines that there are multiple watch faces that fit the criteria “fitness watch face.” In accordance with the determination that there are multiple watch faces that are responsive to spoken input 1006c, computer system 800 displays user interface 1018. User interface 1018 asks the user to choose from multiple watch faces that are responsive to spoken input 1006c, including a first watch face represented by representation 1018a and a second watch face represented by representation 1018b. Representation 1018a is displayed with option 1018a-1 which, when selected (e.g., user input 1022a), causes computer system 800 to communicate with computer system 600 to cause computer system 600 to replace character watch face 1016 with a first fitness watch face that is represented by representation 1018a. Representation 1018b is displayed with option 1018b-1 which, when selected (e.g., user input 1022b), causes computer system 800 to communicate with computer system 600 to cause computer system 600 to replace character watch face 1016 with a second fitness watch face that is represented by representation 1020b.

FIG. 10E depicts various example scenarios in which computer system 600 and/or computer system 800 detect various user inputs, including: a first scenario in which computer system 600 detects user input 1022c (e.g., a tap input) corresponding to selection of option 1020a-1; a second scenario in which computer system 600 detects user input 1022d (e.g., a tap input) corresponding to selection of option 1020b-1; a third scenario in which computer system 800 detects user input 1022a (e.g., a tap input) corresponding to selection of option 1018a-1; and a fourth scenario in which computer system 800 detects user input 1022b (e.g., a tap input) corresponding to selection of option 1018b-1. Each of these scenarios and user inputs will be discussed in greater detail below.

In various embodiments, in FIG. 10F, in response to detecting user input 1022c, computer system 600 replaces character watch face 1016 with activity analog watch face 1024, and displays activity analog watch face 1024. Activity analog watch face 1024 includes analog indication of time 1024a, physical activity metrics 1024b, complication 1024c, and complication 1024d. In various embodiments, in FIG. 10F, in response to detecting user input 1022a, computer system 800 communicates with computer system 600, causes computer system 600 to replace character watch face 1016 with activity analog watch face 1024, and displays notification 1008d-1, which indicates that the watch face of computer system 600 has been changed to activity analog watch face 1024. In some embodiments, computer system 600 also displays a notification indicating that the watch face of computer system 600 has been changed to activity analog watch face 1024.

In various embodiments, in FIG. 10G, in response to detecting user input 1022d, computer system 600 replaces character watch face 1016 with activity digital watch face 1026, and displays activity digital watch face 1026. Activity digital watch face 1026 includes digital indication of time 1026a, physical activity metrics 1026b, complication 1026c, complication 1026d, and complication 1026e. In various embodiments, in FIG. 10G, in response to detecting user input 1022b, computer system 800 communicates with computer system 600, causes computer system 600 to replace character watch face 1016 with activity digital watch face 1026, and displays notification 1008d-2, which indicates that the watch face of computer system 600 has been changed to activity digital watch face 1026. In some embodiments, computer system 600 also displays a notification indicating that the watch face of computer system 600 has been changed to activity digital watch face 1026. At FIG. 10G, user 1000 provides spoken input 1006d (e.g., “Change the top left complication to weather”). In various embodiments, computer system 600 detects spoken input 1006d (e.g., via one or more microphones of computer system 600) and/or computer system 800 detects spoken input 1006d (e.g., via one or more microphones of computer system 800).

In some embodiments, computer system 600 and/or computer system 800 use one or more machine learning models to interpret spoken input 1006d and/or to determine one or more actions that are responsive to spoken input 1006d. In some embodiments, in FIG. 10H, in response to detecting spoken input 1006d, computer system 600 determines that there are multiple complications that are responsive to spoken input 1006d (e.g., multiple complications that fit the criteria “weather”). In accordance with the determination that there are multiple complications that are responsive to spoken input 1006d, computer system 600 displays user interface 1030, which presents multiple complication options that are responsive to spoken input 1006d, including air quality complication option 1030a and conditions complication option 1030b.

In some embodiments, in FIG. 10H, in response to detecting spoken input 1006d, computer system 800 determines that there are multiple complications that are responsive to spoken input 1006d (e.g., multiple complications that fit the criteria “weather”). In accordance with the determination that there are multiple complications that are responsive to spoken input 1006d, computer system 800 displays user interface 1028, which presents multiple complication options that are responsive to spoken input 1006d, including air quality complication option 1028a, conditions complication option 1028b, humidity complication option 1028c, rain complication option 1028d, temperature complication option 1028e, UV index complication option 1028f, and wind complication option 1028g.

FIG. 10H depicts various example scenarios in which computer system 600 and/or computer system 800 detect various user inputs, including: a first scenario in which computer system 600 detects user input 1032c (e.g., a tap input) corresponding to selection of option 1030a; a second scenario in which computer system 600 detects user input 1032d (e.g., a tap input) corresponding to selection of option 1030b; a third scenario in which computer system 800 detects user input 1032a (e.g., a tap input) corresponding to selection of option 1028a; and a fourth scenario in which computer system 800 detects user input 1032b (e.g., a tap input) corresponding to selection of option 1028b. Each of these scenarios and user inputs will be discussed in greater detail below.

In various embodiments, in FIG. 10I, in response to detecting user input 1032c, computer system 600 replaces complication 1026c (e.g., a heart rate complication) with air quality complication 1026f. In various embodiments, in FIG. 10I, in response to detecting user input 1032a, computer system 800 communicates with computer system 600, causes computer system 600 to replace complication 1026c with air quality complication 1026f, and displays notification 1008e-1, which indicates that the complications of computer system 600 have been updated to include air quality complication 1026f. In some embodiments, computer system 600 also displays a notification indicating that complications have been updated to include air quality complication 1026f.

In various embodiments, in FIG. 10J, in response to detecting user input 1032d, computer system 600 replaces complication 1026c (e.g., a heart rate complication) with conditions complication 1026g (e.g., a complication that indicates a current weather condition). In various embodiments, in FIG. 10J, in response to detecting user input 1032b, computer system 800 communicates with computer system 600, causes computer system 600 to replace complication 1026c with conditions complication 1026g, and displays notification 1008e-2, which indicates that the complications of computer system 600 have been updated to include conditions complication 1026g. In some embodiments, computer system 600 also displays a notification indicating that complications have been updated to include conditions complication 1026g. At FIG. 10J, user 1000 provides spoken input 1006e (e.g., “Change my bottom complication to the UV index complication”). In various embodiments, computer system 600 detects spoken input 1006e (e.g., via one or more microphones of computer system 600) and/or computer system 800 detects spoken input 1006e (e.g., via one or more microphones of computer system 800).

In some embodiments, computer system 600 and/or computer system 800 use one or more machine learning models to interpret spoken input 1006e and/or to determine one or more actions that are responsive to spoken input 1006e. In some embodiments, in FIG. 10I, in response to detecting spoken input 1006e, computer system 600 replaces complication 1026e (e.g., a heart rate complication) with UV index complication 1026i. In some embodiments, in FIG. 10I, in response to detecting spoken input 1006e, computer system 800 communicates with computer system 600, causes computer system 600 to replace complication 1026e with UV index complication 1026i, and displays notification 1008f, which indicates that the complications of computer system 600 have been updated to include UV index complication 1026i. In some embodiments, computer system 600 also displays a notification indicating that complications have been updated to include UV index complication 1026i.

The various embodiments described above have described example embodiments and/or scenarios in which computer system 600 and/or computer system 800 automatically perform the tasks requested by user 1000 via spoken inputs. In some embodiments, rather than performing and/or completing the tasks requested by user 1000 via spoken inputs, computer system 600 and/or computer system 800 provide and/or output instructions so that the user is able to perform the requested operations themselves. Example embodiments are depicted in FIGS. 10L-100, described in greater detail below.

At FIG. 10L, in response to detecting spoken input 1006e in FIG. 10J, computer system 600 displays user interface 1038. User interface 1038 includes various options for modifying user interface 1026, including: option 1038a which, when selected, causes computer system 600 to initiate a process for replacing complication 1026d; option 1038b which, when selected, causes computer system 600 to initiate a process for replacing complication 1026g; and option 1038c which, when selected, causes computer system 600 to initiate a process for replacing complication 1026e. In response to detecting spoken input 1006e and/or in accordance with a determination that spoken input 1006e includes a request to replace complication 1026e, computer system 600 displays indication 1036b, which instructs the user to select option 1038c and/or indicates to the user that the user should select option 1038c in order to carry out the requested action. At FIG. 10L, computer system 600 detects user input 1042b (e.g., a tap input) corresponding to selection of option 1038c.

At FIG. 10L, in response to detecting spoken input 1006e in FIG. 10J, computer system 800 displays user interface 1034. User interface 1034 includes preview 1034a which provides a preview of user interface 1026 of computer system 600, and also includes various options for modifying user interface 1026 of computer system 600, including: color options 1036b for modifying one or more colors of user interface 1026; option 1034c-1 which, when selected, causes computer system 800 to initiate a process for replacing complication 1026g of user interface 1026; option 1034c-2 which, when selected, causes computer system 800 to initiate a process for replacing complication 1026d of user interface 1026; option 1034c-3 which, when selected, causes computer system 800 to initiate a process for replacing complication 1026e of user interface 1026; option 1034d which, when selected, causes computer system 800 to communicate with computer system 600 to either enable or disable display of seconds in user interface 1026; and option 1034e which, when selected, causes computer system 800 to communicate with computer system 600 to modify user interface 1026 based on selections made in user interface 1034. In response to detecting spoken input 1006e and/or in accordance with a determination that spoken input 1006e includes a request to replace complication 1026e, computer system 800 displays indication 1036a, which instructs the user to select option 1034c-3 and/or indicates to the user that the user should select option 1034c-3 in order to carry out the requested action. At FIG. 10L, computer system 600 detects user input 1042a (e.g., a tap input) corresponding to selection of option 1034c-3.

At FIG. 10M, in response to detecting user input 1042b, computer system 600 displays user interface 1048. User interface 1048 includes a plurality of complications options that are selectable to replace complication 1026e, including option 1048a (e.g., an air quality complication) and option 1048b (e.g., a conditions complication). In response to spoken input 1006e and/or in accordance with a determination that spoken input 1006e includes a request to replace complication 1026e with a UV index complication, and that the UV index complication is lower down in user interface 1048, computer system 600 displays instruction 1046b, which instructs the user to scroll down. At FIG. 10M, computer system 600 detects user input 1050b, which is an upward swipe user input (e.g., a user request to scroll down in user interface 1048).

At FIG. 10M, in response to detecting user input 1042a, computer system 800 displays user interface 1044. User interface 1044 includes a plurality of complications options that are selectable to replace complication 1026e of computer system 600, including option 1044a (e.g., an option to display no complication as the bottom complication of user interface 1026); option 1044b (e.g., a rings complication); option 1044c (e.g., a timeline complication); option 1044d (e.g., an alarms complication); option 1044e (e.g., a moon complication); option 1044f (e.g., a calendar complication); and option 1044g (e.g., a schedule complication). In response to spoken input 1006e and/or in accordance with a determination that spoken input 1006e includes a request to replace complication 1026e with a UV index complication, and that the UV index complication is lower down in user interface 1044, computer system 800 displays instruction 1046a, which instructs the user to scroll down. At FIG. 10M, computer system 800 detects user input 1050a, which is an upward swipe user input (e.g., a user request to scroll down in user interface 1044).

At FIG. 10N, in response to detecting user input 1042b, computer system 600 scrolls user interface 1048 to reveal additional complication options 1048y, 1048z. In response to spoken input 1006e and/or in accordance with a determination that spoken input 1006e includes a request to replace complication 1026e with a UV index complication and that the UV index complication is represented by option 1048y, computer system 600 displays indication 1052b, which instructs the user to select option 1048y. At FIG. 10N, computer system 600 detects user input 1054b (e.g., a tap input) corresponding to selection of option 1048y.

At FIG. 10N, in response to detecting user input 1042a, computer system 800 scrolls user interface 1044 to reveal additional complication options 1044t-1044z. In response to spoken input 1006e and/or in accordance with a determination that spoken input 1006e includes a request to replace complication 1026e with a UV index complication and that the UV index complication is represented by option 1044y, computer system 800 displays indication 1052a, which instructs the user to select option 1044y. At FIG. 10N, computer system 800 detects user input 1054a (e.g., a tap input) corresponding to selection of option 1044y.

In various embodiments, in FIG. 10O, in response to detecting user input 1054b, computer system 600 replaces complication 1026e with UV index complication 1026i. In various embodiments, in FIG. 10O, in response to detecting user input 1054a, computer system 800 communicates with computer system 600, causes computer system 600 to replace complication 1026e with UV index complication 1026i, and displays notification 1008f, which indicates that the complications of computer system 600 have been updated to include UV index complication 1026i.

At FIG. 10O, user 1000 provides spoken input 1006f (e.g., “Change my watch face color to red”). In various embodiments, computer system 600 detects spoken input 1006f (e.g., via one or more microphones of computer system 600) and/or computer system 800 detects spoken input 1006f (e.g., via one or more microphones of computer system 800).

In some embodiments, computer system 600 and/or computer system 800 use one or more machine learning models to interpret spoken input 1006f and/or to determine one or more actions that are responsive to spoken input 1006f. At FIG. 10P, in response to detecting spoken input 1006f, computer system 600 displays user interface 1058. User interface 1058 includes preview 1060 of user interface 1026, as well as various options for modifying user interface 1026, including: option 1058a which, when selected, causes computer system 600 to display a user interface for modifying one or more style options for user interface 1026; option 1058b which, when selected, causes computer system 600 to display user interface 1058; option 1058c which, when selected, causes computer system 600 to display a user interface for modifying complications of user interface 1026; and color options 1062 which allow the user to select a color for user interface 1026 (e.g., a color for the background of user interface 1026 or for text within user interface 1026). Color options 1062 include yellow color option 1062b, which is a currently selected color (e.g., as indicated by text indication 1063 and a white circle surrounding yellow color option 1062b) and red color option 1062a. In response to detecting spoken input 1006f and/or in accordance with a determination that spoken input 1006f includes a request to change the color of user interface 1026 to red, computer system 600 displays indication 1056b, which directs the user to red color option 1062a. At FIG. 10P, computer system 600 detects user input 1064b, which includes rotation of crown 604a.

At FIG. 10P, in response to detecting spoken input 1006f, computer system 800 displays user interface 1034, various features of which were described above. As mentioned above, user interface 1034 includes preview 1034a, and also includes various options for modifying user interface 1026 of computer system 600, including: color options 1034b for modifying one or more colors of user interface 1026; option 1034c-1 which, when selected, causes computer system 800 to initiate a process for replacing a top left complication of user interface 1026; option 1034c-2 which, when selected, causes computer system 800 to initiate a process for replacing a top right complication of user interface 1026; option 1034c-3 which, when selected, causes computer system 800 to initiate a process for replacing a bottom complication of user interface 1026; option 1034d which, when selected, causes computer system 800 to communicate with computer system 600 to either enable or disable display of seconds in user interface 1026; and option 1034e which, when selected, causes computer system 800 to communicate with computer system 600 to modify user interface 1026 based on selections made in user interface 1034. In FIG. 10P, color options 1034b include yellow color option 1034b-4 (e.g., a currently selected color option, as indicated by the circle surrounding yellow color option 1034b-4); green color option 1034b-3; orange color option 1034b-2; and red color option 1034b-1. In response to detecting spoken input 1006f and/or in accordance with a determination that spoken input 1006f includes a request to change the color of user interface 1026 to red, computer system 800 displays indication 1056a, which directs the user to red color option 1034b-1. At FIG. 10P, computer system 600 detects user input 1064a (e.g., a tap input) corresponding to selection of red color option 1036b-1.

At FIG. 10Q, in response to detecting user input 1064b, computer system 600 displays scrolling of color options 1062 and now shows red color option 1062a as a currently selected color option (e.g., as indicated by the white circle surrounding red color option 1062a and text indication 1063). Additionally, at FIG. 10Q, in accordance with a determination that red color option 1062a is now selected (and that spoken request 1006f includes a request to change the color of user interface 1026 to red), computer system 600 displays indication 1066b, which instructs the user to press crown 604a. At FIG. 10Q, computer system 600 detects user input 1068b, which is a press of crown 604a.

At FIG. 10Q, in response to detecting user input 1064a, computer system 800 displays red color option 1034b-1 with a white circle surrounding red color option 1034b-1 to indicate that red color option 1034b-1 is selected. Additionally, at FIG. 10Q, in accordance with a determination that red color option 1034b-1 is now selected (and that spoken request 1006f includes a request to change the color of user interface 1026 to red), computer system 800 displays indication 1066a, which instructs the user to select option 1034e. At FIG. 10Q, computer system 800 detects user input 1068a (e.g., a tap input) corresponding to selection of option 1034e.

In various embodiments, at FIG. 10R, in response to detecting user input 1064b, computer system 600 displays user interface 1026 with a background portion of user interface 1026 changed to a red color. In various embodiments, at FIG. 10R, in response to detecting user input 1064a, computer system 800 communicates with computer system 600; causes computer system 600 to change a background portion of user interface 1026 to a red color; and displays notification 1008h, which indicates that the watch face color of computer system 600 has been changed to red. In some embodiments, computer system 600 also displays a notification indicating that the watch face color has been changed to red.

At FIG. 10S, computer system 600 displays time user interface 1072, which includes indication of time 1072a, date indication 1072b, and calendar complication 1072d overlaid on media item 1072c (e.g., a photograph and/or a video). In some embodiments, time user interface 1072 is a photos watch face similar to photos watch face 832 described above. At FIG. 10S, computer system 800 displays media viewer user interface 1070. Media viewer user interface 1070 displays media item 1071 (e.g., a photograph and/or a video) and includes scrubber 1070d that includes smaller representations of other media items available in a media library associated with computer system 800 (e.g., a media library associated with a user of computer system 800 and/or computer system 600). Media viewer user interface 1070 also includes options 1070a-1070c. Option 1070a, when selected, causes computer system 800 to initiate a process for sharing a currently displayed media item. Option 1070b, when selected, causes computer system 800 to mark a currently displayed media item as a favorite media item. Option 1070c, when selected, causes computer system 800 to initiate a process for deleting a currently displayed media item. At FIG. 10S, user 1000 provides spoken input 1006g (e.g., “Make this photo my watch face”). In the depicted embodiments, computer system 800 detects spoken input 1006g (e.g., via one or more microphones of computer system 800). Although the depicted example shows computer system 800 detecting spoken input 1006g and taking responsive actions, in some embodiments, computer system 600 detects spoken input 1006g and takes responsive actions.

In some embodiments, computer system 600 and/or computer system 800 use one or more machine learning models to interpret spoken input 1006g and/or to determine one or more actions that are responsive to spoken input 1006g. At FIG. 10T, in response to detecting spoken input 1006g, computer system 800 displays user interface 1074. User interface 1074 includes one or more options for modifying time user interface 1072, including: color options 1074b for modifying a color of time user interface 1072; content options 1074c-1 through 1074c-4, and time position options 1074d-1 and 1074d-2. As described above with reference to FIGS. 8A-8I and user interface 820, content options 1074c-1 through 1074c-4 allow a user to select which media items to use as background media items in time user interface 1072. Content option 1074c-1, when selected, causes computer system 800 to initiate a process for user selection of one or more albums (e.g., user-created albums and/or automatically created albums) as background media items for time user interface 1072. Content option 1074c-2, when selected, causes computer system 800 to initiate a process for user selection of one or more individual media items for use as background media items for time user interface 1072. Option 1074c-3, when selected, causes computer system 800 to initiate a process for using a favorites album as background media items for time user interface 1072. Option 1074c-4, when selected, causes computer system 800 to initiate a process for using media items that are automatically selected based on a context of computer system 600 as background media items for time user interface 1072. At FIG. 10T, based on spoken input 1006g and in accordance with a determination that spoken input 1006g includes a request to use media item 1071 as the background media item for time user interface 1072, computer system 800 displays indication 1076, which directs the user to select content option 1074c-2. At FIG. 10T, computer system 800 detects user input 1078 (e.g., a tap input) corresponding to selection of content option 1074c-2.

At FIG. 10U, in response to detecting user input 1078, computer system 800 displays media library user interface 1080, which includes media grid 1082, options 1080a-1080d, search bar 1080e, and options 1080f-1080g. Media grid 1082 displays representations (e.g., thumbnails) of media items from a media library (e.g., a media library associated with computer system 800 and/or a user of computer system 800), including representations 1082a, 1082b, 1082c (e.g., which is representative of media item 1071), and 1082d. Option 1080a, when selected, causes computer system 800 to cease display of media library user interface 1080. Option 1080b, when selected, causes computer system 800 to display media library user interface 1080. Option 1080c, when selected, causes computer system 800 to display representations of one or more media collections of the media library. Option 1080d, when selected, causes computer system 800 to add selected media items in media grid 1082 to a set of media items to be used as background media items in time user interface 1072. Option 1080f, when selected, causes computer system 800 to reverse the order in which media grid 1082 is sorted. Option 1080g, when selected, causes computer system 800 to display a user interface with representations of all media items that are selected within media grid 1082 (which, in FIG. 10U, is no media items). Search bar 1080e, when selected, causes computer system 800 to initiate a process for performing user-specified searching of the media library. At FIG. 10U, based on a determination that spoken input 1006g includes a request to use media item 1071 as the background media item for time user interface 1072, computer system 800 visually highlights representation 1082c, which is representative of media item 1071. For example, in some embodiments, other representations in media grid 1082 other than representation 1082c are darkened and/or representation 1082c is displayed with a higher brightness than other representations of media grid 1082, and/or representation 1082c is displayed with a bolded border while other representations in media grid 1082 are not displayed with the bolded border. In this way, computer system 800 visually indicates to the user that the user should select representation 1082c. At FIG. 10U, computer system 800 detects user input 1084 (e.g., a tap input) corresponding to selection of representation 1082c.

At FIG. 10V, in response to detecting user input 1084, computer system 800 displays representation 1082c with visual indication 1085 to indicate that representation 1082c is selected, and updates option 1080g to indicate that one media item in media grid 1082 is selected. Additionally, based on a determination that representation 1082c is now selected and that spoken input 1006g includes a request to use media item 1071 as the background media item for time user interface 1072, computer system 800 displays indication 1086a, which directs and/or instructs the user to select option 1080d. At FIG. 10V, computer system 800 detects user input 1088a (e.g., a tap input) corresponding to selection of option 1080d.

At FIG. 10W, in response to detecting user input 1088a, computer system 800 ceases display of media library user interface 1080 and displays a bottom portion of user interface 1074. The bottom portion of user interface 1074 includes time position options 107d-1, 1074d-2 (e.g., to move the indication of time within time user interface 1072 to the top or the bottom of time user interface 1072, respectively); and complications options 1074e-1, 1074e-2 (e.g., to select and/or change top complication 1072b and bottom complication 1072d of time user interface 1072, respectively). User interface 1074 also includes option 1074f which, when selected, causes computer system 800 to communicate with computer system 600 to cause computer system 600 to modify and/or update user interface 1072 based on selections made in user interface 1074. Additionally, based on a determination that media item 1071 is now selected as a background media item and that spoken input 1006g includes a request to use media item 1071 as the background media item for time user interface 1072, computer system 800 displays indication 1086b, which directs and/or instructs the user to select option 1074f. At FIG. 10W, computer system 800 detects user input 1088b (e.g., a tap input) corresponding to selection of option 1074f. At FIG. 10X, in response to detecting user input 1088b, computer system 800 communicates with computer system 600; causes computer system 600 to update time user interface 1072 with media item 1071 as the background media item; and displays notification 1008g indicating that time user interface 1072 of computer system 600 has been updated. In some embodiments, computer system 600 also displays a notification indicating that the background media item has been changed.

FIGS. 10L-10X have depicted embodiments in which computer system 600 and/or computer system 800, in response to spoken user requests to modify a respective user interface, display instructions and/or user interfaces for the user to make the request modifications to the respective user interface. However, as noted above, in some embodiments, in response to spoken user requests to modify a respective user interface, computer system 600 and/or computer system 800 perform and/or complete the modifications automatically and/or without additional user input. For example, in some embodiments, in response to spoken input 1006e in FIG. 10J, computer system 600 and/or computer system 800 jump to the state shown in FIG. 10O, rather than displaying the user interfaces and instructions shown in FIGS. 10L-10N. In another example, in some embodiments, in response to spoken input 1006f in FIG. 10O, computer system 600 and/or computer system 800 jump to the state shown in FIG. 10R rather than displaying the user interfaces and instructions shown in FIGS. 10P-10Q. In yet another example, in some embodiments, in response to spoken input 1006g in FIG. 10S, computer system 600 and/or computer system 800 jump to the state shown in FIG. 10X rather than displaying the user interfaces and instructions shown in FIGS. 10T-10W.

FIG. 11 is a flow diagram illustrating a method for modifying user interfaces using a computer system in accordance with some embodiments. Method 1100 is performed at a computer system (e.g., 100, 300, 500, 600, and/or 800) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 602 and/or 802) (e.g., a display controller, a display, a touch-sensitive display system, a touchscreen, a monitor, and/or a head mounted display system) and one or more input devices (e.g., 602, 604a, 604b, 802, 804a, 804b, and/or 804c) (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 1100 are, optionally, combined, the orders of some operations are, optionally, changed, and some operations are, optionally, omitted.

As described below, method 1100 provides an intuitive way for modifying user interfaces. The method reduces the cognitive burden on a user for modifying user interfaces, thereby creating a more efficient human-machine interface. For battery-operated computing devices, enabling a user to modify user interfaces faster and more efficiently conserves power and increases the time between battery charges.

The computer system (e.g., 600 and/or 800) detects (1102), via the one or more input devices, a first language input (e.g., 1006a, 1006b, 1006c, 1006d, 1006e, 1006f, and/or 1006g) (e.g., a spoken input, a gesture-based language input, and/or a typed language input) that includes one or more words specified by a user (e.g., 1000) of the computer system (e.g., a template-based language input and/or a natural language-based language input). In response to detecting the first language input (1104): in accordance with a determination that the one or more words of the first language input correspond to a request to change a first user interface (e.g., 1002, 1016, 1024, 1026, and/or 1072) (1106) (e.g., a user request to change a portion of the first user interface; a user request to modify one or more visual aspects of the first user interface; a user request to modify one or more visual elements of the first user interface; and/or a user request to replace the first user interface with a different user interface), the computer system (e.g., 600 and/or 800) initiates (1108) a process to change the first user interface in a manner that will persist after the first language input has ended (e.g., turning off night mode in FIG. 10B, displaying user interface 1008b and/or 1012 in FIG. 10C, displaying user interface 1018 and/or 1020 in FIG. 10E, displaying user interface 1028 and/or 1030 in FIG. 10H, adding complication 1026i in FIG. 10K, displaying user interface 1034 and/or 1038 in FIG. 10L, and/or displaying user interface 1074 in FIG. 10T). In some embodiments, initiating the process to change the first user interface (e.g., 1002, 1016, 1024, 1026, and/or 1072) comprises changing the first user interface from a first respective user interface to a second respective user interface different from the first user interface (e.g., FIGS. 10B-10D and/or 10D-10G). In some embodiments, initiating the process to change the first user interface comprises changing a first visual element of the first user interface from a first user interface object to a second user interface object different from the first user interface object (e.g., in some embodiments, while maintaining and/or not changing a second visual element of the first user interface) (e.g., FIGS. 10J-10K). In some embodiments, initiating the process to change the first user interface comprises displaying, via the one or more display generation components, a first UI modification user interface that includes one or more options for changing the first user interface (e.g., user interface 1008b, user interface 1012, user interface 1030, user interface 1028, user interface 1058, user interface 1034, and/or user interface 1074). In some embodiments, initiating the process to change the first user interface comprises outputting a first prompt (e.g., in some embodiments, displaying, via the one or more display generation components, a first prompt) that prompts the user for one or more clarifying inputs to clarify the user request to change the first user interface (e.g., 1018, 1020, 1028, and/or 1030). In some embodiments, the first user interface that is changed in response to the first language input is not a language input user interface (e.g., the first user interface that is changed based on the first language input is not a user interface for interacting with a virtual assistant that displays information about detected language input and/or responses to the language input). In some embodiments, in response to detecting the first language input, in accordance with a determination that the one or more words of the first language input correspond to a request to perform a first operation different from changing the first user interface, the computer system performs the first operation without changing the first user interface. Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first language input (e.g., 1006a, 1006b, 1006c, 1006d, 1006e, 1006f, and/or 1006g) is an audio input (e.g., a spoken input) that is detected via one or more microphones (e.g., one or more microphones that are in communication with the computer system; and/or one or more microphones of the one or more input devices). In some embodiments, the one or more words specified by the user of the computer system comprises and/or is one or more words spoken by the user of the computer system. Allowing a user to change a first user interface using an audio input and/or a spoken input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first user interface (e.g., 1002, 1016, 1024, 1026, and/or 1072) is a time user interface (e.g., a user interface that includes an analog and/or digital indication of time, a clock face user interface, a watch face user interface, a reduced-power screen, a wake screen, and/or a lock screen). In some embodiments, the first language input includes and/or corresponds to a request to change the time user interface. In some embodiments, the time user interface includes one or more complications (e.g., 1024c, 1024d, 1026c, 1026d, 1026e, 1026f, 1026g, 1026i, 1072b, and/or 1072d). Allowing a user to change a time user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first user interface (e.g., 1002, 1016, 1024, 1026, and/or 1072) is a wake screen user interface (e.g., a user interface that is indicative of the computer system having transitioned to an awakened state (e.g., from a sleep state) and/or having transitioned out of a sleep state). In some embodiments, the wake screen user interface is a time user interface (e.g., a user interface that includes an analog and/or digital indication of time, a clock face user interface, a watch face user interface, a reduced-power screen, a wake screen, and/or a lock screen). In some embodiments, the wake screen user interface is a lock screen user interface that is indicative of the computer system being awakened but in a locked state. In some embodiments, the wake screen user interface is a user interface that is indicative of the computer system having transitioned from a locked state to an unlocked state. In some embodiments, the first language input includes and/or corresponds to a request to change the wake screen user interface. Allowing a user to change a wake screen user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the determination that the one or more words of the first language input correspond to a request to change the first user interface comprises a determination that the one or more words of the first language input correspond to a request to change a first complication (e.g., spoken input 1006e requesting to change complication 1026e) (e.g., a first complication that, when selected, causes the computer system to perform a first action corresponding to the first complication and/or causes the computer system to display a first application corresponding to the first complication) within the first user interface (e.g., 1026) (e.g., a request to change a first complication that, when selected, causes the computer system to perform a first action corresponding to the first complication and/or causes the computer system to display a first application corresponding to the first complication to a second complication that, when selected, causes the computer system to perform a second action corresponding to the second complication and/or causes the computer system to display second application corresponding to the second complication; and/or a request to remove the first complication). In some embodiments, initiating a process to change the first user interface in a manner that will persist after the first language input has ended comprises initiating a process to change the first complication within the first user interface in a manner that will persist after the first language input has ended (e.g., in FIG. 10K, in response to spoken input 1006e, replacing complication 1026e with complication 1026i). In some embodiments, initiating the process to change the first user interface in a manner that will persist after the first language input has ended comprises changing the first complication within the first user interface (e.g., FIGS. 10J-10K). In some embodiments, prior to detecting the first language input, the computer system displays the first user interface (e.g., 1026) with a first complication (e.g., 1026e). In some embodiments, in response to detecting the first language input: in accordance with a determination that the one or more words of the first language input correspond to a request to change the first complication within the first user interface, the computer system displays the first user interface with a second complication (e.g., a second complication that was not displayed in the first user interface prior to detecting the first language input) different from the first complication replacing the first complication (e.g., displays the first user interface without the first complication and with the second complication, wherein the second complication is optionally displayed in a region of the first user interface that was previously occupied by the first complication) (e.g., in FIG. 10K, in response to spoken input 1006e, replacing complication 1026e with complication 1026i). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the determination that the one or more words of the first language input correspond to a request to change the first user interface comprises a determination that the one or more words of the first language input correspond to a request to change a color of one or more elements of the first user interface (e.g., spoken input 1006f requesting to change the watch face color to red) (e.g., from a first color to a second color; from a first color setting to a second color setting; from a first color option to a second color option; and/or from a first shade to a second shade). In some embodiments, initiating a process to change the first user interface in a manner that will persist after the first language input has ended comprises initiating a process to change the color of the one or more elements of the first user interface in a manner that will persist after the first language input has ended (e.g., FIGS. 100-10R). In some embodiments, initiating the process to change the first user interface in a manner that will persist after the first language input has ended comprises changing the color of the one or more elements of the first user interface in a manner that will persist after the first language input has ended (e.g., FIGS. 100-10R). In some embodiments, prior to detecting the first language input, the computer system displays the first user interface with the one or more elements including a first color (e.g., FIG. 10O). In some embodiments, in response to detecting the first language input: in accordance with a determination that the one or more words of the first language input correspond to a request to change the color of the one or more elements of the first user interface, the computer system displays the first user interface with the one or more elements including a second color different from the first color and without including the first color (e.g., displays the one or more elements with the first color replaced by the second color) (e.g., FIG. 10R, background of user interface 1026 changed to red). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the determination that the one or more words of the first language input correspond to a request to change the first user interface comprises a determination that the one or more words of the first language input correspond to a request to change a display mode of the computer system from a first display mode to a second display mode different from the first display mode (e.g., spoken input 1006a includes a request to turn off a night display mode) (e.g., a request to change from a bright display mode that has a first brightness to a dark display mode that has a second brightness that is darker than the first brightness (e.g., that has fewer lumens than the first brightness); and/or a request to change from a higher power display mode to a low power display mode that consumes less power than the higher power display mode). In some embodiments, initiating a process to change the first user interface in a manner that will persist after the first language input has ended comprises initiating a process to change the display mode of the computer system from the first display mode to the second display mode (e.g., FIGS. 10A-10B). In some embodiments, initiating the process to change the first user interface in a manner that will persist after the first language input has ended comprises changing the display mode of the computer system from the first display mode to the second display mode. In some embodiments, prior to detecting the first language input, the computer system displays the first user interface with a first set of visual characteristics that correspond to (e.g., are indicative of) the first display mode (e.g., FIG. 10A). In some embodiments, in response to detecting the first language input: in accordance with a determination that the one or more words of the first language input correspond to a request to change the display mode of the computer system from the first display mode to the second display mode, the computer system displays the first user interface with a second set of visual characteristics that is different from the first set of visual characteristics and that correspond to (e.g., are indicative of) the second display mode (e.g., FIG. 10B). In some embodiments, prior to detecting the first language input, the computer system operates in the first display mode and/or displays the first user interface while operating in the first display mode. In some embodiments, in response to detecting the first language input: in accordance with a determination that the one or more words of the first language input correspond to a request to change the display mode of the computer system from the first display mode to the second display mode, the computer system operates in the second display mode (e.g., without operating in the first display mode) and/or displays the first user interface while operating in the second display mode. Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the determination that the one or more words of the first language input correspond to a request to change the first user interface comprises a determination that the one or more words of the first language input correspond to a request to change the first user interface from a first pre-existing configuration of the first user interface (e.g., a first watch face, a first wake screen, and/or a first lock screen that existed and/or that was generated prior to detecting the first language input) to a second pre-existing configuration of the first user interface different from the first pre-existing configuration (e.g., a second watch face, a second wake screen, and/or a second lock screen that existed and/or that was generated prior to detecting the first language input) (e.g., spoken input 1006b request to change the time user interface from time user interface 1002 to a different time user interface; and/or spoken input 1006c includes a user request to change time user interface 1016 to a different time user interface). In some embodiments, initiating a process to change the first user interface in a manner that will persist after the first language input has ended comprises initiating a process to change the first user interface from the first pre-existing configuration of the first user interface to the second pre-existing configuration of the first user interface (e.g., FIGS. 10B-10D; and/or FIGS. 10D-10G). In some embodiments, initiating the process to change the first user interface in a manner that will persist after the first language input has ended comprises changing the first user interface from the first pre-existing configuration of the first user interface to the second pre-existing configuration of the first user interface. In some embodiments, prior to detecting the first language input, the computer system displays the first user interface with the first pre-existing configuration of the first user interface. In some embodiments, in response to detecting the first language input: in accordance with a determination that the one or more words of the first language input correspond to the second pre-existing configuration of the first user interface, the computer system displays the first user interface with the second pre-existing configuration of the first user interface (and, optionally, ceases displaying the first user interface with the first pre-existing configuration of the first user interface). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the determination that the one or more words of the first language input correspond to a request to change the first user interface comprises a determination that the one or more words of the first language input correspond to a request to create a new configuration of the first user interface (e.g., in some embodiments, spoken input 1006b corresponds to a user request to create a new character watch face) (e.g., a new watch face, a new wake screen, and/or a new lock screen that did not exist and/or was not generated prior to detecting the first language input; and/or a new configuration of the first user interface that is generated to have a first set of characteristics based on and/or in response to detecting the first language input). In some embodiments, initiating a process to change the first user interface in a manner that will persist after the first language input has ended comprises initiating a process to create the new configuration of the first user interface based on the first language input (e.g., create a new configuration of the first user interface that has a first set of characteristics based on and/or in response to the first language input) (e.g., FIGS. 10B-10D). In some embodiments, initiating the process to change the first user interface in a manner that will persist after the first language input has ended comprises creating the new configuration of the first user interface based on the first language input and/or displaying, via the one or more display generation components, a new configuration of the first user interface that is generated and/or created based on the first language input (e.g., FIG. 10C, displaying a new character watch face that has been generated based on spoken input 1006b). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first language input (e.g., 1006b) specifies one or more parameters for the new configuration of the first user interface (e.g., a “character watch face” in spoken input 1006b) (e.g., one or more parameters specifying one or more visual characteristics for the new configuration of the first user interface; one or more parameters specifying one or more colors for the new configuration of the first user interface; one or more parameters specifying one or more visual elements to be included in the new configuration of the first user interface; one or more parameters specifying placement of one or more visual elements to be included in the new configuration of the first user interface; and/or one or more parameters specifying size of one or more visual elements to be included in the new configuration of the first user interface). In some embodiments, the determination that the one or more words of the first language input correspond to a request to create a new configuration of the first user interface comprises a determination that the one or more words of the first language input correspond to a request to create a new configuration of the first user interface based on the one or more parameters specified by the first language input. In some embodiments, initiating the process to change the first user interface in a manner that will persist after the first language input has ended comprises initiating a process to create the new configuration of the first user interface based on the one or more parameters for the new configuration of the first user interface specified by the first language input (e.g., creating new watch face 1016 in response to spoken input 1006b). In some embodiments, initiating the process to change the first user interface in a manner that will persist after the first language input has ended comprises creating the new configuration of the first user interface based on the one or more parameters for the new configuration of the first user interface specified by the first language input and/or displaying, via the one or more display generation components, a new configuration of the first user interface that is generated and/or created based on the one or more parameters for the new configuration of the first user interface specified by the first language input. Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, initiating the process to change the first user interface in a manner that will persist after the first language input has ended comprises changing the first user interface in a manner that will persist after the first language input has ended (e.g., automatically and/or without further user input after the first language input) (e.g., FIGS. 10A-10B; and/or FIGS. 10J-10K). In some embodiments, the first user interface (e.g., 1002, 1016, 1024, 1026, and/or 1072) is a wake screen user interface for the computer system that is displayed when the computer system (e.g., 600 and/or 800) switches from a wake state to a sleep state (e.g., based on a determination that user input of a particular type has not been detected for a threshold duration of time; in response to a user input such as a button press, a touch input, a spoken input, a gesture input, a wrist drop gesture, and/or a hand cover gesture); a sleep state to a wake state (e.g., in response to a user input such as a touch input, a spoken input, a button press, a gesture input, and/or a wrist up gesture); an unlocked state to a locked state (e.g., based on a determination that user input of a particular type has not been detected for a threshold duration of time; in response to a user input such as a button press, a touch input, a spoken input, a gesture input, a wrist drop gesture, and/or a hand cover gesture); and/or a locked state to an unlocked state (e.g., based on authentication of the user, such as biometric authentication and/or passcode-based authentication). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, changing the first user interface in a manner that will persist after the first language input has ended comprises applying a first set of changes to the first user interface (e.g., replacing the first user interface with a second user interface; changing one or more colors of the first user interface; changing a configuration of the first user interface; and/or changing one or more settings of the first user interface). In some embodiments, subsequent to applying the first set of changes to the first user interface, the computer system (e.g., 600 and/or 800) displays (e.g., automatically and/or without further user input), via the one or more display generation components (e.g., 602 and/or 802), a first indication that indicates at least a subset of the first set of changes that were applied to the first user interface (e.g., a textual indication describing at least some of the changes that were applied to the first user interface) (e.g., notifications 1008a, 1008c, 1008d-1, 1008d-2, 1008e-1, 1008e-2, 1008f, 1008g, and/or 1008h; and/or a corresponding notification displayed on computer system 600). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently. Furthermore, displaying an indication that indicates at least a subset of the first set of changes that were applied to the first user interface provides the user with feedback about a state of the system (e.g., that the system applied the first set of changes to the first user interface), thereby improving visual feedback provided to the user.

In some embodiments, initiating the process to change the first user interface in a manner that will persist after the first language input has ended comprises displaying, via the one or more display generation components, a first suggestion indicative of one or more proposed changes to the first user interface without applying the one or more proposed changes to the first user interface (e.g., user interface 1012, displaying suggestion 1012a of a potential character watch face in response to spoken input 1006b; and/or user interface 1008b, displaying suggestion 1010 of a character watch face in response to spoken input 1006b) (e.g., displaying a preview of the one or more changes to the first user interface and/or displaying a textual explanation of one or more proposed changes to the first user interface that, for example, can be accepted or declined by a user of the computer system). In some embodiments, the first suggestion and/or the one or more proposed changes to the first user interface are determined and/or generated based on the first language input and/or based on the one or more words of the first language input. In some embodiments, initiating the process to change the first user interface comprises displaying (e.g., in some embodiments, concurrently with the first suggestion or subsequent to displaying the first suggestion) an accept option (e.g., 1012a-1 and/or 1008b-2) that, when selected, causes the computer system to apply the one or more proposed changes to the first user interface. In some embodiments, while displaying the accept option, the computer system detects one or more user inputs (e.g., one or more touch inputs, one or more hardware control inputs, one or more button presses, one or more gesture inputs, one or more air gesture inputs, one or more spoken inputs, and/or one or more language inputs) corresponding to selection of the accept option (e.g., 1014b and/or 1014d); and in response to detecting the one or more inputs corresponding to selection of the accept option, the computer system applies the one or more proposed changes to the first user interface (e.g., displays the first user interface with the one or more proposed changes applied and/or displays a second user interface different from the first user interface that applies the one or more proposed changes) (e.g., FIG. 10D). In some embodiments, while displaying the accept option, the computer system detects one or more user inputs (e.g., one or more touch inputs, one or more hardware control inputs, one or more button presses, one or more gesture inputs, one or more air gesture inputs, one or more spoken inputs, and/or one or more language inputs) that do not correspond to selection of the accept option (e.g., that correspond to a user request not to apply the one or more proposed changes to the first user interface) (e.g., 1014a and/or 1014c); and in response to detecting the one or more inputs that do not correspond to selection of the accept option, the computer system ceases display of the accept option without applying the one or more proposed changes to the first user interface. Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, initiating the process to change the first user interface in a manner that will persist after the first language input has ended further comprises displaying (e.g., in some embodiments, concurrently with the first suggestion or subsequent to displaying the first suggestion), via the one or more display generation components, a regenerate option (e.g., 1012b and/or 1008b-1) that, when selected, causes the computer system to generate a new suggestion proposing one or more changes to the first user interface based on the first language input that is different from the first suggestion. In some embodiments, while displaying the regenerate option (e.g., 1012b and/or 1008b-1), the computer system (e.g., 600 and/or 800) detects, via the one or more input devices, one or more selection inputs (e.g., one or more touch inputs, one or more hardware control inputs, one or more button presses, one or more gesture inputs, one or more air gesture inputs, one or more spoken inputs, and/or one or more language inputs) corresponding to selection of the regenerate option (e.g., 1014a and/or 1014c). In response to detecting the one or more selection inputs corresponding to selection of the regenerate option, the computer system displays, via the one or more display generation components, a second suggestion that is indicative of a second set of one or more proposed changes to the first user interface without applying the second set of one or more proposed changes to the first user interface (e.g., re-displays user interface 1012 and/or user interface 1008b with a different suggested character watch face in FIG. 10C), wherein: the second suggestion and the second set of one or more proposed changes to the first user interface are determined based on the first language input (e.g., 1006b) (e.g., based on the one or more words of the first language input); the second suggestion is different from the first suggestion; and the second set of one or more proposed changes to the first user interface is different from the one or more proposed changes to the first user interface (e.g., displaying a different suggestion for a character watch face in user interface 1012 and/or user interface 1008b). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, displaying the first suggestion indicative of one or more proposed changes to the first user interface without applying the one or more proposed changes to the first user interface comprises displaying, via the one or more display generation components, a visual preview of the one or more proposed changes to the first user interface (e.g., 1012a and/or 1010) (e.g., a visual preview that displays what the first user interface would look like if the one or more proposed changes to the first user interface were applied and/or accepted and/or a visual preview that displays what the first user interface would look like if the user was to provide one or more user inputs accepting the one or more proposed changes to the first user interface and/or one or more user inputs requesting that the one or more proposed changes be applied to the first user interface). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, initiating the process to change the first user interface in a manner that will persist after the first language input has ended comprises displaying, via the one or more display generation components (e.g., 602 and/or 802), a UI modification user interface (e.g., 1018, 1020, 1028, and/or 1030) that includes: a first change option (e.g., 1020a, 1020b, 1018a, 1018b, 1028a, 1028b, 1028c, 1028d, 1028e, 1028f, 1028g, 1030a, and/or 1030b) that corresponds to a first set of one or more changes to the first user interface and that, when selected, causes the computer system (e.g., 600 and/or 800) to apply the first set of one or more changes to the first user interface (or, in some embodiments, causes the computer system to initiate a process for applying the first set of changes to the first user interface); and a second change option (e.g., 1020a, 1020b, 1018a, 1018b, 1028a, 1028b, 1028c, 1028d, 1028e, 1028f, 1028g, 1030a, and/or 1030b) different from the first change option that corresponds to a second set of one or more changes to the first user interface different from the first set of changes and that, when selected, causes the computer system (e.g., 600 and/or 800) to apply the second set of one or more changes to the first user interface without applying the first set of one or more changes to the first user interface (or, in some embodiments, causes the computer system to initiate a process for applying the second set of one or more changes to the first user interface without applying the first set of one or more changes to the first user interface). In some embodiments, while displaying the UI modification user interface (e.g., 1018, 1020, 1028, and/or 1030), the computer system (e.g., 600 and/or 800) detects, via the one or more input devices, a first set of one or more selection inputs (e.g., 1022a, 1022b, 1022c, 1022d, 1032a, 1032b, 1032c, and/or 1032d) (e.g., one or more touch inputs; one or more hardware control inputs; one or more gesture inputs; one or more spoken inputs; and/or one or more language inputs). In response to detecting the first set of one or more selection inputs: in accordance with a determination that the first set of selection inputs corresponds to selection of the first change option (and, in some embodiments, does not correspond to selection of the second change option), the computer system applies the first set of one or more changes to the first user interface without applying the second set of one or more changes to the first user interface (e.g., displaying the first user interface with the first set of one or more changes applied to the first user interface) (e.g., in response to user input 1022a and/or 1022c in FIG. 10E, the time user interface is updated to activity analog watch face 1024 in FIG. 10F; and in response to user input 1022b and/or 1022d in FIG. 10E, the time user interface is updated to activity digital watch face 1026 in FIG. 10G); and in accordance with a determination that the first set of one or more selection inputs corresponds to selection of the second change option (and, in some embodiments, does not correspond to selection of the first change option), the computer system applies the second set of one or more changes to the first user interface without applying the first set of one or more changes to the first user interface (e.g., displaying the first user interface with the second set of one or more changes applied to the first user interface) (e.g., in response to user input 1022a and/or 1022c in FIG. 10E, the time user interface is updated to activity analog watch face 1024 in FIG. 10F; and in response to user input 1022b and/or 1022d in FIG. 10E, the time user interface is updated to activity digital watch face 1026 in FIG. 10G). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, initiating the process to change the first user interface in a manner that will persist after the first language input has ended comprises displaying, via the one or more display generation components (e.g., 602 and/or 802), a first UI modification user interface (e.g., 1034, 1038, 1044, 1048, 1058, and/or 1074) that includes one or more options for modifying the first user interface in a first manner requested by the first language input. Automatically displaying the appropriate user interface for implementing the one or more user-requested changes enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, displaying the first UI modification user interface comprises: in accordance with a determination that the one or more words of the first language input correspond to a user request to change the first user interface in a first respective manner, displaying, via the one or more display generation components (e.g., 602 and/or 802), a first respective UI modification user interface that includes a first set of one or more options for modifying the first user interface in the first respective manner (e.g., in response to spoken input 1006e, computer system 600 displays user interface 1038, and in response to spoken input 1006f, computer system 600 displays user interface 1058; and/or in response to spoken input 1006f, computer system 800 displays user interface 1034 and in response to spoken input 1006g, computer system 800 displays user interface 1074); and in accordance with a determination that the one or more words of the first language input correspond to a user request to change the first user interface in a second respective manner different from the first respective manner, displaying, via the one or more display generation components, a second respective UI modification user interface that is different from the first respective UI modification user interface and that includes a second set of one or more options (e.g., one or more options different from the first set of one or more options) for modifying the first user interface in the second respective manner (e.g., in response to spoken input 1006e, computer system 600 displays user interface 1038, and in response to spoken input 1006f, computer system 600 displays user interface 1058; and/or in response to spoken input 1006f, computer system 800 displays user interface 1034 and in response to spoken input 1006g, computer system 800 displays user interface 1074). Automatically displaying the appropriate user interface for implementing the one or more user-requested changes enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, displaying the first UI modification user interface that includes the one or more options for modifying the first user interface in the first manner requested by the first language input further comprises displaying, within the first UI modification user interface, a first visual indication (e.g., 1036a, 1036b, 1046a, 1046b, 1052a, 1052b, 1056a, 1056b, 1066a, 1066b, 1086a, and/or 1086b), wherein the first visual indication identifies (e.g., visually emphasizes and/or directs the user to) a first subset of the one or more options based on a determination that the first subset of the one or more options is useful for modifying the first user interface in the first manner requested by the first language input. In some embodiments, the first visual indication does not identify (e.g., does not emphasize and/or does not direct the user to) a second subset of the one or more options based on a determination that the second subset of the one or more options is not useful for modifying the first user interface in the first manner requested by the first language input. Visually emphasizing and/or visually identifying one or more options that can be used to make the user-requested changes to the first user interface enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, while displaying the first UI modification user interface (e.g., 1028 and/or 1030) that includes one or more options for modifying the first user interface in the first manner requested by the first language input, the computer system (e.g., 600 and/or 800) detects, via the one or more input devices, a first set of one or more user inputs (e.g., 1032a, 1032b, 1032c, and/or 1032d) (e.g., one or more touch inputs, one or more gesture inputs, one or more hardware control inputs, one or more language inputs, and/or one or more spoken inputs). In response to detecting the first set of one or more user inputs, the computer system displays, via the one or more display generation components, one or more modifications to the first user interface (e.g., 1026 in FIG. 10I and FIG. 10J) (e.g., ceasing display of the first user interface; displaying the first user interface being replaced by a second user interface; and/or displaying the first user interface with a first set of modifications and/or changes applied to the first user interface). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the determination that the one or more words of the first language input correspond to a request to change the first user interface comprises a determination that the one or more words of the first language input correspond to a request to change the first user interface on the computer system (e.g., computer system 600 detecting a spoken input requesting a change to a user interface on computer system 600) (e.g., change how the first user interface is displayed on the computer system and/or replace the first user interface on the computer system). In some embodiments, initiating the process to change the first user interface in a manner that will persist after the first language input has ended comprises initiating a process to change the first user interface on the computer system (e.g., initiating a process to change how the first user interface is displayed on the computer system and/or initiating the process to replace the first user interface on the computer system) in a manner that will persist after the first language input has ended (e.g., changing a user interface on computer system 600). Allowing a user to change a first user interface using a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the determination that the one or more words of the first language input correspond to a request to change the first user interface comprises a determination that the one or more words of the first language input correspond to a request to change the first user interface on a first companion device (e.g., change how the first user interface is displayed on the companion device and/or replace the first user interface on the companion device) separate from the computer system (e.g., computer system 800 detecting a spoken input corresponding to a request to change a user interface on computer system 600) (e.g., a separate computer system; a separate companion device that corresponds to the computer system; a separate companion device that corresponds to the same user as the computer system; and/or a separate companion device that corresponds to and/or is logged into the same user account as the computer system). In some embodiments, initiating the process to change the first user interface in a manner that will persist after the first language input has ended comprises initiating a process to change the first user interface on the companion device (e.g., initiating a process to change how the first user interface is displayed on the computer system and/or initiating the process to replace the first user interface on the computer system) in a manner that will persist after the first language input has ended (e.g., computer system 800 causing changes to a user interface on computer system 600). In some embodiments, the first language input corresponds to a user request to modify and/or change a user interface on a separate device and/or a separate computer system (e.g., 600), and the computer system (e.g., 800) initiates a process for changing the user interface on the separate device and/or the separate computer system (e.g., 600). In some embodiments, initiating the process to change the first user interface in a manner that will persist after the first language input has ended comprises causing the first companion device to change the first user interface in a manner that will persist after the first language input has ended and/or causing the first companion device to display the first user interface with one or more changes based on the first language input. In some embodiments, the first user interface is a wake screen user interface for the first companion device (e.g., 600) that is displayed when the first companion device switches from a wake state to a sleep state (e.g., based on a determination that user input of a particular type has not been detected for a threshold duration of time; in response to a user input such as a button press, a touch input, a spoken input, a gesture input, a wrist drop gesture, and/or a hand cover gesture); a sleep state to a wake state (e.g., in response to a user input such as a touch input, a spoken input, a button press, a gesture input, and/or a wrist up gesture); an unlocked state to a locked state (e.g., based on a determination that user input of a particular type has not been detected for a threshold duration of time; in response to a user input such as a button press, a touch input, a spoken input, a gesture input, a wrist drop gesture, and/or a hand cover gesture); and/or a locked state to an unlocked state (e.g., based on authentication of the user, such as biometric authentication and/or passcode-based authentication). Allowing a user to change a first user interface on a companion device using a language input on the computer system enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, initiating the process to change the first user interface in a manner that will persist after the first language input has ended comprises displaying, via the one or more display generation components, a respective UI modification user interface (e.g., 1034, 1038, 1044, 1048, 1058, 1074, and/or 1080) that includes one or more respective options for modifying the first user interface in a manner requested by the first language input, wherein displaying the first respective UI modification user interface further includes: displaying, via the one or more display generation components, a first visual indication indicating that the first respective UI modification user interface is displayed in response to the first language input (e.g., in some embodiments, user interface 1034, 1038, 1044, 1048, 1058, 1074, and/or 1080 is displayed with a visual indication indicating that the user interface is displayed in response to spoken input 1006a, 1006b, 1006c, 1006d, 1006e, 1006f, and/or 1006g) (e.g., displaying a visual effect, such as a glowing effect or other visual indication around one or more edges of the first respective UI modification user interface, to indicate that the first respective UI modification user interface is being displayed in response to the first language input). Automatically displaying the appropriate user interface for implementing the one or more user-requested changes enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently. Furthermore, displaying the first visual indication provides the user with visual feedback about a state of the system (e.g., that the system is displaying the first respective UI modification user interface in response to the first language input), thereby improving visual feedback.

In some embodiments, the computer system (e.g., 600 and/or 800) detects, via the one or more input devices, a second language input (e.g., 1006g) (e.g., a spoken input, a gesture-based language input, and/or a typed language input) that includes a second set of one or more words specified by the user of the computer system (e.g., a template-based language input and/or a natural language-based language input), wherein: the second language input corresponds to a user request to generate a time (e.g., watch face or clock face) user interface (e.g., 1072) (e.g., a user interface that is displayed with an indication of a respective time (e.g., a current time, a past time, or a future time); and/or a user interface that is displayed on a watch face and/or configured to be displayed on a watch face and is displayed with an indication of a respective time) that includes one or more visual media items (e.g., 1071) (e.g., one or more photographs and/or videos) that are selected from a media library (e.g., a media library associated with the computer system; a media library that is at least partially stored on the computer system; a media library that is accessible the computer system; and/or a media library that corresponds to a user account that is logged into the computer system); and the second language input specifies a first set of one or more criteria for selecting the one or more visual media items from the media library (e.g., “Make this photo my watch face” in FIG. 10S) (e.g., one or more criteria specifying requested traits and/or characteristics of the one or more visual media items to be included in the watch user interface; one or more criteria specifying and/or identifying one or more people, objects, and/or concepts to be depicted in the visual media items; and/or one or more criteria specifying and/or identifying one or more dates, time ranges, events, locations, people, and/or visual characteristics for selecting visual media items from the media library). In response to detecting the second language input, the computer system: selects a first set of visual media items (e.g., 1071) (e.g., one or more media items) from the media library based on the second language input and the first set of one or more criteria specified by the second language input; and displays, via the one or more display generation components, a first time user interface that displays at least a subset of the first set of visual media items (e.g., 1072 in FIG. 10X) (in some embodiments, generating a first time user interface that includes at least a subset of the first set of visual media items). In some embodiments, user interface 1072 is a photos watch face, such as photos watch face 832 from FIGS. 8A-8I. In some embodiments, in response to spoken input 1006g in FIG. 10S, computer system 600 and/or computer system 800 automatically selects one or more media items to be used as background media items in time user interface 1072 (e.g., without additional user input). In some embodiments, the first time user interface sequentially switches between visual media items from the first set of visual media items over time and/or in response to user input. Automatically selecting media items from a media library and generating and/or displaying a time user interface using the selected media items based on a language input enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

Note that details of the processes described above with respect to method 1100 (e.g., FIG. 11) are also applicable in an analogous manner to the methods described above and/or below. For example, methods 700, 900, 1300, 1350, 1500, and/or 1700 optionally include one or more of the characteristics of the various methods described above with reference to method 1100. For example, in various embodiments, the user interface object of the first type recited in method 1300 and/or the first complication recited in method 1500 can be displayed within the time user interface recited in method 700, the wake screen user interface recited in method 900, the time user interface recited in method 1350, and/or the time user interface recited in method 1700. In another example, in various embodiments, the first user interface recited in method 1100 can include the time user interface recited in method 700, the wake screen user interface recited in method 900, the user interface object of the first type recited in method 1300, the time user interface recited in method 1350, the first complication recited in method 1500, and/or the time user interface recited in method 1700. For brevity, these details are not repeated below.

FIGS. 12A-12Y illustrate exemplary user interfaces for providing time user interfaces, in accordance with some embodiments. The user interfaces in these figures are used to illustrate the processes described below, including the processes in FIG. 13A and FIG. 13B.

FIG. 12A depicts computer system 600, which is a smart watch that includes touch-sensitive display 602, rotatable and depressible crown 604a, and button 604b. At FIG. 12A, computer system 600 displays, via touch-sensitive display 602, user interface 1200. User interface 1200 is a time user interface that includes indication of time 1202 and complications 1204a-1204d. Indication of time 1202 includes digital indication of time 1202a, seconds dial 1202c, and seconds indication 1202b. In some embodiments, seconds indication 1202b progressively fills more of a region within seconds dial 1202c to indicate the current time in seconds. For example, in FIG. 12A, seconds indication 1202b fills the area from 0 seconds to 39 seconds on seconds dial 1202c, indicating that the current time in seconds is 39 seconds (e.g., the current time is 10:03:39).

Complication 1204a is a temperature complication that is associated with a weather application and displays the current temperature (e.g., 72 degrees), a forecasted low temperature for the day (e.g., 52 degrees), and a forecasted high temperature for the day (e.g., 84 degrees) for a particular location. In some embodiments, complication 1204a, when selected, causes, computer system 600 to open the weather application and/or display a user interface of the weather application. Complication 1204b is an elevation complication that is associated with an elevation application and displays current elevation information for computer system 600 (e.g., computer system 600 is currently at an elevation of 9,131 feet above sea level). In some embodiments, complication 1204b, when selected, causes computer system 600 to open the elevation application and/or display a user interface of the elevation application. Complication 1204c is a connection status complication that is associated with a connection status feature of computer system 600 and displays a connection status of computer system 600 (e.g., in FIG. 12A, indicating that computer system 600 is connected to a cellular network). In some embodiments, complication 1204c, when selected, causes computer system 600 to display a settings user interface and/or a menu user interface (e.g., of an operating system of computer system 600). Complication 1204d is a compass complication that is associated with a compass application, and displays current heading information for computer system 600 (e.g., indicating in FIG. 12A that computer system 600 is pointed in a northwestern direction). In some embodiments, complication 1204d, when selected, causes computer system 600 to open the compass application and/or display a user interface of the compass application.

User interface 1200 also includes point-of-interest (POI) complication 1206. POI complication 1206 includes arrow 1206a, ring 1206b, heading information 1206c, and POI representations 1208a-1208d. Arrow 1206a is representative of a current heading of computer system 600, and indicates (e.g., in conjunction with positions markers labeled “N,” “S,” “E,” and “W”) that computer system 600 is currently pointing in a northwest direction. Heading information 1206c provides a text indication of the current heading of computer system 600 (e.g., NW 330 degrees). Ring 1206b includes POI representations 1208a-1208d, which each represent respective points of interest, and their respective positions relative to computer system 600. For example, POI representation 1208a represents a first point of interest (e.g., a campsite), and the position of POI representation 1208a indicates that the first point of interest is generally north, and slightly east of the computer system 600. POI representation 1208b represents a second point of interest (e.g., a lodge), and the position of POI representation 1208b indicates that the second point of interest is north-east of computer system 600. POI representation 1208c represents a third point of interest (e.g., a car), and the position of POI representation 1208c indicates that the third point of interest is south-east of computer system 600. POI representation 1208d represents a fourth point of interest (e.g., a tent), and the position of POI representation 1208d indicates that the fourth point of interest is west of computer system 600. In some embodiments, complication 1206 includes representations of points of interest that are within a threshold distance and/or threshold radius of computer system 600. As will be described in greater detail below, in some embodiments, the threshold distance and/or threshold radius is adjustable by a user. In the depicted embodiments, user interface 1200 also includes radius information 1207, which indicates the currently selected threshold distance and/or threshold radius for complication 1206 (e.g., 1200 feet in FIG. 12A).

In some embodiments, computer system 600 provides three different settings and/or arrangements for user interface 1200, which are represented by options 1210a, 1210b, 1210c, respectively, in FIG. 12A. Option 1210a is displayed in FIG. 12A, and corresponds to an arrangement for user interface 1200 in which all four corner complications 1204a-1204d are displayed at a default size. Option 1210b corresponds to an arrangement for user interface 1200 in which bottom-right complication 1204d is displayed at an enlarged size. Option 1210c corresponds to an arrangement for user interface 1200 in which bottom-left complication 1204c is displayed at an enlarged size. In some embodiments, computer system 600 does not provide the option for top right complication 1204b or top left complication 1204a to be displayed at an enlarged size.

At FIG. 12B, option 1210b is enabled (e.g., in response to a user input 1212a in FIG. 12A), such that bottom-right complication 1204d is displayed at an enlarged size (and complications 1204a-1204c are displayed at default sizes that are smaller than the enlarged size). While bottom-right complication 1204d is displayed as a compass complication in the depicted examples, it will be understood that many different complications can be used and/or the compass complication can be replaced with a different complication. In some embodiments, when option 1210b is enabled and bottom-right complication 1204d is displayed at an enlarged size, bottom-right complication 1204d overlaps complication 1206, seconds dial 1202c, and seconds indication 1202b. In FIG. 12B, when option 1210b is enabled, computer system 600 displays seconds dial 1202c with a bend in the region that is overlapped by bottom-right complication 1204d (e.g., from approximately the 16-second position of seconds dial 1202c to the 29-second position of seconds dial 1202c) so that seconds dial 1202c wraps around bottom-right complication 1204d. Similarly, seconds indication 1202b is displayed with a bend in the region that is overlapped by bottom-right complication 1204d so that seconds indication 1202b wraps around bottom-right complication 1204d. In contrast, complication 1206 is partially overlaid and/or covered by bottom-right complication 1204d.

At FIG. 12C, option 1210c is enabled (e.g., in response to user input 1212b in FIG. 12B), such that bottom-left complication 1204c is displayed at an enlarged size (and complications 1204a, 1204b, 1204d are displayed at default sizes that are smaller than the enlarged size). While bottom-left complication 1204c is displayed as a connection status complication in the depicted examples, it will be understood that many different complications can be used and/or the connection status complication can be replaced with a different complication. In some embodiments, when option 1210c is enabled and bottom-left complication 1204c is displayed at an enlarged size, bottom-left complication 1204c overlaps complication 1206, seconds dial 1202c, and seconds indication 1202b. In FIG. 12C, when option 1210c is enabled, computer system 600 displays seconds dial 1202c with a bend in the region that is overlapped by bottom-left complication 1204c (e.g., from approximately the 31-second position of seconds dial 1202c to the 44-second position of seconds dial 1202c) so that seconds dial 1202c wraps around bottom-left complication 1204c. Similarly, seconds indication 1202b is displayed with a bend in the region that is overlapped by bottom-left complication 1204c so that seconds indication 1202b wraps around bottom-left complication 1204c. In contrast, complication 1206 is partially overlaid and/or covered by bottom-left complication 1204c.

As will be described in greater detail below, user interface 1200 includes various selection regions that are respectively selectable to cause computer system 600 to perform different actions. In some embodiments, the sizes and/or shapes of one or more selection regions are changed based on which arrangement option 1210a, 1210b, 1210c is enabled. FIG. 12D displays an example of the ways in which selection regions of user interface 1200 change based on which arrangement option 1210a, 1210b, 1210c is enabled. In the top left of FIG. 12D, arrangement option 1210a is enabled (e.g., no enlarged complications). In the depicted embodiments, user interface 1200 includes selection regions 1216a, 1216b, 1216c, 1216d, 1216e, and 1216f, the boundaries of which are marked using dashed lines in FIG. 12D. Selection region 1216a includes a top half of a circle defined by seconds dial 1202c and, when selected, causes computer system 600 to display user interface 1230 of FIG. 12K (described in greater detail below). Selection region 1216b includes a bottom half of the circle defined by seconds dial 1202c and, when selected, causes computer system 600 to display user interface 1224 of FIG. 12I (described in greater detail below). Selection region 1216c corresponds to top-left complication 1204a and, when selected, causes computer system 600 to display a user interface associated with top-left complication 1204a (e.g., in FIG. 12D, a weather application user interface). Selection region 1216d corresponds to top-right complication 1204b and, when selected, causes computer system 600 to display a user interface associated with top-right complication 1204b (e.g., in FIG. 12D, an elevation application user interface). Selection region 1216e corresponds to bottom-left complication 1204c and, when selected, causes computer system 600 to display a user interface associated with bottom-left complication 1204c (e.g., in FIG. 12D, a connection settings user interface). Selection region 1216f corresponds to bottom-right complication 1204d and, when selected, causes computer system 600 to display a user interface associated with bottom-right complication 1204d (e.g., in FIG. 12D, a compass application user interface).

On the top right of FIG. 12D, arrangement option 1210b is enabled, and bottom-right complication 1204d is displayed at an enlarged size. It can be seen on the top right of FIG. 12D that when arrangement option 1210b is enabled, selection region 1216f grows in size, changes in shape, and is shifted in position (e.g., compared to when option 1210a is enabled on the top left of FIG. 12D), while selection region 1216b is made smaller and changes in shape to curve and/or bend around complication 1204d and/or selection region 1216f. On the bottom of FIG. 12D, arrangement option 1210c is enabled, and bottom-left complication 1204c is displayed at an enlarged size. It can be seen on the bottom of FIG. 12D that when arrangement option 1210c is enabled, selection region 1216e grows in size, changes in shape, and is shifted in position (e.g., compared to when option 1210a is enabled on the top left of FIG. 12D and/or compared to when option 1210b is enabled on the top right of FIG. 12D), while selection region 1216b is made smaller and changes in shape to curve and/or bend around complication 1204c and/or selection region 1216e.

At FIG. 12E, arrangement option 1210b is enabled, and computer system 600 displays user interface 1200 with bottom-right complication 1204d displayed at the enlarged size, and seconds dial 1202c and seconds indication 1202b bending around bottom-right complication 1204d. At FIG. 12E, computer system 600 is pointed in the direction NW330 (e.g., as indication by indication 1208d and complication 1204d). At FIG. 12F, computer system 600 detects that it has been turned, such that computer system 600 is now facing directly west (e.g., as indication by complication 1204d and/or complication 1206). At FIG. 12F, in response to detecting that the heading of computer system 600 has changed, computer system 600 updates display of complication 1204 to indicate the current heading of computer system 600, and also updates display of complication 1206 based on the current heading of computer system 600. In FIG. 12F, POI representations 1208a-1208d have been moved around ring 1206b based on the change in heading of computer system 600. In FIG. 12F, POI representation 1208d is displayed at the top of ring 1206b because computer system 600 is now pointed in the direction of the point of interest represented by POI representation 1208d. Additionally, based on a determination that computer system 600 is now pointed in the direction of the point of interest represented by POI representation 1208d, computer system 600 updates indication 1206c to identify the point of interest represented by POI representation 1208d (e.g., “TENT”) and also to indicate a distance to the point of interest represented by POI representation 1208d (e.g., 385 feet). Additionally, based on the detected change in heading of computer system 600, POI representations 1208a, 1208b are moved to positions within ring 1206b that are covered by and/or overlapped by complication 1204d. Based on a determination that POI representations 1208a, 1208b are covered by complication 1204d, computer system 600 displays indications 1218a, 1218b. Indication 1218a corresponds to POI representation 1208a, and points to the position of POI representation 1208a behind complication 1204d. Indication 1218b corresponds to POI representation 1208b, and points to the position of POI representation 1208b behind complication 1204d.

FIG. 12F depicts various scenarios in which computer system 600 detects various user inputs, including: user input 1220a (e.g., a tap input) corresponding to selection of complication 1204d (e.g., within selection region 1216f of FIG. 12D); user input 1220b (e.g., a tap input) corresponding to selection of selection region 1216b from FIG. 12D; and user input 1220c (e.g., a tap input) corresponding to selection of selection region 1216a from FIG. 12D. Each of these user inputs and the response of computer system 600 to these user inputs will be described in greater detail below.

At FIG. 12G, in response to detecting user input 1220a, computer system 600 displays, via touch-sensitive display 602, compass user interface 1222 (e.g., a user interface associated with bottom-right complication 1204d). Compass user interface 1222 displays heading information 1222b for computer system 600, as well as elevation information 1222c for computer system 600. Compass user interface 1222 includes option 1222a which, when selected, causes computer system 600 to cease display of compass user interface 1222 and/or re-display user interface 1200.

At FIG. 12H, in response to detecting user input 1220b, computer system 600 displays user interface 1224. User interface 1224 includes option 1224a, 1224b, and radius options 1226a-1226g. Radius options 1226a-1226g allow a user to define a radius threshold around computer system 600 for which the user would like to view point of interest information. Points of interest that are outside of the user-selected radius from computer system 600 are not represented in complication 1206 of user interface 1200, and points of interest that are within the user-selected radius from computer system 600 are represented in complication 1206 of user interface 1200. In FIG. 12H, radius option 1226d is currently selected (e.g., 1200 feet), and POI representations 1208-1208d are shown as dark circles to indicate that these four points of interest are within the user-selected radius. However, user interface 1224 includes additional POI representations 1208e-1208k that are displayed in user interface 1224 as white circles to indicate that these points of interest are outside of the current user-selected radius, and will not be represented in user interface 1200. POI representations 1208a-1208k are positioned around ring 1206b based on the positions of the points of interest relative to a current heading of computer system 600 (e.g., a first point of interest represented by POI representation 1208d is directly in front of computer system 600; a second point of interest represented by POI representation 1208j is slightly to the left of the current heading of computer system 600; a third point of interest represented by POI representation 1208i is further to the left of the current heading of computer system 600; a fourth point of interest represented by POI representation 1208f is directly behind computer system 600, and so forth). Option 1224a, when selected, causes computer system 600 to cease display of user interface 1224 and/or re-display user interface 1200 without modifying the user-selected radius. Option 1224b, when selected, causes computer system 600 to cease display of user interface 1224 and/or re-display user interface 1200 and apply any changes to the user-selected radius made by the user in user interface 1224. At FIG. 12H, computer system 600 detects user input 1226, which is a rotation of crown 604a. In some embodiments, rotation of crown 604a in a first direction (e.g., clockwise) causes radius options 1226a-1226g to scroll upwards to decrease the selected radius, and rotation of crown 604b in a second direction (e.g., counter-clockwise) causes radius options 1226a-1226g to scroll downwards to increase the selected radius.

At FIG. 12I, in response to detecting user input 1226, computer system 600 scrolls radius options 1226a-1226g upwards to decrease the user-selected radius from 1200 ft to 900 ft. Additionally, based on the decrease in the user-selected radius, POI representation 1208b and POI representation 1208c are now displayed as white circles, as they are outside of the new user-selected radius from computer system 600. FIG. 12I depicts various scenarios in which computer system 600 detects multiple user inputs, including: user input 1228a (e.g., a rotation of crown 604a); user input 1226b (e.g., a tap input) corresponding to selection of option 1224a; and user input 1226c (e.g., a tap input) corresponding to selection of option 1224b. In response to user input 1228a, computer system 600 displays scrolling of radius options 1226a-1226h to change the user-selected radius. In response to user input 1228b, computer system 600 ceases display of user interface 1224 and re-displays user interface 1200 without changing the user-selected radius (e.g., without applying the changes made in user interface 1224).

At FIG. 12J, in response to detecting user input 1228c, computer system 600 ceases display of user interface 1224, applies the new user-selected radius of 900 feet, and re-displays user interface 1200. In FIG. 12J, POI representations 1208b, 1208c are no longer displayed within user interface 1200 based on the new, reduced radius selected by the user. Additionally, in FIG. 12J, indication 1207 is updated to indicate the new radius selected by the user.

At FIG. 12K, in response to detecting user input 1220c from FIG. 12F, computer system 600 displays user interface 1230. User interface 1230 includes option 1230a, option 1230b, option 1230c, and option 1230d, as well as POI target options 1232a-1232g. POI target options 1232a-1232g represent different points of interest around computer system 600 (e.g., within a maximum radius of computer system 600). The points of interest identified by POI target options 1232a-1232g are the points of interest that are represented by POI representations 1208a-1208k, which were discussed above. POI target options 1232a-1232g allow a user to select a particular point of interest that the user would like to track within user interface 1200, as will be described in greater detail below. In FIG. 12K, POI target option 1232d, corresponding to a tent, is currently selected. Furthermore, in FIG. 12K, POI representation 1208d corresponds to the tent, and is shown as a black circle to indicate that the point of interest associated with POI representation 1208d is currently selected and/or to indicate that POI target option 1232d corresponds to POI representation 1208d. Option 1230a, when selected (e.g., user input 1232a), causes computer system 600 to initiate a process for adding more points of interest. Option 1230b, when selected, causes computer system 600 to initiate a process for editing the current set of points of interest. Option 1230c, when selected, causes computer system 600 to cease display of user interface 1230 and/or re-display user interface 1200 without selecting a particular point of interest to track (e.g., return to the state shown in FIG. 12K). Option 1230d, when selected, causes computer system 600 to cease display of user interface 1230, and re-display user interface 1200, but with a point of interest tracking mode initiated to track a particular, user-selected point of interest, as will be described in greater detail below. At FIG. 12K, computer system 600 detects user input 1234c, which is a rotation of crown 604a. In some embodiments, rotation of crown 604a in a first direction (e.g., clockwise) causes POI target options 1232a-1232g to scroll upwards, and rotation of crown 604b in a second direction (e.g., counter-clockwise) causes POI target options 1232a-1232g to scroll downwards.

At FIG. 12L, in response to detecting user input 1234c, computer system 600 displays POI target options 1232a-1232g scroll downwards such that POI target option 1232c is now selected. Additionally, in FIG. 12L, POI representation 1208d is no longer displayed in black (e.g., because POI target option 1232e is no longer selected), and POI representation 1208c is now displayed in black to indicate that POI target option 1232c corresponds to POI representation 1208c. At FIG. 12L, computer system 600 detects user input 1236 (e.g., a tap input) corresponding to selection of option 1230d.

At FIG. 12M, in response to detecting user input 1236, computer system 600 displays user interface 1200 with a POI tracking feature enabled. In FIG. 12M, with the POI tracking feature enabled, only POI representation 1208c (e.g., corresponding to the selected point of interest for tracking) is displayed within complication 1206, and POI representations 1208a, 1208b, 1208d are no longer displayed. Furthermore, indication 1206c continuously provides distance information relative to the selected point of interest (e.g., campsite, 990 feet), rather than only showing the distance information when the point of interest is directly ahead of computer system 600 (e.g., as was the case above in FIGS. 12E-12F when the POI tracking feature was not enabled). Additionally, in FIG. 12M, direction indication 1207 is displayed to indicate that the user should turn to the right in order to face the target point of interest. In some embodiments, display of direction indication 1207 within complication 1206 is an indication that the POI tracking feature is enabled.

At FIG. 12N, computer system 600 detects that computer system 600 has changed heading to now face directly north (e.g., as indicated by arrow 1206a, complication 1206, and complication 1204d). In response to detecting that computer system 600 has changed heading, computer system 600 rotates complication 1206, including moving POI representation 1208c to a position behind complication 1204d. Based on POI representation 1208c moving to a position behind complication 1204d, computer system 600 displays indication 1218c, which indicates the position of POI representation 1208c behind complication 1204d.

At FIG. 120, computer system 600 detects that computer system 600 has changed heading once again to now face in a south-east direction (e.g., as indicated by arrow 1206a, complication 1206, and complication 1204d). In response to detecting that computer system 600 has changed heading, computer system 600 rotates complication 1206, including moving POI representation 1208c to a position at the top of complication 1206 to indicate that the point of interest represented by POI representation 1208c is directly ahead of computer system 600's current heading. At FIG. 120, computer system 600 detects user input 1238 (e.g., a tap input) corresponding to selection of selection region 1216a from FIG. 12D. At FIG. 12P, in response to detecting user input 1238, computer system 600 disables the POI tracking feature, ceases display of direction indication 1207, and re-displays POI representations 1208a, 1208b, 1208d in complication 1208, with POI representation 1208d being hidden behind complication 1204d and indication 1218d indicating the position of POI representation 1208d behind complication 1204d.

FIG. 12Q depicts an example scenario in which computer system 600 determines that it has low signal strength (e.g., signal strength below a threshold value) and/or has below a threshold level of accuracy in determining the location of computer system 600. For example, in some embodiments, computer system 600 estimates and/or detects the location of computer system 600 and the estimated geographic location of computer system 600 is represented by a geographic region within which computer system 600 determines itself to be (e.g., in some embodiments, a circular region). When the signal strength of computer system 600 is higher, the certainty of the location estimate is higher and the estimated geographic region is smaller and/or has a smaller area. However, when the signal strength of computer system 600 is lower, the certainty of the location estimate is lower and the estimated geographic region is larger and/or has a larger area. In some embodiments, when the location estimate of computer system 600 is less accurate than a threshold level of accuracy (e.g., the geographic region representative of the estimated location of computer system 600 has an area greater than 25,000 sq. meters; 50,000 sq. meters; 100,000 sq. meters; or 250,000 sq. meters), computer system 600 updates indication 1206c to indicate that the location estimate of computer system 600 is less accurate than a threshold level of accuracy. Furthermore, in FIG. 12Q, based on a determination that computer system 600 has less than a threshold level of location estimate accuracy, computer system 600 displays POI representations 1208p, 1208q in a first color, and displays POI representations 1208n, 1208o in a second color. In some embodiments, computer system 600 displays representations of points of interest that are determined to be within the geographic region that is representative of the estimated location of computer system 600 (e.g., POI representations 1208o, 1208n) in a first manner (e.g., a first color; a first size; and/or a first shape) to indicate that the positions of those points of interest may not be accurate due to the low accuracy in estimating the location of computer system 600. In contrast, representations of points of interest that are outside of the geographic region that is representative of the estimated location of computer system 600 (e.g., POI representations 1208p, 1208q), are displayed in a second manner (e.g., a second color; a second size; and/or a second shape), as the positions of those points of interest relative to computer system 600 are still likely to be accurate. Additionally, FIGS. 12Q-12R depict an embodiment of bottom right complication 1204d in which bottom right complication 1204d includes cut-out 1204d-1 through which ring 1206b is visible, such that a user is able to see POI representations that may be positioned behind bottom right complication 1204d through cutout 1204d-1.

At FIG. 12R, computer system 600 has determined that it is within a threshold distance (e.g., within 50 feet) of a point of interest (e.g., labeled “Parked Car”). In some embodiments, when computer system 600 determines that it is within a threshold distance of a respective point of interest, computer system 600 ceases display of other POI representations; displays ring 1206b in a different color; and/or displays the POI representation corresponding to the respective point of interest (e.g., POI representation 1208m) at the top of ring 1206b. In some embodiments, the threshold distance is dynamic and/or changes based on a location accuracy and/or signal strength of computer system 600. For example, in some embodiments, when computer system 600 has a lower signal strength and/or a lower location accuracy, the threshold distance is increased, for example, because computer system 600 is not able to provide useful information as to the direction of the respective point of interest relative to computer system 600 when the point of interest is closer to computer system 600 than the threshold distance. When computer system 600 has a higher signal strength and/or a higher location accuracy, the threshold distance is decreased, for example, because computer system 600 is able to determine the location of computer system 600 relative to the point of interest with greater fidelity. In some embodiments, when the point of interest is determined to no longer be within the threshold distance of computer system 600, computer system 600 returns, for example, to the state shown in FIG. 12P in which other POI representations are presented within complication 1206. At FIG. 12R, computer system 600 detects user input 1250 (e.g., a tap and hold input and/or a hard press input) on user interface 1200.

At FIG. 12S, in response to detecting user input 1250, computer system 600 displays user interface 1252. User interface 1252 is a watch face modification user interface that includes one or more options for modifying visual aspects of user interface 1200. In FIG. 12S, time style category 1254a is selected, and computer system 600 displays options for modifying the time style of user interface 1200. At FIG. 12S, the “digital” time style option is currently selected. FIG. 12S depicts various example scenarios in which computer system 600 detects various inputs, including: user input 1256a (e.g., a rotation of rotatable and depressible input mechanism 604a) and user input 1256b (e.g., a swipe left input). Each of these user inputs and the response of computer system 600 to these user inputs will be described in greater detail below.

At FIG. 12T, in response to detecting user input 1256a in FIG. 12S, computer system 600 updates user interface 1252 to indicate that the “analog” time style is now selected for the time style category 1254a. In the depicted embodiments, a user is able to provide a rotational input to adjust the currently selected category. For example, in some embodiments, in FIG. 12T, rotational input 1258a results in the “digital” time style being selected, as was the case in FIG. 12S. At FIG. 12T, computer system 600 also detects user input 1258b (e.g., a swipe left input)

At FIG. 12U, in response to user input 1256b of FIG. 12S and/or user input 1258b in FIG. 12T, computer system 600 updates user interface 1252 to indicate that POI filter category 1254b is now selected. In FIG. 12U, user interface 1252 includes instruction 1255a, which instructs the user to tap to manage POI groups that will be included in complication 1206. FIG. 12U depicts various example scenarios in which computer system 600 detects various inputs, including: user input 1260a (e.g., a swipe right input); user input 1260b (e.g., a tap input); and user input 1260c (e.g., a swipe left input). Each of these user inputs and the response of computer system 600 to these user inputs will be described in greater detail below. In response to user input 1260a, computer system 600 returns to the state shown in FIG. 12S or FIG. 12T, in which the “time style” category is selected.

At FIG. 12V, in response to user input 1260b in FIG. 12U, computer system 600 displays user interface 1262. User interface 1262 includes options 1264a-1264f that allow a user to select and/or filter out particular categories of points of interest to be included in and/or represented in complication 1206. In some embodiments, points of interest are imported in from two or more different applications and/or features. For example, option 1264a corresponds to points of interest imported into complication 1206 from a compass application, and options 1264b, 1264c correspond to points of interest imported into complication 1206 from a maps application, and options 1264d-1264f correspond to points of interest imported into complication 1206 from one or more guides and/or one or more different guide applications. A user is able to provide user input on options 1264a-1264f (e.g., user input 1268b and/or user input 1268c) to selectively include or exclude different categories of points of interest for complication 1206.

At FIG. 12W, in response to user input 1260c in FIG. 12U, computer system 600 updates user interface 1252 to indicate that a “dial style” category 1254c is now selected. The options in “dial style” category 1254c correspond to configurations 1210a-1210c discussed above. In FIG. 12W, a “high visibility left” dial style is selected in which a bottom left complication is displayed at an enlarged size. At FIG. 12X, a “high visibility right” dial style is selected (e.g., in response to user input 1270c (e.g., a rotation of rotatable and depressible input mechanism 604a)) in which a bottom right complication is displayed at an enlarged size. At FIG. 12Y, a “high visibility off” dial style is selected (e.g., in response to user input 1272c (e.g., a rotation of rotatable and depressible input mechanism 604a)) in which all corner complications are displayed at a default and/or smaller size. In some embodiments, in response to user input 1270a in FIG. 12W and/or user input 1272a in FIG. 12X, computer system 600 returns to the state shown in FIG. 12U. In some embodiments, in response to user input 1270b in FIG. 12W and/or user input 1272b in FIG. 12X, computer system 600 updates user interface 1252 to display a different category of options for user interface 1200 (e.g. options to change the complications of user interface 1200).

FIG. 13A is a flow diagram illustrating a method for providing time user interfaces using a computer system in accordance with some embodiments. Method 1300 is performed at a computer system (e.g., 100, 300, 500, and/or 600) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 602) (e.g., a display controller, a display, a touch-sensitive display system, a touchscreen, a monitor, and/or a head mounted display system) and one or more input devices (e.g., 602, 604a, and/or 604b) (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 1300 are, optionally, combined, the orders of some operations are, optionally, changed, and some operations are, optionally, omitted.

As described below, method 1300 provides an intuitive way for providing time user interfaces. The method reduces the cognitive burden on a user for accessing time user interfaces and/or accessing information within time user interfaces, thereby creating a more efficient human-machine interface. For battery-operated computing devices, enabling a user to access time user interfaces and/or access information within time user interfaces faster and more efficiently conserves power and increases the time between battery charges.

The computer system (e.g., 600) detects (1302), via the one or more input devices, a request (e.g., one or more user inputs, one or more touch inputs, one or more gesture inputs, one or more hardware control inputs, one or more button presses, and/or one or more spoken inputs) (e.g., a press of crown 604a and/or a wrist raise gesture) to display a time user interface (e.g., 1200) (e.g., a user interface that includes an analog and/or digital indication of time, a clock face user interface, a watch face user interface, a reduced-power screen, a wake screen, and/or a lock screen). In response to detecting the request to display the time user interface (1304), the computer system displays (1306), via the one or more display generation components (e.g., 602), the time user interface (e.g., 1200), wherein displaying the time user interface includes: in accordance with a determination that the time user interface includes a user interface object of a first type (e.g., arrangement option 1210b is enabled or arrangement option 1210c is enabled) (e.g., an oversized user interface object, and/or a user interface object that is greater than a threshold size) at a first position of the time user interface (e.g., 1200) (e.g., in accordance with a determination that a user interface object of the first type is selected for display at the first position of the time user interface (e.g., selected from a plurality of potential user interface objects that includes one or more user interface objects that are not of the first type) and/or in accordance with a determination that a first device setting is set to a first state in which a user interface object of the first type is displayed at the first position of the time user interface), displaying (1308) a first element (e.g., 1202c and/or 1202b) of the time user interface (e.g., a frame and/or a dial of the time user interface) with a bend at a first location corresponding to the first position to accommodate the user interface object of the first type (e.g., to accommodate a size and/or shape of the first type of user interface object) at the first position of the time user interface (e.g., in FIG. 12B, seconds dial 1202c is displayed with a bend between the 16-second position and the 29-second position of seconds dial 1202c to accommodate complication 1204d; and/or in FIG. 12C, seconds dial 1202c is displayed with a bend between the 31-second position and the 44-second position of seconds dial 1202c to accommodate complication 1204c). In some embodiments, displaying the time user interface further includes: in accordance with a determination that the time user interface does not include a user interface object of the first type at the first position of the time user interface (e.g., arrangement option 1210a is enabled) (e.g., in accordance with a determination that a user interface object of a second type (e.g., a regular-sized user interface object and/or a user interface object that is smaller than the threshold size) different from the first type (e.g., a second type of user interface object that is smaller than the first type) is selected for display at the first position of the time user interface and/or in accordance with a determination that a first device setting is set to a second state in which a user interface object of a second type (e.g., a regular-sized user interface object and/or a user interface object that is smaller than the threshold size) different from the first type is displayed at the first position of the time user interface), displaying the first element (e.g., 1202b and/or 1202c) of the time user interface without the bend at the first location corresponding to the first position of the time user interface (e.g., in FIG. 12A, seconds dial 1202c is displayed without a bend to accommodate complication 1204d and/or complication 1204c). In some embodiments, the first element (e.g., 1202c) of the time user interface (e.g., 1200) has a consistent curvature, a consistent shape, and/or a consistent path in regions that do not include the first location corresponding to the first position (e.g., 1202c in FIG. 12A and/or 1202c in FIG. 12B in regions other than the region occupied by complication 1204d), and the bend at the first location corresponding to the first position disrupts and/or changes the curvature and/or shape of the first element in order to accommodate user interface objects of the first type (e.g., changing a generally concave curvature to a convex curvature or changing a generally convex curvature into a generally concave curvature). In some embodiments, the first element (e.g., 1202c) of the time user interface (e.g., 1200) would overlap user interface objects of the first type (e.g., 1204d in FIG. 12B and/or 1204c in FIG. 12C) at the first position of the time user interface if the curvature, shape, and/or path of the first element was maintained at the first location corresponding to the first position, and the bend at the first location corresponding to the first position prevents the first element from overlapping and/or intersecting user interface objects of the first type at the first position of the time user interface. In some embodiments, when the time user interface does not include a user interface object of the first type (e.g., FIG. 12A) (e.g., does not include any oversized user interface objects, oversized complications, user interface objects that are greater than a threshold size, and/or complications that are greater than a threshold size), the first element (e.g., 1202c in FIG. 12A) is displayed having a first shape and/or occupying a first display region. The first element, when displayed having the first shape and/or occupying the first display region, intersects and/or overlaps user interface objects of the first type at the first position of the time user interface (e.g., 1202c, as shown in FIG. 12A, would overlap complication 1204d in FIG. 12B and/or complication 1204c in FIG. 12C). In some embodiments, when the time user interface includes a user interface object of the first type at the first position of the time user interface object, the first element (e.g., 1202c) is displayed having a second shape different from the first shape and/or occupying a second display region different from the first display region (e.g., 1202c in FIG. 12A has a different shape than 1202c in FIG. 12B and/or FIG. 12C). The second shape and/or the second display region (e.g., 1202c in FIG. 12B and/or FIG. 12C) includes a bend at a first location corresponding to the first position that is not included in the first shape and/or the first display region (e.g., 1202 in FIG. 12A), and the bend at the first location corresponding to the first position prevents the second shape and/or the second display region from overlapping user interface objects of the first type at the first position of the time user interface. Automatically bending an element of the time user interface to accommodate a size and/or shape of a user interface object allows for this operation to be performed without user input. Furthermore, doing also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently. Doing so also permits inclusion of certain over-sized and/or enlarged user interface objects that allow users to view information more quickly.

In some embodiments, displaying the time user interface (e.g., 1200) further includes: in accordance with a determination that the time user interface includes a user interface object of the first type (e.g., an oversized user interface object, and/or a user interface object that is greater than a threshold size) at a second position of the time user interface different from the first position of the time user interface (e.g., FIG. 12B has complication 1204d in bottom-right corner; and FIG. 12C has complication 1204c in bottom-left corner) (e.g., in accordance with a determination that a user interface object of the first type is selected for display at the second position of the time user interface (e.g., selected from a plurality of potential user interface objects that includes one or more user interface objects that are not of the first type)), displaying the first element (e.g., 1202c) of the time user interface (e.g., a frame and/or a dial of the time user interface) with a bend at a second location corresponding to the second position to accommodate user interface objects of the first type (e.g., to accommodate a size and/or shape of user interface objects of the first type) at the second position of the time user interface (and, optionally, without a bend at the first location corresponding to the first position) (e.g., in FIG. 12B, seconds dial 1202c has a bend in the bottom right corner to accommodate complication 1204d, and in FIG. 12C, seconds dial 1202c has a bend in the bottom left corner to accommodate complication 1204c). In some embodiments, displaying the time user interface (e.g., 1200) further includes: in accordance with a determination that the time user interface does not include a user interface object of the first type at the second position of the time user interface (e.g., FIG. 12A) (e.g., in accordance with a determination that a user interface object of a second type (e.g., a regular-sized user interface object and/or a user interface object that is smaller than the threshold size) different from the first type (e.g., a second type of user interface object that is smaller than the first type) is selected for display at the second position of the time user interface), displaying the first element (e.g., 1202c) of the time user interface without the bend at the second location corresponding to the second position (e.g., 1202c in FIG. 12A). In some embodiments, the first element (e.g., 1202c) of the time user interface has a consistent curvature, a consistent shape, and/or a consistent path in regions that do not include the second location corresponding to the second position, and the bend at the second location corresponding to the second position disrupts and/or changes the curvature and/or shape of the first element in order to accommodate user interface objects of the first type displayed at the second position. In some embodiments, the first element (e.g., 1202c) of the time user interface would overlap user interface objects of the first type at the second position of the time user interface if the curvature, shape, and/or path of the first element was maintained at the second location corresponding to the second position, and the bend at the first location corresponding to the first position prevents the first element from overlapping and/or intersecting user interface objects of the first type at the second position (e.g., 1202c from FIG. 12A would overlap complication 1204d in FIG. 12B and/or complication 1204c in FIG. 12C). In some embodiments, when the time user interface (e.g., 1200) does not include the a user interface object of the first type (e.g., FIG. 12A) (e.g., does not include any oversized user interface objects, oversized complications, user interface objects that are greater than a threshold size, and/or complications that are greater than a threshold size), the first element is displayed having a first shape and/or occupying a first display region (e.g., 1202c in FIG. 12A). The first element, when displayed having the first shape and/or occupying the first display region, intersects and/or overlaps user interface objects of the first type that are displayed at the second position of the time user interface (e.g., 1202c from FIG. 12A would overlap complication 1204d in FIG. 12B and/or complication 1204c in FIG. 12C). In some embodiments, when the time user interface includes a user interface object of the first type at the second position of the time user interface object, the first element is displayed having a third shape different from the first shape and/or occupying a third display region different from the first display region. The third shape and/or the third display region includes a bend at a second location corresponding to the second position that is not included in the first shape and/or the first display region, and the bend at the second location corresponding to the second position prevents the second shape and/or the second display region from overlapping user interface objects of the first type that are displayed at the second position of the time user interface. Automatically bending an element of the time user interface to accommodate a size and/or shape of a user interface object allows for this operation to be performed without user input. Furthermore, doing also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently. Doing so also permits inclusion of certain over-sized and/or enlarged user interface objects that allow users to view information more quickly.

In some embodiments, the first element of the time user interface comprises a timescale (e.g., seconds dial 1202c) (e.g., a timescale that is part of the indication of time; a seconds dial; a minutes dial; and/or an hours dial that, in combination with a position indicator such as a clock hand or other object, indicates at least a portion of the respective time). In some embodiments, the timescale is associated with a clock hand (e.g., the timescale in combination with the click hand indicates at least a portion of the respective time). In some embodiments, the clock hand changes in size, shape, and/or length at the location of the bend in the timescale (e.g., as the clock hand passes and/or moves along the bend in the timescale). Automatically bending an element of the time user interface to accommodate a size and/or shape of a user interface object allows for this operation to be performed without user input. Furthermore, doing also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently. Doing so also permits inclusion of certain over-sized and/or enlarged user interface objects that allow users to view information more quickly.

In some embodiments, the first element of the time user interface comprises a seconds indicator (e.g., seconds dial 1202c) (e.g., a seconds dial that, in combination with a position indicator such as a clock hand or other object, indicates at least a portion of the respective time). Automatically bending an element of the time user interface to accommodate a size and/or shape of a user interface object allows for this operation to be performed without user input. Furthermore, doing also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently. Doing so also permits inclusion of certain over-sized and/or enlarged user interface objects that allow users to view information more quickly.

In some embodiments, the time user interface (e.g., 1200) includes a first region (e.g., 1216a, 1216b, 1216c, 1216d, 1216e, and/or 1216f) that, when selected, causes the computer system to perform a first operation (e.g., display a first user interface and/or perform a first action); and the first region does not include user interface objects of the first type (e.g., the first region does not include oversized user interface objects, oversized complications, and/or complications and/or user interface objects that are greater than a threshold size, or, in some embodiments, does not include any complications). In some embodiments, while displaying the time user interface (e.g., 1200), the computer system (e.g., 600) detects, via the one or more input devices (e.g., 602), a selection input (e.g., 1220a, 1220b, and/or 1220c) directed to the time user interface (e.g., a tap input, a touch input, a hardware control input, a gesture input, a gaze input, and/or a spoken input). In response to detecting the selection input directed to the time user interface: in accordance with a determination that the selection input corresponds to the first region (e.g., user input 1220b and/or user input 1220c) (e.g., the selection input is directed to the first region, the selection input is located in the first region, and/or at least a portion of the selection input is directed to and/or located in the first region), the computer system performs the first operation (e.g., displays user interface 1224 and/or displays user interface 1230) (e.g., displaying a first user interface associated with and/or corresponding to the first operation; displaying a first user interface associated with and/or corresponding to the first region; displaying a first user interface that includes one or more options for modifying the time user interface and/or one or more features of the time user interface; displaying a first user interface associated with a first application; and/or displaying a first user interface associated with a first complication different from the first user interface object); and in accordance with a determination that the selection input corresponds to a first user interface object of the first type (e.g., user input 1220a) (e.g., the selection input is directed to a first user interface object that is of the first type, the selection input is located within and/or on a first user interface object that is of the first type, and/or at least a portion of the selection input is directed to and/or located on a first user interface object that is of the first type), the computer system performs a second operation different from the first operation (e.g., displays user interface 1222) (e.g., in some embodiments, displaying a second user interface different from the first user interface; displaying a second user interface that corresponds to the first user interface object of the first type; displaying a second user interface that is associated with and/or generated by a first application that is associated with the first user interface object of the first type). Performing a first operation when a user input is directed to the first region and performing a second operation when a user input is directed to a user interface object of the first type enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, displaying the time user interface further includes: in accordance with a determination that the time user interface includes a user interface object of the first type at the first position of the time user interface, defining the first region to have a first shape (e.g., a first shape that excludes the first position of the time user interface) (e.g., region 1216b on the top right of FIG. 12D); and in accordance with a determination that the time user interface does not include a user interface object of the first type at the first position of the time user interface, defining the first region to have a second shape that is different from the first shape (e.g., region 1216b on the top left of FIG. 12D) (e.g., a second shape that includes at least a portion of the first position of the time user interface; and/or a second shape that includes some or all of the first position of the time user interface). In some embodiments, displaying the time user interface further includes: in accordance with a determination that the time user interface includes a user interface object of the first type at a second position of the time user interface different from the first position (and, optionally, does not include a user interface object of the first type at the first position of the time user interface), the computer system defines the first region to have a third shape that is different from the first shape and the second shape (e.g., a third shape that excludes the second position of the time user interface (e.g., region 1216b at the bottom of FIG. 12D) and, optionally, includes at a least a portion of the first position of the time user interface.) In some embodiments, the second shape includes at least a portion of the second position the time user interface. Automatically redefining the shape of the first region based on whether or not a user interface object of the first type is displayed at the first position of the time user interface enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first shape of the first region excludes the first position of the time user interface (e.g., region 1216b on the top right of FIG. 12D); and the second shape of the first region includes at least a portion of the first position of the time user interface (e.g., region 1216b on the top left of FIG. 12D would at least partially overlap complication 1204d from the top right of FIG. 12D). In some embodiments, the first shape of the first region (e.g., 1216b on the top right of FIG. 12D) includes a cutout and/or a removed portion compared to the second shape of the first region in order to exclude the first position (e.g., 1204d on the top right of FIG. 12D) of the time user interface. Automatically redefining the shape of the first region based on whether or not a user interface object of the first type is displayed at the first position of the time user interface enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first region, when displayed in the first shape, has a first size (e.g., occupies a first display area) (e.g., 1216b on the top right of FIG. 12D); and the first region, when displayed in the second shape, has a second size that is larger than the first size (e.g., occupies a second display area that is larger than the first display area) (e.g., 1216b on the top left of FIG. 12D). Automatically redefining the shape of the first region based on whether or not a user interface object of the first type is displayed at the first position of the time user interface enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the time user interface (e.g., 1200) is configured to display user interface objects of the first type (e.g., oversized user interface objects, oversized complications, user interface objects having a size greater than a threshold size, and/or complications having a size greater than a threshold size) in a first number of display positions within the time user interface (e.g., a first plurality of display positions within the time user interface) (e.g., arrangement options 1210a-1210c allow for enlarged complications to be displayed in the bottom right or the bottom left); and the time user interface is configured to display user interface objects of a second type different from the first type (e.g., non-oversized user interface objects, non-oversized complications, user interface objects having a size smaller than a threshold size, and/or complications having a size smaller than a threshold size) in a second number of display positions within the time user interface (e.g., a second plurality of display positions within the time user interface), wherein the second number of display positions is greater than the first number of display positions (e.g., complications of the default size can be displayed in all four corners, whereas complications of enlarged size can only be displayed on the bottom left and bottom right corners). In some embodiments, normal-sized, non-oversized, and/or small complications and/or user interface objects can be displayed in more positions within the time user interface than oversized complications and/or user interface objects. Restricting the number of places in which user interface objects of the first type (e.g., oversized user interface objects) can be displayed enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently. Doing so also permits inclusion of certain over-sized and/or enlarged user interface objects that allow users to view information more quickly.

In some embodiments, in accordance with a determination that the time user interface includes a user interface object of the first type (e.g., an oversized user interface object, and/or a user interface object that is greater than a threshold size) at the first position of the time user interface (e.g., in accordance with a determination that a user interface object of the first type is selected for display at the first position of the time user interface and/or in accordance with a determination that a first device setting is set to a first state in which a user interface object of the first type is displayed at the first position of the time user interface), the computer system (e.g., 600) displays, via the one or more display generation components, at the first position of the time user interface, a first user interface object of the first type at the first position within the time user interface (e.g., a first oversized complication and/or user interface object selected from a plurality of available oversized complications and/or user interface objects) (e.g., 1204d in FIG. 12B); and in accordance with a determination that the time user interface does not include a user interface object of the first type at the first position of the time user interface (e.g., in accordance with a determination that a user interface object of a second type (e.g., a regular-sized user interface object and/or a user interface object that is smaller than the threshold size) different from the first type (e.g., a second type of user interface object that is smaller than the first type) is selected for display at the first position of the time user interface and/or in accordance with a determination that a first device setting is set to a second state in which a user interface object of a second type (e.g., a regular-sized user interface object and/or a user interface object that is smaller than the threshold size) different from the first type is displayed at the first position of the time user interface), the computer system displays, via the one or more display generation components, at the first position of the time user interface, a second user interface object of a second type different from the first type (e.g., a non-oversized user complication and/or user interface object) without displaying the first user interface object of the first type at the first position within the time user interface (e.g., 1204d in FIG. 12A), wherein, the first user interface object of the first type corresponds to the second user interface object of the second type, and represents a larger version of the second user interface object of the second type (e.g., a larger version that occupies a larger display area) (e.g., 1204d in FIG. 12B is an enlarged version and/or a larger version of 1204d in FIG. 12A). Providing oversized version of user interface objects and/or complications allows users to view information more quickly. Doing so enhances the operability of the system and makes the user-system interface more efficient (e.g., by helping the user to view and/or access information more quickly), which reduces power usage and improves battery life of the device by enabling the user to use the system more quickly and efficiently.

In some embodiments, the time user interface (e.g., 1200) includes a first indicator (e.g., 1206, 1206b, 1208a, 1208b, 1208c, and/or 1208d) (e.g., a directional indicator, a progress indicator, and/or other visual indication). In some embodiments, while displaying a first user interface object of the first type at the first position of the time user interface (e.g., 1204d in FIG. 12E) (e.g., while displaying a first oversized user interface object at the first position of the time user interface), the computer system (e.g., 600): displays, via the one or more display generation components, the first indicator at a first indicator position within the time user interface that is outside of the first position of the time user interface (e.g., 1208a and/or 1208b in FIG. 12E); and subsequent to displaying the first indicator at the first indicator position within the time user interface that is outside of the first position of the time user interface, the computer system displays movement of the first indicator to the first position of the time user interface, wherein displaying movement of the first indicator to the first position of the time user interface causes the first indicator to no longer be displayed (e.g., in FIG. 12F, POI representations 1208a and/or 1208b are hidden behind complication 1204d) (e.g., the first indicator is hidden behind the first user interface object of the first type and/or the visual effect is given that the first indicator is hidden behind the first user interface object of the first type at the first position of the time user interface). Hiding the first indicator when the first indicator is positioned at the same position as the first user interface object of the first type enhances the operability of the system and makes the user-system interface more efficient (e.g., by preventing the first indicator from obscuring and/or blocking the first user interface object of the first type). This allows the user to view information provided by the first user interface object of the first type more easily, which reduces power usage and improves battery life of the device by enabling the user to use the system more quickly and efficiently.

In some embodiments, while the first indicator (e.g., 1208a and/or 1208b) is located at the first position of the time user interface and is not displayed (e.g., FIG. 12F), the computer system (e.g., 600) displays, via the one or more display generation components, a second indicator (e.g., 1218a and/or 1218b) that indicates that the first indicator is located at the first position of the time user interface (e.g., a second indicator that indicates and/or suggests that the first indicator is hidden behind the first user interface object of the first type) and is not displayed (e.g., is not displayed due to being located at the first position of the time user interface). In some embodiments, the computer system ceases to display the second indicator (e.g., 1218a and/or 1218b) when the first indicator is moved outside of the first position of the time user interface and is displayed outside of the first position of the time user interface (e.g., FIGS. 12N-120, indication 1218c ceases to be displayed when POI representation 1208c moves from behind complication 1204d). Displaying an indication that the first indicator is located at the first position of the time user interface and is not displayed (e.g., and/or displaying an indication that the first indicator is hidden behind the first user interface object of the first type) provides the user with visual feedback about a state of the system (e.g., that the system is not displaying the first indicator because it is positioned at the first position of the time user interface), thereby improving visual feedback to the user. Furthermore, doing so also enhances the operability of the system and makes the user-system interface more efficient (e.g., by informing the user about a state of the system and helping the user to provide correct inputs and/or avoid erroneous inputs), which reduces power usage and improves battery life of the device by enabling the user to use the system more quickly and efficiently.

In some embodiments, the second indicator (e.g., 1218a, 1218b, and/or 1218c) is animated over time (e.g., moves, oscillates, and/or bounces). Displaying an indication that the first indicator is located at the first position of the time user interface and is not displayed (e.g., and/or displaying an indication that the first indicator is hidden behind the first user interface object of the first type) provides the user with visual feedback about a state of the system (e.g., that the system is not displaying the first indicator because it is positioned at the first position of the time user interface), thereby improving visual feedback to the user. Furthermore, doing so also enhances the operability of the system and makes the user-system interface more efficient (e.g., by informing the user about a state of the system and helping the user to provide correct inputs and/or avoid erroneous inputs), which reduces power usage and improves battery life of the device by enabling the user to use the system more quickly and efficiently.

In some embodiments, the computer system (e.g., 600) concurrently displays, via the one or more display generation components, within the time user interface (e.g., 1200): a first respective user interface object of the first type (e.g., an oversized user interface object and/or a user interface object that is greater than a threshold size) at the first position of the time user interface (e.g., 1204d in FIG. 12B); a first user interface object of a second type (e.g., a non-oversized user interface object, a regular-sized user interface object, a user interface object that is smaller than a threshold size, and/or a user interface object that is smaller than user interface objects of the first type) different from the first type at a second position of the time user interface different from the first position (e.g., 1204a and/or 1204b in FIG. 12B); and a second user interface object of the second type (e.g., a non-oversized user interface object, a regular-sized user interface object, a user interface object that is smaller than a threshold size, and/or a user interface object that is smaller than user interface objects of the first type) that is different from the first user interface object of the second type at a third position of the time user interface that is different from the first position and the second position (e.g., 1204a and/or 1204b in FIG. 12B), wherein: the first respective user interface object of the first type is displayed having a first shape (e.g., 1204d in FIG. 12B); the first user interface object of the second type is displayed having a second shape that is different from the first shape (e.g., 1204a and/or 1204b in FIG. 12B); and the second user interface object of the second type is displayed having a third shape that is different from the first shape (e.g., 1204a and/or 1204b in FIG. 12B). In some embodiments, the third shape is different from the second shape. In some embodiments, the third shape is the same as the second shape. In some embodiments, user interface objects of the first type have a different shape than user interface objects of the second type. Automatically bending an element of the time user interface to accommodate a size and/or shape of a user interface object allows for this operation to be performed without user input. Furthermore, doing also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently. Doing so also permits inclusion of certain over-sized and/or enlarged user interface objects that allow users to view information more quickly.

In some embodiments, displaying the time user interface (e.g., 1200) further includes: in accordance with a determination that the time user interface does not include a user interface object of the first type at the first position of the time user interface (e.g., FIG. 12A) (e.g., in accordance with a determination that a user interface object of a second type (e.g., a regular-sized user interface object and/or a user interface object that is smaller than the threshold size) different from the first type (e.g., a user interface object of a second type that is smaller than the first type) is selected for display at the first position of the time user interface), displaying, via the one or more display generation components, the first element of the time user interface without the bend at the first location corresponding to the first position (e.g., 1202c in FIG. 12A is displayed without a bend to accommodate complication 1204d and/or complication 1204c) (or, optionally, without a change in curvature at the first location corresponding to the first position). Automatically bending an element of the time user interface to accommodate a size and/or shape of a user interface object allows for this operation to be performed without user input. Furthermore, doing also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently. Doing so also permits inclusion of certain over-sized and/or enlarged user interface objects that allow users to view information more quickly.

Note that details of the processes described above with respect to method 1300 (e.g., FIG. 13A) are also applicable in an analogous manner to the methods described above and/or below. For example, methods 700, 900, 1100, 1350, 1500, and/or 1700 optionally include one or more of the characteristics of the various methods described above with reference to method 1300. For example, in various embodiments, the user interface object of the first type recited in method 1300 and/or the first complication recited in method 1500 can be displayed within the time user interface recited in method 700, the wake screen user interface recited in method 900, the time user interface recited in method 1350, and/or the time user interface recited in method 1700. In another example, in various embodiments, the first user interface recited in method 1100 can include the time user interface recited in method 700, the wake screen user interface recited in method 900, the user interface object of the first type recited in method 1300, the time user interface recited in method 1350, the first complication recited in method 1500, and/or the time user interface recited in method 1700. For brevity, these details are not repeated below.

FIG. 13B is a flow diagram illustrating a method for providing time user interfaces using a computer system in accordance with some embodiments. Method 1350 is performed at a computer system (e.g., 100, 300, 500, and/or 600) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 602) (e.g., a display controller, a display, a touch-sensitive display system, a touchscreen, a monitor, and/or a head mounted display system) and one or more input devices (e.g., 602, 604a, and/or 604b) (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 1350 are, optionally, combined, the orders of some operations are, optionally, changed, and some operations are, optionally, omitted.

As described below, method 1350 provides an intuitive way for providing time user interfaces. The method reduces the cognitive burden on a user for accessing time user interfaces and/or accessing information within time user interfaces, thereby creating a more efficient human-machine interface. For battery-operated computing devices, enabling a user to access time user interfaces and/or access information within time user interfaces faster and more efficiently conserves power and increases the time between battery charges.

The computer system (e.g., 600) displays (1302), via the one or more display generation components (e.g., 602), a time user interface (e.g., 1200) (e.g., a user interface that includes an analog and/or digital indication of time, a clock face user interface, a watch face user interface, a reduced-power screen, a wake screen, and/or a lock screen) with a first visual appearance (e.g., FIG. 12E), wherein displaying the time user interface with the first visual appearance includes concurrently displaying: an indication of a respective time (e.g., 1202) (e.g., an analog and/or digital indication of a current time, past time, or future time); a point of interest (POI) region (e.g., 1206 and/or 1206b) that at least partially surrounds (in some embodiments, surrounds and/or completely surrounds) the indication of the respective time; a first POI representation (e.g., one of 1208a, 1208b, 1208c, and/or 1208d) representative of a first point of interest, wherein the first POI representation is displayed at a first display position within the POI region indicative of the first point of interest being located at a first direction relative to the computer system (e.g., 1208a, 1208b, 1208c, and/or 1208d in FIG. 12E); and a second POI representation (e.g., one of 1208a, 1208b, 1208c, and/or 1208d), wherein the second POI representation is representative of a second point of interest different from the first point of interest, and the second POI representation is displayed at a second display position within the POI region different from the first display position, wherein the second display position is indicative of the second point of interest being located at a second direction relative to the computer system (e.g., a second direction different from the first direction) (e.g., 1208a, 1208b, 1208c, and/or 1208d in FIG. 12E). The computer system (e.g., 600) detects (1354), via the one or more input devices, a first movement of the computer system (e.g., a change in heading and/or direction of the computer system) (e.g., FIG. 12E to FIG. 12F). In response to detecting the first movement of the computer system (1356), the computer system displays (1358) (e.g., in some embodiments, concurrently displaying), via the one or more display generation components: movement of the first POI representation within the POI region (e.g., 1206b) from the first display position within the POI region to a third display position within the POI region that is different from the first display position and is indicative of the first point of interest being located at a third direction relative to the computer system (e.g., movement of 1208a-1208d from FIG. 12E-12F) (e.g., a third direction different from the first direction) (1360); and movement of the second POI representation within the POI region (e.g., 1206b) from the second display position within the POI region to a fourth display position within the POI region that is different from the second display position and is indicative of the second point of interest being located at a fourth direction relative to the computer system (e.g., movement of 1208a-1208d from FIG. 12E-12F) (e.g., a fourth direction different from the second direction) (1362). In some embodiments, points of interest include one or more of the following: buildings, geographic locations, addresses, locations of objects, routes, user-specified geographic locations and/or GPS coordinates, user-specified map positions, and/or landmarks. Performing an operation when a set of conditions has been met without requiring further user input (such as by automatically updating the positions of POI representations in response to detected movement of the computer system) enhances the operability of the device by reducing unnecessary inputs and/or steps to navigate through different user interfaces or sets of controls, reducing energy usage by the device. Displaying user interface elements with different appearances at different times (such as POI representations moving to different locations at different times) helps to avoid image persistence or burn in effects that can occur with some display technologies when the same object is displayed with the same appearance at the same location repeatedly or for a long period of time.

In some embodiments, displaying the time user interface with the first visual appearance further comprises: in accordance with a determination that the computer system (e.g., a portion of the computer system and/or a particular portion of the computer system) is directed at (e.g., is pointed at and/or is pointed toward) a first respective point of interest (e.g., FIG. 12F) (e.g., a first respective point of interest in a first category; and/or a first respective point of interest that is within a threshold radius of the computer system), displaying, via the one or more display generation components and within the time user interface, first POI information pertaining to the first respective point of interest (e.g., 1206c in FIG. 12F) (e.g., a name of the first respective point of interest, distance to the first respective point of interest); and in accordance with a determination that the computer system is not directed at the first respective point of interest (e.g., FIG. 12E) (e.g., the computer system is not directed at any point of interest; is not directed at any recognized point of interest; is not directed at any point of interest in a first category; and/or is not directed at any point of interest that is within a threshold radius of the computer system), displaying, via the one or more display generation components, device heading information indicative of a heading of the computer system (e.g., 1206c in FIG. 12E) without displaying the first POI information pertaining to the first respective point of interest. Performing an operation when a set of conditions has been met without requiring further user input (such as by automatically updating the positions of POI representations in response to detected movement of the computer system) enhances the operability of the device by reducing unnecessary inputs and/or steps to navigate through different user interfaces or sets of controls, reducing energy usage by the device. Displaying user interface elements with different appearances at different times (such as POI representations moving to different locations at different times) helps to avoid image persistence or burn in effects that can occur with some display technologies when the same object is displayed with the same appearance at the same location repeatedly or for a long period of time.

In some embodiments, the first point of interest is represented in the time user interface (e.g., 1200) (e.g., by the first POI representation) based on point of interest information received from a first map application (e.g., option 1264b and/or option 1264c in FIG. 12V) (e.g., a first map application installed on the computer system and/or accessible to the computer system). In some embodiments, the point of interest information received from the first map application includes information identifying a name of the first point of interest, a location of the first point of interest, an address of the first point of interest, and/or coordinates of the first point of interest. Performing an operation when a set of conditions has been met without requiring further user input (such as by automatically updating the positions of POI representations in response to detected movement of the computer system) enhances the operability of the device by reducing unnecessary inputs and/or steps to navigate through different user interfaces or sets of controls, reducing energy usage by the device. Displaying user interface elements with different appearances at different times (such as POI representations moving to different locations at different times) helps to avoid image persistence or burn in effects that can occur with some display technologies when the same object is displayed with the same appearance at the same location repeatedly or for a long period of time.

In some embodiments, the second point of interest is represented in the time user interface (e.g., 1200) (e.g., by the second POI representation) based on second point of interest information received from a second application different from the first map application (e.g., in FIG. 12V, there are options to import points of interest from various applications such as a compass application, a maps application, and/or one or more API guide applications) (e.g., a second application that is installed on the computer system and/or is accessible to the computer system). In some embodiments, the second point of interest information received from the second application includes information identifying a name of the second point of interest, a location of the second point of interest, an address of the second point of interest, and/or coordinates of the second point of interest. Performing an operation when a set of conditions has been met without requiring further user input (such as by automatically updating the positions of POI representations in response to detected movement of the computer system) enhances the operability of the device by reducing unnecessary inputs and/or steps to navigate through different user interfaces or sets of controls, reducing energy usage by the device. Displaying user interface elements with different appearances at different times (such as POI representations moving to different locations at different times) helps to avoid image persistence or burn in effects that can occur with some display technologies when the same object is displayed with the same appearance at the same location repeatedly or for a long period of time.

In some embodiments, the first point of interest corresponds to one or more objects associated with a user of the computer system (e.g., 600) (e.g., a vehicle of the user, a campsite of the user, a home of the user, a workplace of the user, a smartphone of the user, a watch of the user, a tablet of the user, and/or a computing device of the user); and the location of the first point of interest is determined based on a detected location of the one or more objects associated with the user of the computer system (e.g., “parked car” in FIGS. 12Q-12R and/or “campsite” in FIG. 12P). In some embodiments, the first POI representation within the time user interface is indicative of the position and/or location of the one or more objects relative to the computer system. Performing an operation when a set of conditions has been met without requiring further user input (such as by automatically updating the positions of POI representations in response to detected movement of the computer system) enhances the operability of the device by reducing unnecessary inputs and/or steps to navigate through different user interfaces or sets of controls, reducing energy usage by the device. Displaying user interface elements with different appearances at different times (such as POI representations moving to different locations at different times) helps to avoid image persistence or burn in effects that can occur with some display technologies when the same object is displayed with the same appearance at the same location repeatedly or for a long period of time.

In some embodiments, while displaying the time user interface (e.g., 1200) with a first number of POI representations (e.g., 1208a-1208d in FIG. 12F) within the POI region (e.g., 1206b) of the time user interface, the computer system detects, via the one or more input devices, a first set of one or more user inputs (e.g., 1220b, 1226, 1228a, and/or 1228c) (e.g., one or more touch inputs, one or more hardware control inputs, one or more button press inputs, one or more rotational inputs, one or more spoken inputs, and/or one or more gesture inputs) corresponding to a user request to modify a threshold POI radius from a first radius to a second radius different from the first radius (e.g., a second radius that is larger than the first radius or a second radius that is smaller than the first radius). In response to detecting the first set of one or more user inputs, the computer system displays, via the one or more display generation components, a second number of POI representations different from the first number of POI representations within the POI region of the time user interface based on modifying the threshold POI radius from the first radius to the second radius (e.g., 1208d, 1218a in FIG. 12J). In some embodiments, in response to detecting the first set of one or more user inputs: in accordance with a determination that the second radius is less than the first radius, the computer system displays the time user interface with a second number of POI representations that is less than the first number of POI representations (e.g., displays fewer POI representations within the POI region); and in accordance with a determination that the second radius is larger than the first radius, the computer system displays the time user interface with a second number of POI representations that is greater than the first number of POI representations (e.g., displays more POI representations within the POI region). Performing an operation when a set of conditions has been met without requiring further user input (such as by automatically updating the positions of POI representations in response to detected movement of the computer system) enhances the operability of the device by reducing unnecessary inputs and/or steps to navigate through different user interfaces or sets of controls, reducing energy usage by the device. Displaying user interface elements with different appearances at different times (such as POI representations moving to different locations at different times) helps to avoid image persistence or burn in effects that can occur with some display technologies when the same object is displayed with the same appearance at the same location repeatedly or for a long period of time.

In some embodiments, in response to detecting the first set of one or more user inputs (e.g., 1220b, 1226, 1228a, and/or 1228c), the computer system displays, via the one or more display generation components and within the time user interface (e.g., 1200), an indication of the second radius (e.g., 1207 in FIG. 12J). In some embodiments, while displaying the time user interface with the first number of POI representations within the POI region of the time user interface (and/or while the threshold POI radius is set to the first radius), the computer system displays an indication of the first radius within the time user interface (e.g., 1207 in FIG. 12F). Providing improved feedback (such as by displaying an indication of a currently-applied search radius) enhances the operability of the device by reducing accidental and mistaken inputs, reducing energy usage by the device.

In some embodiments, while displaying the time user interface (e.g., 1200) with the first POI representation (e.g., 1208a, 1208b, 1208c, and/or 1208d) and the second POI representation (e.g., 1208a, 1208b, 1208c, and/or 1208d) displayed within the POI region (e.g., 1206b) of the time user interface, the computer system detects, via the one or more input devices, a second set of one or more user inputs (e.g., 1220c, 1234c, and/or 1236) (e.g., one or more touch inputs, one or more hardware control inputs, one or more button press inputs, one or more rotational inputs, one or more spoken inputs, and/or one or more gesture inputs) corresponding to a user request to transition the time user interface (e.g., 1200) from a non-targeted POI mode (e.g., FIG. 12F) (e.g., a mode in which multiple points of interest are represented within the time user interface and/or the POI region) to a targeted POI mode (e.g., FIG. 12M) (e.g., a mode in which a single point of interest is represented within the time user interface and/or the POI region) corresponding to the first point of interest (e.g., 1208c and/or “Campsite”), wherein the user request to transition the time user interface from the non-targeted POI mode to the targeted POI mode for the first point of interest includes user identification of the first point of interest (e.g., FIG. 12I). In response to detecting the second set of one or more user inputs, the computer system transitions the time user interface (e.g., 1200) from the non-targeted POI mode (e.g., FIG. 12F) to the targeted POI mode corresponding to the first point of interest (e.g., FIG. 12M), wherein: transitioning the time user interface from the non-targeted POI mode to the targeted POI mode corresponding to the first point of interest includes ceasing display of the second POI representation (e.g., ceasing display of all POI representations other than the first POI representation) while maintaining display of the first POI representation (e.g., in FIG. 12M, only POI representation 1208c is maintained); and in the targeted POI mode corresponding to the first point of interest, the time user interface (e.g., 1200) persistently displays first point of interest information pertaining to the first point of interest (e.g., a name of the first point of interest and/or a distance of the first point of interest from the computer system) without regard for a position (e.g., a direction and/or a location) of the first point of interest relative to the computer system (e.g., 1206c in FIGS. 12M-120). In some embodiments, in the non-targeted POI mode (e.g., 1200 in FIG. 12E), the time user interface does not persistently display the first point of interest information pertaining to the first point of interest without regard for a direction of the first point of interest relative to the computer system (e.g., only displays the first point of interest information when the computer system is directed toward and/or pointed toward the first point of interest). Providing improved feedback (such as by displaying an indication of being in a targeted POI mode) enhances the operability of the device by reducing accidental and mistaken inputs, reducing energy usage by the device. Furthermore, displaying user interface elements with different appearances at different times (such as POI representations moving to different locations at different times) helps to avoid image persistence or burn in effects that can occur with some display technologies when the same object is displayed with the same appearance at the same location repeatedly or for a long period of time.

In some embodiments, the first point of interest information pertaining to the first point of interest includes a name of the first point of interest (e.g., 1206c in FIGS. 12M-120) (e.g., an identifier, a title, and/or a text-based identifier of the first point of interest). Providing improved feedback (such as by displaying an indication of being in a targeted POI mode) enhances the operability of the device by reducing accidental and mistaken inputs, reducing energy usage by the device.

In some embodiments, the first point of interest information pertaining to the first point of interest includes a distance of the first point of interest from the computer system (e.g., 1206c in FIGS. 12M-120) (e.g., an estimated distance and/or a detected distance). Providing improved feedback (such as by displaying an indication of being in a targeted POI mode) enhances the operability of the device by reducing accidental and mistaken inputs, reducing energy usage by the device.

In some embodiments, while displaying the time user interface (e.g., 1200) in the targeted POI mode corresponding to the first point of interest (e.g., FIGS. 12M-120), the computer system detects, via the one or more input devices, a third set of one or more user inputs (e.g., 1238) (e.g., one or more touch inputs, one or more hardware control inputs, one or more button press inputs, one or more rotational inputs, one or more spoken inputs, and/or one or more gesture inputs) corresponding to a user request to transition the time user interface from the targeted POI mode corresponding to the first point of interest to the non-targeted POI mode. In response to detecting the third set of one or more user inputs, the computer system transitions the time user interface (e.g., 1200) from the targeted POI mode corresponding to the first point of interest (e.g., FIGS. 12M-120) to the non-targeted POI mode (e.g., FIG. 12P), wherein: transitioning the time user interface from the targeted POI mode corresponding to the first point of interest to the non-targeted POI mode includes re-displaying the second POI representation (e.g., in FIG. 12P, POI representations 1208a, 1208b, 1208d are re-displayed); and in the non-targeted POI mode, the time user interface does not persistently display the first point of interest information pertaining to the first point of interest without regard for a direction of the first point of interest relative to the computer system (e.g., 1200 in FIG. 12E) (e.g., only displays the first point of interest information when the computer system is directed toward and/or pointed toward the first point of interest). Providing improved feedback (such as by displaying an indication of being in a targeted POI mode) enhances the operability of the device by reducing accidental and mistaken inputs, reducing energy usage by the device. Furthermore, reducing the number of inputs needed to perform an operation (such as initiating or ending a targeted POI mode) enhances the operability of the device by reducing the number of inputs and time required to perform a particular operation, reducing energy usage by the device.

In some embodiments, in response to detecting the first movement of the computer system (e.g., 600): in accordance with a determination that the first POI representation is positioned behind a first respective user interface object (e.g., 1204d) (e.g., a first respective user interface object of the time user interface, a first complication of the time user interface, and/or a first affordance of the time user interface) (e.g., in accordance with a determination that the first POI representation is obscured by and/or hidden by the first respective user interface object), the computer system displays, via the one or more display generation components, a first visual indication (e.g., 1218a and/or 1218b) that the first POI representation is positioned behind the first respective user interface object. In some embodiments, in response to detecting the first movement of the computer system: in accordance with a determination that the first POI representation is not positioned behind the first respective user interface object (and/or in accordance with a determination that no POI representation is positioned behind and/or hidden behind the first respective user interface object), the computer system forgoes display of the first visual indication (e.g., FIG. 12E). Providing improved feedback (such as by displaying an indication of a POI representation moving behind another user interface object) enhances the operability of the device by reducing accidental and mistaken inputs, reducing energy usage by the device. Furthermore, displaying user interface elements with different appearances at different times (such as POI representations moving to different locations at different times) helps to avoid image persistence or burn in effects that can occur with some display technologies when the same object is displayed with the same appearance at the same location repeatedly or for a long period of time.

In some embodiments, while displaying the time user interface (e.g., 1200) with the first POI representation (e.g., 1208a, 1208b, 1208c, and/or 1208d) and the second POI representation (e.g., 1208a, 1208b, 1208c, and/or 1208d) displayed within the POI region (e.g., 1206b) of the time user interface, the computer system detects that the computer system is within a first threshold distance of the first point of interest (e.g., FIG. 12R). In response to detecting that the computer system is within the first threshold distance of the first point of interest, the computer system displays, via the one or more display generation components, a visual indication that computer system is within the first threshold distance of the first point of interest (e.g., 1206c in FIG. 12R). Providing improved feedback (such as by displaying an indication that the computer system is within a threshold distance of a point of interest) enhances the operability of the device by reducing accidental and mistaken inputs, reducing energy usage by the device. Furthermore, displaying user interface elements with different appearances at different times (such as POI representations moving to different locations at different times) helps to avoid image persistence or burn in effects that can occur with some display technologies when the same object is displayed with the same appearance at the same location repeatedly or for a long period of time.

In some embodiments, in response to detecting that the computer system is within the first threshold distance of the first point of interest, the computer system ceases display of the first POI representation and the second POI representation (e.g., in some embodiments, in FIG. 12R, computer system 600 ceases display of all POI representations within ring 1206b; and/or in some embodiments, in FIG. 12R, computer system 600 displays a non-moving version of POI representation 1208m at the top of ring 1206a while ceasing display of all other POI representations) (e.g., in some embodiments, ceasing display of all POI representations within he POI region). Providing improved feedback (such as by displaying an indication that the computer system is within a threshold distance of a point of interest) enhances the operability of the device by reducing accidental and mistaken inputs, reducing energy usage by the device. Furthermore, displaying user interface elements with different appearances at different times (such as POI representations moving to different locations at different times and/or not being displayed at certain times) helps to avoid image persistence or burn in effects that can occur with some display technologies when the same object is displayed with the same appearance at the same location repeatedly or for a long period of time.

In some embodiments, the first threshold distance is a non-fixed threshold distance that is determined based on signal strength information (e.g., GPS signal strength information and/or cellular signal strength information) corresponding to the computer system (e.g., 600) (e.g., signal strength information that is indicative of a confidence and/or a degree of accuracy in determining the geographic location of the computer system). In some embodiments, signal strength information that is indicative of a higher signal strength and/or a higher degree of confidence and/or accuracy in determining the location of the computer system results in a smaller threshold distance; and signal strength information that is indicative of a lower signal strength and/or a lower degree of confidence and/or accuracy in determining the location of the computer system results in a larger threshold distance. Providing improved feedback (such as by displaying an indication that the computer system is within a threshold distance of a point of interest) enhances the operability of the device by reducing accidental and mistaken inputs, reducing energy usage by the device. Furthermore, displaying user interface elements with different appearances at different times (such as POI representations moving to different locations at different times and/or not being displayed at certain times) helps to avoid image persistence or burn in effects that can occur with some display technologies when the same object is displayed with the same appearance at the same location repeatedly or for a long period of time.

In some embodiments, while displaying the time user interface (e.g., 1200), the computer system receives device location information that identifies a first geographic region within which the computer system is determined to be located. In response to receiving the device location information: in accordance with a determination that the device location information identifies a first geographic region that encompasses an area that is greater than a threshold area (e.g., greater than 250 sq. meters, greater than 500 sq. meters, greater than 1000 sq. meters) (e.g., the first geographic region encompasses an area that is greater than the threshold area which, for example, is indicative of a low level of confidence in the location of the computer system), the computer system displays via the one or more display generation components and within the time user interface, a visual indication of low location accuracy (e.g., 1206c in FIG. 12Q); and in accordance with a determination that the device location information identifies a first geographic region that encompasses an area that is less than the threshold area (e.g., the first geographic region encompasses an area that is less than the threshold area which, for example, is indicative of a high level of confidence in the location of the computer system), the computer system maintains display of the time user interface without displaying the visual indication of low location accuracy (e.g., 1200 and/or 1206c in FIG. 12P). Providing improved feedback (such as by displaying an indication that the computer system has less than a threshold level of location accuracy and/or confidence) enhances the operability of the device by reducing accidental and mistaken inputs, reducing energy usage by the device. Furthermore, displaying user interface elements with different appearances at different times (such as selectively displaying or ceasing display of indications at different times) helps to avoid image persistence or burn in effects that can occur with some display technologies when the same object is displayed with the same appearance at the same location repeatedly or for a long period of time.

In some embodiments, the computer system displays, via the one or more display generation components, the time user interface (e.g., 1200) with the visual indication of low location accuracy (e.g., 1206c in FIG. 12Q), including concurrently displaying the first POI representation and the second POI representation within the POI region of the time user interface, wherein the visual indication of low location accuracy is displayed based on a determination that device location information corresponding to the computer system identifies a first respective geographic region that encompasses a first respective geographic area, and wherein: in accordance with a determination that the first point of interest that is represented by the first POI representation is within the first respective geographic region, the first POI representation is displayed with a first set of visual characteristics (e.g., 1208n, 1208o in FIG. 12Q) (e.g., a first color, a first shade, a first saturation, a first brightness, a first size, and/or a first shape); and in accordance with a determination that the first point of interest that is represented by the first POI representation is outside of the first respective geographic region, the first POI representation is displayed with a second set of visual characteristics (e.g., 1208p, 1208q in FIG. 12Q) (e.g., a second color, a second shade, a second saturation, a second brightness, a second size, and/or a second shape) different from the first set of visual characteristics. In some embodiments, in accordance with a determination that the second point of interest that is represented by the second POI representation is within the first respective geographic region, the second POI representation is displayed with the first set of visual characteristics (e.g., a first color, a first shade, a first saturation, a first brightness, a first size, and/or a first shape); and in accordance with a determination that the second point of interest that is represented by the second POI representation is outside of the first respective geographic region, the second POI representation is displayed with the second set of visual characteristics (e.g., a second color, a second shade, a second saturation, a second brightness, a second size, and/or a second shape) different from the first set of visual characteristics. Providing improved feedback (such as by displaying an indication that the computer system has less than a threshold level of location accuracy and/or confidence) enhances the operability of the device by reducing accidental and mistaken inputs, reducing energy usage by the device. Furthermore, displaying user interface elements with different appearances at different times (such as displaying POI representations with different visual characteristics at different times) helps to avoid image persistence or burn in effects that can occur with some display technologies when the same object is displayed with the same appearance at the same location repeatedly or for a long period of time.

Note that details of the processes described above with respect to method 1350 (e.g., FIG. 13B) are also applicable in an analogous manner to the methods described above and/or below. For example, methods 700, 900, 1100, 1300, 1500, and/or 1700 optionally include one or more of the characteristics of the various methods described above with reference to method 1350. For example, in various embodiments, the user interface object of the first type recited in method 1300 and/or the first complication recited in method 1500 can be displayed within the time user interface recited in method 700, the wake screen user interface recited in method 900, the time user interface recited in method 1350, and/or the time user interface recited in method 1700. In another example, in various embodiments, the first user interface recited in method 1100 can include the time user interface recited in method 700, the wake screen user interface recited in method 900, the user interface object of the first type recited in method 1300, the time user interface recited in method 1350, the first complication recited in method 1500, and/or the time user interface recited in method 1700. For brevity, these details are not repeated below.

FIGS. 14A-14J illustrate exemplary user interfaces for providing interactive complications, in accordance with some embodiments. The user interfaces in these figures are used to illustrate the processes described below, including the processes in FIG. 15.

FIG. 14A depicts computer system 600, which is a smart watch with touch-sensitive display 602, rotatable and depressible crown 604a, and button 604b. At FIG. 14A, computer system 600 displays, via touch-sensitive display 602, user interface 1400. User interface 1400 is a time user interface that includes indication of time 1402, and complications 1404a-1404d. In some embodiments, user interface 1400 is user interface 1200 described above with reference to FIG. 12A. For example, in some embodiments, user interface 1400 includes complication 1206, which includes representations of a plurality of points of interest and their locations relative to computer system 600, as discussed above with reference to FIG. 12A. Complication 1404a is a temperature complication that is associated with a weather application and displays the current temperature (e.g., 72 degrees), a forecasted low temperature for the day (e.g., 52 degrees), and a forecasted high temperature for the day (e.g., 89 degrees) for a particular location. In some embodiments, complication 1404a, when selected, causes, computer system 600 to open the weather application and/or display a user interface of the weather application. Complication 1404b is an elevation complication that is associated with an elevation application and displays current elevation information for computer system 600 (e.g., computer system 600 is currently at an elevation of 9,131 feet above sea level). In some embodiments, complication 1404b, when selected, causes computer system 600 to open the elevation application and/or display a user interface of the elevation application. Complication 1404c is a connectivity complication that indicates a connection state of computer system 600, as will be described in greater detail below. In some embodiments, complication 1404c, when selected, causes computer system 600 to perform multiple different actions based on a state of complication 1404c and/or a state of computer system 600, as will be described in greater detail below. Complication 1404d is a physical activity complication that displays the user's progress in the current day towards three different daily physical activity goals (e.g., calories burned; minutes of movement; and/or standing hours). In some embodiments, complication 614d corresponds to and/or is generated by a physical activity application and/or a fitness application.

At FIG. 14A, complication 1404c is displayed in a first state indicating that computer system 600 is connected to a cellular network (e.g., is connected to one or more cellular towers). At FIG. 14A, while complication 1404c is displayed in the first state, computer system 600 detects user input 1406 (e.g., a tap input) corresponding to selection of complication 1404c. On the right side of FIG. 14A, in response to detecting user input 1406 while complication 1404c is displayed in the first state, computer system 600 displays user interface 1408. User interface 1408 is a cellular connection user interface that includes option 1408a, cellular plan information 1408b, cellular data option 1408c, cellular status information 1408d. Option 1408a, when selected, causes computer system 600 to cease display of user interface 408 and, optionally, re-display user interface 1400. In some embodiments, cellular plan information 1408b indicates a cellular carrier and/or cellular provider of computer system 600. Option 1408c, when selected, causes computer system 600 to enable or disable cellular data connections on computer system 600 (e.g., based on a current state of option 1408c). Cellular status information 1408d indicates whether computer system 600 is connected to a cellular network or is not connected to a cellular network.

At FIG. 14B, computer system 600 displays user interface 1400 with complication 1404c in a second state different from the first state of FIG. 14A. In FIG. 14B, the second state of complication 1404c indicates that computer system 600 has network connectivity via a connection with a companion device (e.g., a companion smart phone, such as computer system 800 from previous figures) labeled “ELLIE'S PHONE.” In FIG. 14B, computer system 600 is not connected to a cellular network (e.g., is not connected to cellular towers) directly, but has network connectivity and/or data connectivity via a connection to the companion device. At FIG. 14B, while complication 1404c is displayed in the second state, computer system 600 detects user input 1410 (e.g., a tap input) corresponding to selection of complication 1404c. On the right side of FIG. 14B, in response to detecting user input 1410 while complication 1404c is displayed in the second state, computer system 600 displays user interface 1412. User interface 1412 is a companion device connection user interface that includes option 1412a, connection status information 1412b, companion device information 1412c, and option 1412d. Option 1412a, when selected, causes computer system 600 to cease display of user interface 1412 and, optionally, display user interface 1400. Connection status information 1412b indicates whether computer system 600 is connected to a companion device or is not connected to a companion device. Companion device information 1412c identifies the name and/or identifier of a companion device that computer system 600 is connected to. Option 1412d, when selected, causes computer system 600 to enable or disable Bluetooth connections on computer system 600 (e.g., based on a current state of option 1412d). It can be seen that selection of complication 1404c causes computer system 600 to perform different actions depending on a state of complication 1404c and/or a state of computer system 600 (e.g., perform a first action when complication 1404c is in a first state; and perform a second action when complication 1404c is in a second state).

At FIG. 14C, computer system 600 displays user interface 1400 with complication 1404c in a third state different from the first state of FIG. 14A and the second state of FIG. 14B. In FIG. 14C, the third state of complication 1404c indicates that computer system 600 is connected to a WiFi network named “ELLIE'S WIFI.” At FIG. 14C, while complication 1404c is displayed in the third state, computer system 600 detects user input 1411 (e.g., a tap input) corresponding to selection of complication 1404c. On the right side of FIG. 14C, in response to detecting user input 1411 while complication 1404c is displayed in the third state, computer system 600 displays user interface 1416. User interface 1416 is a WiFi connection user interface that includes option 1416a, option 1416b, wireless network information 1416c, and option 1416d. Option 1416a, when selected, causes computer system 600 to cease display of user interface 1416 and, optionally, display user interface 1400. Option 1416b, when selected, causes computer system 600 to enable or disable WiFi connections on computer system 600 (e.g., based on a current state of option 1416d). Wireless network information 1416c identifies a wireless network that computer system 600 is currently connected to (e.g., “Ellie's WiFi”). Option 1416d, when selected, causes computer system 600 to initiate a process for user selection of a wireless network for computer system 600 to connect to.

At FIG. 14D, computer system 600 displays user interface 1400 with complication 1404c in a fourth state different from the first state of FIG. 14A, the second state of FIG. 14B, and the third state of FIG. 14C. In FIG. 14D, the fourth state of complication 1404c indicates that a satellite network is available for computer system 600 to connect to. In some embodiments, the fourth state of complication 1404c indicates that computer system 600 does not detect any available cellular networks and/or WiFi networks (e.g., satellite network connectivity is a backup option to cellular connections or wireless network connections). At FIG. 14D, while complication 1404c is displayed in the fourth state, computer system 600 detects user input 1418 (e.g., a tap input) corresponding to selection of complication 1404c. On the right side of FIG. 14D, in response to detecting user input 1418 while complication 1404c is displayed in the fourth state, computer system 600 displays user interface 1420. User interface 1420 is a satellite connection user interface that includes option 1420a. Option 140a, when selected, causes computer system 600 to initiate a process for connecting to a satellite network. At FIG. 14D, computer system 600 detects user input 1421, which is a tap input directed to user interface 1420 and/or option 1420a. In some embodiments in response to detecting user input 1421, computer system 600 initiates a process for connecting to a satellite network.

At FIG. 14E, computer system 600 displays user interface 1400 with complication 1404c in a fifth state different from the first state of FIG. 14A, the second state of FIG. 14B, the third state of FIG. 14C, and the fourth state of FIG. 14D. In FIG. 14E, the fifth state of complication 1404c indicates that computer system 600 is connected to a satellite network. In some embodiments, the fifth state of complication 1404c indicates that computer system 600 does not detect any available cellular networks and/or WiFi networks (e.g., satellite network connectivity is a backup option to cellular connections or wireless network connections). At FIG. 14E, while complication 1404c is displayed in the fifth state, computer system 600 detects user input 1424 (e.g., a tap input) corresponding to selection of complication 1404c. On the right side of FIG. 14E, in response to detecting user input 1424 while complication 1404c is displayed in the fifth state, computer system 600 displays user interface 1426. User interface 1424 is a satellite connection user interface that displays indication 1426a, which indicates that computer system 600 is connected to a satellite network, and instructs the user to continue pointing computer system 600 in the current direction to maintain the satellite network connection.

At FIG. 14F, computer system 600 displays user interface 1400 with complication 1404c in a sixth state different from the first state of FIG. 14A, the second state of FIG. 14B, the third state of FIG. 14C, the fourth state of FIG. 14D, and the fifth state of FIG. 14E. In FIG. 14F, the sixth state of complication 1404c indicates that computer system 600 is connected to a satellite network but the connection is weak and/or falls below a threshold signal strength. In the sixth state shown in FIG. 14F, complication 1404c includes an instruction for the user to turn around to improve satellite signal strength. In the depicted embodiments, complication 1404c is displayed with an arrow indicating that the user should turn to the right. In some embodiments, as the user turns in the instructed direction, the arrow of complication 1404c decreases in size until the user is pointed in a desired and/or instructed direction, at which point complication 1404c changes to the fifth state of complication 1404c. In some embodiments, the sixth state of complication 1404c indicates that computer system 600 does not detect any available cellular networks and/or WiFi networks (e.g., satellite network connectivity is a backup option to cellular connections or wireless network connections). At FIG. 14F, while complication 1404c is displayed in the sixth state, computer system 600 detects user input 1428 (e.g., a tap input) corresponding to selection of complication 1404c. At the bottom of FIG. 14F, in response to detecting user input 1428 while complication 1404c is displayed in the sixth state, computer system 600 displays user interface 1430. User interface 1430 is a satellite connection user interface that displays indication 1430a and indication 1430b. Indication 1430a indicates that computer system 600 has a weak satellite signal strength, and instructs the user to turn to improve signal strength. Indication 1430b displays an arrow that indicates that the user should turn to the right towards the satellite. In some embodiments, as the user turns in the instructed direction, the arrow of indication 1430b decreases in size until the user is pointed in a desired and/or instructed direction. In some embodiments, when the user is pointed in the instructed and/or desired direction, computer system 600 replaces display of user interface 1430 with user interface 1426. In some embodiments, while displaying user interface 1426, if the user turns away from the satellite and the satellite connection of computer system 600 falls below a threshold signal strength level, computer system 600 ceases display of user interface 1426 and displays user interface 1430.

FIG. 14G depicts another embodiment in which complication 1404c is displayed in the sixth state. In FIG. 14G, based on a determination that computer system 600 has a weak satellite connection, computer system 600 displays complication 1404c in the sixth state, with an arrow instructing the user to turn right, and also a text instruction instructing the user to turn right. Additionally, complication 1206 surrounding time indication 1402 in user interface 1400 (various embodiments of which were described above, for example, with reference to FIG. 12A) includes representation 1429, which represents a satellite and indicates that the satellite is positioned to the right of the user, and the user should turn right to point towards the satellite. In some embodiments, when computer system 600 does not have a cellular connection or a wireless network connection, and computer system 600 has a weak satellite connection or no satellite connection, a POI tracking feature of computer system 600 and/or user interface 1400 is enabled, in which the nearest detected communications satellite is used as the point of interest that is tracked by computer system 600 and complication 1206. In some embodiments, as described above, when the POI tracking feature is enabled, other POI representations in complication 1206 are no longer displayed, and only a single point of interest being tracked is represented in complication 1206. Various embodiments of the POI tracking feature were described above with reference to FIGS. 12M-120.

At FIG. 14H, computer system 600 detects that the user has turned to the right and/or that computer system 600 is now pointing in the heading of NE 40 degrees, and is pointed towards the satellite. Based on this determination, computer system 600 updates complication 1404c with the instruction “KEEP POINTING,” and also shows representation 1429 at the top of the user interface to indicate that computer system 600 is pointed in the correct and/or instructed direction. At FIG. 14I, computer system 600 has connected to the satellite network, and displays complication 1404c in the fifth state of FIG. 14E to indicate that computer system 600 is connected to the satellite network. In some embodiments, in FIG. 14I, based on a determination that computer system 600 is now connected to a satellite network, computer system 600 disables and/or disengages the POI tracking feature, and re-displays additional POI representations within complication 1206. At FIG. 14J, computer system 600 detects a cellular network and connects to the cellular network, and displays complication 1404c in the first state of FIG. 14A to indicate that computer system 600 is connected to a cellular network.

FIG. 15 is a flow diagram illustrating a method for providing interactive complications using a computer system in accordance with some embodiments. Method 1500 is performed at a computer system (e.g., 100, 300, 500, and/or 600) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 602) (e.g., a display controller, a display, a touch-sensitive display system, a touchscreen, a monitor, and/or a head mounted display system) and one or more input devices (e.g., 602, 604a, and/or 604b) (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 1500 are, optionally, combined, the orders of some operations are, optionally, changed, and some operations are, optionally, omitted.

As described below, method 1500 provides an intuitive way for providing interactive complications. The method reduces the cognitive burden on a user for accessing interactive complications and/or related information, thereby creating a more efficient human-machine interface. For battery-operated computing devices, enabling a user to access interactive complications and/or related information faster and more efficiently conserves power and increases the time between battery charges.

In some embodiments, the computer system (e.g., 600) displays (1502), via the one or more display generation components (e.g., 602), a first set of one or more complications (e.g., 14104a, 1404b, 1404c, and/or 1404d) (e.g., one or more user interface objects and/or one or more icons) including a first complication (e.g., 1404c) (e.g., a first complication that corresponds to a first feature of the computer system; a first complication that corresponds to a first functionality of the computer system; and/or a first complication that is indicative of a state of a first feature of the computer system). In some embodiments, the first set of one or more complications are displayed as part of a user interface, such as a time user interface and/or a wake screen user interface. While displaying the first set of one or more complications (1504), the computer system detects (1506), via the one or more input devices (e.g., 602), one or more inputs (e.g., 1406, 1410, 1411, 1418, 1424, and/or 1428) (e.g., one or more touch inputs, one or more gesture inputs, one or more spoken inputs, and/or one or more hardware control inputs) directed to the first complication (e.g., one or more inputs selecting the first complication; one or more inputs indicative of a user request to select the first complication; one or more touch inputs and/or tap inputs directed to and/or located on the first complication; one or more gesture inputs directed to the first complication; one or more gaze inputs directed to the first complication; one or more hardware control inputs (e.g., crown rotation inputs and/or button presses) corresponding to selection of the first complication; and/or one or more spoken inputs corresponding to a user request to select the first complication). In response to detecting the one or more inputs directed to the first complication (1508): in accordance with a determination that the first complication is in a first state (1510) (e.g., a first state of the first complication that is indicative of an underlying application associated with the first complication being in a first application state; and/or a first state of the first complication that is indicative of the computer system and/or a function of the computer system being in a first system state), the computer system displays (1512), via the one or more display generation components, a first user interface (e.g., 1408, 1412, 1416, 1420, 1426, and/or 1430) (e.g., a first user interface that corresponds to the first state of the first complication); and in accordance with a determination that the first complication is in a second state (e.g., a second state of the first complication that is indicative of an underlying application associated with the first complication being in a second application state; and/or a second state of the first complication that is indicative of the computer system and/or a function of the computer system being in a second system state) different from the first state (1514), the computer system displays (1516), via the one or more display generation components, a second user interface (e.g., 1408, 1412, 1416, 1420, 1426, and/or 1430) (e.g., a second user interface that corresponds to the second state of the first complication) different from the first user interface (e.g., in some embodiments, without displaying the first user interface) (e.g., in FIGS. 14A-14F, selection of complications 1404c results in display of different user interfaces depending on the state of complication 1404c). In some embodiments, displaying the first user interface includes displaying the first user interface without displaying a second user interface. In some embodiments, when the first complication is in the first state, the first complication has a first visual appearance (e.g., 1404c in FIG. 14A); and when the first complication is in the second state, the first complication has a second visual appearance different from the first visual appearance (e.g., 1404c in FIG. 14B). In some embodiments, when a first feature of the computer system is in a first feature state, the first complication is in the first state and/or is displayed with the first visual appearance (e.g., in some embodiments, the first complication being in the first state is indicative of the first feature of the computer system being in the first feature state). In some embodiments, when the first feature of the computer system is in a second feature state different from the first feature state, the first complication is in the second state and/or is displayed with the second visual appearance (e.g., in some embodiments, the first complication being in the second state is indicative of the first feature of the computer system being in the second feature state). In some embodiments, a complication refers to any clock face feature other than those used to indicate the hours and minutes of a time (e.g., clock hands or hour/minute indications). In some embodiments, complications provide data obtained from an application. In some embodiments, a complication includes an affordance that when selected launches a corresponding application. In some embodiments, a complication is displayed at a fixed (and/or, predefined) location on the display. Displaying a first user interface when the first complication is selected in the first state, and displaying a second user interface when the first complication is selected in the second state, allows for multiple different functions to be performed by a single complication and without needing to display multiple different user interface objects, thereby conserving limited display space. Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first user interface is a system user interface (e.g., a system user interface that is generated by an operating system of the computer system; and/or a system user interface that is not generated by and/or is not displayed by an installed application of the computer system) (e.g., in some embodiments, user interfaces 1408, 1412, and/or 1416 are system user interfaces); and the second user interface is an application user interface corresponding to (e.g., generated by and/or displayed by) a first application (e.g., a first application that is different from the operating system of the computer system; and/or a first application that is installed on the computer system) (e.g., in some embodiments, user interface 1420, 1426, and/or 1430 correspond to a satellite connection application). Displaying a first user interface when the first complication is selected in the first state, and displaying a second user interface when the first complication is selected in the second state, allows for multiple different functions to be performed by a single complication and without needing to display multiple different user interface objects, thereby conserving limited display space. Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the system user interface (e.g., 1408, 1412, and/or 1416) is a control center user interface that includes one or more options that, when selected, modify one or more settings of the computer system (e.g., in some embodiments, rather than displaying user interface 1408, 1412, and/or 1416, computer system 600 displays a control center user interface; and/or, in some embodiments, user interface 1408, 1412, and/or 1416 is a control center user interface) (e.g., a volume option that modifies a volume setting of the computer system; a brightness option that modifies a brightness setting of the computer system; a Bluetooth option that turns Bluetooth functionality on or off; a Wi-Fi option that turns Wi-Fi functionality on or off; a cellular option that turns cellular connections on or off; and/or a satellite option that turns satellite communications on or off). Displaying a first user interface when the first complication is selected in the first state, and displaying a second user interface when the first complication is selected in the second state, allows for multiple different functions to be performed by a single complication and without needing to display multiple different user interface objects, thereby conserving limited display space. Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first user interface corresponds to a first functionality (e.g., user interface 1408 pertains to cellular connection functionality; user interface 1412 pertains to companion device connection functionality; user interface 1416 pertains to wireless network connection functionality; and user interfaces 1420, 1426, and/or 1430 pertain to satellite network connection functionality) (e.g., a first functionality of the computer system and/or a first functionality of a first application), and includes a first set of options for controlling one or more aspects of the first functionality (e.g., Wi-Fi connections, Bluetooth connections, cellular connections, and/or satellite connections); and the second user interface corresponds to a second functionality different from the first functionality (e.g., user interface 1408 pertains to cellular connection functionality; user interface 1412 pertains to companion device connection functionality; user interface 1416 pertains to wireless network connection functionality; and user interfaces 1420, 1426, and/or 1430 pertain to satellite network connection functionality), and includes a second set of options different from the first set of options and for controlling one or more aspects of the second functionality (e.g., Wi-Fi connections, Bluetooth connections, cellular connections, and/or satellite connections). Displaying a first user interface when the first complication is selected in the first state, and displaying a second user interface when the first complication is selected in the second state, allows for multiple different functions to be performed by a single complication and without needing to display multiple different user interface objects, thereby conserving limited display space. Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first functionality is a first communication functionality (e.g., Wi-Fi connections, Bluetooth connections, cellular connections, and/or satellite connections) (e.g., user interface 1408 pertains to cellular connection functionality; user interface 1412 pertains to companion device connection functionality; user interface 1416 pertains to wireless network connection functionality; and user interfaces 1420, 1426, and/or 1430 pertain to satellite network connection functionality); and the second functionality is a second communication functionality different from the first communication functionality (e.g., Wi-Fi connections, Bluetooth connections, cellular connections, and/or satellite connections) (e.g., user interface 1408 pertains to cellular connection functionality; user interface 1412 pertains to companion device connection functionality; user interface 1416 pertains to wireless network connection functionality; and user interfaces 1420, 1426, and/or 1430 pertain to satellite network connection functionality). Displaying a first user interface when the first complication is selected in the first state, and displaying a second user interface when the first complication is selected in the second state, allows for multiple different functions to be performed by a single complication and without needing to display multiple different user interface objects, thereby conserving limited display space. Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, displaying the first set of one or more complications comprises: in accordance with a determination that the first complication is in the first state, displaying the first complication with a first set of visual characteristics (e.g., with a first icon, with a first set of text, with a first size, with a first color, and/or with a first brightness) indicative of the first complication being in the first state (e.g., in FIG. 14A, complication 1404c is displayed with a first visual appearance that indicates computer system 600 is connected to a cellular network; and in FIG. 14B, complication 1404c is displayed with a second visual appearance that indicates that computer system 600 is connected to a companion device); and in accordance with a determination that the first complication is in the second state, displaying the first complication with a second set of visual characteristics (e.g., with a second icon different from the first icon, with a second set of text different from the first set of text, with a second size different from the first size, with a second color different from the first color, and/or with a second brightness different from the first brightness) that is different from the first set of visual characteristics and is indicative of the first complication being in the second state (e.g., in FIG. 14A, complication 1404c is displayed with a first visual appearance that indicates computer system 600 is connected to a cellular network; and in FIG. 14B, complication 1404c is displayed with a second visual appearance that indicates that computer system 600 is connected to a companion device). Changing the appearance of the first complication based on the state of the first complication provides the user with visual feedback about a state of the system (e.g., whether the first complication is in the first state or the second state). Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, displaying the first complication with the first set of visual characteristics indicative of the first complication being in the first state further comprises: in accordance with a determination that the first complication is in the first state (e.g., a first state indicative of a Wi-Fi connection, a cellular connection, a device connection, a Bluetooth connection, or a satellite connection) and the first state has a first status (e.g., Wi-Fi connection to a first Wi-Fi network, Wi-Fi connection having a first signal strength, cellular connection to a first cellular network, cellular connection having a first signal strength, Bluetooth connection to a first device, and/or satellite connection having a first signal strength), displaying, via the one or more display generation components, the first complication with the first set of visual characteristics and a first set of supplemental visual characteristics (e.g., with a first respective icon, with a first respective set of text, with a first respective size, with a first respective color, and/or with a first respective brightness) indicative of the first complication being in the first state and having the first status (e.g., in FIG. 14B, complication 1404c is displayed with a visual appearance indicating that computer system 600 is connected to a companion device, and also with supplemental information indicating that computer system 600 is connected to a device named “ELLIE'S PHONE”; and in FIG. 14C, complication 1404c is displayed with a visual appearance indicating that computer system 600 is connected to a wireless network, and also with supplemental information indicating that computer system 600 is connected to a wireless network named “ELLIE'S WIFI”); and in accordance with a determination that the first complication is in the first state (e.g., a first state indicative of a Wi-Fi connection, a cellular connection, a device connection, a Bluetooth connection, or a satellite connection) and the first state has a second status (e.g., Wi-Fi connection to a first Wi-Fi network, Wi-Fi connection having a first signal strength, cellular connection to a first cellular network, cellular connection having a first signal strength, Bluetooth connection to a first device, and/or satellite connection having a first signal strength) different from the first status, displaying, via the one or more display generation components, the first complication with the first set of visual characteristics and a second set of supplemental visual characteristics (e.g., with a second respective icon, with a second respective set of text, with a second respective size, with a second respective color, and/or with a second respective brightness) different from the first set of supplemental visual characteristics and indicative of the first complication being in the first state and having the second status (e.g., in FIG. 14C, had computer system 600 been connected to a different wireless network, complication 1404c would be displayed with different supplemental information identifying the name of that wireless network). In some embodiments, the first set of visual characteristics (e.g., displaying the first complication with the first set of visual characteristics) indicates that the complication is in the first state (e.g., indicates a connection type being used by the computer system and/or indicates a connection type being represented by the complication). In some embodiments, both the first set of supplemental visual characteristics and the second set of supplemental visual characteristics are indicative of the complication being in the first state. In some embodiments, the first set of supplemental visual characteristics indicates that the first state has a first status (e.g., the first connection type and/or communication type associated with the first state has a first status (e.g., connected, not connected, weak connection, and/or strong connection)); and the second set of supplemental visual characteristics indicates that the first state has a second status (e.g., the first connection and/or communication type associated with the first state has a second status (e.g., connected, not connected, weak connection, and/or strong connection)). Changing the appearance of the first complication based on the state of the first complication and based on a status of the state of the first complication provides the user with visual feedback about a state of the system (e.g., whether the first complication is in the first state and whether the first state has a first status or a second status). Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first status corresponds to (e.g., is indicative of) a first error status of the first state (e.g., connection disconnected and/or weak connection) (e.g., in FIG. 14G, complication 1404c is displayed with a status “TURN RIGHT” that indicates that the satellite network connection is weak and/or note working). In some embodiments, the first set of supplemental visual characteristics (e.g., displaying the first complication with the first set of supplemental visual characteristics) indicates that the first state is in the first error status. Changing the appearance of the first complication based on the state of the first complication and based on a status of the state of the first complication provides the user with visual feedback about a state of the system (e.g., whether the first complication is in the first state and whether the first state has a first status or a second status). Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first complication (e.g., 1404c) is associated with a first system functionality (e.g., connection type, Wi-Fi, Bluetooth, cellular, and/or satellite); and displaying the first complication with the first set of visual characteristics and the first set of supplemental visual characteristics includes displaying the first complication with a first set of instructions for interacting with the first system functionality (e.g., “TURN RIGHT” in FIG. 14G; and/or “KEEP POINTING” in FIG. 14H) (e.g., stay at current location to maintain signal strength, turn around to improve signal strength, or move to improve signal strength). Displaying the first set of instructions for interacting with the first system functionality provides the user with visual feedback about a state of the system (e.g., whether the first complication is in the first state and whether the first state has a first status or a second status). Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, while displaying the first complication with the first set of visual characteristics and the first set of supplemental visual characteristics, including displaying the first complication with the first set of instructions for interacting with the first system functionality (e.g., FIG. 14F, displaying complication 1404c with instruction “TURN AROUND”), the computer system (e.g., 600) detects, via the one or more input devices, one or more selection inputs (e.g., 1428) corresponding to selection of the first complication (e.g., one or more touch inputs and/or tap inputs directed to and/or located on the first complication; one or more gesture inputs directed to the first complication; one or more gaze inputs directed to the first complication; one or more hardware control inputs (e.g., crown rotation inputs and/or button presses) corresponding to selection of the first complication; and/or one or more spoken inputs corresponding to a user request to select the first complication). In response to detecting the selection input corresponding to selection of the first complication, the computer system displays, via the one or more display generation components, a second set of instructions different from the first set of instructions and that pertain to the first system functionality (e.g., 1430a in user interface 1430) (e.g., a second set of instructions that provide additional details related to the first set of instructions and/or the first system functionality). Displaying the first set of instructions for interacting with the first system functionality provides the user with visual feedback about a state of the system (e.g., whether the first complication is in the first state and whether the first state has a first status or a second status). Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, the first complication (e.g., 1404c) corresponds to a satellite connectivity functionality (e.g., a non-terrestrial communication functionality) of the computer system (e.g., 600); the determination that the first complication is in the first state comprises a determination that terrestrial communication (e.g., cellular, Wi-Fi, and/or Bluetooth) is not available (e.g., no terrestrial network, no cellular network, and no Wi-Fi network is detected) (e.g., FIGS. 14I, cellular and/or wireless networks are not available); displaying the first user interface comprises displaying a first respective user interface that pertains to non-terrestrial (e.g., satellite) connectivity of the computer system (e.g., a first respective user interface that includes information about a non-terrestrial and/or a satellite connection of the computer system and/or a first respective user interface that includes one or more options for initiating and/or managing a non-terrestrial and/or a satellite connection of the computer system) (e.g., user interfaces 1420, 1426, and/or 1430 pertain to satellite connectivity); the determination that the first complication is in the second state comprises a determination that terrestrial communication is available (e.g., one or more terrestrial communication networks are detected) (e.g., FIGS. 14A-14C, a cellular connection and/or a wireless network connection is available); and displaying the second user interface comprises displaying a second respective user interface that pertains to terrestrial connectivity of the computer system (e.g., user interface 1408, user interface 1412, and/or user interface 1416 pertain to terrestrial connectivity, such as cellular network connectivity, Bluetooth connectivity, and/or wireless network connectivity) (e.g., a second respective user interface that includes information about a terrestrial connection of the computer system and/or a second respective user interface that includes one or more options for initiating and/or managing a terrestrial connection of the computer system). In some embodiments, the second respective user interface does not pertain to non-terrestrial and/or satellite connectivity of the computer system. In some embodiments, the second respective user interface does not include any options that pertain to and/or control non-terrestrial and/or satellite connectivity of the computer system. Displaying a satellite connectivity user interface when the first complication is selected and a terrestrial communication link is not available, and displaying a terrestrial connectivity user interface when the first complication is selected and terrestrial communication is available, allows for multiple different functions to be performed by a single complication and without needing to display multiple different user interface objects, thereby conserving limited display space. Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

In some embodiments, displaying the first set of one or more complications, including displaying the first complication, further comprises: in accordance with a determination that terrestrial communication is not available (e.g., FIGS. 14D-14I, displaying, via the one or more display generation components, the first complication (e.g., 1404c) in a first manner (e.g., with a first icon, with a first set of text, with a first size, with a first color, and/or with a first brightness) indicating that terrestrial communication is not available (e.g., 1404c in FIGS. 14D-14I); and in accordance with a determination that terrestrial communication is available (e.g., FIGS. 14A-14C), displaying, via the one or more display generation components, the first complication in a second manner (e.g., with a second icon, with a second set of text, with a second size, with a second color, and/or with a second brightness) different from the first manner and indicating that terrestrial communication is available (e.g., 1404c in FIGS. 14A-14C). Changing the appearance of the first complication based on the whether or not terrestrial communication is available provides the user with visual feedback about a state of the system (e.g., whether the computer system detects any terrestrial communications networks). Furthermore, doing so also enhances the operability of the system and makes the user-system interface more efficient (e.g., by helping the user to provide proper inputs and/or by reducing erroneous inputs), which reduces power usage and improves battery life of the device by enabling the user to use the system more quickly and efficiently.

Note that details of the processes described above with respect to method 1500 (e.g., FIG. 15) are also applicable in an analogous manner to the methods described above and/or below. For example, methods 700, 900, 1100, 1300, 1350, and/or 1700 optionally include one or more of the characteristics of the various methods described above with reference to method 1500. For example, in various embodiments, the user interface object of the first type recited in method 1300 and/or the first complication recited in method 1500 can be displayed within the time user interface recited in method 700, the wake screen user interface recited in method 900, the time user interface recited in method 1350, and/or the time user interface recited in method 1700. In another example, in various embodiments, the first user interface recited in method 1100 can include the time user interface recited in method 700, the wake screen user interface recited in method 900, the user interface object of the first type recited in method 1300, the time user interface recited in method 1350, the first complication recited in method 1500, and/or the time user interface recited in method 1700. For brevity, these details are not repeated below.

FIGS. 16A-16X illustrate exemplary user interfaces for providing time user interfaces, in accordance with some embodiments. The user interfaces in these figures are used to illustrate the processes described below, including the processes in FIG. 17.

FIG. 16A depicts computer system 600, which is a smart watch with touch-sensitive display 602, rotatable and depressible crown 604a, and button 604b. At FIG. 16A, computer system 600 displays, via touch-sensitive display 602, user interface 1602. User interface 1602 is a time user interface that includes indication of time 1604. In the depicted embodiments, indication of time 1604 includes hour hand 1604a, minute hand 1604b, and second hand 1604c. User interface 1602 also includes a background behind indication of time 1604 that includes horizontal rows 1608a-1608e, vertical columns 1610a-1610e, and diagonal 1609 that divides (e.g., separates) horizontal rows 1608a-1608e from vertical columns 1610a-1610e. In FIG. 16A, and throughout FIGS. 16A-16X, each horizontal row 1608a-1608e is labeled with one or two letters (e.g., R, O, Y, G, B) to indicate the color of the row (e.g., red, orange, yellow, green, blue). Similarly, each vertical column 1610a-1610e is labeled with one or two letters (e.g., V, LB, W, LP, P) to indicate the color of the vertical column (e.g., violet, light blue, white, light pink, pink). As will be described in greater detail below, the background of user interface 1602 (e.g., horizontal rows 1608a-1608e and/or vertical columns 1610a-1610e) changes over time and/or in response to certain detected events. In some embodiments, the changes to the background of user interface 1602 provide an indication of the current time and/or an indication of changes in the current time. For example, in some embodiments, user interface 1602 includes one or more shapes and/or blocks overlaid on one or more of horizontal rows 1608a-1608e and/or vertical columns 1610a-1610e to indicate a current hour. For example, on the left side of FIG. 16A, user interface 1602 is shown with block 1612-1 overlaid on at least some of the horizontal rows and vertical columns so that block 1612-1 in conjunction with horizontal rows 1608a-1608e and vertical columns 1610a-1610e appear to form the number “1” (e.g., to indicate that it is currently the 1 o'clock hour). Similarly, in the middle of FIG. 16A, user interface 1602 is shown with block 1612-2a and block 1612-2b overlaid on at least some of the horizontal rows and vertical columns so that block 1612-2a and block 1612-2b, in conjunction with horizontal rows 1608a-1608e and vertical columns 1610a-1610e, appear to form the number “2” (e.g., to indicate that it is currently the 2 o'clock hour). Similarly, on the right side of FIG. 16A, user interface 1602 is shown with block 1612-3a and block 1612-3b overlaid on at least some of the horizontal rows and vertical columns so that block 1612-3a and block 1612-3b, in conjunction with horizontal rows 1608a-1608e and vertical columns 1610a-1610e, appear to form the number “3” (e.g., to indicate that it is currently the 3 o'clock hour). Furthermore, as will be described in greater detail below, the colors used for horizontal rows 1608a-1608e and/or vertical columns 1610a-1610e change over time and/or in response to detected events to provide an interesting visual effect and also, for example, to provide an indication of the passage of time. These features and others will be described in greater detail below.

In some embodiments, diagonal 1609 changes position and/or direction as time progresses and/or in response to detection of a particular event. For example, in some embodiments, diagonal 1609 changes direction and/or changes position at the start of each new hour. At the top left of FIG. 16B, diagonal 1609 is shown going from the bottom left of user interface 1602 to the top right of user interface 1602 for the 1 o'clock, 3 o'clock, 5 o'clock, 7 o'clock, and 9 o'clock hours. On the top right of FIG. 16B, diagonal 1609 is shown going from the bottom right of user interface 1602 to the top left of user interface 1602 for the 2 o'clock, 4 o'clock, 6 o'clock, and 8 o'clock hours. In some embodiments, one or more of horizontal rows 1608a-1608e and/or vertical columns 1610a-1610e are split into more than one region (e.g., more than one color) when certain events are detected. For example, on the bottom left of FIG. 16B, user interface 1602 is shown with top row 1608a divided into two different color segments 1608a-1, 1608a-2 and second row 1608b divided into two different color segments 1608b-1, 1608b-2 for the 10 o'clock and 12 o'clock hours. On the bottom right of FIG. 16B, user interface 1602 is also shown with top row 1608a divided into two different color segments 1608a-1, 1608a-2, with second row 1608b divided into two different color segments 1608b-1, 1608b-2, and third row 1608c divided into two different color segments 1608c-1, 1608c-2 for the 11 o'clock hour. In some embodiments, these additional color sections are provided to indicate that the current hour is a double-digit number (e.g., 10, 11, and/or 12) and/or to make it more readily evident to the user that the current hour is a double digit number.

In some embodiments, the colors of horizontal rows 1608a-1608e are ordered from top to bottom according to a pre-defined ordered set of colors 1611 (shown on the bottom of FIG. 16B). In some embodiments, the colors of vertical columns 1610a-1610e are ordered from right-to-left when diagonal 1609 goes from bottom-left to top-right (e.g., for odd-numbered hours in FIG. 16B), and the colors of vertical columns 1610a-1610e are flipped and ordered from left-to-right when diagonal 1609 goes from bottom-right to top-left (e.g., for even-numbered hours in FIG. 16B). In some embodiments, the colors of vertical columns 1610a-1610e are ordered according to the same pre-defined order set of colors 1611 as horizontal rows 1608a-1608e, but vertical column 1610a-1610e show a different portion of the predefined ordered set of colors 1611 than horizontal rows 1608a-1608e at any given time. In some embodiments, the colors in horizontal rows 1608a-1608e advance by one position and/or the colors in vertical columns 1610a-1610e advance by one position in response to a detected event. These features will be described in greater detail below, for example, with reference to FIGS. 16P-16S.

As noted above, in some embodiments, computer system 600 displays time user interface 1602 with one or more blocks overlaid on horizontals rows 1608a-1608e and/or vertical columns 1610a-1610e so that time user interface 1602 appears to form the number of the current hour. FIGS. 16C-1 through 16C-3 depict examples of time user interface 1602 to demonstrate exemplary placement of blocks on horizontal rows 1608a-1608e and/or vertical columns 1610a-1610e to form numbers. In some embodiments, and as can be seen in FIGS. 16C-1 through 16C-3, the blocks that are overlaid on horizontal rows 1608a-1608e and/or vertical columns 1610a-1610e have the same width and/or height as the width and/or height of horizontal rows 1608a-1608e and/or vertical columns 1610a-1610e. The top-left of FIG. 16C-1 shows block 1612-1 overlaid on horizontal rows 1608a-1608e and/or vertical columns 1610a-1610e (e.g., completely obscuring vertical column 1610a and horizontal row 1608e, and partially obscuring horizontal row 1608d and horizontal row 1608c) so that user interface 1602 appears to form the number “1” (e.g., to indicate that it is currently the 1 o'clock hour). The top-right of FIG. 16C-1 shows block 1612-2a and block 1612-2b overlaid on horizontal rows 1608a-1608e and/or vertical columns 1610a-1610e (e.g., completely obscuring horizontal row 1608d, and partially obscuring vertical column 1610a, vertical column 1610b, and horizontal row 1608b) so that user interface 1602 appears to form the number “2” (e.g., to indicate that it is currently the 2 o'clock hour). The bottom-left of FIG. 16C-1 shows block 1612-3a and block 1612-3b overlaid on horizontal rows 1608a-1608e and/or vertical columns 1610a-1610e (e.g., completely obscuring horizontal row 1608d, and partially obscuring horizontal row 1608b and vertical column 1610b) so that user interface 1602 appears to form the number “3” (e.g., to indicate that it is currently the 3 o'clock hour). The bottom-right of FIG. 16C-1 shows block 1612-4a and block 1612-4b overlaid on horizontal rows 1608a-1608e and/or vertical columns 1610a-1610e (e.g., partially obscuring horizontal row 1608a, horizontal row 1608b, vertical column 1610a, and vertical column 1610b) so that user interface 1602 appears to form the number “4” (e.g., to indicate that it is currently the 4 o'clock hour). The top-left of FIG. 16C-2 shows block 1612-5a and block 1612-5b overlaid on horizontal rows 1608a-1608e and/or vertical columns 1610a-1610e (e.g., completely obscuring horizontal row 1608d, and partially obscuring horizontal row 1608b, vertical column 1610b, vertical column 1610d, and vertical column 1610e) so that user interface 1602 appears to form the number “5” (e.g., to indicate that it is currently the 5 o'clock hour). The top-right of FIG. 16C-2 shows block 1612-6a and block 1612-6b overlaid on horizontal rows 1608a-1608e and/or vertical columns 1610a-1610e (e.g., completely obscuring horizontal row 1608b, and partially obscuring horizontal row 1608d, vertical column 1610b, and vertical column 1610d) so that user interface 1602 appears to form the number “6” (e.g., to indicate that it is currently the 6 o'clock hour). The bottom-left of FIG. 16C-2 shows block 1612-7 overlaid on horizontal rows 1608a-1608e and/or vertical columns 1610a-1610e (e.g., completely obscuring horizontal rows 1608d, 1608e) so that user interface 1602 appears to form the number “7” (e.g., to indicate that it is currently the 7 o'clock hour). The bottom-right of FIG. 16C-2 shows block 1612-8a and block 1612-8b overlaid on horizontal rows 1608a-1608e and/or vertical columns 1610a-1610e (e.g., partially obscuring horizontals row 1608b, vertical column 1610b, and vertical column 1610c) so that user interface 1602 appears to form the number “8” (e.g., to indicate that it is currently the 8 o'clock hour). The top-left of FIG. 16C-3 shows block 1612-9a and block 1612-9b overlaid on horizontal rows 1608a-1608e and/or vertical columns 1610a-1610e (e.g., completely obscuring horizontal row 1608d, and partially obscuring horizontal row 1608b and vertical column 1610b) so that user interface 1602 appears to form the number “9” (e.g., to indicate that it is currently the 9 o'clock hour). The top-right of FIG. 16C-3 shows block 1612-10a and block 1612-10b overlaid on horizontal rows 1608a-1608e and/or vertical columns 1610a-1610e (e.g., partially obscuring horizontal row 1608c, horizontal row 1608d, vertical column 1610a, and vertical column 1610d) so that user interface 1602 appears to form the number “10” (e.g., to indicate that it is currently the 10 o'clock hour). The bottom-left of FIG. 16C-3 shows block 1612-11a and block 1612-11b overlaid on horizontal rows 1608a-1608e and/or vertical columns 1610a-1610e (e.g., completely obscuring horizontal row 1608e, vertical column 1610a, and vertical column 1608c, and partially obscuring horizontal row 1608c and horizontal row 1608d) so that user interface 1602 appears to form the number “11” (e.g., to indicate that it is currently the 11 o'clock hour). The bottom-right of FIG. 16C-3 shows block 1612-12a, block 1612-12b, and block 1612-12c overlaid on horizontal rows 1608a-1608e and/or vertical columns 1610a-1610e (e.g., completely obscuring horizontal row 1608d, and partially obscuring horizontal row section 1608b-2, vertical column 1610a, and vertical column 1610d) so that user interface 1602 appears to form the number “12” (e.g., to indicate that it is currently the 12 o'clock hour).

FIGS. 16D through 160 depict example animations to show various example embodiments of how computer system 600 animates user interface 1602 at the start of a new hour. At FIG. 16D, indication of time 1604 indicates that the time is currently 8:59, and computer system 600 displays user interface 1602 with block 1612-8a and block 1612-8b overlaid on horizontal rows 1608a-1608e and vertical columns 1610a-1610e so that user interface 1602 appears to form the number “8” (e.g., to indicate that it is currently the 8 o'clock hour). At FIG. 16E, computer system 600 detects that the time is now 9:00, and updates indication of time 1604 to indicate the current time. Additionally, based on a determination that it is now 9:00, computer system 600 reverses the order of the colors of vertical columns 1610a-1610e, and displays block 1612-8a moving off screen to the right and displays block 1612-8b moving downwards off display 602. At FIG. 16F, block 1612-8a and block 1612-8b have been moved completely off screen and are no longer displayed. Additionally, at FIG. 16F, computer system 600 displays diagonal 1609 rotating in a counter-clockwise direction and at FIG. 16G, computer system 600 continues to display diagonal 1609 rotating in a counter-clockwise direction until at FIG. 16H, diagonal 1609 is now directed from the bottom-left of user interface 1602 to the top-right of user interface 1602. At FIG. 16I, computer system 600 displays block 1612-9a and block 1612-9b moving to the right from the left side of display 602 and at FIG. 16J, block 1612-9a and block 1612-9b are in place and stop moving.

At FIG. 16K, computer system 600 detects that the time is now 10:00, and updates indication of time 1604 to indicate the current time. Additionally, based on a determination that it is now 10:00, computer system 600 reverses the order of the colors of vertical columns 1610a-1610e, and displays block 1612-9a and block 1612-9b moving out of view to the left until in FIG. 16L, they are no longer displayed. Additionally, from FIG. 16L to FIG. 16M, computer system 600 displays diagonal 1609 rotating in a counter-clockwise direction so that in FIG. 16M, diagonal 1609 is now oriented from the top-left of user interface 1602 to the bottom-right of user interface 1602. In some embodiments, diagonal 1609 is rotated in a clockwise direction rather than the counter-clockwise direction shown in FIG. 16L. In some embodiments, diagonal 1609 is rotated in one direction when the hour changes from an odd number to an even number, and is rotated in the opposite direction when the hour changes from an even number to an odd number. At FIG. 16N, computer system 600 displays the vertical line between vertical column 1610b and vertical column 1610c extend upwards past diagonal 1609 to divide horizontal row 1608a into two horizontal color segments 1608a-1, 1608a-2, and to also divide horizontal row 1608b into two horizontal color segments 1608b-1, 1608b-2. At FIG. 16N, computer system 600 also displays block 1612-10a moving upwards into view from the bottom of display 602, and displays blocks 1612-10b moving leftwards into view from the right side of display 602. At FIG. 160, block 1612-10a and block 1612-10b are in place and stop moving.

As mentioned above, in some embodiments, horizontal rows 1608a-1608e and/or vertical columns 1610a-1610e are displayed in different colors that are ordered according to a pre-defined ordered sequence of colors (e.g., sequence 1611 in FIG. 16B). In some embodiments, the colors of horizontal rows 1608a-1608e and/or vertical columns 1610a-1610e change in response to detecting an event and/or in response to user input. FIGS. 16P-16S depict example embodiments in which the colors of horizontal rows 1608a-1608e and/or vertical columns 1610a-1610e are changed in response to user input. FIG. 16P depicts the example scenario in which user interface 1602 is configured for a single-digit even-numbered hour (e.g., 2 o'clock, 4 o'clock, 6 o'clock, or 8 o'clock). On the left side of FIG. 16P, computer system 600 displays user interface 1602 with horizontal rows 1608a-1608e displayed in red, orange, yellow, green, and blue, respectively, and with vertical columns 1610a-1610e displayed in violet, light blue, white, light pink, and pink, respectively. On the left side of FIG. 16P, computer system 600 detects user input 1618 (e.g., in some embodiments, a tap input). On the right side of FIG. 16P, in response to detecting user input 1618, computer system 600 displays the colors of horizontal rows 1608a-1608e advancing by one color from bottom-to-top according to the ordered sequence 1611 shown in FIG. 16B, such that horizontal rows 1608a-1608e are now shown in orange, yellow, green, blue, and violet, respectively. Similarly, in response to detecting user input 1618, computer system 600 displays the colors of vertical columns 1610a-1610e advancing by one color from right-to-left according to the ordered sequence 1611 shown in FIG. 16B, such that vertical column 1610a changes from violet to light blue, vertical column 1610b changes from light blue to white, vertical column 1610c changes from white to light pink, vertical column 1610d changes from light pink to pink, and vertical column 1610e changes from pink to red. In this way, a user is able to provide user input to update the colors of user interface 1602.

FIG. 16Q depicts the example scenario in which user interface 1602 is configured for a single-digit odd-numbered hour (e.g., 1 o'clock, 3 o'clock, 5 o'clock, 7 o'clock, or 9 o'clock). On the left side of FIG. 16Q, computer system 600 displays user interface 1602 with horizontal rows 1608a-1608e displayed in red, orange, yellow, green, and blue, respectively, and with vertical columns 1610a-1610e displayed in pink, light pink, white, light blue, and violet, respectively. On the left side of FIG. 16Q, computer system 600 detects user input 1620 (e.g., in some embodiments, a tap input). On the right side of FIG. 16Q, in response to detecting user input 1620, computer system 600 displays the colors of horizontal rows 1608a-1608e advancing by one color from bottom-to-top according to the ordered sequence 1611 shown in FIG. 16B, such that horizontal rows 1608a-1608e are now shown in orange, yellow, green, blue, and violet, respectively. Similarly, in response to detecting user input 1620, computer system 600 displays the colors of vertical columns 1610a-1610e advancing by one color from left-to-right (e.g., a direction opposite the direction of the color shift shown in FIG. 16P) according to the ordered sequence 1611 shown in FIG. 16B, such that vertical column 1610a changes from pink to red, vertical column 1610b changes from light pink to pink, vertical column 1610c changes from white to light pink, vertical column 1610d changes from light blue to white, and vertical column 1610e changes from violet to light blue.

FIGS. 16R and 16S show similar features as FIGS. 16P and 16Q, but with user interface 1602 in an arrangement for two-digit numbered hours. FIG. 16R depicts the example scenario in which user interface 1602 is configured for a double-digit even-numbered hour (e.g., 10 o'clock or 12 o'clock). On the left side of FIG. 16R, computer system 600 displays user interface 1602 with horizontal row segment 1608a-1 in red, horizontal row segment 1608a-2 in yellow, horizontal row segment 1608b-1 in orange, horizontal row segment 1608b-2 in green, horizontal row 1608c in blue, horizontal row 1608d in violet, and horizontal row 1608e in light blue. In some embodiments, partial row segments 1608a-1, 1608a-2, 1608b-1, 1608b-2 are ordered such that segment 1608a-1 is ordered in front of segment 1608b-1, which is ordered in front of segment 1608a-2, which is ordered in front of segment 1608b-2. In other embodiments, the partial row segments are ordered differently (e.g., 1608a-1, then 1608a-2, then 1608b-1, then 1608b-2). On the left side of FIG. 16R, computer system 600 also displays vertical columns 1610a-1610e displayed in white, light pink, pink, red, and orange, respectively. On the left side of FIG. 16R, computer system 600 detects user input 1622 (e.g., in some embodiments, a tap input). On the right side of FIG. 16R, in response to detecting user input 1622, computer system 600 displays the colors of the horizontal rows and row segments 1608a-1, 1608a-2, 1608b-1, 1608b-2, 1608c, 1608d, 1608e advancing by one color according to the ordered sequence 1611 shown in FIG. 16B. As such, row segment 1608a-1 changes from red to orange, row segment 1608b-1 changes from orange to yellow, row segment 1608a-2 changes from yellow to green, row segment 1608b-2 changes from green to blue, row 1608c changes from blue to violet, row 1608d changes from violet to light blue, and row 1608e changes from light blue to white. Similarly, in response to detecting user input 1622, computer system 600 displays the colors of vertical columns 1610a-1610e advancing by one color from right-to-left according to the ordered sequence 1611 shown in FIG. 16B, such that vertical column 1610a changes from white to light pink, vertical column 1610b changes from light pink to pink, vertical column 1610c changes from pink to red, vertical column 1610d changes from red to orange, and vertical column 1610e changes from orange to yellow.

FIG. 16S depicts the example scenario in which user interface 1602 is configured for a double-digit odd-numbered hour (e.g., 11 o'clock). On the left side of FIG. 16S, computer system 600 displays user interface 1602 with horizontal row segment 1608a-1 in green, horizontal row segment 1608a-2 in red, horizontal row segment 1608b-1 in blue, horizontal row segment 1608b-2 in orange, horizontal row segment 1608c-1 in violet, horizontal row segment 1608c-2 in yellow, horizontal row 1608d in light blue, and horizontal row 1608e in white. In some embodiments, partial row segments 1608a-1, 1608a-2, 1608b-1, 1608b-2, 1608c-1, 1608c-2 are ordered such that segment 1608a-2 is ordered in front of segment 1608b-2, which is ordered in front of segment 1608c-2, which is ordered in front of segment 1608a-1, which is ordered in front of segment 1608b-1, which is ordered in front of segment 1608c-1. In other embodiments, the partial row segments are ordered differently (e.g., 1608a-2, then 1608a-1, then 1608b-2, then 1608b-1, then 1608c-2, then 1608c-1). On the left side of FIG. 16S, computer system 600 also displays vertical columns 1610a-1610e displayed in yellow, orange, red, pink, and light pink, respectively. On the left side of FIG. 16S, computer system 600 detects user input 1624 (e.g., in some embodiments, a tap input). On the right side of FIG. 16S, in response to detecting user input 1624, computer system 600 displays the colors of the horizontal rows and row segments 1608a-1, 1608a-2, 1608b-1, 1608b-2, 1608c-1, 1608c-2, 1608d, 1608e advancing by one color according to the ordered sequence 1611 shown in FIG. 16B. As such, row segment 1608a-2 changes from red to orange, row segment 1608b-2 changes from orange to yellow, row segment 1608c-2 changes from yellow to green, row segment 1608a-1 changes from green to blue, row segment 1608b-1 changes from blue to violet, row segment 1608c-1 changes from violet to light blue, row 1608d changes from light blue to white, and row 1608e changes from white to light pink. Similarly, in response to detecting user input 1624, computer system 600 displays the colors of vertical columns 1610a-1610e advancing by one color from left-to-right according to the ordered sequence 1611 shown in FIG. 16B, such that vertical column 1610a changes from yellow to green, vertical column 1610b changes from orange to yellow, vertical column 1610c changes from red to orange, vertical column 1610d changes from pink to red, and vertical column 1610e changes from light pink to pink.

FIGS. 16T-16W depict example embodiments and/or scenarios in which the colors of user interface 1602 (e.g., the colors of horizontal rows 1608a-1608e and/or vertical columns 1610a-1610e) change based on computer system 600 switching between a higher power state and a lower power state and/or vice versa. FIG. 16T depicts two different scenarios. The top of FIG. 16T depicts a scenario in which the current time is 5:20 PM, and the bottom of FIG. 16T depicts a scenario in which the current time is 5:45 PM. In both scenarios, computer system 600 displays user interface 1602 with the same arrangement of colors shown for horizontal rows 1608a-1608e and vertical columns 1610a-1610e. At the top of FIG. 16T, computer system 600 detects user input 1632a (e.g., a wrist down gesture) and at the bottom of FIG. 16T, computer system 600 detects user input 1632b (e.g., a wrist down gesture).

In some embodiments, in response to a wrist down gesture, computer system 600 transitions from a higher power state to a lower power state. In some embodiments, in the higher power state, display 602 is set to a higher brightness level than in the lower power state. In some embodiments, in the higher power state, display 602 is updated at a higher frequency than in the lower power state. In some embodiments, in the lower power state, one or more displayed elements are displayed with lower brightness, contrast, saturation, and/or definition compared to the higher power state (e.g., in order to decrease battery usage and/or power consumption while in the lower power state). In some embodiments, when computer system 600 is operating in the higher power state, horizontal rows 1608a-1608e and/or vertical columns 1610a-1610e are displayed in solid colors (e.g., filled with and/or substantially filled with color). In some embodiments, when computer system 600 transitions from the higher power state to the lower power state (e.g., in response to user input 1632a and/or user input 1632b), user interface 1602 is displayed with horizontal rows 1608a-1608e and/or vertical columns 1610a-1610e only partially filled with color (e.g., filled with less color than in the higher power state). This is shown in FIGS. 16U and 16V by depicting horizontal rows 1608a-1608e and/or vertical columns 1610a-1610e with strips of color rather than being filled with color. Additionally, in some embodiments, when computer system 600 is operating in the lower power state, computer system 600 automatically updates and/or changes the colors of horizontal rows 1608a-1608e and/or vertical columns 1610a-1610e according to a fixed schedule. For example, in FIG. 16U, when computer system 600 is operating in the lower power state, computer system 600 automatically displays user interface 600 with a first arrangement of colors from 5:00-5:11; computer system 600 automatically displays user interface 600 with a second arrangement of colors from 5:12-5:23; computer system 600 automatically displays user interface 600 with a third arrangement of colors from 5:24-5:35; computer system 600 automatically displays user interface 600 with a fourth arrangement of colors from 5:36-5:47; and computer system 600 automatically displays user interface 600 with a fifth arrangement of colors from 5:48-5:59.

At the top of FIG. 16V, in response to detecting user input 1632a, computer system 600 transitions from the higher power state to the lower power state, updates user interface 1602 from a higher power version (e.g., in which horizontal rows 1608a-1608e and vertical columns 1610a-1610e are filled and/or substantially filled with color) to a lower power version (e.g., in which horizontal rows 1608a-1608e and vertical columns 1610a-1610e are only partially filled with color), and automatically updates the colors of horizontal rows 1608a-1608e and vertical columns 1610a-1610e based on the current time (e.g., 5:20 PM) and the schedule shown in FIG. 16U. At the bottom of FIG. 16V, in response to detecting user input 1632B, computer system 600 transitions from the higher power state to the lower power state, updates user interface 1602 from a higher power version to a lower power version, and automatically updates the colors of horizontal rows 1608a-1608e and vertical columns 1610a-1610e based on the current time (e.g., 5:45 PM) and the schedule shown in FIG. 16U. At the top of FIG. 16V, computer system 600 detects user input 1644a (e.g., a wrist up gesture) and at the bottom of FIG. 16V, computer system 600 detects user input 1644b (e.g., a wrist up gesture).

At the top of FIG. 16W, in response to detecting user input 1644a, computer system 600 transitions from the lower power state to the higher power state, and updates user interface 1602 from the lower power version of user interface 1602 to the higher power version of user interface 1602. Additionally, in the depicted embodiments, in response to user input 1644a, computer system 600 displays horizontal rows 1608a-1608e and vertical columns 1610a-1610e with the color arrangement that was automatically applied to user interface 1602 while computer system was operating in the lower power state. Similarly, at the bottom of FIG. 16W, in response to detecting user input 1644b, computer system 600 transitions from the lower power state to the higher power state, and updates user interface 1602 from the lower power version of user interface 1602 to the higher power version of user interface 1602. Additionally, in the depicted embodiments, in response to user input 1644b, computer system 600 displays horizontal rows 1608a-1608e and vertical columns 1610a-1610e with the color arrangement that was automatically applied to user interface 1602 while computer system was operating in the lower power state. As such, whereas user interface 1602 was displayed with the same arrangement of colors in FIG. 16T, the top scenario and the bottom scenario in FIGS. 16V and 16W have different color arrangements applied due to computer system 600 transitioning to the lower power state in FIG. 16V.

At FIG. 16X, computer system 600 displays, via touch-sensitive display 602, user interface 1650. In the depicted embodiments, user interface 1650 includes current date indication 1652, current time indication 1654, and contextual stack 1656. In various embodiments, contextual stack 1656 includes one or more user interface objects 1656a-1656c. In some embodiments, contextual stack 1656 and/or user interface objects 1656a-1656c are updated, modified, replaced, and/or re-ordered based on a current context of computer system 600 (e.g., a location-based context of the computer system, a time-based context of the computer system, based on one or more detected calendar events associated with the user of the computer system, and/or based on one or more actions being performed by the computer system). For example, in some embodiments, user interface object 1656a is displayed at the top of contextual stack 1656 and/or included in contextual stack 1656 based on a determination that computer system 600 and/or a connected device and/or affiliated device (e.g., a smart phone) is playing a music track. In some embodiments, user interface object 1656c is included in contextual stack 1656 based on a determination that a user of computer system 600 has a scheduled appointment tomorrow at 10:30 AM. In some embodiments, user interface object 1656c would be re-ordered to the top of contextual stack 1656 if the scheduled appointment was coming up in less than a threshold number of minutes (e.g., was taking place in one hour, in 30 minutes, in 15 minutes, or in 5 minutes).

Current time indication 1654 includes indication of time 1655, horizontal rows 1658a-1658c, vertical columns 1660a-1660c, and diagonal 1659 between horizontal rows 1658a-1658c and vertical columns 1660a-1660c. In some embodiments, one or more of the features described above with respect to user interface 1602, horizontal rows 1608a-1608e, vertical columns 1610a-1610e, and/or diagonal 1609 can be applied to current time indication 1654, horizontal rows 1658a-1658c, vertical columns 1660a-1660c, and/or diagonal 1659. For example, in some embodiments, diagonal 1659 is oriented in a first orientation for odd-numbered hours (e.g., as shown on the left side of FIG. 16X) and is oriented in a second orientation for even-numbered hours (e.g., as shown on the right side of FIG. 16X). In another example, in some embodiments, the colors of horizontal rows 1658a-1658c and/or vertical columns 1660a-1660c are arranged in a particular order and/or can be changed and/or advanced in response to user input. In yet another example, in some embodiments, when computer system 600 transitions from a higher power state to a lower power state, current time indication 1654 is displayed with less color saturation and/or with less color fill than in a higher power state, and/or the colors of current time indication 1654 are automatically updated according to a fixed schedule when computer system 600 is operating in the lower power state.

FIG. 17 is a flow diagram illustrating a method for providing time user interfaces using a computer system in accordance with some embodiments. Method 1700 is performed at a computer system (e.g., 100, 300, 500, and/or 600) (e.g., a smartphone, a smartwatch, a tablet computer, a laptop computer, a desktop computer, and/or a head mounted device (e.g., a head mounted augmented reality and/or extended reality device)) that is in communication with one or more display generation components (e.g., 602) (e.g., a display controller, a display, a touch-sensitive display system, a touchscreen, a monitor, and/or a head mounted display system) and one or more input devices (e.g., 602, 604a, and/or 604b) (e.g., a touch-sensitive surface (e.g., a touch-sensitive display); a mouse; a keyboard; a remote control; a visual input device (e.g., one or more cameras (e.g., an infrared camera, a depth camera, a visible light camera, and/or a gaze tracking camera)); an audio input device; a biometric sensor (e.g., a fingerprint sensor, a face identification sensor, a gaze tracking sensor, and/or an iris identification sensor) and/or one or more mechanical input devices (e.g., a depressible input mechanism; a button; a rotatable input mechanism; a crown; and/or a dial)). Some operations in method 1700 are, optionally, combined, the orders of some operations are, optionally, changed, and some operations are, optionally, omitted.

As described below, method 1700 provides an intuitive way for providing time user interfaces. The method reduces the cognitive burden on a user for accessing time user interfaces and/or related information, thereby creating a more efficient human-machine interface. For battery-operated computing devices, enabling a user to access time user interfaces and/or related information faster and more efficiently conserves power and increases the time between battery charges.

In some embodiments, the computer system (e.g., 600) displays (1702), via the one or more display generation components (e.g., 602), a time user interface (e.g., 1602) (e.g., a user interface that includes an analog and/or digital indication of time, a clock face user interface, a watch face user interface, a reduced-power screen, a wake screen, and/or a lock screen) with a first appearance (e.g., a first set of visual elements; a first arrangement of visual elements; a first set of colors; a first sequence of colors; and/or a first arrangement of colors) (e.g., left side of FIG. 16P, FIG. 16Q, FIG. 16R, and/or FIG. 16S), wherein displaying the time user interface with the first appearance includes concurrently displaying: an indication of a respective time (e.g., 1604) (e.g., an analog and/or digital indication of a current time, past time, or future time); a first sequence of colors that includes a first plurality of colors (e.g., a first sequence of colors that is visually grouped together; a first sequence of colors in a respective order; a first sequence of colors that is displayed adjacent to one another; and/or a first sequence of colors that is displayed in a first contiguous and/or semi-contiguous region of the time user interface) (e.g., horizontal rows 1608a-1608e on the left side of FIG. 16P and/or FIG. 16Q); and a second sequence of colors that is different from the first sequence of colors and includes a second plurality of colors different from the first plurality of colors (e.g., vertical columns 1610a-1610e on the right side of FIG. 16P and/or FIG. 16Q) (e.g., a second sequence of colors that is separate from the first sequence of colors; a second sequence of colors that is visually grouped together; a second sequence of colors in a respective order that is optionally different from or the same as the order of the first sequence of colors; a second sequence of colors that is displayed adjacent to one another; and/or a second sequence of colors that is displayed in a second contiguous and/or semi-contiguous region of the time user interface that is different from the first region of the time user interface that displays the first sequence of colors). While displaying the time user interface with the first appearance (1704), the computer system detects (1706) the occurrence of an event (e.g., user input 1618 and/or user input 1620). In some embodiments, detecting the occurrence of the event includes detecting the passage of a respective amount of time (e.g., moving from the first arrangement in FIG. 16U to the second arrangement in FIG. 16U), or detecting, via the one or more input devices, a first user input (e.g., user input 1618 and/or user input 1620) (e.g., one or more touch inputs, one or more hardware control inputs, one or more gaze inputs, one or more gesture inputs, one or more air gesture inputs, one or more spoken inputs, a movement input, and/or a wrist raise input). In response to detecting the event (1708), the computer system displays (1710), via the one or more display generation components, the time user interface (e.g., 1602) with a second appearance (e.g., a second set of visual elements that is optionally different from a first set of visual elements; a second arrangement of visual elements that is optionally different from a first arrangement of visual elements; a second set of colors that is optionally different from a first set of colors; a second sequence of colors that is optionally different from a first sequence of colors; and/or a second arrangement of colors that is optionally different from a first arrangement of colors) different from the first appearance (e.g., right side of FIG. 16P or FIG. 16Q), including: displaying (1712) the first sequence of colors shifted (e.g., displaying the first sequence of colors shifted in the first direction, optionally displaying an animation of the sequence of colors moving and/or shifting in the first direction) in a first direction (e.g., from the left side of FIG. 16P to the right side of FIG. 16P, the colors of horizontal rows 1608a-1608e are shifted upwards); and displaying (1714) the second sequence of colors shifted (e.g., displaying the second sequence of colors shifted in the second direction, optionally displaying an animation of the sequence of colors moving and/or shifting in the second direction) in a second direction different from the first direction (e.g., from the left side of FIG. 16P to the right side of FIG. 16P, the colors of vertical columns 1610a-1610e are shifted to the left). In some embodiments, displaying the first sequence of colors shifted in the first direction includes ceasing display of one or more colors of the first plurality of colors and/or adding one or more colors to the first plurality of colors (e.g., displaying one or more colors in the first sequence of colors that were not displayed in the first arrangement). In some embodiments, displaying the second sequence of colors shifted in the second direction includes ceasing display of one or more colors of the second plurality of colors and/or adding one or more colors to the second plurality of colors (e.g., displaying one or more colors in the second sequence of colors that were not displayed in the first arrangement). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, the indication of the respective time includes one or more negative space elements (e.g., 1612-1, 1612-2a, 1612-2b, 1612-3a, 1612-3b, 1612-4a, 1612-4b, 1612-5a, 1612-5b, 1612-6a, 1612-6b, 1612-7, 1612-8a, 1612-8b, 1612-9a, 1612-9b, 1612-10a, 1612-10b, 1612-11a, 1612-11b, 1612-12a, 1612-12b, and/or 1612-12c) (e.g., one or more shapes, one or more monochromatic shapes, one or more black shapes, one or more white shapes, and/or one or more gray shapes) that are visually distinct from the first sequence of colors (e.g., two or more of 1608a-1608e) and the second sequence of colors (e.g., two or more of 1610a-1610e) (e.g., are a different color from the first sequence of colors and the second sequence of colors) and that, in conjunction with the first sequence of colors and the second sequence of colors, indicate the respective time (e.g., indicate a current time, past time, or future time; indicate at least a portion of a current time, past time, or future time; and/or one or more negative space elements that, in conjunction with the first sequence of colors and the second sequence of colors, form one or more numbers that indicate the respective time and/or at least a portion of the respective time). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, displaying the time user interface (e.g., 1602) with the second appearance different from the first appearance further includes: displaying, via the one or more display generation components (e.g., 602), the first sequence of colors shifted in the first direction (e.g., from the left side of FIG. 16P to the right side of FIG. 16P, the colors of horizontal rows 1608a-1608e are shifted upwards) and displaying the second sequence of colors shifted in the second direction (e.g., from the left side of FIG. 16P to the right side of FIG. 16P, the colors of vertical columns 1610a-1610e are shifted to the left) while maintaining the respective positions of the one or more negative space elements (e.g., without moving the one or more negative space elements) (e.g., from the left side of FIG. 16P to the right side of FIG. 16P, blocks 1612-2a and 1612-2b are maintained). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, while displaying the time user interface (e.g., 1602) (e.g., in some embodiments, with the first appearance or with the second appearance), the computer system detects the occurrence of a second event (e.g., detecting a second event different from the first event; detecting a second event that indicates the passage of a threshold duration of time; and/or detecting that an hour of the current time and/or the respective time has changed from a first hour to a second hour different from the first hour). In response to detecting the occurrence of the second event, the computer system (e.g., 600) displays, via the one or more display generation components, the one or more negative space elements change from a first set of one or more negative space elements having a first negative space appearance (e.g., a first set of one or more negative space elements that has a first number of negative space elements arranged in a first arrangement) to a second set of one or more negative space elements having a second negative space appearance different from the first negative space appearance (e.g., a second set of one or more negative space elements that has a second number of negative space elements arranged in a second arrangement different from the first arrangement) (e.g., from FIG. 16D-FIG. 16J, blocks 1612-8a, 1612-8b are replaced with blocks 1612-9a, 1612-9b). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, displaying the time user interface (e.g., 1602) with the first appearance further includes: displaying, via the one or more display generation components, the first sequence of colors (e.g., two or more of 1608a-1608e) and the second sequence of colors (e.g., two or more of 1610a-1610e) divided along a first line (e.g., 1609) (e.g., a first line that delineates, separates, and/or defines a border between the first sequence of colors and the second sequence of colors), wherein: the first line (e.g., 1609) extends in a first line direction (e.g., bottom-left to top-right and/or bottom-right to top-left); the first line direction is not perpendicular to the first direction (e.g., up, down, left or right); the first line direction is not perpendicular to the second direction (e.g., up, down, left, or right); the first line direction is not parallel to the first direction; and the first line direction is not parallel to the second direction. In some embodiments, the first line is neither perpendicular nor parallel to the first direction or the second direction. In some embodiments, displaying the time user interface with the second appearance further includes displaying the first sequence of colors shifted in the first direction and the second sequence of colors shifted in the second direction while maintaining the first line. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, while displaying the time user interface (e.g., 1602) (e.g., in some embodiments, with the first appearance or with the second appearance), the computer system detects the occurrence of a third event (e.g., detecting a third event different from the first event; detecting a third event that indicates the passage of a threshold duration of time; and/or detecting that an hour of the current time and/or the respective time has changed from a first hour to a second hour different from the first hour); and in response to detecting the occurrence of the third event, the computer system displays, via the one or more display generation components, the first sequence of colors and the second sequence of colors divided along a second line (e.g., a second line that delineates, separates, and/or defines a border between the first sequence of colors and the second sequence of colors) different from the first line, wherein the second line extends in a second line direction different from the first line direction (e.g., from FIG. 16D to FIG. 16J, diagonal 1609 changes direction). In some embodiments, the second direction is not perpendicular to the first direction; the second line direction is not perpendicular to the second direction; the second line direction is not parallel to the first direction; and the second line direction is not parallel to the second direction. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, the computer system (e.g., 600) displays, via the one or more display generation components, the first sequence of colors (e.g., two or more of 608a-608e) with the first plurality of colors and the second sequence of colors (e.g., two or more of 610a-610) with the second plurality of colors divided along the first line extending in the first line direction. While displaying the first sequence of colors with the first plurality of colors and the second sequence of colors with the second plurality of colors divided along the first line (e.g., 1609), the computer system detects the occurrence of the third event. In response to detecting the occurrence of the third event, the computer system displays, via the one or more display generation components, the first sequence of colors and the second sequence of colors divided along the second line different from the first line (e.g., the second line extending in the second line direction different from the first line direction) (e.g., in FIG. 16J, rows 1608a-1608e and columns 1610a-1610e are divided along diagonal 1609, which is in a different direction than it was in FIG. 16D), while maintaining the first plurality of colors in the first sequence of colors and the second plurality of colors in the second sequence of colors (e.g., from FIGS. 16D-16J, diagonal 1609 changes direction, while the colors of rows 1608a-1608e and columns 1610a-1610e are maintained) (e.g., without shifting and/or advancing the colors in the first sequence of colors and without shifting and/or advancing the colors in the second sequence of colors). In some embodiments, in response to detecting the occurrence of the third event, the size and/or shape of one or more elements in the first sequence of colors and/or the second sequence of colors changes, but the order of the first sequence of colors, the first plurality of colors, the second sequence of colors, and/or the second plurality of colors does not change. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, the computer system (e.g., 600) displays, via the one or more display generation components, the time user interface (e.g., 1602) with a third appearance (e.g., a third set of visual elements; a third arrangement of visual elements; a third set of colors; a third sequence of colors; and/or a third arrangement of colors), wherein displaying the time user interface with the third appearance includes concurrently displaying: the indication of the respective time (e.g., 1602 and/or 1604); the first sequence of colors that includes the first plurality of colors (e.g., two or more of 1608a-1608e); and the second sequence of colors that includes the second plurality of colors (e.g., two or more of 1610a-1610e), wherein the first sequence of colors that includes the first plurality of colors and the second sequence of colors that includes the second plurality of colors are divided along the first line (e.g., 1609) that extends in the first line direction. While displaying the time user interface with the third appearance, the computer system detects the occurrence of a fourth event. In some embodiments, detecting the occurrence of the fourth event includes detecting the passage of a respective amount of time, or detecting, via the one or more input devices, one or more user inputs (e.g., one or more touch inputs, one or more hardware control inputs, one or more gaze inputs, one or more gesture inputs, one or more air gesture inputs, one or more spoken inputs, a movement input, and/or a wrist raise input). In response to detecting the fourth event, the computer system: displays, via the one or more display generation components, the time user interface (e.g., 1602) with a fourth appearance (e.g., a fourth set of visual elements; a fourth arrangement of visual elements; a fourth set of colors; a fourth sequence of colors; and/or a fourth arrangement of colors) different from the third appearance, including: displaying, via the one or more display generation components, the first sequence of colors and the second sequence of colors divided by the second line that is different from the first line and extends in the second line direction that is different from the first line direction (e.g., from FIGS. 16D-16J, diagonal 1609 changes direction); and displaying, via the one or more display generation components, at least one of: the first sequence of colors shifted in the first direction; or the second sequence of colors shifted in the second direction (e.g., in some embodiments, from FIGS. 16D-16J, the colors of rows 1608a-1608e and/or columns 1610a-1610e shift, similar to what was described above with reference to FIGS. 16P-16S; and/or in some embodiments, in FIG. 16U, if the time changes from 5:59 to 6:00, diagonal 1609 would change direction, and the colors of rows 1608a-1608e and/or columns 1610a-1610e would automatically shift and/or change). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, displaying the time user interface (e.g., 1602) with the fourth appearance further includes: displaying, via the one or more display generation components, the first sequence of colors (e.g., two or more of 1608a-1608e) shifted in the first direction without shifting the second sequence of colors (e.g., two or more of 1610a-1610e). In some embodiments, the colors of the horizontal rows 1608a-1608e shift without shifting the colors of the vertical columns 1610a-1610e; and/or the colors of vertical columns 1610a-1610e shift without shifting the colors of horizontal rows 1608a-1608e. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, the first plurality of colors (e.g., colors of rows 1608a-1608e) is a first sub-portion of a first ordered set of colors (e.g., 1611); the second plurality of colors (e.g., colors of columns 1610a-1610e) is a second sub-portion of the first ordered set of colors (e.g., 1611) different from the first sub-portion; displaying the first sequence of colors shifted in the first direction comprises displaying, within the first sequence of colors, a third sub-portion of the first ordered set of colors different from the first sub-portion while maintaining a color order of the first ordered set of colors (e.g., the third sub-portion of the first ordered set of colors is displayed in the first sequence of colors in the color order prescribed and/or defined by the first ordered set of colors) (e.g., from left of FIG. 16P to right of FIG. 16P, rows 1608a-1608e show a different subset of colors for sequence 1611); and displaying the second sequence of colors shifted in the second direction comprises displaying, within the second sequence of colors, a fourth sub-portion of the first ordered set of colors different from the second sub-portion and the third sub-portion while maintaining the color order of the first ordered set of colors (e.g., from left of FIG. 16P to right of FIG. 16P, columns 1610a-1610e show a different subset of colors for sequence 1611) (e.g., the fourth sub-portion of the first ordered set of colors is displayed in the second sequence of colors in the color order prescribed and/or defined by the first ordered set of colors). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, the first direction is substantially perpendicular to the second direction (e.g., in some embodiments, the first direction is in a substantially horizontal direction and the second direction is in a substantially vertical direction) (e.g., from the left of FIG. 16P to the right of FIG. 16P, the colors of rows 1608a-1608e shift upwards, and the colors of columns 1610a-1610b shift to the right). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, displaying the time user interface (e.g., 1602) with the first appearance further comprises: in accordance with a determination that the respective time (e.g., a current time and/or the respective time indicated by the indication of the respective time) includes a first number of digits (e.g., single-digit hour or double-digit hour), displaying the first sequence of colors with a first number of colors (e.g., the first plurality of colors includes a first number of colors) (e.g., the top row of FIG. 16B); and in accordance with a determination that the respective time (e.g., a current time and/or the respective time indicated by the indication of the respective time) includes a second number of digits different from the first number of digits (e.g., double-digit hour or single-digit hour), displaying the first sequence of colors with a second number of colors (e.g., the first plurality of colors includes a second number of colors) different from the first number of colors (e.g., the bottom row of FIG. 16B). In some embodiments, when the hour of the respective time is a single-digit number (e.g., an hour of 1, 2, 3, 4, 5, 6, 7, 8, or 9), the first sequence of colors is divided into a first number of segments and/or includes a first number of colors. In some embodiments, when the hour of the respective time is a double-digit number (e.g., an hour of 10, 11, or 12), the first sequence of colors is divided into a second number of segments and/or includes a second number of colors. In some embodiments, the second number is larger than the first number. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, the indication of the respective time includes one or more clock hands (e.g., 1604, 1604a, 1604b, and/or 1604c) (e.g., an hour hand, a minute hand, and/or a second hand) that are indicative of at least a portion of the respective time (e.g., respective positions and/or orientations of the one or more clocks hands are indicative of at least a portion of the respective time), including a first clock hand (e.g., 1604, 1604a, 1604b, and/or 1604c) that is indicative of at least a portion of the respective time. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, displaying the time user interface (e.g., 1602) with the first appearance comprises displaying, via the one or more display generation components (e.g., 602), the first clock hand (e.g., 1604a, 1604b, and/or 1604c) with a first clock hand color; and displaying the time user interface with the second appearance comprises displaying, via the one or more display generation components, the first clock hand (e.g., 1604a, 1604b, and/or 1604c) with a second clock hand color different from the first clock hand color. In some embodiments, when the first sequence of colors shift in the first direction and the second sequence of color shift in the second direction, the color of the first clock hand changes. In some embodiments, the color of the first clock hand changes based on colors presented in the first sequence of colors and/or the second sequence of colors (e.g., to match one or more colors of the first sequence of colors and/or the second sequence of colors). In some embodiments, the first clock hand changes colors to match the color of a smallest row or smallest column (e.g., in some embodiments, in FIG. 16P, from the left side of FIG. 16P to the right side of FIG. 16P, hour hand 1604a, minutes hand 1604b, and/or seconds hand 1604c changes to match the color of column 1610e or row 1608e). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, displaying the time user interface (e.g., 1602) with the first appearance comprises displaying, via the one or more display generation components, a first complication (e.g., in some embodiments, user interface 1602 includes one or more complications, such as complications 1404a, 140b, 1404c, and/or 1404d discussed above in previous figures) (e.g., a first complication that, when selected, causes the computer system to perform a first action corresponding to the first complication and/or causes the computer system to display a first application corresponding to the first complication) with a first complication appearance (e.g., a first color, a first shape, and/or a first size). In some embodiments, displaying the time user interface with the second appearance comprises displaying, via the one or more display generation components, the first complication with a second complication appearance (e.g., a second color, a second shape, and/or a second size) different from the first complication appearance. In some embodiments, as blocks 1612 in user interface 1602 change, computer system 600 moves one or more complications to avoid overlap with one or more blocks 1612. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, while the computer system (e.g., 600) is operating in a first power state (e.g., a normal power state, a high-power state, and/or a higher-power state), the computer system displays, via the one or more display generation components, a higher-power version of the time user interface (e.g., 1602 in FIG. 16T), including: concurrently displaying the indication of the respective time (e.g., 1604 and/or 1612), the first sequence of colors (e.g., two or more of rows 1608a-1608e), and the second sequence of colors (e.g., two or more of columns 1610a-1610e) different from the first sequence of colors; and displaying the first sequence of colors divided into a first plurality of color segments (e.g., 1608a, 1608b, 1608c, 1608d, 1608e, 1608a-1, 1608a-2, 1608b-1, 1608b-2, 1608c-1, and/or 1608c-2), including a first color segment that is substantially filled in a first color and a second color segment different from the first color segment that is substantially filled in a second color different from the first color. In some embodiments, while displaying the time user interface, the computer system detects that low power state criteria are met (e.g., user input 1632a and/or 1632b) (e.g., detecting that the user has moved a body part in a prescribed manner; detecting that the user has lowered his or her wrist while wearing the computer system on his or her wrist; detecting one or more user inputs corresponding to a user request to transition to a lower power state; and/or detecting that the user has not provided user input on the computer system for a threshold duration of time). In response to detecting that the low power state criteria are met, the computer system: transitions the computer system from the first power state to a low power state (e.g., FIG. 16U and/or FIG. 16V) in which the computer system consumes less power than in the first power state (e.g., a low power state in which the one or more display generation components are darkened to a lower brightness; and/or a lower power state in which the one or more display generation components and/or the time user interface is refreshed at a lower frequency than in the first power state); and displays, via the one or more display generation components, a low-power version of the time user interface (e.g., 1602 in FIG. 16U and/or FIG. 16V) that is different from the higher-power version of the time user interface. In some embodiments, displaying the low-power version of the time user interface includes displaying the first sequence of colors divided into the first plurality of color segments (e.g., the same number, size, and/or shape of color segments as the higher-power version of the time user interface), that includes the first color segment 1608a, 1608b, 1608c, 1608d, 1608e, 1608a-1, 1608a-2, 1608b-1, 1608b-2, 1608c-1, and/or 1608c-2 and the second color segment 1608a, 1608b, 1608c, 1608d, 1608e, 1608a-1, 1608a-2, 1608b-1, 1608b-2, 1608c-1, and/or 1608c-2. In some embodiments, transitioning from the higher-power version of the time user interface to the low-power version of the time user interface includes changing the colors shown in the first sequence of colors and/or the second sequence of colors while maintaining the size, shape, and/or numbers of color segments in the first sequence of colors and/or the second sequence of colors. In some embodiments, in the low-power version of the time user interface, the first color segment includes a first set of one or more colored sections that are colored in a first respective color (e.g., a first respective color that is the same as or different from the first color), and a first set of one or more uncolored sections that are not filled with color (e.g., are white or are black) such that the first color segment is not substantially filled with the first respective color (e.g., the first color segment includes portions filled with the first respective color and portions that are uncolored (e.g., are white or are black)) (e.g., in some embodiments, in FIG. 16T, rows 1608a-1608e and/or columns 1610a-1610e are filled in and/or substantially filled in with color; whereas, in some embodiments, in FIG. 16U and/or FIG. 16V, rows 1608a-1608e and/or columns 1610a-1610e are only partially filled in with color). In some embodiments, in the low-power version of the time user interface, the second color segment includes a second set of one or more colored sections that are colored in a second respective color (e.g., a second respective color that is the same as or different from the second color) different from the first respective color, and a second set of one or more uncolored sections that are not filled with color (e.g., are white or are black) such that the second color segment is not substantially filled with the second respective color (e.g., the second color segment includes portions filled with the second respective color and portions that are uncolored (e.g., are white or are black)). In some embodiments, color segments in the higher-power version of the time user interface (e.g., FIG. 16T) are substantially filled with color, and color segments in the low-power version of the time user interface (e.g., FIG. 16U and/or FIG. 16V) are less filled with color and/or have less color (e.g., include more uncolored portions) relative to the higher-power version of the time user interface. Performing an operation when a set of conditions has been met without requiring further user input (such as by transitioning between different power states when criteria are met) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, while the computer system (e.g., 600) is operating in the low power state (e.g., FIG. 16U and/or FIG. 16V), the computer system displays, via the one or more display generation components, the time user interface (e.g., 1602) (e.g., the higher-power version of the time user interface or the low-power version of the time user interface) with a first appearance of the low power state (e.g., leftmost watch in FIG. 16U), including concurrently displaying: the indication of the respective time (e.g., 1604); and the first sequence of colors including a plurality of colors that are different from a plurality of colors included in the second sequence of colors (e.g., two or more of 1608a-1608e and/or 1610a-1610e in the leftmost watch of FIG. 16U). While displaying the time user interface with the first appearance of the low power state, the computer system detects that first time-change criteria are met (e.g., detecting that a first duration of time has elapsed, detecting that one minute has elapsed, detecting that five minutes have elapsed, detecting that the respective time has changed by a threshold amount, and/or detecting that the respective time has changed from a first minute value to a second minute value different from the first minute value). In response to detecting that the first time-change criteria are met: in accordance with a determination that the computer system is operating in the low-power state (and/or, in some embodiments, in accordance with a determination that the low-power version of the time user interface is displayed), the computer system displays, via the one or more display generation components, the time user interface with a second appearance of the low power state different from the first appearance of the low power state (e.g., from the leftmost watch in FIG. 16U to the second watch in FIG. 16U, in response to a change in the current time, computer system 600 shifts the colors of rows 1608a-1608e and columns 1610a-1610e), including: displaying the first sequence of colors shifted in the first direction; and displaying the second sequence of colors shifted in the second direction. In some embodiments, when the computer system is operating in the low-power state, the colors in the first sequence of colors and the second sequence of colors are shifted periodically (e.g., once each minute or once every five minutes). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, in response to detecting that the first time-change criteria are met: in accordance with a determination that the computer system is operating in the first power state (and/or, in some embodiments, in accordance with a determination that the higher-power version of the time user interface is displayed), the computer system maintains display of the time user interface with the first appearance of the low power state, including: forgoing shifting the first sequence of colors in the first direction; and forgoing shifting the second sequence of colors in the second direction (e.g., in some embodiments, when computer system 600 is operating in the higher power state of FIG. 16T, computer system 600 does not automatically shift the colors of rows 1608a-1608e and/or columns 1610a-1610e in response to a change in time). In some embodiments, when the computer system is operating in the low-power state, the colors in the first sequence of colors and the second sequence of colors are shifted periodically according to a first threshold duration of time (e.g., once each minute or once every five minutes) (e.g., FIG. 16U). In some embodiments, when the computer system is operating in the higher-power state (e.g., FIG. 16T), the colors in the first sequence of colors and the second sequence of colors are not shifted and/or changed according to the first threshold duration of time. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, while the computer system is operating in the first power state (e.g., FIG. 16T), the computer system displays, via the one or more display generation components, the higher-power version of the time user interface with a first appearance of the higher-power state (e.g., 1602 in FIG. 16T), wherein displaying the higher-power version of the time user interface with the first appearance of the higher-power state includes concurrently displaying: the indication of the respective time (e.g., 1604); and the first sequence of colors including a plurality of colors that are different from a plurality of colors included in the second sequence of colors (e.g., colors of rows 1608a-1608e). In some embodiments, while displaying the time user interface with the first appearance of the higher-power state, the computer system detects that the low power state criteria are met (e.g., detecting that the user has moved a body part in a prescribed manner; detecting that the user has lowered his or her wrist while wearing the computer system on his or her wrist; detecting one or more user inputs corresponding to a user request to transition to a lower power state; and/or detecting that the user has not provided user input on the computer system for a threshold duration of time) (e.g., user input 1632a and/or 1632b in FIG. 16T). In response to detecting that the low power state criteria are met, the computer system displays, via the one or more display generation components, the low-power version of the time user interface (e.g., 1602 in FIG. 16V) with a third appearance of the low power state, wherein displaying the low-power version of the time user interface with the third appearance of the low power state includes concurrently displaying: the first sequence of colors including a plurality of colors different from the plurality of colors in the first sequence of colors in the first appearance of the higher-power state (e.g., 1602 in FIG. 16V has different colors for rows 1608a-1608e and columns 1610a-1610e than in FIG. 16T); and the second sequence of colors including a plurality of colors different from the plurality of colors in the second sequence of colors in the first appearance of the higher-power state (e.g., 1602 in FIG. 16V has different colors for rows 1608a-1608e and columns 1610a-1610e than in FIG. 16T). While displaying the low-power version of the time user interface with the third appearance of the low power state (e.g., 1602 in FIG. 16V) (e.g., the same as or different from the first appearance of the low power state and/or the second appearance of the low power state), the computer system detects that high power state criteria are met (e.g., user input 1644a and/or 1644b) (e.g., detecting that the user has moved a body part in a prescribed manner; detecting that the user has raised his or her wrist while wearing the computer system on his or her wrist; detecting one or more user inputs corresponding to a user request to transition to a higher power state; and/or detecting one or more user inputs). In response to detecting that the high power state criteria are met, the computer system displays, via the one or more display generation components, the higher-power version of the time user interface with a second appearance of the higher-power state (e.g., 1602 in FIG. 16W), wherein displaying the higher-power version of the time user interface with the second appearance of the higher-power state includes concurrently displaying: the first sequence of colors including a same plurality of colors as were included in the first sequence of colors in the third appearance of the low power state; and the second sequence of colors including a same plurality of colors as were included in the second sequence of colors in the third appearance of the low power state (e.g., in FIG. 16W, the colors of rows 1608a-1608e and columns 1610a-1610e match the colors in FIG. 16V). In some embodiments, when the computer system transitions from the low power state (e.g., FIG. 16V) to the first power state (e.g., FIG. 16W) (e.g., a higher power state), the color sequence in the first sequence of colors and the color sequence in the second sequence of colors is maintained as the time user interface is transitioned from the low-power version of the time user interface to the higher-power version of the time user interface. Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, displaying the time user interface (e.g., 1602) with the first appearance includes: displaying, via the one or more display generation components, the first sequence of colors with the first plurality of colors arranged in a first order (e.g., sequence 1611); and displaying, via the one or more display generation components, the second sequence of colors with the second plurality of colors arranged in a second order (e.g., sequence 1611). In some embodiments, the computer system displays, via the one or more display generation components, a second time user interface (e.g., 1650) different from the time user interface with a respective appearance of the second time user interface, wherein displaying the second time user interface with the respective appearance of the second time user interface includes concurrently displaying: a first set (e.g., a first stack) of contextually relevant information that pertains to the computer system and/or a user of the computer system and that automatically changes (e.g., that is automatically updated) based on a current context of the computer system (e.g., 1656, 1656a, 1656b, and/or 1656c) (e.g., a location-based context of the computer system, a time-based context of the computer system, based on one or more detected calendar events associated with the user of the computer system, and/or based on one or more actions being performed by the computer system); and a second indication of a respective time (e.g., 1654) (e.g., an analog and/or digital indication of a current time, past time, or future time) that includes: a first sequence of colors for the second indication of the respective time that includes at least a subset of the first plurality of colors arranged in the first order (e.g., rows 1658a-1658c); and a second sequence of colors for the second indication of the respective time that includes at least a subset of the second plurality of colors arranged in the second order (e.g., columns 1660a-1660c). In some embodiments, the rows and/or columns of user interface 1650 display colors in the same sequence as the rows and/or columns of user interface 1602 (e.g., sequence 1611). In some embodiments, while displaying the second time user interface (e.g., 1650) with the respective appearance of the second time user interface, the computer system detects the occurrence of a first respective event. In some embodiments, detecting the occurrence of the first respective event includes detecting the passage of a respective amount of time, or detecting, via the one or more input devices, a first user input (e.g., one or more touch inputs, one or more hardware control inputs, one or more gaze inputs, one or more gesture inputs, one or more air gesture inputs, one or more spoken inputs, a movement input, and/or a wrist raise input). In some embodiments, the first respective event is the same as the event. In some embodiments, in response to detecting the occurrence of the first respective event, the computer system displays the second time user interface (e.g., 1650) with a second appearance of the second time user interface different from the respective appearance of the second time user interface, including: displaying the first sequence of colors for the second indication of the respective time shifted in a first respective direction; and displaying the second sequence of colors for the second indication of the respective time shifted in a second respective direction (e.g., in some embodiments, in response to the respective event, the colors of rows 1658a-1658c and/or columns 1660a-1660c are shifted in a manner similar to that of rows 1608a-1608e and/or columns 1610a-1610e discussed above). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, displaying the time user interface (e.g., 1602) with the first appearance includes: displaying the first sequence of colors with a first number of colors (e.g., in FIG. 16W, user interface 1602 includes five rows 1608a-1608e); and displaying the second sequence of colors with a second number of colors (e.g., a second number that is the same as the first number or different from the first number) (e.g., in FIG. 16W, user interface 1602 includes five columns 1610a-1610e). In some embodiments, displaying the second time user interface (e.g., 1650) with the respective appearance of the second time user interface includes: displaying the first sequence of colors for the second indication of the respective time with a first respective number of colors that is less than the first number of colors (e.g., in FIG. 16X, user interface 1650 includes three rows 1658a-1658c); and displaying the second sequence of colors for the second indication of the respective time with a second respective number of colors that is less than the second number of colors (e.g., in FIG. 16X, user interface 1650 includes three columns 1660a-1660c). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, displaying the second time user interface with the first respective appearance further comprises: in accordance with a determination that an hour numeral of the respective time is an even number, displaying the first sequence of colors for the second indication of the respective time (e.g., rows 1658a-1658c) and the second sequence of colors for the second indication of the respective time (e.g., columns 1660a-1660c) divided by a first dividing line (e.g., 1659) that has a first direction for the second indication of the respective time (e.g., 1659 on left side of FIG. 16X); and in accordance with a determination that the hour numeral of the respective time is an odd number, displaying the first sequence of colors for the second indication of the respective time and the second sequence of colors for the second indication of the respective time divided by a second dividing line that has a second direction for the second indication of the respective time different from the first direction for the second indication of the respective time (e.g., 1659 on right side of FIG. 16X). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors) helps to avoid image persistence or burn in effects that can occur with some display technologies when the same object is displayed with the same appearance at the same location repeatedly or for a long period of time.

In some embodiments, the first sequence of colors (e.g., two or more of rows 1608a-1608e) includes a first set of one or more boundaries that separate at least some of (e.g., in some embodiments, all of) the first plurality of colors, including a boundary dividing a first color of the first plurality of colors from a second color of the first plurality of colors (e.g., boundaries between rows 1608a-1608e); and displaying the time user interface with the first appearance further comprises displaying, via the one or more display generation components, an appearance of the boundary changing (e.g., the boundary moving, and/or changing in curvature) over time (e.g., in some embodiments, randomly or pseudorandomly). In some embodiments, displaying the time user interface with the first appearance further comprises displaying, via the one or more display generation components, one or more and/or two or more of the first set of one or more boundaries shifting (e.g., moving and/or moving gradually) over time (e.g., in some embodiments, randomly or pseudorandomly). In some embodiments, a boundary includes an edge of a color region (e.g., 1608a, 1608b, 1608c, 1608d, 1608e, 1608a-1, 1608a-2, 1608b-1, 1608b-2, 1608c-1, 1608c-2, 1610a, 1610b, 1610c, 1610d, and/or 1610e) (e.g., so that when the boundary shifts the region shifts, changes in size, and/or changes in shape based on the change in appearance of the boundary). In some embodiments, a boundary includes a line between two color regions (e.g., 1608a, 1608b, 1608c, 1608d, 1608e, 1608a-1, 1608a-2, 1608b-1, 1608b-2, 1608c-1, 1608c-2, 1610a, 1610b, 1610c, 1610d, and/or 1610e). In some embodiments the second sequence of colors includes a second set of one or more boundaries that separate at least some of (e.g., in some embodiments, all of) the second plurality of colors, including a second boundary dividing a first color of the second plurality of colors from a second color of the second plurality of colors; and displaying the time user interface with the first appearance further comprises displaying, via the one or more display generation components, an appearance of the second boundary changing (e.g., the boundary moving, and/or changing in curvature) over time (e.g., in some embodiments, randomly or pseudorandomly). Providing improved feedback (such as by displaying a change in a user interface upon detection of an event) enhances the operability of the device by reducing accidental and mistaken inputs, reducing energy usage by the device. Furthermore, performing an operation when a set of conditions has been met without requiring further user input (such as by displaying a change in a user interface upon detection of an event) enhances the operability of the device by reducing unnecessary inputs and/or steps to navigate through different user interfaces or sets of controls, reducing energy usage by the device. Additionally, displaying user interface elements with different appearances at different times (such as by shifting sets of colors and/or boundaries) helps to avoid image persistence or burn in effects that can occur with some display technologies when the same object is displayed with the same appearance at the same location repeatedly or for a long period of time.

Note that details of the processes described above with respect to method 1700 (e.g., FIG. 17) are also applicable in an analogous manner to the methods described above. For example, methods 700, 900, 1100, 1300, 1350, and/or 1500 optionally include one or more of the characteristics of the various methods described above with reference to method 1700. For example, in various embodiments, the user interface object of the first type recited in method 1300 and/or the first complication recited in method 1500 can be displayed within the time user interface recited in method 700, the wake screen user interface recited in method 900, the time user interface recited in method 1350, and/or the time user interface recited in method 1700. In another example, in various embodiments, the first user interface recited in method 1100 can include the time user interface recited in method 700, the wake screen user interface recited in method 900, the user interface object of the first type recited in method 1300, the time user interface recited in method 1350, the first complication recited in method 1500, and/or the time user interface recited in method 1700. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve the delivery to users of content that may be of interest to them, such as media items and/or content items for display within time user interfaces, wake screen user interfaces, and/or other user interfaces. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to have calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of user interface generation, the present technology can be configured to allow users to select to “opt in” or “opt out” of participation in the collection of personal information data during registration for services or anytime thereafter. In another example, users can select not to provide personal data for targeted content delivery services. In yet another example, users can select to limit the length of time personal data is maintained or entirely prohibit the use of personal data in providing personalized content. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

1-7. (canceled)

8. A computer system configured to communicate with one or more display generation components, comprising:
one or more processors; and
memory storing one or more programs configured to be executed by the one or more processors, the one or more programs including instructions for:
displaying, via the one or more display generation components, a time user interface, wherein:
the time user interface includes an indication of a respective time;
the time user interface includes a first dial that is used to indicate the respective time; and
displaying the time user interface includes displaying the first dial moving from a first position of the time user interface to a second position of the time user interface different from the first position as the respective time changes.

9. The computer system of claim 8, wherein:
the time user interface includes a first clock hand corresponding to the first dial; and
displaying the time user interface further includes:
displaying, via the one or more display generation components, the first clock hand moving from a first clock hand position to a second clock hand position different from the first clock hand position as the first dial moves from the first position of the time user interface to the second position of the time user interface.

10. The computer system of claim 9, wherein:
the first dial has a first curve; and
the first clock hand is perpendicular to at least a portion of the first curve.

11. The computer system of any of claim 9, wherein:
displaying the first dial moving from the first position of the time user interface to the second position of the time user interface as the respective time changes comprises displaying movement of the first dial from the first position of the time user interface to the second position of the time user interface without displaying rotation of the first dial and without displaying zooming of the first dial; and
displaying the first clock hand moving from the first clock hand position to the second clock hand position comprises displaying the first clock hand moving from the first clock hand position to the second clock hand position while maintaining an orientation of the first clock hand relative to the first dial.

12. The computer system of claim 9, wherein the first clock hand and the first dial both include a first color.

13. The computer system of claim 9, wherein:
the first dial includes a plurality of time division indicators;
the first clock hand overlaps the first dial; and
the first clock hand is at least partially translucent such that one or more time division indicators of the plurality of time division indicators is visible through the first clock hand.

14. The computer system of claim 8, wherein:
the time user interface includes a second dial that is different from the first dial and that is used to indicate the respective time; and
displaying the time user interface further includes displaying the second dial moving from a third position of the time user interface to a fourth position of the time user interface different from the third position as the respective time changes.

15. The computer system of claim 14, the one or more programs further including instructions for:
displaying, via the one or more display generation components, and at a first time, the first dial overlapping the second dial.

16. The computer system of claim 15, the one or more programs further including instructions for:
at a second time subsequent to the first time, concurrently displaying, via the one or more display generation components, the first dial and the second dial without the first dial overlapping the second dial.

17. The computer system of claim 8, wherein:
the time user interface includes a second dial that is different from the first dial and that is used to indicate the respective time; and
the one or more programs further include instructions for:
detecting, via one or more input devices, a first set of one or more user inputs corresponding to a user request to display the time user interface in a first mode, wherein in the first mode, displaying the time user interface includes displaying the first dial changing positions as the respective time changes without displaying the second dial changing positions as the respective time changes;
in response to detecting the first set of one or more user inputs, displaying, via the one or more display generation components, the time user interface in the first mode;
subsequent to detecting the first set of one or more user inputs, detecting, via the one or more input devices, a second set of one or more user inputs corresponding to a user request to display the time user interface in a second mode different from the first mode, wherein in the second mode, displaying the time user interface includes concurrently displaying the first dial changing positions and displaying the second dial changing positions as the respective time changes; and
in response to detecting the second set of one or more user inputs, displaying, via the one or more display generation components, the time user interface in the second mode.

18. The computer system of claim 17, wherein:
the first set of one or more user inputs includes at least a first subset of one or more user inputs that correspond to selection of a first mode option that is displayed within a first user interface that is different from the time user interface; and
the second set of one or more user inputs includes at least a second subset of one or more user inputs that correspond to selection of a second mode option that is different from the first mode option and is displayed within the first user interface.

19. The computer system of claim 17, wherein:
the first set of one or more user inputs is detected while displaying the time user interface and is directed to the time user interface; and
the second set of one or more user inputs is detected while displaying the time user interface and is directed to the time user interface.

20. The computer system of claim 19, the one or more programs further including instructions for:
prior to detecting the first set of one or more user inputs, displaying, via the one or more display generation components, the time user interface in a third mode different from the first mode and the second mode, wherein:
in the third mode of the time user interface, the first dial is displayed outside of the second dial;
in the third mode of the time user interface, the first dial is displayed at a first size and the second dial is displayed at a second size;
in the first mode of the time user interface, the first dial is displayed at a first expanded size that is larger than the first size and the second dial is displayed at the second size; and
in the second mode of the time user interface, the first dial is displayed at the first expanded size and the second dial is displayed at a second expanded size that is larger than the second size;
while displaying the time user interface, detecting, via the one or more input devices, a third set of one or more user inputs; and
in response to detecting the third set of one or more user inputs:
in accordance with a determination that the time user interface was displayed in the third mode when the third set of one or more user inputs was detected, displaying, via the one or more display generation components, the first dial at the first expanded size while maintaining display of the second dial at the second size; and
in accordance with a determination that the time user interface was displayed in the first mode when the third set of one or more user inputs was detected, displaying, via the one or more display generation components, the second dial at the second expanded size.

21. The computer system of claim 19, the one or more programs further including instructions for:
in response to detecting the second set of one or more user inputs, displaying, via the one or more display generation components, the second dial expanding from a second respective size to a second respective expanded size that is larger than the second respective size; and
subsequent to detecting the second set of one or more user inputs:
in accordance with a determination that first criteria are satisfied, automatically displaying, via the one or more display generation components, the second dial at the second respective size.

22. The computer system of claim 19, wherein:
the first set of one or more user inputs is detected while displaying the first dial at a first size;
the second set of one or more user inputs is detected while displaying the second dial at a second size; and
the one or more programs further include instructions for:
in response to detecting the first set of one or more user inputs:
displaying, via the one or more display generation components, the first dial at a first expanded size that is larger than the first size; and
in response to detecting the second set of one or more user inputs:
displaying, via the one or more display generation components, the second dial at a second expanded size that is larger than the second size.

23. The computer system of claim 19, the one or more programs further including instructions for:
while displaying the time user interface, including displaying the first dial at a first expanded size, detecting, via the one or more input devices, a third set of one or more user inputs; and
in response to detecting the third set of one or more user inputs:
displaying, via the one or more display generation components, the first dial at a first size that is smaller than the first expanded size.

24. The computer system of claim 19, wherein:
the time user interface includes a first clock hand corresponding to the first dial; and
the one or more programs further include instructions for:
in response to detecting the first set of one or more user inputs:
displaying, via the one or more display generation components, expansion of the first dial from a first size to a first expanded size that is larger than the first size, including:
in accordance with a determination that the first clock hand is pointed in a first respective direction when the first set of one or more user inputs is detected, expanding the first dial in a first expansion direction that corresponds to the first respective direction; and
in accordance with a determination that the first clock hand is pointed in a second respective direction different from the first respective direction when the first set of one or more user inputs is detected, expanding the first dial in a second expansion direction that is different from the first expansion direction and that corresponds to the second respective direction.

25. The computer system of claim 8, the one or more programs further including instructions for:
displaying, via the one or more display generation components and within the time user interface, the first dial at a first dial size;
while displaying the first dial at the first dial size, detecting, via one or more input devices, a first user input; and
in response to detecting the first user input:
displaying, via the one or more display generation components and within the time user interface, the first dial changing in size from the first dial size to a second dial size that is different from the first dial size.

26. The computer system of claim 25, the one or more programs further including instructions for:
while displaying the first dial having the first dial size, displaying, via the one or more display generation components, the first dial moving at a first speed of movement; and
while displaying the first dial having the second dial size, displaying, via the one or more display generation components, the first dial moving at a second speed of movement that is different from the first speed of movement.

27. The computer system of claim 8, wherein displaying the time user interface further includes:
while displaying the first dial at the first position of the time user interface, displaying, via the one or more display generation components, within the time user interface, a first complication at a first complication position within the time user interface, wherein the first complication at the first complication position does not overlap the first dial when the first dial is in the first position of the time user interface; and
while displaying the first dial at the second position of the time user interface, displaying, via the one or more display generation components, within the time user interface, the first complication at a second complication position within the time user interface that is different from the first complication position, wherein the first complication at the second complication position does not overlap the first dial when the first dial is in the second position of the time user interface.

28. The computer system of claim 27, wherein displaying the time user interface further includes:
while displaying the first dial moving from the first position of the time user interface to the second position of the time user interface, displaying, via the one or more display generation components, the first complication moving gradually from the first complication position to the second complication position as the first dial moves from the first position of the time user interface to the second position of the time user interface.

29. The computer system of claim 27, wherein:
the first complication position does not overlap the second complication position; and
displaying the time user interface further includes:
while displaying the first dial moving from the first position of the time user interface to a third position of the time user interface that is between the first position and the second position of the time user interface, maintaining display of the first complication at the first complication position; and
in accordance with a determination that the first dial has moved to the second position of the time user interface:
ceasing display of the first complication at the first complication position; and
displaying, via the one or more display generation components, the first complication at the second complication position.

30. The computer system of claim 8, wherein:
the time user interface includes:
a first display mode setting, wherein when the first display mode setting is enabled, a default display state of the time user interface includes displaying, via the one or more display generation components, the first dial at a first size and displaying movement of the first dial around the time user interface; and
a second display mode setting different from the first display mode setting, wherein when the second display mode setting is enabled, the default display state of the time user interface includes displaying, via the one or more display generation components, the first dial at a second size that is smaller than the first size, and displaying, via the one or more display generation components, the first dial as a stationary object that does not move around the time user interface; and
displaying the time user interface further includes:
in accordance with a determination that the first display mode setting is enabled, displaying, via the one or more display generation components, a first complication in a first region of the time user interface while displaying the first dial moving from the first position of the time user interface to the second position of the time user interface; and
in accordance with a determination that the second display mode setting is enabled, forgoing display of the first complication in the first region of the time user interface while displaying the first dial moving from the first position of the time user interface to the second position of the time user interface.

31. The computer system of claim 30, wherein:
displaying the time user interface further includes:
in accordance with a determination that the first display mode setting is enabled, displaying, via the one or more display generation components, a second complication different from the first complication in a second region of the time user interface different from the first region of the time user interface while displaying the first dial moving from the first position of the time user interface to the second position of the time user interface; and
in accordance with a determination that the second display mode setting is enabled, forgoing display of the second complication in the second region of the time user interface while displaying the first dial moving from the first position of the time user interface to the second position of the time user interface.

32. The computer system of claim 8, wherein:
the time user interface further comprises a second dial separate from the first dial that is used to indicate the respective time; and
displaying the time user interface further comprises:
in accordance with a determination that a first color combination setting is enabled, concurrently displaying the first dial in a first color corresponding to the first color combination setting and the second dial in a second color that is different from the first color and that corresponds to the first color combination setting; and
in accordance with a determination that a second color combination setting different from the first color combination setting is enabled, concurrently displaying the first dial in a third color that is different from the first color and that corresponds to the second color combination setting and the second dial in a fourth color that is different from the third color and the second color and that corresponds to the second color combination setting.

33. The computer system of claim 8, wherein:
displaying the time user interface further comprises:
in accordance with a determination that a first display mode of the time user interface is enabled, displaying, via the one or more display generation components, the first dial with a first degree of transparency and overlaid on a background having a first darkness level; and
in accordance with a determination that a second display mode of the time user interface is enabled, displaying, via the one or more display generation components, the first dial with a second degree of transparency that is less transparent than the first degree of transparency and overlaid on a background having a second darkness level that is brighter than the first darkness level.

34. The computer system of claim 8, the one or more programs further including instructions for:
displaying, via the one or more display generation components, the time user interface in a first display state, wherein in the first display state:
the first dial is displayed at a first size and is displayed as a stationary object that does not move within the time user interface; and
the first dial is displayed with a first number of time indication marks that are indicative of at least a portion of the respective time;
while displaying the time user interface in the first display state, detecting, via one or more input devices, a first set of user inputs that correspond to a request to transition the time user interface from the first display state to a second display state different from the first display state; and
in response to detecting the first set of user inputs that correspond to the request to transition the time user interface from the first display state to the second display state, displaying, via the one or more display generation components, the time user interface in the second display state, wherein the second display state:
the first dial is displayed at a second size that is larger than the first size and is displayed as a moving object that changes positions in the time user interfaces as the respective time changes; and
the first dial is displayed with a second number of time indication marks that are indicative of at least a portion of the respective time, wherein the second number is greater than the first number.

35. The computer system of claim 8, the one or more programs further including instructions for:
while the computer system is in a first power state, displaying, via the one or more display generation components, the time user interface in a first expanded display state, wherein in the first expanded display state, the first dial is displayed at a first expanded size;
while displaying the time user interface in the first expanded display state, detecting that low power state criteria are met; and
in response to detecting that the low power state criteria are met:
transitioning the computer system from the first power state to a low power state in which the computer system consumes less power than in the first power state; and
displaying the time user interface in a first collapsed display state different from the first expanded display state, wherein, in the first collapsed display state, the first dial is displayed at a first collapsed size that is smaller than the first expanded size.

36. The computer system of claim 35, the one or more programs further including instructions for:
while the computer system is in the low power state and the time user interface is displayed in the first collapsed display state, detecting that higher power state criteria are met; and
in response to detecting that the higher power state criteria are met:
transitioning the computer system from the low power state to the first power state in which the computer system consumes more power than in the low power state; and
displaying the time user interface in the first expanded display state, including displaying, via the one or more display generation components, the first dial at the first expanded size that is larger than the first collapsed size.

37. A non-transitory computer-readable storage medium storing one or more programs configured to be executed by one or more processors of a computer system that is in communication with one or more display generation components, the one or more programs including instructions for:
displaying, via the one or more display generation components, a time user interface, wherein:
the time user interface includes an indication of a respective time;
the time user interface includes a first dial that is used to indicate the respective time; and
displaying the time user interface includes displaying the first dial moving from a first position of the time user interface to a second position of the time user interface different from the first position as the respective time changes.

38. A method, comprising:
at a computer system that is in communication with one or more display generation components:
displaying, via the one or more display generation components, a time user interface, wherein:
the time user interface includes an indication of a respective time;
the time user interface includes a first dial that is used to indicate the respective time; and
displaying the time user interface includes displaying the first dial moving from a first position of the time user interface to a second position of the time user interface different from the first position as the respective time changes.
